(19) United States
(12) Patent Application Publication
(10) Pub. No.: US 2012/0264637 A1
(43) Pub. Date: Oct. 18, 2012

(54) METHODS AND SYSTEMS FOR PHYLOGENETIC ANALYSIS

(75) Inventors: Jeanine Wiener-Kronish, Boston, MA (US); Susan Lynch, San Francisco, CA (US); Eoin Brodie, San Francisco, CA (US)

(73) Assignee: THE REGENTS OF THE UNIVERSITY OF CALIFORNIA, Oakland, CA (US)

(21) Appl. No.: 13/502,108

(22) PCT Filed: Oct. 15, 2010
(86) PCT No.: PCT/US10/02755

§ 371 Date: Jun. 27, 2012

Related U.S. Application Data
(63) Continuation of application No. PCT/US10/40106, filed on Jun. 25, 2010.
(60) Provisional application No. 61/317,644, filed on Mar. 25, 2010.
(60) Provisional application No. 61/259,565, filed on Nov. 9, 2009.
(60) Provisional application No. 61/220,937, filed on Jun. 26, 2009.
(60) Provisional application No. 61/347,817, filed on May 24, 2010.
(60) Provisional application No. 61/347,817, filed on May 24, 2010.
(60) Provisional application No. 61/317,644, filed on Mar. 25, 2010.
(60) Provisional application No. 61/259,565, filed on Nov. 9, 2009.
(60) Provisional application No. 61/252,620, filed on Oct. 16, 2009.

(51) Int. Cl. C40B 30/04; C40B 40/06

(52) U.S. Cl. 506/9; 506/16

(57) ABSTRACT

Methods and systems for designing and using organism specific and/or operational taxon unit (OTU)-specific probes. The methods and systems allow for detecting, identifying and quantitating a plurality of biomolecules or microorganisms in a sample based on the hybridization or binding of target molecules in the sample with the probes, including the detection of rare OTU's in a sample. In some cases, methods are provided for selecting an oligonucleotide probe specific for a node on a clustering tree.

### CROSS-REFERENCE

This application is related to and claims priority to the following co-pending U.S. provisional patent applications: U.S. Application Ser. No. 61/259,565 [Attorney Docket No. IB-2733P1], filed on Nov. 9, 2009; U.S. Application Ser. No. 61/317,644 [Attorney Docket No. IB-2733P2], filed on Mar. 25, 2010; U.S. Application Ser. No. 61/347,817 [Attorney Docket No. IB-2733P3], filed on May 24, 2010; U.S. Application Ser. No. 61/252,620 [Attorney Docket No. IB-2229P4], filed Oct. 16, 2009; each of which are incorporated herein by reference.

This application is related to the co-pending international application having application number PCT/US2010/040106 [Attorney Docket No. IB-2733PCT], filed on Jun. 25, 2010, which is incorporated herein by reference.

### STATEMENT AS TO FEDERALLY SPONSORED RESEARCH

This invention was made with Government support under Contract No. DE-AC02-05CH11231 awarded by the Department of Energy; a grant from the Department of Homeland Security and Agreement Number 07-576-550-0 from State of California Water Quality Board, and a grant from the National Institutes of Health having Award Number AI075410. The government has certain rights in this invention.

### BACKGROUND OF THE INVENTION

With as many as 10³⁰ microbial genomes globally, across multiple: different environmental and host conditions, variety both within and between microbiomes is well recognized (Huse et al. (2008), PLoS Genetics 4(11): e1000255). As a result of this variety, characterizing the contents of a microbiome is a challenge for current approaches. Firstly, standard culturing techniques are successful in maintaining only a small fraction of the microorganisms in nature. Means of more direct profiling, such as sequencing, face two additional challenges. Both the sheer number of different genomes in a given sample and the degree of homology between members present a complex problem for already laborious procedures.

Biopolymers such as nucleic acids and proteins are often identified in the search for useful genes, to diagnose diseases or to identify organisms. Frequently, hybridization or another binding reaction is used as part of the identification step. As the number of possible targets increases in a sample, the design of systems to detect the different hybridization reactions increases in difficulty along with the analysis of the binding or hybridization data. The design and analysis problems become acute when there are many similar targets in a sample as is the case when the individual species or groups that comprise a microbiome are detected or quantified in a single assay based on a highly conserved polynucleotide. For example, while approximately 98% of bacteria found in the human gut belong to only four bacterial divisions, this includes approximately 36,000 different phylotypes at the strain level, having ≧99% sequence identity (Hattori et al. (2009), DNA Res. 16: 1-12). While possibly containing certain overlapping taxa, the different environments presented by the guts of other hosts are expected to support different microbiomes. In situations where contributions from multiple sub-enviroments are combined, such as a water source potentially contaminated by a variety of sources, just identifying the thousands of taxa is a significant challenge to current methods of detection.

Since the study of microbiomes can offer new insight into origins of environmental change, disease, immunological functions, and physiological functions, improved methods for designing nucleic acids, proteins, or other probes that can recognize specific organisms, or taxa are needed. Similarly, improved methods for data analysis that allow detection and quantification of the members of a microbial community at high confidence levels are also needed.

### SUMMARY OF THE INVENTION

In one aspect, the invention provides a method for determining a pulmonary condition of a subject. In one embodiment, the method comprises: (a) contacting a sample from said subject with a plurality of different probes; (b) determining hybridization signal strength for each of said probes, wherein said determination establishes a biosignature for said sample; and, (c) determining a pulmonary condition of said subject based on the results of step (b). In some embodiments, step (b) further comprises comparing the biosignature of said sample to a biosignature for one or more pulmonary conditions. In some embodiments, the sample is a pulmonary sample, including but not limited to sputum, endotracheal aspirate, a bronchoalveolar lavage sample, or a swab of the endotrachea. In some embodiments, the method further comprises making a healthcare decision based on the results of step (c). In some embodiments, the biosignature comprises the presence, relative abundance, and/or quantity of one or more OTUs selected from OTUs listed in one or more of Table 3, Table 4, or Table 5. In some embodiments, the biosignature comprises the presence, relative abundance, and/or quantity of at least 1, 2, 3, 4, 5, 6, 7, 8, 9, 10, 11, 12, 13, 14, 15, 16, 17, 18, 19, 20, 30, 40, 50, 100, 250, 300, 400, 500, 600, 700, 800, 900, 1000, or more OTUs listed in one or more of Table 3, Table 4, or Table 5. In some embodiments, the pulmonary condition is selected from the group consisting of: healthy, exacerbated COPD, non-exacerbated COPD, and intermediate COPD exacerbation, wherein intermediate COPD exacerbation comprises a prediction of the onset of exacerbation of COPD in said subject. In some embodiments,

In one aspect, the invention provides a method of classification, diagnosis, prognosis, and/or prediction of an outcome of a pulmonary condition in a subject. In one embodiment, the method comprises: (a) isolating nucleic acid material from a sample from said subject; (b) determining hybridization signal strength distributions of negative control probes that do not specifically hybridize to one or more highly conserved polynucleotides in one or more target operational taxon units (OTUs); (c) determining hybridization signal strengths for a plurality of different interrogation probes, each of which is complementary to a section within said one or more highly conserved polynucleotides; (d) using the hybridization signal strengths of the negative and positive probes to determine the probability that the hybridization signal for the different interrogation probes represents the presence, relative abundance, and/or quantity of said one or more OTUs; and, (e) classifying, diagnosing, prognosing, and/or predicting an outcome of said pulmonary condition based on the results of step (d). In some embodiments, the sample is a pulmonary sample, including but not limited to sputum, endotracheal aspirate, a bronchoalveolar lavage sample, or a swab of the endotrachea. In some embodiments, the method further comprises making a healthcare decision based on the results of step (e). In some embodiments, the pulmonary condition is selected from the group consisting of: healthy, exacerbated COPD, non-exacerbated COPD, and intermediate COPD exacerbation, wherein intermediate COPD exacerbation comprises a prediction of the onset of exacerbation of COPD in said subject. In some embodiments, the presence, relative abundance, and/or quantity is detected with a confidence level greater than 95%. Highly conserved polynucleotides include, but are not limited to, 16S rRNA gene, 23S rRNA gene, 5S rRNA gene, 5.8S rRNA gene, 12S rRNA gene, 18S rRNA gene, 28S rRNA gene, gyrB gene, rpoB gene, fusA gene, recA gene, cox1 gene, nif13 gene, RNA molecules derived therefrom, or a combination thereof.

In one aspect, the invention provides a method for assessing a pulmonary condition of a subject. In one embodiment, the method comprises detecting in a sample from said subject the presence, relative abundance, and/or quantity of one or more OTUs in a single assay, wherein said one or more OTUs are selected from OTUs listed in one or more of Table 3, Table 4, or Table 5; and determining the pulmonary condition of said subject based on said detection. In some embodiments, the presence, relative abundance, and/or quantity of at least 1, 2, 3, 4, 5, 6, 7, 8, 9, 10, 11, 12, 13, 14, 15, 16, 17, 18, 19, 20, 30, 40, 50, 100, 250, 300, 400, 500, 600, 700, 800, 900, 1000, or more OTUs listed in one or more of Table 3, Table 4, or Table 5 are detected in a single assay. In some embodiments, the sample is a pulmonary sample, including but not limited to sputum, endotracheal aspirate, a bronchoalveolar lavage sample, or a swab of the endotrachea. In some embodiments, the method further comprises making a healthcare decision based on the determination of the pulmonary condition of the subject. In some embodiments, the pulmonary condition is selected from the group consisting of: healthy, exacerbated COPD, non-1-exacerbated COPD, and intermediate COPD exacerbation, wherein intermediate COPD exacerbation comprises a prediction of the onset of exacerbation of COPD in said subject. In some embodiments, the presence, relative abundance, and/or quantity is detected with a confidence level greater than 95%.

In one aspect, the invention provides a system for practicing the methods of the invention. In one embodiment, the system comprises: (a) negative control probes that do not specifically hybridize to one or more highly conserved polynucleotides in a plurality of target OTUs; and (b) a plurality of different interrogation probes, each of which is complementary to a section within said one or more highly conserved polynucleotides in one or more of said plurality of target OTUs, wherein said plurality of target OTUs consists of OTUs in one or more of Table 3, Table 4, or Table 5. Highly conserved polynucleotides include, but are not limited to, 16S rRNA gene, 23S rRNA gene, 5S rRNA gene, 5.8S rRNA gene, 12S rRNA gene, 18S rRNA gene, 28S rRNA gene, gyrB gene, rpoB gene, fusA gene, recA gene, cox1 gene, nif13 gene, RNA molecules derived therefrom, or a combination thereof. In some embodiments, the system further comprises a plurality of positive control probes, such as probes comprising sequences selected from SEQ ID NOs: 51-100, and/or the complements thereof.

Probes used in methods and systems of the present invention can be used to detect the presence, absence, relative abundance, and/or quantity of at least 10,000 different OTUs in a single assay. In some embodiments, probes are attached to a substrate. Substrates can comprise any suitable material, including but not limited to glass, plastic, or silicon. Substrates can take any suitable shape, such as a flat surface, a bead, or a microsphere.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized; and the accompanying drawings of which:

FIG. 1 illustrates an example of a suitable computer system environment.

FIG. 2 illustrates a networked system for the remote acquisition or analysis of data obtained through a method of the invention.

FIG. 3 illustrates a flow chart of the probe selection process.

FIGS. 4A-B demonstrate the distribution of observed pair difference score, d, from quantitative standards (QS) probes and negative controls (NC) probes.

FIG. 5 is a graph showing variations of gamma scale across 79 arrays.

FIG. 6 illustrates the pre-partition process for computational load balancing.

FIG. 7 is a chart showing the concentration of 16S amplicon versus PhyloChip response.

FIG. 8 is boxplot comparison of the detection algorithm based on pair “response score”, r, distribution (novel) versus the positive fraction calculation (previously used with the G2 PhyloChip.

FIG. 9 is two graphs that show the comparison of the r score metric versus the pf by receiver operator characteristic (R.O.C) plots.

FIG. 10A illustrates a phylogenetic tree exhibiting family level bacterial diversity detected in COPD airways following antimicrobial administration.

FIG. 10B illustrates bacterial richness detected in individual patient samples.

FIG. 11 illustrates the results of NMDS analysis showing bacterial community composition that is highly influenced by the duration of intubation, with subjects COPD 5 and COPD 6 superimposed on the right side of the figure, indicative of highly similar bacterial community composition.

FIG. 12 shows a phylogenetic tree illustrating core bacterial taxa detected in COPD airways sample, with known pathogens denoted with an asterisk, and distinct bacterial families indicated by different shades of gray.

FIG. 13 illustrates the time points of 25 sputa samples before, during, and after clinical exacerbation of COPD, with lines for subjects 3, 19, and 49 having exacerbations clinically considered to be infectious related, first and second time points pre-exacerbation designated pre1 and pre2, respectively, and first and second time points post-exacerbation are designated post1 and post2, respectively.

FIG. 14 a graph that illustrates bacterial community richness as measured by 16S rRNA PhyloChip analysis.

FIG. 15 is a graph showing bacterial community richness over time, with sampling time points combined across subjects.

FIG. 16 illustrates bacterial diversity overtime for each subject as determined by 16S rRNA PhyloChip analysis, using an inverse Simpson index.

FIG. 17 is a graph showing bacterial community diversity over time, with inverse Simpson indices for each time point combined across subjects.

FIG. 18 is a graph showing bacterial community diversity over time, with Shannon indices for each time point combined across subjects.

FIG. 20 illustrates a hierarchical cluster analysis of bacterial community composition across samples based on a Bray-Curtis distance metric of dissimilarities in community composition.

FIG. 21 illustrates an ordination-based analysis of the variation in bacterial community composition across subject samples, using non-metric multidimensional scaling (NMDS), where each circle represents the total bacterial community present in that sample.

FIG. 22 illustrates changes in relative abundance from time points pre1 to exacerbation for selected taxa from subject 3, where each bar is a distinct taxon, a positive change indicates increased relative abundance at the later time point, and a negative change indicates decreased relative abundance at the later time point.

FIG. 23 illustrates changes in relative abundance from time points exacerbation to post2 for selected taxa from subject 3, where each bar is a distinct taxon, a positive change indicates increased relative abundance at the later time point, and a negative change indicates decreased relative abundance at the later time point.

FIG. 24 illustrates changes in relative abundance from each time point to the next for selected taxa from subject 19, where each bar is a distinct taxon, a positive change indicates increased relative abundance at the later time point, and a negative change indicates decreased relative abundance at the later time point.

FIG. 25 illustrates changes in relative abundance from time points pre1 to pre2 and from pre2 to exacerbation for selected taxa from subject 49, where each bar is a distinct taxon, a positive change indicates increased relative abundance at the later time point, and a negative change indicates decreased relative abundance at the later time point.

FIG. 26 illustrates changes in relative abundance from time points exacerbation (Exac) to post1 and from post1 to post2 for selected taxa from subject 49, where each bar is a distinct taxon, a positive change indicates increased relative abundance at the later time point, and a negative change indicates decreased relative abundance at the later time point.

FIG. 27 illustrates changes in relative abundance from each time point to the next for selected taxa from subject 40, where each bar is a distinct taxon, a positive change indicates increased relative abundance at the later time point, and a negative change indicates decreased relative abundance at the later time point.

FIG. 28 illustrates changes in relative abundance from each time point to the next for selected taxa from subject 46, where each bar is a distinct taxon, a positive change indicates increased relative abundance at the later time point, and a negative change indicates decreased relative abundance at the later time point.

FIG. 29 illustrates the bacterial community distribution at the family level for subject 3 over time.

FIG. 30 illustrates the bacterial community distribution at the class level for subject 3 over time.

FIG. 31 illustrates the bacterial community distribution at the family level for subject 19 over time.

FIG. 32 illustrates the bacterial community distribution at the class level for subject 19 over time.

FIG. 33 illustrates the bacterial community distribution at the family level for subject 49 over time.

FIG. 34 illustrates the bacterial community distribution at the class level for subject 49 over time.

FIG. 35 illustrates the bacterial community distribution at the family level for subject 40 over time.

FIG. 36 illustrates the bacterial community distribution at the class level for subject 40 over time.

FIG. 37 illustrates the bacterial community distribution at the family level for subject 46 over time.

FIG. 38 illustrates the bacterial community distribution at the class level for subject 46 over time.

### DETAILED DESCRIPTION OF THE INVENTION

### Definitions

As used herein, the term “oligonucleotide” refers to a polynucleotide, usually single stranded, that is either a synthetic polynucleotide or a naturally occurring polynucleotide. The length of an oligonucleotide is generally governed by the particular role thereof, such as, for example, probe, primer and the like. Various techniques can be employed for preparing an oligonucleotide, for instance, biological synthesis or chemical synthesis. A nucleic acid of the present invention will generally contain phosphodiester bonds, although in some cases, as outlined below, nucleic acid analogs are included that may have alternate backbones, comprising, for example, phosphoramide (Beaucage, et al., Tetrahedron, 49(10):1925 (1993) and references therein; Letsinger, J. Org. Chem., 35:3800 (1970); Sprinzl, et al., Eur. J. Biochem., 81:579 (1977); Letsinger, et al., Nucl. Acids Res., 14:3487 (1986); Sawai, et al., Chem. Lett., 805 (1984), Letsinger, et al., J. Am. Chem. Soc., 110:4470 (1988); and Pauwels, et al., Chemica Scripta, 26:141 (1986)); phosphorothioate (Mag, et al, Nucleic Acids Res., 19:1437 (1991); and U.S. Pat. No. 5,644,048); phosphorodithioate (Briu, et al., J. Am. Chem. Soc., 111:2321 (1989)); O-methylphosphoroamidite linkages (see Eckstein, Oligonucleotides and Analogues: A Practical Approach, Oxford University Press); and peptide nucleic acid backbones and linkages (see Egholm, J. Am. Chem. Soc., 114:1895 (1992); Meier, et al., Chem. Int. Ed. Engl., 31:1008 (1992); Nielsen, Nature, 365:566 (1993); Carlsson, et al., Nature, 380:207 (1996), all of which are incorporated by reference)). Other analog nucleic acids include those with positive backbones (Denpcy, et al., Proc. Natl. Acad. Sci. USA, 92:6097 (1995)); non-ionic backbones (U.S. Pat. Nos. 5,386,023; 5,637,684; 5,602,240; 5,216,141; and 4,469,863; Kiedrowshi, et al., Angew. Chem. Intl. Ed. English, 30:423 (1991); Letsinger, et al., J. Am. Chem. Soc., 110:4470 (1988); Letsinger, et al., Nucleosides & Nucleotides, 13:1597 (1994); Chapters 2 and 3, ASC Symposium Series 580, “Carbohydrate Modifications in Antisense Research”, Ed. Y. S. Sanghui and P. Dan Cook; Mesmaeker, et al., Bioorganic & Medicinal Chem. Lett., 4:395 (1994); Jeffs, et al., J. Biomolecular NMR, 34:17 (1994); Tetrahedron Lett., 37:743 (1996)); and non-ribose backbones, including those described in U.S. Pat. Nos. 5,235,033 and 5,034,506, and Chapters 6 and 7, ASC Symposium Series 580, “Carbohydrate Modifications in Antisense Research”, Ed. Y. S. Sanghui and P. Dan Cook. Nucleic acids containing one or more carbocyclic sugars are also included within the definition of nucleic acids (see Jenkins, et al., Chem. Soc. Rev., (1995) pp. 169-176). Several nucleic acid analogs are described in Rawls, C & E News, Jun. 2, 1997, page 35. All of these references are hereby expressly incorporated by reference.

The nucleic acid may be DNA, RNA, or a hybrid and may contain any combination of deoxyribo- and ribo-nucleotides, and any combination of bases, including uracil, adenine, thymine, cytosine, guanine, inosine, xanthanine, hypoxanthanine, isocytosine, isoguanine, and base analogs such as nitropyrrole and nitroindole, etc. Oligonucleotides can be synthesized by standard methods such as those used in commercial automated nucleic acid synthesizers and later attached to an array, bead or other suitable surface. Alternatively, the oligonucleotides can be synthesized directly on the assay surface using photolithographic or other techniques. In some embodiments, linkers are used to attach the oligonucleotides to an array surface or to beads.

As used herein, the term “nucleic acid molecule” or “polynucleotide” refers to a compound or composition that is a polymeric nucleotide or nucleic acid polymer. The nucleic acid molecule may be a natural compound or a synthetic compound. The nucleic acid molecule can have from about 2 to 5,000,000 or more nucleotides. The larger nucleic acid molecules are generally found in the natural state. In an isolated state, the nucleic acid molecule can have about 10 to 50,000 or more nucleotides, usually about 100 to 20,000 nucleotides. It is thus obvious that isolation of a nucleic acid molecule from the natural state often results in fragmentation. It may be useful to fragment longer target nucleic acid molecules, particularly RNA, prior to hybridization to reduce competing intramolecular structures. Fragmentation can be achieved chemically, enzymatically, or mechanically. Typically, when the sample contains DNA, a nuclease such as deoxyribonuclease (DNase) is employed to cleave the phosphodiester linkages. Nucleic acid molecules, and fragments thereof, include, but are not limited to, purified or unpurified forms of DNA (dsDNA and ssDNA) and RNA, including tRNA, mRNA, rRNA, mitochondrial DNA and RNA, chloroplast DNA and RNA, DNA/RNA hybrids, biological material or mixtures thereof, genes, chromosomes, plasmids, cosmids, the genomes of microorganisms, e.g., bacteria, yeasts, phage, chromosomes, viruses, viroids, molds, fungi, or other higher organisms such as plants, fish, birds, animals, humans, and the like. The polynucleotide can be only a minor fraction of a complex mixture such as a biological sample.

As used herein, the term “hybridize” refers to the process by which single strands of polynucleotides form a double-stranded structure through hydrogen bonding between the constituent bases. The ability of two polynucleotides to hybridize with each other is based on the degree of complementarity of the two polynucleotides, which in turn is based on the fraction of matched complementary nucleotide pairs. The more nucleotides in a given polynucleotide that are complementary to another polynucleotide, the more stringent the conditions can be for hybridization and the more specific will be the binding between the two polynucleotides. Increased stringency may be achieved by elevating the temperature, increasing the ratio of co-solvents, lowering the salt concentration, and combinations thereof.

As used herein, the terms “complementary,” “complement,” and “complementary nucleic acid sequence” refer to the nucleic acid strand that is related to the base sequence in another nucleic acid strand by the Watson-Crick base-pairing rules. In general, two polynucleotides are complementary when one polynucleotide can bind another polynucleotide in an anti-parallel sense wherein the 3′-end of each polynucleotide binds to the 5′-end of the other polynucleotide and each A, T(U), G, and C of one polynucleotide is then aligned with a T(U), A, C, and G, respectively, of the other polynucleotide. Polynucleotides that comprise RNA bases can also include complementary G/U or U/G basepairs. Two complementary strands may comprise complementary regions comprising all or one or more portions of one or both strands.

As used herein, the term “clustering tree” refers to a hierarchical tree structure in which observations, such as organisms, genes, and polynucleotides, are separated into one or more clusters. The root node of a clustering tree consists of a single cluster containing all observations, and the leaf nodes correspond to individual observations. A clustering tree can be constructed on the basis of a variety of characteristics of the observations, such as sequences of the genes and morphological traits of the organisms. Many techniques known in the art, e.g. hierarchical clustering analysis, can be used to construct a clustering tree. A non-limiting example of the clustering tree is a phylogenetic, taxonomic or evolutionary tree.

As used herein, the terms “operational taxon unit,” “OTU,” “taxon,” “hierarchical cluster,” and “cluster” are used interchangeably. An operational taxon unit (OTU) refers to a group of one or more organisms that comprises a node in a clustering tree. The level of a cluster is determined by its hierarchical order. In one embodiment, an OTU is a group tentatively assumed to be a valid taxon for purposes of phylogenetic analysis. In another embodiment, an OTU is any of the extant taxonomic units under study. In yet another embodiment, an OTU is given a name and a rank. For example, an OTU can represent a domain, a sub-domain, a kingdom, a sub-kingdom, a phylum, a sub-phylum, a class, a sub-class, an order, a sub-order, a family, a subfamily, a genus, a subgenus, or a species. In some embodiments, OTUs can represent one or more organisms from the kingdoms eubacteria, protista, or fungi at any level of a hierarchal order. In some embodiments, an OTU represents a prokaryotic or fungal order.

As used herein, the term “kmer” refers to a polynucleotide of length k. In some embodiments, k is an integer from 1 to 1000. In some embodiments, k is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 125, 150, 175, 200, 250, 300, 400, 500, 600, 700, 800, 900, or 1000.

As used herein, the term “perfect match probe” (PM probe) refers to a kmer which is 100% complementary to at least a portion of a highly conserved target gene or polynucleotide. The perfect complementarity usually exists throughout the length of the probe. Perfect probes, however, may have a segment or segments of perfect complementarity that is/are flanked by leading or trailing sequences lacking complementarity to the target gene or polynucleotide.

As used herein, the term “mismatch probe” (MM probe) refers a control probe that is identical to a corresponding PM probe at all positions except for one, 2, 3, 4, 5, 6, 7, 8, 9 or 10 nucleotides of the PM probe. Typically, the non-identical position or positions are located at or near the center of the PM probe. In some embodiments, the mismatch probes are universal mismatch probes, e.g., a collection of mismatch probes that have no more than a set number of nucleotide variations or substitutions compared to positive probes. For example, the universal mismatch probes may differ in nucleotide sequence by no more than five nucleotides compared to any one PM probe in the PM probe set. In some embodiments, a MM probe is used adjacent to each test probe, e.g., a PM probe targeting a bacterial 16S rRNA sequence, in the array.

As used herein, the term “probe pair” refers to a PM probe and its corresponding MM probe. In some embodiments, the PM probes and the MM probes are scored in relation to each other during data processing and statistic analysis. As used herein, the term “a probe pair associated with an OTU” is defined as a pair of probes consisting of an OTU-specific PM probe and its corresponding MM probe.

As used herein, a “sample” is from any source, including, but not limited to a biological sample, a gas sample, a fluid sample, a solid sample, or any mixture thereof.

As used herein, a “microorganism” or “organism” includes, but is not limited to, a virus, viroids, bacteria, archaea, fungi, protozoa and the like.

The term “sensitivity” refers to a measure of the proportion of actual positives which are correctly identified as such.

The term “specificity” refers to a measure of the proportion of actual negatives which are correctly identified as such.

The term “confidence level” refers to the likelihood, expressed as a percentage, that the results of a test are real and repeatable, and not random. Confidence levels are used to indicate the reliability of an estimate and can be calculated by a variety of methods.

### Biosignatures

In one aspect, the invention utilizes a biosignature of OTUs. As used herein, the term “biosignature” refers to an association of the level of one or more members of one or more OTUs with a particular condition, such as a classification, diagnosis, prognosis, and/or predicted outcome of a pulmonary condition in a subject. In one embodiment, the biosignature comprises a determination of the presence, absence, and/or quantity of at least 1, 2, 3, 4, 5, 10, 20, 50, 100, 250, 500, 1000, 5000, 10,000, 20,000, 30,000, 40,000, 50,000, 60,000, 70,000, 80,000, 90,000, 100,000, 250,000, 500,000 or 1,000,000 OTUs in a sample using a single assay. In some embodiments, the biosignature comprises the presence of or changes in the level of at least 1, 2, 3, 4, 5, 6, 7, 8, 9, 10, 15, 20, 30, 40, 50, 75, 100, 125, 150, 175, 200, 250, 300, or more OTUs. In some embodiments, OTUs in a biosignature comprise OTUs selected from one or more of Table 3, Table 4, or Table 5.

In one embodiment, the biosignature is associated with a single condition, for example a single pulmonary condition. In another embodiment, the biosignature is associated with a combination of conditions, for example two or more pulmonary conditions, or one or more pulmonary conditions combined with one or more non-pulmonary conditions. In some embodiments, the condition is chronic obstructive pulmonary disease. A biosignature can be obtained for any sample, including but not limited to: tissue samples; cell culture samples; bacterial culture samples; samples obtained from a subject, including biopsies, body fluids and other excreted material; pulmonary samples; other samples as described herein; materials derived therefrom; and combinations thereof. In some embodiments, the sample is a pulmonary sample. In some embodiments, the pulmonary sample is sputum, endotracheal aspirate, bronchoalveolar lavage sample, a swab of the endotrachea, materials derived therefrom, or combinations thereof. In some embodiments, a biosignature of a test sample is compared to a known biosignature, and a determination is made as to likelihood that the biosignatures are the same. In some embodiments, a biosignature of a sample is compared to a biosignature for a classification, diagnosis, prognosis, and/or predicted outcome of a pulmonary condition. The biosignature to which the biosignature of the test sample is compared can be determined before, after, or at substantially the same time as that of the test sample. Biosignatures can be the result of one or more analyses of one or more samples from a particular source. In some embodiments, a biosignature is indicative of a response to treatment. In some embodiments, a biosignature is used as a basis for the selection of a mode of treatment.

In some embodiments, the biosignature of a test sample is a combination of two or more independent biosignatures, such as 2, 3, 4, 5, 6, 7, 8, 9, 10 or more independent biosignatures. In one embodiment, each of the two or more biosignatures contained in a sample are assayed simultaneously. In a further embodiment, a subset of biosignatures can be evaluated through the use of low-density detection systems, comprising the determination of the presence, absence, and/or level of no more than 10, 25, 50, 100, 250, 500, 1000, 2000, or 5000 OTUs.

In some embodiments, a biosignature comprises a measure of the number of members in one or more bacterial families or OTUs. The number of members may range from 0 to 10000 or more, such as 0 to 5000, 0 to 2500, 0 to 1000, 0 to 2000, 0 to 1000, 0 to 900, 0 to 800, 0 to 700, 0 to 600, 0 to 500, 0 to 400, 0 to 300, 0 to 200, 0 to 100, 0 to 50, 0 to 25, 0 to 20, 0 to 10, or 0 to 5. In some embodiments, a biosignature comprises the presence of 1, 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 1000, 2000, 2500, 5000, 10000, or more members of one or more bacterial families or OTUs, or the presence of a range that includes any two of these values as end points. In some embodiments, a biosignature comprises a ratio between numbers of members in two or more bacterial families or OTUs. The numerator and denominator of such ratios may include overlapping sets of bacterial families or OTUs. Ratios of the numbers of members in two or more bacterial families may compare a first set of one or more bacterial families or OTUs to a second set of one or more bacterial families or OTUs, where there is at least one bacterial family or OTU difference between the first and second set. A set of bacterial families or OTUs may include 1, 2, 3, 4, 5, 6, 7, 8, 9, 10, 11, 12, 13, 14, 15, 16, 17, 18, 19, 20, 25, 30, 40, 50, 60, 70, 80, 90, 100, or more OTUs. Bacterial families or OTUs may be selected from one or more of Table 3, Table 4, or Table 5. Examples of bacterial families or OTUs include, but are not limited to, Campylobacteraceae, Porphyromonadaceae, Prevotellaceae, Corynebacteriaceae, Enterobacteriaceae, Alteromonadaceae, Peptococc/Acidaminococcacea, Lactobacillaceae, Enterococcaceae, Pasteurellaceae, Flavobacteriaceae, Acidobacteriaceae, Staphylococcaceae, Micrococcaceae, Peptostreptococcaceae, Helicobacteraceae, Streptococcaceae, Pseudomonadaceae, Bacillaceae, Clostridiaceae, Mollicutes, Cyanobacteria, Anaerolineae, Sphingobacteria, Acidobacteria, Flavobacteria, Alphaproteobacteria, Bacteroidetes, Epsilonproteobacteria, Betaproteobacteria, Deltaproteobacteria, Actinobacteria, Gammaproteobacteria, Bacilli, Clostridia, Moraxellaceae, Chloroplasts, Peptostreptococcaceae, Spirochaetaceae, Lachnospiraceae, Verrucomicrobiae, Corynebacteriaceae, Bifidobacteriaceae, Micromonosporaceae, Desulfotomaculum, Dehalococcoidetes, and bacterial families or OTUs as described in the drawings.

In one aspect, the invention provides methods, systems, and compositions for detecting and identifying a plurality of biomolecules and/or organisms in a sample. The invention utilizes the ability to differentiate between individual organisms or OTUs. In one aspect, the individual organisms or OTUs are identified using organism-specific and/or OTU-specific probes, e.g., oligonucleotide probes. More specifically, some embodiments relate to selecting organism-specific and/or OTU-specific oligonucleotide probes useful in detecting and identifying biomolecules and organisms in a sample. In some embodiments, an oligonucleotide probe is selected on the basis of the cross-hybridization pattern of the oligonucleotide probe to regions within a target oligonucleotide and its homologs in a plurality of organisms. The homologs can have nucleotide sequences that are at least 80%, 85%, 90%, 91%, 92%, 93%, 94%, 95%, 96%, 97%, 98%, 99% or 99.5% identical. Such oligonucleotides can be gene, or intergenetic sequences, in whole or a portion thereof. The oligonucleotides can range from 10 to over 10,000 nucleotides in length. In some other embodiments, a method is provided for detecting the presence of an OTU in a sample based at least partly on the cross-hybridization of the OTU-specific oligonucleotide probes to probes specific for other organisms or OTUs. In some embodiments, the biosignature to which a sample biosignature is compared comprises a positive result for the presence of the targets for one or more probes.

In one aspect, the invention provides a diagnostic system for the determination or evaluation of a biosignature of a sample. In one embodiment, the diagnostic system comprises at least 1, 2, 3, 4, 5, 6, 7, 8, 9, 10, 15, 20, 30, 40, 50, 75, 100, 125, 150, 175, 200, 250, 300, or more probes. In another embodiment, the diagnostic system comprises up to 1, 2, 3, 4, 5, 6, 7, 8, 9, 10, 15, 20, 30, 40, 50, 75, 100, 125, 150, 175, 200, 250, 300, or more probes.

### High Capacity Systems

In one aspect of the invention, a high capacity system is provided for determining a biosignature of a sample by assessing the total microorganism population of a sample in terms of the microorganisms present and optionally their percent composition of the total population. In some embodiments, the system comprises a plurality of probes that are capable of determining the presence or quantity of at least 10,000, 20,000, 30,000, 40,000, 50,000, 60,000, or more different OTUs in a single assay. In some embodiments, one or more OTUs are selected from one or more of Table 3, Table 4, or Table 5. Typically, the probes selectively hybridize to a highly conserved polynucleotide. Usually, the probes hybridize to the same highly conserved polynucleotide or within a portion thereof. Generally, the highly conserved polynucleotide or fragment thereof comprises a gene or fragment thereof. Non-limiting examples of highly conserved polynucleotides comprise nucleotide sequences found in the 16S rRNA gene, 23S rRNA gene, 5S rRNA gene, 5.8S rRNA gene, 12S rRNA gene, 18S rRNA gene, 28S rRNA gene, gyrB gene, rpoB gene, fusA gene, recA gene, cox1 gene and nifD gene. In other embodiments, two or more, three or more, four or more, five or more, six or more, seven or more, eight or more, nine or more, ten or more, 15 or more, 20 or more, 25 or more, or 50 or more collections of probes are employed, each of which specifically hybridizes to a different highly conserved polynucleotide or portion thereof. For example, a first collection of probes binds to the same region of the 16S rRNA gene, a second collection of probes binds to the same region of the 16S rRNA gene that is different from the region bound by probes in the first collection, and a third collection of probes binds to the same region of the 23S rRNA gene. The use of two or more collections of probes where each collection recognizes distinct and separate highly conserved polynucleotides or portions thereof allows for the generation and testing of more probes the use of which can provide greater discrimination between species or OTUs.

Highly conserved polynucleotides usually show at least 80%, 85%, 90%, 92%, 94%, 95%, or 97% homology across a domain, kingdom, phylum, class, order, family or genus, respectively. The sequences of these polynucleotides can be used for determining evolutionary lineage or making a phylogenetic determination and are also known as phylogenetic markers. In some embodiments, a biosignature comprises the presence, absence, and/or abundance of a combination of phylogenetice markers. The OTUs detected by the probes disclosed herein can be bacterial, archeal, fungal, or eukaryotic in origin. Additionally, the methodologies disclosed herein can be used to quantify OTUs that are bacterial, archaeal, fungal, or eukaryotic. By combining the various probe sets, a system for the detection of bacteria, archaea, fungi, eukaryotes, or combinations thereof can be designed. Such a universal microorganism test that is conducted as a single assay can provide great benefit for assessing and understanding the composition and ecology of numerous environments, including characterization of biosignatures for various samples, environments, conditions, and contaminants.

In another aspect of the invention, a system is provided that is capable of determining the probability of presence and optionally quantity of at least 10,000, 20,000, 30,000, 40,000, 50,000 or 60,000 different OTUs of a single domain in a single assay. Such a system makes a probability determination with a confidence level greater than 90%, 91%, 92%, 93%, 94%, 95%, 99% or 99.5%. In some embodiments, a biosignature can comprise the combined result of each probability determination.

Some embodiments provide a method of selecting an oligonucleotide probe that is specific for a node in a clustering tree. In some embodiments, the method comprises selecting a highly conserved target polynucleotide and its homologs for a plurality of organisms; clustering the polynucleotides and homologs of the plurality of organisms into a clustering tree; and determining a cross-hybridization pattern of a candidate oligonucleotide probe that hybridizes to a first polynucleotide to each node on the clustering tree. This determination is performed (e.g., in silico) to determine the likelihood that the probe would cross hybridize with homologs of its target complementary sequence. The candidate oligonucleotide probe can be complementary to a highly conserved target polynucleotide, a fragment of the highly conserved target or one of its homologs in one of the plurality of organisms. In some embodiments, a method is provided for the determination of the cross-hybridization pattern of a variant of the candidate oligonucleotide probe to each node on the clustering tree, wherein the variant corresponds to the candidate oligonucleotide probe but comprises at least 1 nucleotide mismatch; and selecting or rejecting the candidate oligonucleotide probe on the basis of the cross-hybridization pattern of the candidate oligonucleotide probe and the cross-hybridization pattern of the variant. In some embodiments, the node is an operational taxon unit (OTU). In some embodiments, the node is a single organism.

Some embodiments provide a method of selecting an OTU-specific oligonucleotide probe for use in detecting a plurality of organisms in a sample. In some embodiments, the method comprises: selecting a highly conserved target polynucleotide and its homologs from the plurality of organisms; clustering the polynucleotides of the target gene and its homologs from the plurality of organisms into one or more operational taxonomic units (OTUs), wherein each OTU comprises one or more groups of similar nucleotide sequence; determining the cross-hybridization pattern of a candidate OTU-specific oligonucleotide probe to the OTUs, wherein the candidate OTU-specific oligonucleotide probe corresponds to a fragment of the target gene or its homolog from one of the plurality of organisms; determining the cross-hybridization pattern of a variant of the candidate OTU-specific oligonucleotide probe to the OTUs, wherein the variant comprises at least 1 nucleotide mismatch from the candidate OTU-specific oligonucleotide probe; and selecting or rejecting the candidate OTU-specific oligonucleotide probe on the basis of the cross-hybridization pattern of the candidate OTU-specific oligonucleotide probe and the cross-hybridization pattern of the variant. In some embodiments, the candidate OTU-specific oligonucleotide probe is selected if the candidate OTU-specific oligonucleotide probe does not cross-hybridize with any polynucleotide that is complementary to probes from other OTUs. In further embodiments, the candidate OTU-specific oligonucleotide probe is selected if the candidate OTU-specific oligonucleotide probe cross-hybridizes with the polynucleotide in no more than 1, 2, 3, 4, 5, 6, 7, 8, 9, 10, 11, 12, 13, 14, 15, 20, 30, 40, 50, 100, 200, 500, or 1000 other OTU groups.

Some embodiments provide a method of selecting a set of organism-specific oligonucleotide probes for use in detecting a plurality of organisms in a sample. In some embodiments, the method comprises: identifying a highly conserved target polynucleotide and its homologs in the plurality of organisms; determining the cross-hybridization pattern of a candidate organism-specific oligonucleotide probe to the sequences of the highly conserved target polynucleotide and its homologs in the plurality of organisms, wherein the candidate oligonucleotide probe corresponds to a fragment of the target sequence or its homolog from one of the plurality of organisms; determining the cross-hybridization pattern of a variant of the candidate organism-specific oligonucleotide probe to the sequences of the highly conserved target sequence and its homologs in the plurality of organisms, wherein the variant comprises at least 1 nucleotide mismatch from the candidate organism-specific oligonucleotide probe; and selecting or rejecting the candidate organism-specific oligonucleotide probe on the basis of the cross-hybridization pattern of the candidate organism-specific oligonucleotide probe and the cross-hybridization pattern of the variant of the candidate organism-specific oligonucleotide probe.

In some embodiments, an OTU-specific oligonucleotide probe does not cross-hybridize with any polynucleotide that is complementary to probes from other OTUs. In other embodiments, an OTU-specific oligonucleotide probe cross-hybridizes with the polynucleotide in no more than 1, 2, 3, 4, 5, 6, 7, 8, 9, 10, 11, 12, 13, 14, 15, 20, 30, 40, 50, 100, 200, 500, or 1000 other OTU groups. Some embodiments utilize a set of organism-specific oligonucleotide probes for use in detecting a plurality of organisms in a sample. In further embodiments, the candidate organism-specific oligonucleotide probe is selected if the candidate organism-specific oligonucleotide probe only hybridizes with the target nucleic acid molecule of no more than 1, 2, 3, 4, 5, 6, 7, 8, 9, 10, 11, 12, 13, 14, 15, 20, 30, 40, 50 unique organisms in the plurality of organisms. In other embodiments, the process is iterative with multiple candidate specific-specific oligonucleotide probes selected. Frequently, the selected organism-specific oligonucleotide probes are clustered and aligned into groups of similar sequences that allow for the detection of an organism with high confidence based on no more than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 50, or 60 organism-specific oligonucleotide probe matches per OTU. Generally, the candidate organism that the organism-specific oligonucleotide probes detect corresponds to a leaf or node of at least one phylogenetic, genealogic, evolutionary, or taxonomic tree. Knowledge of the position that a candidate organism detected by the organism-specific oligonucleotide probe occupies on a tree provides relational information of the organism to other members of its domain, phylum, class, subclass, order, family, subfamily, or genus.

In some embodiments, the method disclosed herein selects and/or utilizes a set of organism-specific oligonucleotide probes that are a hierarchical set of oligonucleotide probes that can be used to detect and differentiate a plurality of organisms. In some embodiments, the method selects and/or utilizes organism-specific or OTU-specific oligonucleotide probes that allow a comprehensive screen for at least 80%, 85%, 90%, 95%, 99% or 100% of all known bacterial or archaeal taxa in a single analysis, and thus provides an enhanced detection of different desired taxonomic groups. In some embodiments, the identity of all known bacterial or archaeal taxa comprises taxa that were previously identified by the use of oligonucleotide specific probes, PCR cloning, and sequencing methods. Some embodiments provide methods of selecting and/or utilizing a set of oligonucleotide probes capable of correctly categorizing mixed target nucleic acid molecules into their proper operational taxonomic unit (OTU) designations. Such methods can provide comprehensive prokaryotic or eukaryotic identification, and thus comprehensive biosignature characterization.

In some embodiments, the selected OTU-specific oligonucleotide probe is used to calculate the relative abundance of one or more organisms that belong to a specific OTU at differing levels of taxonomic identification. In some embodiments, an array or collection of microparticles comprising at least one organism-specific or OTU-specific oligonucleotide probe selected by the method disclosed herein is provided to infer specific microbial community activities. For example, the identity of individual taxa in a microbial consortium from an anaerobic environment for instance, a marsh, can be determined along with their relative abundance. If the consortium is suspected of harboring microorganisms capable of butanol fermentation, then after providing a suitable feedstock in an anaerobic environment if the production of butanol is noted, then those taxa responsible for butanol fermentation can be inferred by the microorganisms that have abundant quantities of 16S rRNA. The invention provides methods to measure taxa abundance based on the detection of directly labeled 16S rRNA.

In some embodiments, multiple probes are selected for increasing the confidence level and/or sensitivity level of identification of a particular organism or OTU. The use of multiple probes can greatly increase the confidence level of a match to a particular organism. In some embodiments, the selected organism-specific oligonucleotide probes are clustered and aligned into groups of similar sequence such that detection of an organism is based on 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35 or more oligonucleotide probe matches. In some embodiments, the oligonucleotide probes are specific for a species. In other embodiments, the oligonucleotide probe recognizes related organisms such as organisms in the same subgenus, genus, subfamily, family, sub-order, order, sub-class, class, sub-phylum, phylum, sub-kingdom, or kingdom.

Perfect match (PM) probes are perfectly complementary to the target polynucleotide, e.g., a sequence that identifies a particular organism. In some embodiments, a system of the invention comprises mismatch (MM) control probes. Usually, MM probes are otherwise identical to PM probes, but differ by one or more nucleotides. Probes with one or more mismatch can be used to indicate non-specific binding and a possible non-match to the target sequence. In some embodiments, the MM probes have one mismatch located in the center of the probe, e.g., in position 13 for a 25mer probe. The MM probe is scored in relation to its corresponding PM probe as a “probe pair.” MM probes can be used to estimate the background hybridization, thereby reducing the occurrence of false positive results due to non-specific hybridization, a significant problem with many current detection systems. If an array is used, such as an Affymetrix high density probe array or Illumina bead array, ideally, the MM probe is positioned adjacent or close to its corresponding PM probe on the array.

Some embodiments relate to a method of selecting and/or utilizing a set of oligonucleotide probes that enable simultaneous identification of multiple prokaryotic taxa with a relatively high confidence level. Typically, the confidence level of identification is at least 90%, 91%, 92%, 93%, 94%, 95%, 96%, 97%, 98%, 99% or 99.5%. In general, an OTU refers to an individual species or group of highly related species that share an average of at least 80%, 85%, 90%, 91%, 92%, 93%, 94%, 95%, 96%, 97%, 98%, 99% 99.5%, or more sequence homology in a highly conserved region. Multiple MM probes may be utilized to enhance the quantification and confidence of the measure. In some embodiments, each interrogation probe of a plurality of interrogation probes has from about 1 to about 20 corresponding mismatch control probes. In further embodiments, each interrogation probe has from about 1 to about 10, about 1 to about 5, about 1 to 4, 1 to 3, 2 or 1 corresponding mismatch probes. These interrogation probes target unique regions within a target nucleic acid sequence, e.g., a 16S rRNA gene, and provide the means for identifying at least about 10, 20, 50, 100, 500, 1,000, 2,000, 5,000, 10,000, 20,000, 30,000, 40,000, 50,000, 60,000, 70,000, 80,000, 90,000, 100,000, 250,000, 500,000 or 1,000,000 taxa. In some embodiments, multiple targets can be simultaneously assayed or detected in a single assay through a high-density oligonucleotide probe system. The sum of all target hybridizations is used to identify specific prokaryotic taxa. The result is a more efficient and less time consuming method of identifying unculturable or unknown organisms. The invention can also provide results that could not previously be achieved, e.g., providing results in hours where other methods would require days. In some embodiments, a microbiome (i.e., sample) can be assayed to determine the identity and optionally the abundance of its constituent microorganisms in less than 20, 19, 18, 17, 16, 15, 14, 13, 12, 11, 10, 9, 8, 7, 6, 5, 4, 3, 2, or 1 hour.

In some embodiments, the set of OTU-specific oligonucleotide probes comprises from about 1 to about 500 probes for each taxonomic group. In some embodiments, the probes are proteins including antibodies, or nucleic acid molecules including oligonucleotides or fragments thereof. In some embodiments, an oligonucleotide probe corresponds to a nucleotide fragment of the target nucleic acid molecule. In some embodiments, from about 1 to about 500, about 2 to about 200, about 5 to about 150, about 8 to about 100, about 10 to about 35, or about 12 to about 30 oligonucleotide probes can be designed for each taxonomic grouping. In other embodiments, a taxonomic group can have at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 40, or more probes. In some embodiments, various taxonomic groups can have different numbers of probes, while in other embodiments, all taxonomic groups have a fixed number of probes per group. Multiple probes in a taxonomic group can provide additional data that can be used to make a determination, also known as “making a call” as to whether an OTU is present or not. Multiple probes also allow for the removal of one or more probes from the analysis based on insufficient signal strength, cross hybridization or other anomalies. Removing probes can increase the confidence level of results and further allow for the detection of low abundant microorganisms. The oligonucleotide probes can each be from about 5 to about 100 nucleotides, from about 10 to about 50 nucleotides, from about 15 to about 35 nucleotides, or from about 20 to about 30 nucleotides. In some embodiments, the probes are at least 5-mers, 6-mers, 7-mers, 8-mers, 9-mers, 10-mers, 11-mers, 12-mers, 13-mers, 14-mers, 15-mers, 16-mers, 17-mers, 18-mers, 19-mers, 20-mers, 21-mers, 22-mers, 23-mers, 24-mers, 25-mers, 26-mers, 27-mers, 28-mers, 29-mers, 30-mers, 31-mers, 32-mers, 33-mers, 34-mers, 35-mers, 36-mers, 37-mers, 38-mers, 39-mers, 40-mers, 41-mers, 42-mers, 43-mers, 44-mers, 45-mers, 46-mers, 47-mers, 48-mers, 49-mers, 50-mers, 51-mers, 52-mers, 53-mers, 54-mers, 55-mers, 56-mers, 57-mers, 58-mers, 59-mers, 60-mers, 61-mers, 62-mers, 63-mers, 64-mers, 65-mers, 66-mers, 67-mers, 68-mers, 69-mers, 70-mers, 71-mers, 72-mers, 73-mers, 74-mers, 75-mers, 76-mers, 77-mers, 78-mers, 79-mers, 80-mers, 81-mers, 82-mers, 83-mers, 84-mers, 85-mers, 86-mers, 87-mers, 88-mers, 89-mers, 90-mers, 91-mers, 92-mers, 93-mers, 94-mers, 95-mers, 96-mers, 97-mers, 98-mers, 99-mers, 100-mers or combinations thereof.

Some embodiments provide methods of selecting multiple, confirmatory, organism-specific or OTU-specific probes to increase the confidence of detection. In some embodiments, the methods also select one or more mismatch (MM) probes for every perfect match (PM) probe to minimize the effect of cross-hybridization by non-target regions. The organism-specific and OTU-specific oligonucleotide probes selected by the methods disclosed herein can simultaneously identify thousands of taxa present in an environmental sample and allow accurate identification of microorganisms and their phylogenetic relationships in a community of interest. Systems that use the organism-specific and OTU-specific oligonucleotide probes selected by the methods disclosed herein and the computational analysis disclosed herein have numerous advantages over rRNA gene sequencing techniques. Such advantages include reduced cost per microbiome analysis, and increased processing speed per sample or microbiome from both the physical analysis and the computational analysis point of view. In general, the analysis procedures are not adversely affected by chimeras, are not subject to creating artificial phylotypes, and are not subject to barcode PCR bias. Additionally, quantitative standards can be run with a microbiome sample of the invention.

Some embodiments provide a method for selecting and/or utilizing a set of OTU- or organism-specific oligonucleotide probes for use in an analysis system or bead multiplex system for simultaneously detecting a plurality of organisms in a sample. The method targets known diversity within target nucleic acid molecules to determine microbial community composition and establish a biosignature. The target nucleic acid molecule is typically a highly conserved polynucleotide. In some embodiments, the highly conserved polynucleotide is from a highly conserved gene, whereas in other embodiments the polynucleotide is from a highly conserved region of a gene with moderate or large sequence variation. In further embodiments, the highly conserved region may be an intron, exon, or a linking section of nucleic acid that separates two genes. In some embodiments, the highly conserved polynucleotide is from a “phylogenetic” gene. Phylogenetic genes include, but are not limited to, the 5.8S rRNA gene, 12S rRNA gene, 16S rRNA gene-prokaryotic, 16S rRNA gene-mitochondrial, 18S rRNA gene, 23S rRNA gene, 28S rRNA gene, gyrB gene, rpoB gene, fusA gene, recA gene, cox1 gene, and the nifD gene. With eukaryotes, the rRNA gene can be nuclear, mitochondrial, or both. In some embodiments, the 16S-23S rRNA gene internal transcribed spacer (ITS) can be used for differentiation of closely related taxa with or without the use of other rRNA genes. For example, rRNA, e.g., 16S or 23S rRNA, acts directly in the protein assembly machinery as a functional molecule rather than having its genetic code translated into protein. Due to structural constraints of 16S rRNA, specific regions throughout the gene have a highly conserved polynucleotide sequence; although, non-structural segments may have a high degree of variability. Probing the regions of high variability can be used to identify OTUs that represent a single species level, while regions of less variability can be used to identify OTUs that represent a subgenus, a genus, a subfamily, a family, a sub-order, an order, a sub-class, a class, a sub-phylum, a phylum, a sub-kingdom, or a kingdom. The methods disclosed herein can be used to select organism-specific and OTU-specific oligonucleotide probes that offer a high level of specificity for the identification of specific organisms, OTUs representing specific organisms, or OTUs representing specific taxonomic group of organisms. The systems and methods disclosed herein are particularly useful in identifying closely related microorganisms and OTUs from a background or pool of closely related organisms.

The probes selected and/or utilized by the methodologies of the invention can be organized into OTUs that provide an assay with a sensitivity and/or specificity of more than 80%, 85%, 90%, 91%, 92%, 93%, 94%, 95%, 96%, 97%, 98% or 99%. In some embodiments, sensitivity and specificity depends on the hybridization signal strength, number of probes in the OTU, the number of potential cross hybridization reactions, the signal strength of the mismatch probes, if present, background noise, or combinations thereof. In some embodiments, an OTU containing one probe may provide an assay with a sensitivity and specificity of at least 90%, while another OTU may require at least 20 probes to provide an assay with sensitivity and specificity of at least 90%.

Some embodiments relate to methods for phylogenetic analysis system design and signal processing and interpretation for use in detecting and identifying a plurality of biomolecules and organisms in a sample. More specifically, some embodiments relate to a method of selecting a set of organism-specific oligonucleotide probes for use in detecting a plurality of organisms in a sample with a high confidence level. Some embodiments relate to a method of selecting a set of OTU-specific oligonucleotide probes for use in detecting a plurality of organisms in a sample with a high confidence level.

In the case of highly conserved polynucleotides like 16S rRNA that may have only one to a few nucleotides of sequence variability over any 15- to 30-bp region targeted by probes for discrimination between related microbial species, it is advantageous to maximize the probe-target sequence specificity in an assay system. Some embodiments of the present invention provide methods of selecting organism-specific oligonucleotide probes that effectively minimize the influence of cross-hybridization. In one embodiment, the method comprises: (a) identifying sequences of a target nucleic acid molecule corresponding to the plurality of organisms; (b) determining the cross-hybridization pattern of a candidate organism-specific oligonucleotide probe to the target nucleic acid molecule from the plurality of organisms, wherein the candidate oligonucleotide probe corresponds to a sequence fragment of the target nucleic acid molecule from the plurality of organisms; (c) determining the cross-hybridization pattern of a variant of the candidate organism-specific oligonucleotide probe to the target nucleic acid molecule from the plurality of organisms, wherein the variant of the candidate organism-specific oligonucleotide probe comprises at least 1 nucleotide mismatch compared to the candidate organism-specific oligonucleotide probe; and (d) selecting or rejecting the candidate organism-specific oligonucleotide probe on the basis of the cross-hybridization pattern of the candidate organism-specific oligonucleotide probe and the cross-hybridization pattern of the variant of the candidate organism-specific oligonucleotide probe. In some embodiments, a method of selecting a set of OTU-specific oligonucleotide probes for use in detecting a plurality of organisms in a sample is provided. In some embodiments, the method comprises: (a) identifying sequences of a target nucleic acid molecule corresponding to the plurality of organisms; (b) clustering the sequences of the target nucleic acid molecule from the plurality of organisms into one or more Operational Taxonomic Units (OTUs), wherein each OTU comprises one or more groups of similar sequences; (c) determining the cross-hybridization pattern of a candidate OTU-specific oligonucleotide probe to the OTUs, wherein the candidate OTU-specific oligonucleotide probe corresponds to a sequence fragment of the target nucleic acid molecule from one of the plurality of organisms; (d) determining the cross-hybridization pattern of a variant of the candidate OTU-specific oligonucleotide probe to the OTUs, wherein the variant of the candidate OTU-specific oligonucleotide probe comprises at least 1 nucleotide mismatch compared to the candidate OTU-specific oligonucleotide probe; and (e) selecting or rejecting the candidate OTU-specific oligonucleotide probe on the basis of the cross-hybridization pattern of the candidate OTU-specific oligonucleotide probe to the OTUs and the cross-hybridization pattern of the variant of the candidate OTU-specific oligonucleotide probe to the OTUs. In some embodiments, candidate OTU-specific oligonucleotide probe are rejected when the candidate OTU-specific oligonucleotide probe or its variant are predicted to cross-hybridize with other target sequences. In some embodiments, a predetermined amount of predicted cross-hybridization is allowed.

In some embodiments, selected oligonucleotide probes are synthesized by any relevant method known in the art. Some examples of suitable methods include printing with fine-pointed pins onto glass slides, photolithography using pre-made masks, photolithography using dynamic micromirror devices, ink-jet printing, or electrochemistry. In one example, a photolithographic method can be used to directly synthesize the chosen oligonucleotide probes onto a surface. Suitable examples for the surface include glass, plastic, silicon and any other surface available in the art. In certain examples, the oligonucleotide probes can be synthesized on a glass surface at an approximate density from about 1,000 probes per μm² to about 100,000 probes per μm², preferably from about 2000 probes per μm² to about 50,000 probes per μm², more preferably from about 5000 probes per μm² to about 20,000 probes per μm². In one example, the density of the probes is about 10,000 probes per μm². The number of probes on the array can be quite large e.g., at least 10⁵, 10⁶, 10′, 10⁸ or 10⁹ probes per array. Usually, for large arrays only a relatively small proportion (i.e., less than about 1%, 0.1% 0.01%, 0.001%, 0.00001%, 0.000001% or 0.0000001%) of the total number of probes of a given length target an individual OTU. Frequently, lower limit arrays have no more than 10, 25, 50, 100, 500, 1,000, 5,000, or 10,000, 25,000, 50,000, 100,000 or 250,000 probes.

Typically, the arrays or microparticles have probes to one or more highly conserved polynucleotides. The arrays or microparticles may have further probes (e.g. confirmatory probes) that hybridize to functionally expressed genes, thereby providing an alternate or confirmatory signal upon which to base the identification of a taxon. For example, an array may contain probes to 16S rRNA gene sequences from Yersinia pestis and Vibrio cholerae and also confirmatory probes to Y. pestis cafl virulence gene or V. cholerae zonula occludens toxin (zot) gene. The detection of hybridization signals based on probes binding to 16S rRNA polynucleotides associated with a particular OTU coupled with the detection of a hybridization signal based on a confirmatory probe can provide a higher level of confidence that the OTU is present. For instance, if hybridization signals are detected for the probes associated Y. pestis OTU and the confirmatory probe also displays a hybridization signal for the expression of Y. pestis cafl then the confidence level subscribed to the presence or quantity of Y. pestis will be higher than the confidence level obtained from the use of OTU probes alone.

A range of lengths of probes can be employed on the arrays or microparticles. As noted above, a probe may consist exclusively of a complementary segments, or may have one or more complementary segments juxtaposed by flanking, trailing and/or intervening segments. In the latter situation, the total length of complementary segment(s) can be more important that the length of the probe. In functional terms, the complementary segment(s) of the PM probes should be sufficiently long to allow the PM probes to hybridize more strongly to a target polynucleotide e.g., 16S rRNA, compared with a MM probe. A PM probe usually has a single complementary segment having a length of at least 15 nucleotides, and more usually at least 16, 17, 18, 19, 20, 21, 22, 23, 24, 25 or 30 bases exhibiting perfect complementarity.

In some arrays or lots of microparticles, all probes are the same length. In other arrays or lots of microparticles, probe length varies between quantification standard (QS) probes, negative control (NC) probes, probe pairs, probe sets (OTUs) and combinations thereof. For example, some arrays may have groups of OTUs that comprise probe pairs that are all 23 mers, together with other groups of OTUs or probe sets that comprise probe pairs that are all 25 mers. Additional groups of probes pairs of other lengths can be added. Thus, some arrays may contain probe pairs having sizes of 15 mers, 16mers, 17mers, 18mers, 19mers, 20mers, 21mers, 22mers, 23mers, 24mers, 25 mers, 26mers, 27 mers, 28mers, 29 mers, 30mers, 31mers, 32mers, 33mers, 34mers, 35mers, 36mers, 37mers, 38mers, 39mers, 40mers or combinations thereof. Other arrays may have different size probes within the same group, OTU, or probe set. In these arrays, the probes in a given OTU or probe set can vary in length independently of each other. Having different length probes can be used to equalize hybridization signals from probes depending on the hybridization stability of the oligonucleotide probe at the pH, temperature, and ionic conditions of the reaction.

In another aspect of the invention, a system is provided for determining the presence or quantity of a plurality of different OTUs in a single assay where the system comprises a plurality of polynucleotide interrogation probes, a plurality of polynucleotide positive control probes, and a plurality of polynucleotide negative control probes. In some embodiments, the system is capable of detecting the presence, absence, relative abundance, and/or quantity of at least 5, 10, 20, 50, 100, 250, 500, 1000, 5000, 10,000, 20,000, 30,000, 40,000, 50,000, 60,000, 70,000, 80,000, 90,000, 100,000, 250,000, 500,000 or 1,000,000 OTUs in a sample using a single assay. In some embodiments, the polynucleotide positive control probes include 1) probes that target sequences of prokaryotic or eukaryotic metabolic genes spiked into the target nucleic acid sequences in defined quantities prior to fragmentation, or 2) probes complimentary to a pre-labeled oligonucleotide added into the hybridization mix after fragmentation and labeling. The control added prior to fragmentation collectively tests the fragmentation, biotinylation, hybridization, staining and scanning efficiency of the system. It also allows the overall fluorescent intensity to be normalized across multiple analysis components used in a single or combined experiment, such as when two or more arrays are used in a single experiment or when data from two separate experiments is combined. The second control directly assays the hybridization, staining and scanning of the system. Both types of control can be used in a single experiment.

In some embodiments, the QS standards (positive controls) are PM probes. In other embodiments, the QS standards are PM and MM probe pairs. In further embodiments, the QS standards comprise a combination of PM and MM probe pairs and PM probes without corresponding MM probes. In another embodiment, the QS standards comprise at least one, two, three, four, five, six, seven, eight, nine, ten or more MM probes for each corresponding PM probe. In a further embodiment, the QS standards comprise at least one, two, three, four, five, six, seven, eight, nine, ten or more PM probes for each corresponding MM probe. A system can comprise at least 1 positive control probe for each 1, 10, 100, or 1000 different interrogation probes.

In some cases, the spiked-in oligonucleotides that are complementary to the positive control probes vary in G+C content, uracil content, concentration, or combinations thereof. In some embodiments, the G+C % ranges from about 30% to about 70%, about 35% to about 65% or about 40% to about 60%. QS standards can also be chosen based on the uracil incorporation frequency. The QS standards may incorporate uracil in a range from about 1 in 100 to about 60 in 100, about 4 in 100 to about 50 in 100, or about 10 in 100 to about 50 in 100. In some cases, the concentration of these added oligonucleotides will range over 1, 2, 3, 4, 5, 6, or 7 orders of magnitude. Concentration ranges of about 10⁵ to 10¹⁴, 10⁶ to 10¹³, 10⁷ to 10¹², 10⁷ to 10¹¹, 10⁸ to 10″, and 10⁸ to 10¹⁰ can be employed and generally feature a linear hybridization signal response across the range. In some embodiments, positive control probes for the conduction of the methods disclosed herein comprise polynucleotides that are complementary to the positive control sequences shown in Table 6. Other genes that can be used as targets for positive controls include genes encoding structural proteins, proteins that control growth, cell cycle or reproductive regulation, and house keeping genes. Additionally, synthetic genes based on highly conserved genes or other highly conserved polynucleotides can be added to the sample. Useful highly conserved genes from which synthetic genes can be designed include 16S rRNA genes, 18S rRNA genes, 23SrRNA genes. Exemplary control probes are provided as SEQ ID NOs:51-100.

TABLE 6
Positive Control Sequences

| | Description |
|---|---|
| Positive Control ID | |
| AFFX-BioB-5_at | E. coli biotin synthetase |
| AFFX-BioB-M_at | E. coli biotin synthetase |
| AFFX-BioC-5_at | E. coli bioC protein |
| AFFX-BioC-3_at | E. coli bioC protein |
| AFFX-BioDn-3_at | E. coli dethiobiotin synthetase |
| AFFX-CreX-5_at | Bacteriophage P1 cre recombinase protein |
| AFFX-DapX-5_at | B. subtilis dapB, dihydrodipicolinate reductase |
| AFFX-DapX-M_at | B. subtilis dapB, dihydrodipicolinate reductase |
| YFL039C | Saccharomyces, Gene for actin (Act 1p) protein |
| YER022W | Saccharomyces, RNA polymerase II mediator |
| | complex subunit (SRB4p) |
| YER 148 W | Saccharomyces, TATA-binding protein, general |
| | transcription factor (SPT15) |
| YEL002C | Saccharomyces, Beta subunit of the oligosaccharyl |
| | transferase (OST) glycoprotein |
| | complex (WBP1) |
| YEL024W | Saccharomyces, Ubiquinol-cytochrome-c |
| | reductase (RIP1) |
| Synthetic 16S rRNA | |
| controls | |
| SYNM neurolyt_st | Synthetic derivative of Mycoplasma neurolyticum |
| | 16S rRNA gene |
| SYNLc.oenos_st | Synthetic derivative of Leuconostoc oenos |
| | 16S rRNA gene |
| SYNCau.cres8_st | Synthetic derivative of Caulobacter crescenius |
| | 16S rRNA gene |
| SYNFer.nodosm_st | Synthetic derivative of Fervidobacterium nodosum |
| | 16S rRNA gene |
| SYNSap.grandi_st | Synthetic derivative of Saprospira grandis |
| | 16S rRNA gene |

In some embodiments, the negative controls comprise PM and MM probe pairs. In further embodiments, the negative controls comprise a combination of PM and MM probe pairs and PM probes without corresponding MM probes. In other embodiments, the negative control probes comprise at least one, two, three, four, five, six, seven, eight, nine, ten or more MM probes for each corresponding negative control PM probe. A system can comprise at least 1 negative control probe for each 1, 10, 100, or 1000 different interrogation probes (PMs).

Generally, the negative control probes hybridize weakly, if at all, to 16S rRNA gene or other highly conserved gene targets. The negative control probes can be complementary to metabolic genes of prokaryotic or eukaryotic origin. Generally, with negative control probes, no target material is spiked into the sample. In some embodiments, negative control probes are from the same collection of probes that are also used for positive controls, but no material complementary to the negative control probes are spiked into the sample, in contrast to the positive control probe methodology. In essence, the control probes are universal control probes and play the role of a positive or negative control probes depending on the system's design. One of skill in the art will appreciate that the universal control probes are not limited to highly conserved sequence analysis systems and have applications beyond the present embodiments disclosed herein.

In a further embodiment, probes to non-highly conserved polynucleotides are added to a system to provide species-specific identification or confirmation of results achieved with the probes to the highly conserved polynucleotides. Usually, these “confirmatory” probes cross hybridize very weakly, if at all, to highly conserved polynucleotides recognized by the perfect match probes. Useful species-specific genes include metabolic genes, genes encoding structural proteins, proteins that control growth, cell cycle or reproductive regulation, housekeeping genes or genes that encode virulence, toxins, or other pathogenic factors. In some embodiments, the system comprises at least 1, 5, 10, 20, 30, 40, 50 60, 70, 80, 90 100, 150, 200, 250, 300, 400, 500, 600, 700, 800, 900, 1000, 5,000 or 10,000 species-specific probes.

In some embodiments, a system of the invention comprises an array. Non-limiting examples of arrays include microarrays, bead arrays, through-hole arrays, well arrays, and other arrays known in the art suitable for use in hybridizing probes to targets. Arrays can be arranged in any appropriate configuration, such as, for example, a grid of rows and columns. Some areas of an array comprise the OTU detection probes whereas other areas can be used for image orientation, normalization controls, signal scaling, noise reduction processing, or other analyses. Control probes can be placed in any location in the array, including along the perimeter of the array, diagonally across the array, in alternating sections or randomly. In some embodiments, the control probes on the array comprise probe pairs of PM and MM probes. The number of control probes can vary, but typically the number of control probes on the array range from 1 to about 500,000. In some embodiments, at least 10, 100, 500, 1,000, 5,000, 10,000, 25,000, 50,000, 100,000, 250,000 or 500,000 control probes are present. When control probe pairs are used, the probe pairs will range from 1 to about 250,000 pairs. In some embodiments, at least 5, 50, 250, 500, 2,500, 5,000, 12,500, 25,000, 50,000, 125,000 or 250,000 control probe pairs are present. The arrays can have other components besides the probes, such as linkers attaching the probes to a support. In some embodiments, materials for fabricating the array can be obtained from Affymetrix (Santa Clara, Calif.), GE Healthcare (Little Chalfont, Buckinghamshire, United Kingdom) or Agilent Technologies (Palo Alto, Calif.)

Besides arrays where probes are attached to the array substrate, numerous other technologies may be employed in the disclosed system for the practice of the methods of the invention. In one embodiment, the probes are attached to beads that are then placed on an array as disclosed by Ng et al. (Ng et al. A spatially addressable bead-based biosensor for simple and rapid DNA detection. Biosensors & Bioelectronics, 23:803-810, 2008).

In another embodiment, probes are attached to beads or microspheres, the hybridization reactions are performed in solution, and then the beads are analyzed by flow cytometry, as exemplified by the Luminex multiplexed assay system. In this analysis system, homogeneous bead subsets, each with beads that are tagged or labeled with a plurality of identical probes, are combined to produce a pooled bead set that is hybridized with a sample and then analyzed in real time with flow cytometry, as disclosed in U.S. Pat. No. 6,524,793. Bead subsets can be distinguished from each other by variations in the tags or labels, e.g., using variability in laser excitable dye content.

In a further embodiment, probes are attached to cylindrical glass microbeads as exemplified by the Illumina Veracode multiplexed assay system. Here, subsets of microbeads embedded with identical digital holographic elements are used to create unique subsets of probe-labeled microbeads. After hybridization, the microbeads are excited by laser light and the microbead code and probe label are read in real time multiplex assay.

In another embodiment, a solution based assay system is employed as exemplified by the NanoString nCounter Analysis System (Geiss G et al. Direct multiplexed measurement of gene expression with color-coded probe pairs. Nature Biotech. 26:317-325, 2008). With this methodology, a sample is mixed with a solution of reporter probes that recognize unique sequences and capture probes that allow the complexes formed between the nucleic acids in the sample and the reporter probes to be immobilized on a solid surface for data collection. Each reporter probe is color-coded and is detected through fluorescence.

In a further embodiment, branched DNA technology, as exemplified by Panomics QuantiGene Plex 2.0 assay system, is used. Branched DNA technology comprises a sandwich nucleic acid hybridization assay for RNA detection and quantification that amplifies the reporter signal rather than the sequence. By measuring the RNA at the sample source, the assay avoids variations or errors inherent to extraction and amplification of target polynucleotides. The QuantiGene Plex technology can be combined with multiplex bead based assay system such as the Luminex system described above to enable simultaneous quantification of multiple RNA targets directly from whole cells or purified RNA preparations.

### Probes and the Selection Thereof

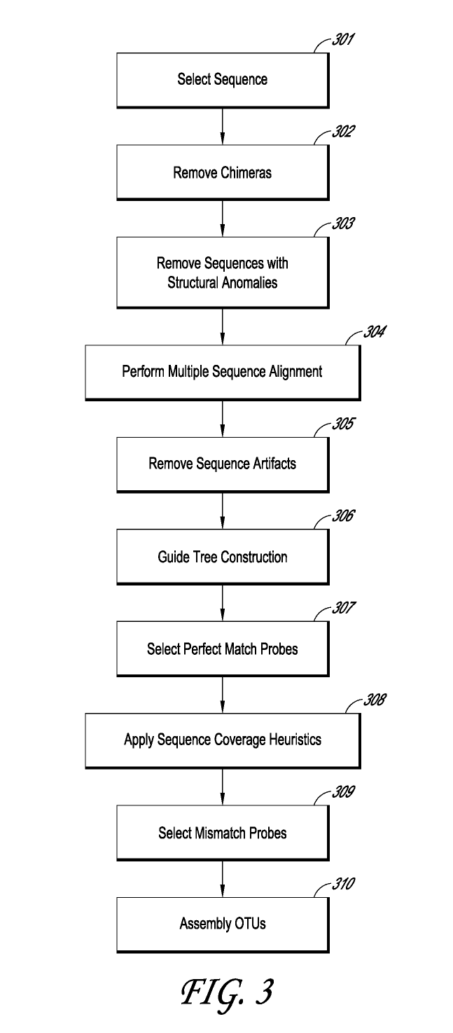

An exemplary process 300 for the design of target probes for use in the simultaneous detection of a plurality of microorganisms is illustrated in FIG. 3. Briefly, sequences are extracted from a database at a state 301. Typically, the database contains phylogenetic sequences or other highly conserved or homologous sequences. The sequences are analyzed for chimeras at a state 302 that are removed from further consideration. Chimeric sequences result from the union of two or more unrelated sequences, typically from different genes. Optionally, sequences can be further analyzed for structural anomalies, such as propensity for hairpin loop formation, at a state 303 with the identified sequences subsequently removed from further consideration. Next, multiple sequence alignments are performed on the remaining sequences in the dataset at a state 304. The aligned sequences are then checked for laboratory artifacts, such as PCR primer sequences, at a state 305, with identified sequences removed from further consideration. The remaining sequences are clustered at a state 306 and perfect match (PM) probes are selected at a state 307 that have perfect complementarity to sections of the clustered sequences. Optionally, sequence coverage heuristics are performed at a state 308 prior to selecting the mismatch (MM) probes at a state 309 for the corresponding PM probes to create probe pairs. Finally, OTUs represented by probe sets comprising a plurality of probe pairs are assembled at a state 310 to construct a hierarchal taxonomy.

Generally, a database for extraction of sequences to be used for probe selection is chosen based on the particular conserved gene or highly homologous sequence of interest, the total number of sequences within the database, the length of the overall sequences or the length of highly conserved regions within the sequences listed in the database, and the quality of the sequences therein. Typically, between two databases of equal sequence number but of different sequence length, the database with longer target regions of highly conserved sequence will generally contain a larger total number of possible sequences that can be compared. In some embodiments, the sequences are at least 300, 400, 500, 600, 700, 800, 900, 1,000, 1,200, 1,400, 1,600, 1,800, 2,000, 4,000, 8,000, 16,000 or 24,000 nucleotides long. Generally, databases with larger number of total sequences provide more material to compare. In a further embodiment, the database contains at least 10,000, 20,000, 30,000, 40,000, 50,000, 60,000, 70,000, 80,000, 100,000, 200,000, 500,000, 1,000,000 or 2,000,000 sequence listings. A gene of particular interest for probe construction is 16S rDNA (16S rRNA gene). Other conserved genes include 18S rDNA, 23 S rDNA, gyrA, gyrB gene, groEL, rpoB gene, fusA gene, recA gene, sodA, cox1 gene, and nifD gene. In a further embodiment, the spacer region between highly conserved segments of two genes can be used. For example, the spacer region between 16S and 23S rDNA genes can be used in conjunction with conserved sections of the 16S and 23S rDNA.

In some embodiments, the detection of a biosignature comprises the use of probes designed to hybridize with known or discovered targets within one or more OTUs. In some embodiments, targets are selected from a collection of known targets, such as in a database. In some embodiments of the invention, a database used for the selection of probes comprises at least 50%, 60%, 70%, 80%, 90%, 95%, 96%, 97%, 98%, 99% or up to 100% of the known sequences of the organisms of interest, e.g., of the bacteria, archaea, fungi, eukaryotes, microorganisms, or prokaryotes of interest. The sequences for each individual organism in the database can include more than 20%, 30%, 40%, 50%, 60%, 70%, 80%, 90%, or more than 95% of the genome of the organism, or of the non-redundant regions thereof. In some embodiments, the database includes up to 100% of the genome of the organisms whose sequenced are contained therein, or of the non-redundant sequences thereof. A listing of almost 40,000 aligned 16S rDNA sequences greater than 1250 nucleotides in length can be found on the Greengenes web application, a publicly accessible database run by Lawrence Berkeley National Laboratory. Other publicly accessible databases include GenBank, Michigan State University's ribosomal database project, the Max Planck Institute for Marine Microbiology's Silva database, and the National Institute of Health's NCBI. Proprietary sequence databases or combinations created by amalgamating the contents of two or more private and/or public databases can also be used to practice the methods of this invention. In some embodiments, a sample is assayed for all targets in one or more chosen databases simultaneously. In other embodiments, a sample is assayed for subsets of targets identified in one or more databases simultaneously. In some embodiments, a biosignature comprises the results of assaying a sample for some or all targets in one or more chosen databases. In other embodiments, a biosignature comprises a subset of the results of assaying a sample for some or all targets in one or more chosen databases.

The analysis of the selected sequences from the database for the detection and removal of chimeras at state 302 is typically performed by generating overlapping fragments and comparing these fragments against each other. Fragments may be retained if they have at least 60%, 70%, 80%, 90%, 95% or 99% sequence identity. It was realized that the above process potentially missed chimeras because the sequence diversity of the selected sequences may be low. By comparing the fragments against a core set of diverse chimera-free sequences, more chimeras can be identified and removed from the sequence set. In cases where one or more sequences are identified that as an ambiguous chimera, e.g., a chimera with a chimeric parent, the chimera is removed and the parent chimera is fragmented and a second comparison cycle is performed. Sequences from a dataset can also be screened for chimeras using a proprietary software program such as Bellerophon3 available from the Greengenes website at greengenes.lbl.gov.

The dataset of retained non-chimeric sequences can then be screened for structural anomalies at state 303 by aligning the retained sequences against the core set of known sequences. Sequences in the retained dataset that have at least 25, 30, 35, 40, 45, 50, 60, 70 or 80 gaps in their alignment when compared against a core set or have insertions of greater than 50, 60, 70, 80, 90, 100, 110, 120, 130, 140, 150, 160, 170, 180, 190, 200, 250, 300 or 400 basepairs when compared against the core set are tagged as having a sequence anomaly and are removed from the dataset.

The screened sequences are then aligned into a multiple sequence alignment (MSA) at state 304 for comparison against the known, chimeric free core set. One alignment tool for performing intensive alignment computations is NAST (Nearest Alignment Space Termination) web tool (DeSantis et al., Nucleic Acids Res. (2006) 34:W394-399). Any appropriate alignment tool can be used to compile the MSAs, for example, clustalw (Thompson et al., Nucleic Acids Res (1994) 22:4673-4680) and MUSCLE (Edgar, Nucleic Acids Res. (2004) 32:1792-1797).

The aligned sequences are searched for sequences harboring PCR primer sequences at state 305 and any so-identified sequences are removed from the dataset.

The aligned sequences can then be clustered at the state 306 to create what is termed a “guide tree.” First, the sequences are converted to a list of kmers. A pair-wise comparison of the lists of kmers is performed and the percent of kmers in common is recorded in a sparse matrix only if a threshold similarity is found. The sparse matrix is clustered e.g., using complete linkage. Clustering includes agglomerative “bottom-up” or divisive “top-down” hierarchical clustering, distance “partition” clustering and alignment clustering. From each cluster, the sequence with the most information content is chosen as a representative. Usually, sequences derived from genome sequencing projects are given priority in cluster creation because they are less likely to be chimeras or have other sequence anomalies. The cyclic process is repeated using only the representatives from the previous cycle. For each new cycle, the threshold for recording in the sparse matrix is reduced. At the final stage, a root node is linked to the final representative sequences in a multifurcated tree. The representative sequences found in each cycle represent a node in the resulting guide tree. All nodes are linked based on their clustering results via a self-referential table allowing rapid access to any hierarchical point in the guide tree. In some embodiments, the results are stored in a database format, e.g., in a Structured Query Language (SQL) compliant format. In the resulting guide tree, each leaf node represents an individual organism and each node above the lowest level of the guide tree represents a candidate OTU.

Typical distance matrixes built from approximately 2×10⁵ sequences can require 40 billion intersections that would require about 40 gigabytes of data space if encoded to disk. Doubling the amount of sequences to 4×10⁵ requires a quadrupling of the file size (approximately 160 GB). The clustering methodology illustrated here using a sparse matrix avoids the need for large files and the expected increase in computing time. Therefore the methodology can be performed more efficiently than conventional sequence clustering methods. Moreover, with distance matrices created from sequence alignments (e.g., DNA alignments), one misalignment can affect many distance values. In contrast, the clustering method illustrated herein is based on the alignment of tuners, and thus the effect of a misalignment on clustering values is significantly reduced.

Following guide tree construction, the dataset of remaining sequences, now termed the “filtered sequence dataset” is used to select candidate probes, e.g., PM probes. First, unsupported sequence polymorphisms are identified and removed from the filtered sequence dataset using a pre-clustering process that uses the guide tree generated above to create clusters over a minimum similarity and under a maximum size. Typically, clustered sequences are at least 80%, 85%, 90%, 95%, 97% or 99% similar. Usually, clusters have no more than 1,000, 500, 200, 100, 80, 60, 50, 40, 30, 20 or 10 sequences. This process allows sequence data outliers to be detected by comparison within near-neighbors and removed from the filtered sequence dataset.

Next, the remaining sequences are fragmented to the desired size to generate candidate target probes. Typically, the fragments range from about 10mer to 100mer, 15mer to about 50mer, about 20mer to about 40mer, about 20mer to about 30mer. Usually, the fragments are at least 15mer, 20mer, 25mer, 30mer, 40mer, 50mer or 100mer in size. Each candidate target probe is required to be found within a threshold fraction of at least one pre-cluster. Generally, threshold fractions of at least 80%, 90% or 95% are used.

All candidate PM probes that are within a threshold fraction of at least one pre-cluster are then evaluated for various biophysical parameters, such as melting temperature (61-80° C.), G+C content (35-70%), hairpin energy over −4 kcal/mol, potential for self-dimerization (>35° C.). Candidate PM probes that fall outside of the setting boundaries of the biophysical parameters are eliminated from the dataset. Optionally, probes can be further filtered for ease of photolithographic synthesis.

The likelihood of cross-hybridization of each PM candidate probe to each non-target input 16s rRNA gene sequence is determined. The cross-hybridization pattern for each PM candidate probe is recorded.

Sequence coverage heuristics are performed at the state 308 are then applied to candidate PM probes with acceptable biophysical parameters.

For each candidate PM probe, corresponding MM probes can be generated at the state 309. Each MM probe differs from its corresponding PM probe by at least one nucleotide. In some embodiments, the MM probe differs from its corresponding PM probe by 1, 2, 3, 4, 5, 6, 7, 8, 9 or 10 nucleotides. Within a MM probe, the mismatched nucleotide or nucleotides can include any of the 3 central bases that are not found in the same position or positions in the PM probe. For example, with a 25mer PM probe that has a guanine at the 13^{th} position, i.e., the central nucleotide, the MM probes comprise probes with adenine, thymine, uracil or cytosine at the 13^{th} position. Similarly, with a 25mer PM probe with an adenine at the 12^{th} nucleotide position and a guanine at the 13^{th} nucleotide position when read from the 3′ direction, the possible MM probes comprise probes with guanine at the 12^{th} nucleotide and adenine, thymine or cytosine at the 13^{th} nucleotide position; cytosine at the 12^{th} nucleotide position and adenine, thymine or cytosine at the 13^{th} nucleotide position; and thymine at the 12^{th} nucleotide position and adenine, thymine or cytosine at the 13^{th} nucleotide position. In some embodiments, the mismatched nucleotide or nucleotides include any one or more of the nucleotides in a corresponding PM probe. Increasing the number of MM probes and/or the mis-match positions represented may be used to enhance quantification, accuracy, and confidence.

As describe above for the PM probes, each candidate MM probe is required to meet the set boundaries of one or more biophysical parameters, such as melting temperature, G+C content, hairpin energy, self-dimers and photolithography synthesis steps. Generally, these parameters are identical or substantially similar to the PM probe biophysical parameters.

Candidate MM probes that meet the biophysical parameters and optionally, photolithographic parameters above are then screened for the likelihood of cross-hybridization to a target sequence. Usually, a central kmer length is evaluated. For a 25mer candidate MM, a central kmer from the candidate MM, generally a 15mer, 16mer, 17mer, 18mer, or 19mer is compared against the target sequences. A candidate MM probe that contains a central kmer that is identical to a target sequence is eliminated. Next, candidate PM probes for which no suitable candidate MM probes can be identified are also eliminated.

Each candidate OTU may be evaluated to determine the number of PM probes that are incapable of hybridization to sequences outside the OTU.

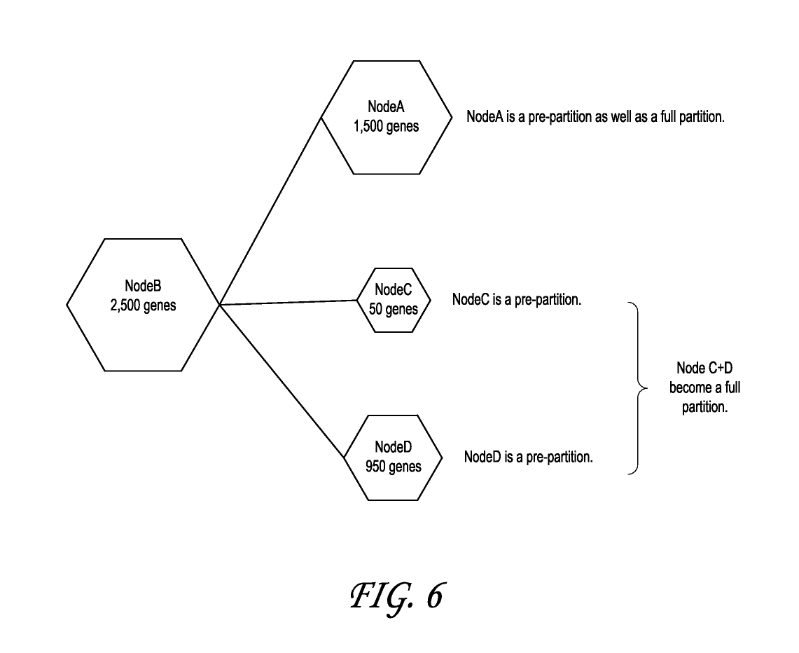

In one embodiment, a pre-partition process is performed. A pre-partition is the largest possible Glade (node_id) that does not exceed the max partition size. See FIG. 6. Typically, useful partition sizes range from about 1,000 to about 8,000 nodes. Any pre-partition that is in a predetermined size range becomes a full-partition. Pre-partitions that are below the minimum partition size are combined into partitions by assembling sister nodes where possible. For example, assume that partitions are allowed to range in size from 1000 to 2000 members. If node A represents 1500 genes and its parent, node B, represents 2500 genes, then node A is considered a pre-partition. If node C is a sibling of node A, and node C represents only 50 genes, then node C is also a pre-partition because moving node C to its parent, node B, would encapsulate more than the maximum partition size of 2000 members.

To create candidate sequence clusters, transitive sequence clusters are identified using a sliding threshold of two distance matrixes based on either the count of pairwise unique candidate targets or the count of pairwise common candidate targets. Probes prevalent in a large fraction of the sequences in a candidate sequence cluster, e.g., >=90% of the sequence in the cluster, are identified using the count of sequences containing the PM and the count of sequences with unambiguous data for given PM's locus. For each prevalent probe, a cross-hybridization potential outside the cluster is also tested. All information regarding cluster-PM sets is recorded. Futile clusters are defined as clusters for which only cross-hybridizing probes are identified are removed from the dataset.

Where necessary, probes that are expected to display some degree of cross-hybridization can be selected. Potentially hybridization-prone probes are constrained to reduce the probability that sequences outside the cluster could hybridize to many of the cluster-specific PM probes. A distribution algorithm can be used to examine a graph of probe-sequence interconnections (edges) and to favor sets of probes that minimize overlapping edges.

After solutions from all partitions are completed, a global reconciliation of set solutions across partitions is performed. The sequence clusters are locked as OTUs and each cluster's PM probe set is tested for global cross-hybridization against the other remaining PM probe sets. Probes are ranked for utility based on global cross-hybridization patterns.

The OTUs are assembled and annotated. Typically, each OTU is taxonomically annotated using one term for each rank from domain, kingdom, phylum, sub-phylum, class, sub-class, order, and family. As a result, all the 16S rRNA sequences presented without taxonomic nomenclature and annotated as “environmental samples” or “unclassified” are assigned with taxonomic annotation.

Each genus-level name recognized by NCBI is read and recorded. For each lineage of taxonomic terms, duplicate adjacent terms are removed; domain-level terms are found by direct pattern match; and phylum-level terms are found as rank immediately subordinate to domain. Order-level terms are found by -ales suffix and family-level terms are found by -eae suffix. If a family level-term is unavailable but a genus is identified (e.g., by match to an accepted list), the genus-level term is used to derive a family level-term. All unrecognized terms found between recognized terms are fit into available ranks (new ranks are not created for extra terms). Empty ranks are filled by deriving root terms from subordinate terms and adding pre-determined suffixes. Finally, the family of an OTU is determined by vote from the family assignment of the sequences. Ties are broken by priority sequences (e.g., sequences derived from genome sequencing projects can be given highest priority). All OTUs within a subfamily are compared by kmer distance among the sequences and OTUs are linked into a subfamily whenever a threshold similarity is observed. Each candidate OTU is evaluated to determine the count of targets which are prevalent across the sequences of the candidate OTU and are not expected to hybridize to sequences outside the OTU.

Exemplary PM and MM 25mer probes generated using the disclosed algorithms are provided as SEQ ID Nos. 1-50. It should be noted that the above process is applicable to the selection of probes ranging in size from at least 15 nucleotides to at least 200 nucleotides in length and includes probes that are flanked on one or both sides by common or irrelevant sequences, including linking sequences. Furthermore, probes selected by this process can be further processed to yield probes that are smaller than or larger than the original selected probes. For example, probes listed as SEQ ID Nos. 1-50 can be further processed by removing sequences from the 3′ end, 5′ end or both to produce smaller sequences that are identical to at least a portion of the sequence of the 25mers. In other embodiments, larger probes can be generated by incorporating the sequences of probes identified by the disclosed algorithms, i.e., a 25mer probe can be incorporated into a 30mer or larger, 35mer or larger, 40mer or larger, 45mer or larger, 50mer or larger, 55mer or larger, 60mer or larger, 65mer or larger, 70mer or larger, 75mer or larger, 80mer or larger, 85mer or larger or 90mer or larger probe. Additionally, probes listed as SEQ ID Nos. 1-50 can be shortened on one end and lengthened on the other end to yield probes that range from 10mer to 200mer.

Probes selected by the above process also include probes that comprise one or more base substitutions, for example uracil in the place of thymine; incorporate one or more base analogs such as nitropyrrole and nitroindole; comprise of one or more sugar substitutions, e.g., ribose in the place of deoxyribose, or any combination thereof. Similarly, probes selected by the process of the invention, may further comprise alternate backbone chemistry, for example, comprising of phosphoramide.

The size of the collection of putative probes generated by the methodologies of the invention is partially dependent on the length of the particular highly conserved sequence with longer sequences like that of 23 S rRNA gene allowing for a greater number of homologous sequences than a smaller highly conserved sequence such as 16S rRNA gene. In some embodiments, the length of the highly conserved sequence is at least 100 bp, 250 bp, 500 bp, 1,000 bp, 2,000 bp, 4,000 bp, 8,000 bp, 10,000 bp, or 20,000 bp. Additionally, the size of the collection of putative probes generated by the methodologies of the invention is also dependent on the size of the collection of homologous sequences in one or more databases from which sequences are selected for the analysis and generation of probes. Larger collections of homologous sequences, by providing a larger pool of sequences that can be analyzed, allow for the generation of more putative probes. In some embodiments, the starting collection of homologous sequences in one or more databases contains at least 100,000, 250,000, 500,000, 1,000,000, 2,000,000, 5,000,000 or 10,000,000 sequences. The size of the collection of putative probes is further dependent on the length of the desired probe, because the probe length decreases, as the number of probes that bind to unique sequences increases. Depending on the particular highly conserved sequence, the size of the database and the length of the desired probe, collections of putative probes of at least 100, 1,000, 10,000, 25,000, 50,000, 100,000, 250,000, 500,000, 1,000,000, 2,000,000, 5,000,000 or 10,000,000 probes can be generated.

Detection systems can be constructed from the putative probes generated by the above methods. The detection system can have any number of probes and range from 1 probe to all the probes selected by the methodology. In some embodiments, the detection system comprises at least 1, 2, 3, 4, 5, 6, 7, 8, 9, 10, 15, 20, 25, 30, 35, 36, 40, 45, 50, 55, 60, 65, 70, 80, 90, 100, 125, 150, 200, 300, 400, 500, 1000, 2,000, 5,000, 10,000, 20,000, 40,000, 50,000, 100,000, 200,000, 500,000, 1,000,000 or 2,000,000 probes. Systems with large number of probes can be used to identify relevant microorganisms in a sample, e.g., an environment or clinical sample, and/or to generate a biosignature. In another embodiment, once relevant microorganisms are known, detection systems with low (e.g., 1-10,000) to medium (e.g., 10,000-100,000) numbers of probes can be designed for special purpose applications, such as determining one or more specific biosignatures. In some embodiments, knowledge of the identity of relevant microorganisms can be used to select further probes to these microorganisms. If, for instance, five 25mer probes in a first set of probes hybridize to a relevant microorganism, then variants of these five probes can be generated and tested (e.g. in silico) for their binding and biophysical characteristics. Alternately, identification of relevant microorganisms can lead to the generation of new probes that are unlike the probes first used to identify the microorganisms. For example, once novel microorganisms are identified, antibodies can be generated for specific applications.

To select OTU-specific probes, e.g., oligonucleotide probes specific for organisms that are included within a hierarchical node, additional PM probes can be chosen for each hierarchical node that has more than one child node. To qualify targets for selection to a certain node, a threshold fraction of sequences within a node matching a PM set are enforced. Examples of the threshold fractions included 0.2%, 0.5%, 1%, 2%, 3%, 4%, 5%, 6%, 7%, 8%, 9%, and 10%. Coverage of direct sub-nodes (children) is also enforced. For example, each target should be representative of at least 25% of at least one sub-node.

The specificity of the probes selected by the methods disclosed herein can be validated experimentally in a number of ways. For example, the hybridization signal of a probe in the presence of the target sequence can be measured and compared to the background signal. Target sequences can be derived from one or more pure cultures or from environmental or clinical samples that are known to contain the target sequence. A specific taxa can be identified as present in a sample if a majority (about 70% to about 100%, about 80% to about 100% or about 90% to about 100%) of the probes on the array have a hybridization signal at least about 50 times, 100 times, 150 times, 200 times, 250 times, 300 times, 350 times, 400 times, 450 times, 500 times, or 1,000 times greater than that of the background. Also, the hybridization signal of the probe can be compared to the hybridization signal of one or more of its mismatch probes. A PM:MM ratio of at least 1.05, 1.10, 1.15, 1.20, 1.25, 1.30, 1.40, 1.45, or 1.50 can indicate that the PM probe, can selectively hybridize to its target sequence. An additional way to test the ability of a probe to selectively hybridize to its target is to calculate a pair difference score (d), further explained below. A pair difference score above 1.0 indicates that the probe can selectively hybridize to the target compared to one of its mismatch probes.

The methods disclosed herein can be used to select and/or utilize organism-specific and/or OTU-specific oligonucleotide probes for biomolecules, such as proteins, DNA, RNA, DNA or RNA amplicons, and native rRNA from a target nucleic acid molecule. In some embodiments, probes are designed to be antisense to the native rRNA so that rRNA from samples can be placed on the array to identify actively metabolizing organisms in a sample with no bias from PCR amplification. Actively metabolizing organisms have significantly higher numbers of ribosomes used for the production of proteins, compared to quiescent or dead organisms. Therefore, in some embodiments, the capacity of one or more organisms to make proteins at a particular point in time can be measured. In this way, the array system of the present embodiments can be used to directly identify the metabolizing organisms within diverse communities.

### Sample Preparation

In some embodiments, the sample used can be an ecosystems sample. Ecosystems include microbiomes associated with plants, animals, and humans. Animal and human associated microbiomes include those found in the gastrointestinal tract, respiratory system, nares, urogenital tract, mammary glands, oral cavity, auditory canal, feces, urine, and skin. In some embodiments, the sample can be any kind of clinical or medical sample. For example, samples from blood, urine, feces, nares, the lungs, the gut, other bodily fluids or excretions, materials derived therefrom, or combinations thereof of mammals may be assayed using the array system. Also, the probes selected by the methods disclosed herein and the array system of the present embodiments can be used to identify an infection in the blood of an animal. The probes selected by the methods disclosed herein and the array system of the present embodiments can also be used to assay medical samples that are directly or indirectly exposed to the outside of the body, such as the lungs, ear, nose, throat, the entirety of the digestive system or the skin of an animal. In some embodiments, a sample includes cell culture samples and/or bacterial culture samples. In some embodiments, a sample comprises a pulmonary sample from a subject, including but not limited to sputum, endotracheal aspirate, bronchoalveolar lavage sample, a swab of the endotrachea, materials derived therefrom, or combinations thereof.

Techniques and systems to obtain genetic sequences from multiple organisms in a sample, such as an ecosystem, medical, or clinical sample, are well known by persons skilled in the art. Many commercially available DNA extraction and purification kits can also be used. Samples, with lower than 2 pg purified DNA may require amplification, which can be performed using conventional techniques known in the art, such as a whole community genome amplification (WCGA) method (Wu et al., Appl. Environ. Microbiol. (2006) 72, 4931-4941). In some embodiments, highly conserved sequences such as those found in the 16S RNA gene, 23S RNA gene, 5S RNA gene, 5.8S rRNA gene, 12S rRNA gene, 18S rRNA gene, 28S rRNA gene, gyrB gene, rpoB gene, fusA gene, recA gene, cox1 gene and nifD gene are amplified. Usually, amplification is performed using PCR, but other types of nucleic acid amplification can be employed. Generally, amplification is performed using a single pair of universal primers specific to a highly conserved sequence. For redundancy or for increased amount of total amplicon concentration, two or more universal probe pairs each specific to a different highly conserved sequence can be used. Representative PCR primers include: bacterial primers 27F and 1492R. In some embodiments, a nucleic acid sample is amplified using a collection of primers each comprising one or more nucleotide positions selected at random from two or more different nucleotides. In some embodiments, primers, nucleotides, or other reagents used in an amplification reaction are labeled to produced labeled amplification products.

A gel electrophoresis method can also be used to isolate community RNA (McGrath et al., J. Microbiol. Methods (2008) 75:172-176). Samples with lower than 5 pg purified RNA may require amplification, which can be performed using conventional techniques known in the art, such as a whole community RNA amplification approach (WCRA) (Gao et al., Appl. Environ. Microbiol. (2007) 73:563-571) to obtain cDNA. In some embodiments, sampling and DNA extraction are conducted as previously described (DeSantis et al., Microbial Ecology, 53(3):371-383, 2007).

In some embodiments, DNA; total RNA, or a fraction thereof, including rRNA, 16S rRNA, and 23S rRNA; or combinations thereof are directly labeled and used without any amplification.

### Probe Preparation

Techniques and means for generating oligonucleotide probes to be used on analysis systems, beads or in other systems are well-known by persons skilled in the art. For example, the oligonucleotide probes can be generated by synthesis of synthetic polynucleotides or oligonucleotides, e.g., using N-phosphonate or phosphoramidite chemistries (Froehler et al., Nucleic Acid Res. 14:5399-5407 (1986); McBride et al., Tetrahedron Lett. 24:246-248 (1983)). Synthetic sequences are typically between about 10 and about 500 bases in length, more typically between about 15 and about 100 bases, and most preferably between about 20 and about 40 bases in length. In some embodiments, synthetic nucleic acids include non-natural bases, such as, but by no means limited to, inosine. An example of a suitable nucleic acid analogue is peptide nucleic acid (see, e.g., Egholm et al., Nature 363:566-568 (1993); U.S. Pat. No. 5,539,083). In some embodiments, at least 10, 25, 50, 100, 500, 1,000, 5,000, 10,000, 20,000, 40,000, 50,000, 60,000, 70,000, 80,000, 90,000 100,000, 200,000, 500,000, 1,000,000 or 2,000,000 probes are included on the array. In further embodiments, each PM probe has one or more corresponding MM probe present on the array. Typically, each PM-MM probe pair is associated with an OTU. In some embodiments, at least 10, 25, 50, 100, 500, 1,000, 5,000, 10,000, 20,000, 40,000, 50,000, 60,000, 70,000, 80,000, 90,000 100,000, 200,000 or 500,000 probe pairs are placed on the array. Generally, sets of probe pairs have at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34 or 35 probe pairs present.

In some embodiments, positive control probes that are complementary to particular sequences in the target sequences (e.g., 16S rRNA gene) are used as internal quantification standards (QS) and included in the system. In other embodiments, positive control probes, also known as internal DNA quantification standards (QS) probes are probes that hybridize to spiked-in nucleic acid sequence targets. Usually, the sequences are from metabolic genes. In some embodiments, negative control (NC) probes, e.g., probes that are not complementary or do not appreciably hybridize to sequences in the target sequences (e.g., 16S rRNA gene) are included on the array. Unlike the QS probes, no target material is spiked into the sample mix for the NC probes, prior to sample processing.

### Hybridization Platform Fabrication

In some embodiments, the probes are synthesized separately and then attached to a solid support or surface, which may be made, e.g., from glass, latex, plastic (e.g., polypropylene, nylon, polystyrene), polyacrylamide, nitrocellulose, gel, silicon, or other porous or nonporous material. In some embodiments, the surface is spherical or cylindrical as in the case of microbeads or rods. In other embodiments, the surface is planar, as in an array or microarray. For example, the method described generally by Schena et al, Science 270:467-470 (1995) can be used for attaching the nucleic acids to a surface by printing on glass plates. In other embodiments, typically used for making high-density oligonucleotide arrays, thousands of oligonucleotides complementary to defined sequences are synthesized in situ at defined locations on a surface by photolithographic techniques (see e.g., Fodor et al., 1991, Science 251:767-773; Pease et al., 1994, Proc. Natl. Acad. Sci. U.S.A. 91:5022-5026; Lockhart et al., 1996, Nature Biotechnology 14:1675; U.S. Pat. Nos. 5,578,832; 5,556,752; and 5,510,270) or other methods for rapid synthesis and deposition of defined oligonucleotides (e.g., Blanchard et al., Biosensors & Bioelectronics 11:687-690). In some of these methods, oligonucleotides (e.g., 25-mers) of known sequence are synthesized directly on a surface such as a derivatized glass slide. Other methods for making analysis systems are also available, e.g., by masking (Maskos and Southern, 1992, Nuc. Acids. Res. 20:1679-1684). Embodiments of the present invention are applicable to any type of array, for example, bead-based arrays, arrays on glass plates or derivatized glass slides as discussed above, and dot blots on nylon hybridization membranes.

Embodiments of the invention are applicable for use in any analysis system, including but not limited to bead or solution multiplex reaction platforms, or across multiple platforms, for example, Affymetrix GeneChip® Arrays, Illumina BeadChip® Arrays, Luminex xMAP® Technology, Agilent Two-Channel Arrays, MAGIChips (Analysis systems of Gel-immobilized Compounds) or the NanoString nCounter Analysis System. The Affymetrix (Santa Clara, Calif., USA) platform DNA arrays can have the oligonucleotide probes (approximately 25mer) synthesized directly on the glass surface by a photolithography method at an approximate density of 10,000 molecules per μm² (Chee et al., Science (1996) 274:610-614). Spotted DNA arrays use oligonucleotides that are synthesized individually at a predefined concentration and are applied to a chemically activated glass surface. In general, oligonucleotide lengths can range from a few nucleotides to hundreds of bases in length, but are typically from about 10mer to 50mer, about 15mer to 40mer, or about 20mer to about 30mer in length.

### Microparticle Systems

Oligonucleotides produced using techniques known in the art can be built on and/or coupled to microspheres, beads, microbeads, rods, or other microscopic particles for use in arrays, flow cytometry, and other multiplex assay systems. Numerous microparticles are commercially available from about 0.01 to 100 micrometers in diameter. Generally, microparticles from about 0.1-50 μm, about 1-20 μm, or about 3-10 μm are preferred. The size and shapes of microparticles can be uniform or they can vary. In some embodiments, sublots of different sizes, shapes or both are conjugated to probes before combining the sublots to make a final mixed lot of labeled microparticles. The individual sublots can therefore be distinguished and classified based on their size and shape. The size of the microparticles can be measured in practically any flow cytometry apparatus by so-called forward or small-angle scatter light. The shape of the particle can be also discriminated by flow cytometry, e.g., by high-resolution slit-scanning method.

Microparticles can be made out of any solid or semisolid material including glass, glass composites, metals, ceramics, or polymers. Frequently, the microparticles are polystyrene or latex material, but any type of polymeric material is acceptable including but not limited to brominated polystyrene, polyacrylic acid, polyacrylonitrile, polyacrylamide, polyacrolein, polybutadiene, polydimethylsiloxane, polyisoprene, polyurethane, polyvinylacetate, polyvinylchloride, polyvinylpyridine, polyvinylbenzylchloride, polyvinyltoluene, polyvinylidene chloride, polydivinylbenzene, polymethylmethacrylate, or combinations thereof. Microparticles can be magnetic or non-magnetic and may also have a fluorescent dye, quantum dot, or other indicator material incorporated into the microparticle structure or attached to the surface of the microparticles. Frequently, microparticles may also contain 1 to 30% of a cross-linking agent, such as divinyl benzene, ethylene glycol dimethacrylate, trimethylol propane trimethacrylate, or N,N′ methylene-bis-acrylamide or other functionally equivalent agents known in the art.

### Target Labeling

In one embodiment, the nucleic acid targets are labeled so that a laser scanner tuned to a specific wavelength of light can measure the number of fluorescent molecules that hybridized to a specific DNA probe. For arrays, the nucleic acid targets are typically fragmented to between 15 and 100 nucleotides in length and a biotinylated nucleotide is added to the end of the fragment by terminal DNA transferase. At a later stage, the biotinylated fragments that hybridize to the oligonucleotide probes are used as a substrate for the addition of multiple phycoerythrin fluorophores by a sandwich (Streptavidin) method. For some arrays, such as those made by AGILENT or NIMBLEGEN, the purified community DNA can be fluorescently labeled by random priming using the Klenow fragment of DNA polymerase and more than one fluorescent moiety can be used (e.g. controls could be labeled with Cy3, and experimental samples labeled with Cy5 for direct comparison by hybridization to a single analysis system). Some labeling methods incorporate the molecular label into the target during an amplification or enzymatic step to produce multiple labeled copies of the target.

In some embodiments, the detection system is able to measure the microbial diversity of complex communities without PCR amplification, and consequently, without the inherent biases associated with PCR amplification. Actively metabolizing cells typically contain about 20,000 or more ribosomes for protein assembly compared to quiescent or dead cells that have few. In some embodiments, rRNA can be purified directly from a sample and processed with no amplification step, thereby reducing or avoiding bias caused by preferential amplification of some sequences over others. Thus, in some embodiments, the signal from the analysis system can reflect the true number of rRNA molecules that are present in the samples. This can be expressed as the number of cells multiplied by the number of rRNA copies within each cell. The number of cells in a sample can then be inferred by several different methods, such as, for example, quantitative real-time PCR, or FISH (fluorescence in situ hybridization.). Then the average number of ribosomes within each cell may be calculated.

### Hybridization

Hybridizations can be carried out under conditions well-known by persons skilled in the art. See Rhee et al. (Appl. Environ. Microbiol. (2004) 70:4303-4317) and Wu et al. (Appl. Environ. Microbiol. (2006) 72:4931-4941). The temperature can be varied to reduce or increase stringency and allow the detection of more or less divergent sequences. Robotic hybridization and stringency wash stations can be used to give more consistent results and reduce processing time. In some embodiments, the hybridization and washing process can be accomplished in less than about half an hour, 1 hour, 2 hours, 3 hours, 4 hours, 5 hours, 6 hours, 7 hours, 8 hours, 9 hours, 10 hours, 11 hours, 12 hours, 14 hours, 16 hours, 18 hours, 20 hours or 24 hours. Generally, hybridization and washing times are reduced for microparticle based detection systems owing to the greater accessibility of the probes to the target molecules. Generally, hybridization times may be reduced for low complexity assays and/or assays for which there is an excess of target analytes.

### Signal Quantification

After hybridization, arrays can be scanned using any suitable scanning device. Non-limiting examples of conventional microarray scanners include GeneChip Scanner 3000 or GeneArray Scanner, (Affymetrix, Santa Clara, Calif.); and ProScan Array (Perkin Elmer, Boston, Mass.); and can be equipped with lasers having resolutions of 10 pm or finer. The scanned image displays can be captured as a pixel image, saved, and analyzed by quantifying the pixel density (intensity) of each spot on the array using image quantification software (e.g., GeneChip Analysis system Analysis Suite, version 5.1 Affymetrix, Santa Clara, Calif.; and ImaGene 6.0, Biodiscovery Inc. Los Angeles, Calif., USA). For each probe, an individual signal value can be obtained through imaging parsing and conversion to xy-coordinates. Intensity summaries for each feature can be created and variance estimations among the pixels comprising a feature can be calculated.

With flow cytometry based detection systems, a representative fraction of microparticles in each sublot of microparticles can be examined. The individual sublots, also known as subsets, can be prepared so that microparticles within a sublot are relatively homogeneous, but differ in at least one distinguishing characteristic from microparticles in any other sublot. Therefore, the sublot to which a microparticle belongs can readily be determined from different sublots using conventional flow cytometry techniques as described in U.S. Pat. No. 6,449,562. Typically, a laser is shined on individual microparticles and at least three known classification parameter values measured: forward light scatter (C₁) which generally correlates with size and refractive index; side light scatter (C₂) which generally correlates with size; and fluorescent emission in at least one wavelength (C₃) which generally results from the presence of fluorochrome incorporated into the labeled target sequence. Because microparticles from different subsets differ in at least one of the above listed classification parameters, and the classification parameters for each subset are known, a microparticle's sublot identity can be verified during flow cytometric analysis of the pool of microparticles in a single assay step and in real-time. For each sublot of microparticles representing a particular probe, the intensity of the hybridization signal can be calculated along with signal variance estimations after performing background subtraction.

### Data Processing and Statistical Analysis

Simultaneous detection of at least 500, 1,000, 5,000, 10,000, 20,000, 30,000, 40,000, 50,000, 60,000, or more taxa with a high level of confidence can incorporate techniques to de-convolute the signal intensity of numerous probe sets into probability estimates. In some embodiments, the methods, compositions, and systems of the invention enable detection in one assay the presence or absence of a microorganism in a community of microorganisms, such as an environmental or clinical sample when the microorganism comprises less than 0.05% of the total population of microorganisms. In some embodiments, detection includes determining the quantity of the microorganism, e.g., the percentage of the microorganism in the total microorganism population. De-convolution techniques can include the incorporation of NC probe pairs into the analysis system and the use of the data to fit the hybridization signals from the QS probe pairs to the hybridization distribution of the NC probe pairs.

De-convolution techniques can allow the detection and quantification of nucleic acids in a sample and by inference, the detection and quantification of microorganisms in a sample. In one aspect of the invention, a system is provided for determining the presence or quantity of a microorganism in a sample comprising contacting a sample with a plurality of probes, detecting the hybridization signals of the sample nucleic acids with the probes and de-convoluting the signals to determine the presence, absence and/or quantity of a particular nucleic acid present in a population of nucleic acids where the particular nucleic acid is present at less than 0.01% of the total nucleic acid population. In some embodiments, the particular nucleic acid is at least 80%, 85%, 90%, 91%, 92%, 93%, 94%, 95%, 96% or 97% homologous to other nucleic acids in the population.

In some embodiments, the data output from an imaged or scanned sample is de-convoluted and analyzed using the following methods. Using an array as an illustrative example, the hybridization signals are converted to xy-coordinates with intensity summaries and variance estimates generated for the pixels using commercial software. The data is outputted using a standard data format like a CEL file (Affymetrix), or a Feature Report file (NimbleGen).

The hybridization signals undergo background subtraction. Typically, the background intensity is computed independently for each quadrant as the average signal intensity of the least intense 2% of the probes in the quadrant. Other threshold values may also be used, e.g., 0.5%, 1%, 3%, 4%, 5% or 10%. Background intensity is then subtracted from all probes in a quadrant before further computation is performed. This noise removal procedure can be done on a quadrant-by-quadrant basis or across a whole array.

In some embodiment, array signals are normalized to allow for the comparison of results achieved in different experiments or for the comparison of replicate experiments. Normalization can be achieved by a number of methods. In one embodiment, reproducibility between different probes for the same target are evaluated using a Position Dependent Nearest Neighbor (PDNN) model as described in Zhang L. et al., A model of molecular interactions on short oligonucleotide analysis systems, Nat. Biotechnol. 2003, 21(7):818-821. The PDNN model allows estimation of the sequence specific noise signal and a non-specific background signal, and thus enables estimation of the true intensity for the probes.

In other embodiments, per-array models of signal and background distributions using responses observed from comparison of the PM and MM probe pairs and the internal DNA quantification standards (QS) probe pairs are created. In one embodiment, the probability that each probe pair is “positive” is determined by calculating a difference score, d, for each probe pair. d may be defined as:

$$d = 1 - ( \frac{PM - MM}{PM + MM} ) \qquad Eqn . 1$$

wherein:
PM=scaled intensity of the perfect match probe;
MM=scaled intensity of the mismatch probe; and,
d=pair difference score.
   The value ofd can range from 0 to 2. When PM>>MM, the value of d approaches 0; when PM=MM, d=1; and when PM<<MM, the value of d approaches 2.

In some embodiments, the internal DNA quantification standards (QS) and negative control (NC) probe pairs are binned and sorted by attributes of the probes. Examples of the attributes of the probes that can be used in the embodiments of the present invention include, but are not limited to binding energy; base composition, including A+T count, G+C count, and T count; sequence complexity; cross-hybridization binding energy; secondary structure; hair-pin forming potential; melting temperature; and length of the probe. These attributes of the probes may affect hybridization properties of the probes, for example, A+T count may affect hydrogen bonding of the probe, and T count may affect the length and base composition of the fragments produced by the use of DNase. Fragmentation with other enzyme systems may be influenced by the composition of other bases.

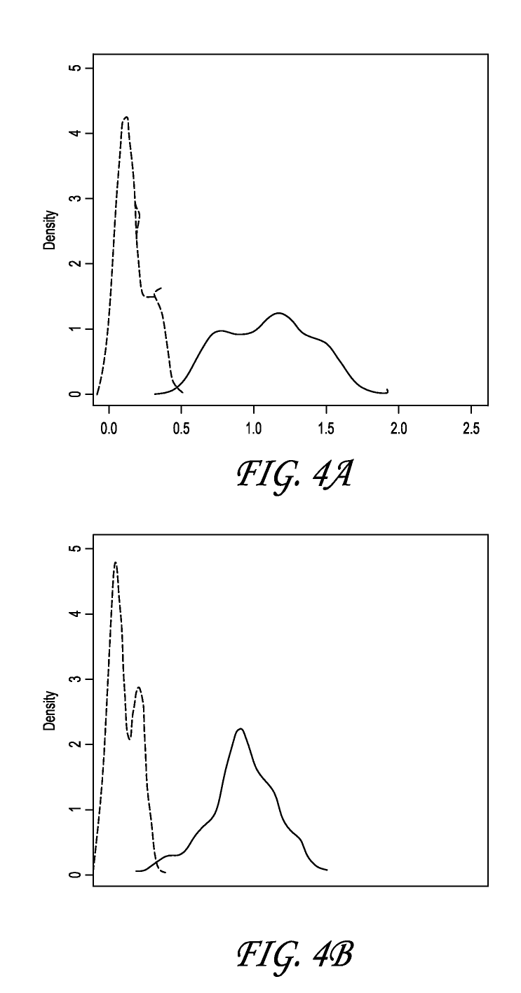

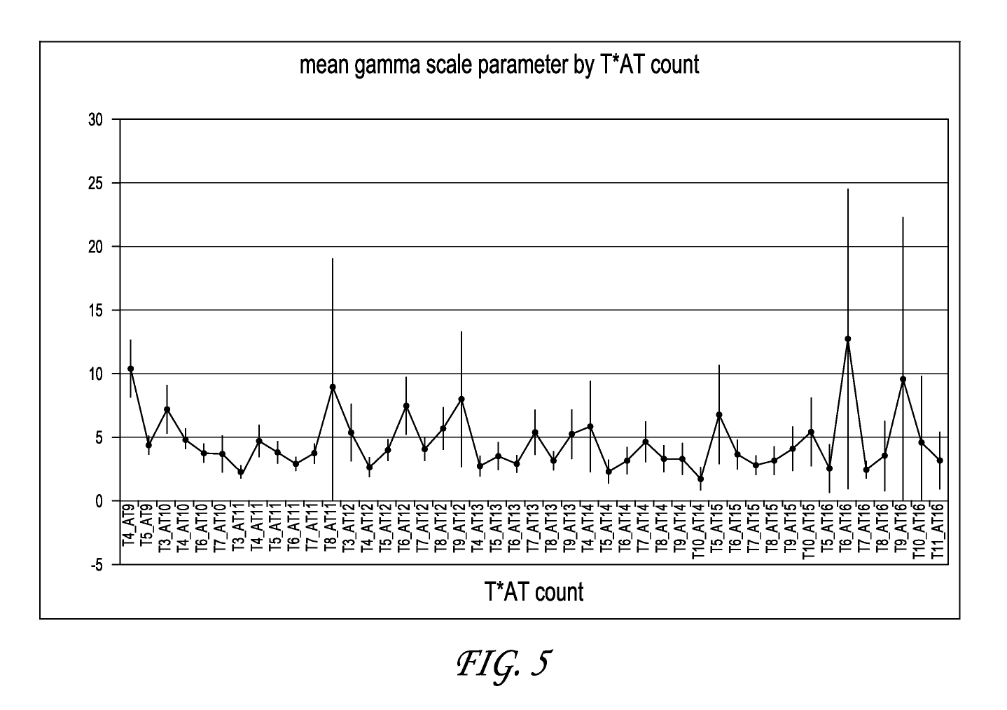

In one embodiment, QS and NC probe pairs are binned and sorted based on the individual probe's A+T count and T count. For each bin (A+T count by T count), the d values from the negative control probes are fit to a normal distribution to derive the scale (mean) and shape (standard deviation). Then, the d values from QS are fit to a gamma distribution to derive scale and shape. For each array, multiple density plots are produced by this process. Two examples of density plots generated from two different probe bins within the same array are shown in FIG. 4A-B. The AT count is 14 for the probes represented both figures. The T count is 9 for the probes in FIG. 4A, while the T count is 10 for the probes represented in FIG. 4B. As these graphs demonstrate, even one extra T, as shown in FIG. 4B, can result in appreciable difference in the probe gamma scale parameter. Variations of gamma scale across 79 arrays are shown in FIG. 5.

The parameters derived from gamma and normal distributions are used to derive a pair response score, r, for each probe pair. r is an indicator of the probability that a probe pair is positive, i.e., the probability for a probe pair to be responsive to the target sequence. r may be defined as:

$$r = ( \frac{{pdf}_{γ} ( X = d )}{{pdf}_{γ} ( X = d ) + {pdf}_{norm} ( X = d )} ) \qquad Eqn . 2$$

where:
   r=response score to measure the potential that a specific probe pair is binding a target sequence and not a background signal, i.e. the probability of the probe pair being positive for the specific target sequence;
   pdf_{γ}(X=d)=probability that d could be drawn from the gamma distribution estimated for the target class ATx Ty;
   pdfₙₒᵣₘ(X=d)=probability that d could be drawn from the normal distribution estimated for the target class ATx Ty.
   r can range from 0 to 1. r approaches 1 when PM>>MM, and r approaches 0 when PM<<MM.

Each set of interrogation probe pairs, e.g., an OTU, can be scored based on pair response scores, cross-hybridization relationships or both. In some embodiments, the system removes data from at least a subset of probe pair sets before making a final call on the presence or quantity of said microorganisms. In one embodiment, the data is removed based on interrogation probe cross hybridization potential. In one embodiment, the scoring of probe pairs is performed by a two-stage process as discussed below.

For example, a two stage analysis can be performed wherein only probe pairs that pass a first stage are analyzed in the next stage. In the first stage, the distribution of r across each set of probe pairs, R, is determined. For each set of probe pairs that is associated with an OTU, the r values of all probe pairs are ranked within the set, and percentage of probe pairs that meet one or more threshold r values are determined. Frequently, three threshold determinations are made at 25% increments across the total range of ranked probe pairs (interquartile Q1, Q2, and Q3); however, any number of threshold determinations or percentage increments can be used. For example, a determination may use one increment at 70% in which probe pairs must pass a threshold value of 80%.

Typically, to differentiate signal from noise, an OTU is considered to pass Stage 1 if Q1, Q2, and Q3 of the set of probe pairs that is associated with this OTU surpass the threshold of Q1ₘᵢₙ, Q2ₘᵢₙ, and Q3ₘᵢₙ, respectively. That is, for an OTU to pass Stage 1, the r value of 75% of the probe pairs in the set of probe pairs that is associated with that OTU has to be at least Q1ₘᵢₙ, the r value of 50% of the probe pairs in that set of probe pairs have to be at least Q2ₘᵢₙ, and the r value of 25% of the probe pairs in that set of probe pairs have to be at least Q3ₘᵢₙ. Q1ₘᵢₙ is at least about 0.5, about 0.55, about 0.6, about 0.65, about 0.7, about 0.75, about 0.8, about 0.82, about 0.84, about 0.86, about 0.88, about 0.90, about 0.91, about 0.92, about 0.93, about 0.94, about 0.95, about 0.96, about 0.97, about 0.98, or about 0.99. Q2ₘᵢₙ is at least about 0.5, about 0.55, about 0.6, about 0.65, about 0.7, about 0.75, about 0.8, about 0.82, about 0.84, about 0.86, about 0.88, about 0.90, about 0.91, about 0.92, about 0.93, about 0.94; about 0.95, about 0.96, about 0.97, about 0.98, or about 0.99. Q3ₘᵢₙ is at least about 0.5, about 0.55, about 0.6, about 0.65, about 0.7, about 0.75, about 0.8, about 0.82, about 0.84, about 0.86, about 0.88, about 0.90, about 0.91, about 0.92, about 0.93, about 0.94, about 0.95, about 0.96, about 0.97, about 0.98, about 0.99, about 0.992, about 0.994, about 0.996, about 0.998, or about 0.999. In some embodiments, Q2ₘᵢₙ, and Q3ₘᵢₙ are determined empirically from spike-in experiments. For example, Q1ₘᵢₙ, Q2ₘᵢₙ, and Q3ₘᵢₙ are chosen to allow 2 pM amplicon concentration to pass. In one embodiment, Q1ₘᵢₙ, Q2ₘᵢₙ, and Q3ₘᵢₙ are 0.98, 0.97, and 0.82, respectively. These threshold numbers were empirically derived using DNase to fragment the sample sequences. Since DNase has a T-bias, the use of other enzymes may require a shift in the threshold numbers and can be empirically derived.

In the second stage only the OTUs passing the first are considered as potential sources of cross-hybridization. In some embodiments, for each OTU, only probe-pairs with r>0.5 (these are the probe pairs considered as to be likely responsive to the target sequence) are further analyzed. In other instances, only probe pairs with r>0.6, 0.7, 0.8, or 0.9 are considered responsive and are further analyzed. Probe pairs that are unlikely to be responsive (i.e., r<0.5) are not analyzed further even if their set R, was responsive overall. R_{0.5} represents the subset of probe pairs in which all probe pairs have r>0.5. Typically, based on the interquartile Q1, Q2 and Q3 values chosen at Stage 1, most of the probe pairs in the OTUs passing Stage 1 are analyzed. In other embodiments, only the probe-pairs with r>0.55, 0.60, 0.65, 0.70, 0.75, 0.80, 0.85, or 0.90 are further analyzed.

For each probe pair in the R_{0.5} subset, the count of putatively cross-hybridizing OTUs (i.e., the number of OTUs with which the probe pair can cross-hybridize) is determined. In this process, only the OTUs that have passed Stage 1 are considered as potential sources of cross-hybridization. Each probe pair in the R_{0.5} subset is penalized by dividing its r value by the count of putatively cross-hybridizing OTUs to determine its modified possibility of being positive. The modified possibility of being positive for a probe pair may be represented by a rₓ value. rₓ may be defined as:

$${r}_{x} = \frac{r}{{scalarS}_{1 x}} \qquad Eqn . 3$$

where
S₁=Set of OTUs passing Stage 1; and,
S₁ₓ=Set of OTUs passing Stage 1 with cross hybridization potential to the given probe pair

rₓ is proportional to the response of the probe pair and the specificity of the probe pair given the community observed during the first stage. rₓ value can range from 0 to 1. For each set of probe pairs associated with an OTU, rₓ are calculated for each probe pair and ranked within the set. Interquartile Q1, Q2, Q3 values for the distribution of rₓ value in each set of probe pairs are determined. The taxon represented by the OTU is considered to be present if Q1 is greater than Qₓ₁, Q2 is greater than Qₓ₂, or Q3 is greater than Qₓ₃. Qₓ₁ is at least about 0.5, at least about 0.55, at least about 0.6, at least about 0.65, at least about 0.7 at least about 0.75, at least at least about 0.8, at least about 0.85, at least about 0.90, at least about 0.95, or at least about 0.97. Qₓ₂ is at least about 0.5, at least about 0.55, at least about 0.6, at least about 0.65, at least about 0.7 at least about 0.75, at least at least about 0.8, at least about 0.85, at least about 0.90, at least about 0.95, or at least about 0.97. Qₓ₃ is at least about 0.5, at least about 0.55, at least about 0.6, at least about 0.65, at least about 0.7 at least about 0.75, at least at least about 0.8, at least about 0.85, at least about 0.90, at least about 0.95, or at least about 0.97. In one embodiment, Qₓ₁ is at least 0.66, that is, 75% of the probe pairs in the set of the probe pairs have a rₓ value that is at least 0.66.

A two stage hybridization signal analysis procedure can be performed on hybridization signals from any array or microparticle generated data set, including data generated from the use of any combination of probes selected using the disclosed methodologies. In some embodiments, the second stage of the procedure penalizes probes based on the number of cross-hybridizations, the intensity of the cross-hybridization signals or a combination of the two.

The method disclosed herein is useful for hierarchical probe set scoring. An OTU may be present at a node at any hierarchical level on a clustering tree. As used herein, an OTU is a group of one or more organisms, such as a domain, a sub-domain, a kingdom, a sub-kingdom, a phylum, a sub-phylum, a class, a sub-class, an order, a sub-order, a family, a subfamily, a genus, a subgenus, a species, or any cluster. In some embodiments, a R_{0.5} set is collected for each node on the phylogenetic tree and consists of all unique probes from subordinate R_{0.5} sets. For example, for calculating rₓ values for probe pairs in a R_{0.5} set for an OTU representing an “order,” the count of putatively cross-hybridizing equally-ranked taxa (i.e., “order” node) containing at least one sequence with cross-hybridization potential is used as the denominator in Eqn. 3.

In some embodiments, the OTUs at the leaf level (e.g., species, sub-genus or genus) are first analyzed. Then each successive level of nodes in the clustering tree is analyzed. In one embodiment, the analysis is performed up to the domain level. In another embodiment, the analysis is performed up to the phylum level. In yet another embodiment, the analysis is performed up to the kingdom level. Penalization for cross-hybridization in Eqn. 3 is only performed for probes on the same taxonomy level. All present taxa are quantified using the mean scaled PM probe intensity after discarding the highest and lowest value of the set R (HybScore). In some embodiments, only taxa present at a first level are analyzed further.

In some embodiments, a summary abundance score is determined. Corrected abundance scores are created based on G+C content and uracil incorporation. Generally, probes with higher G+C content produce a higher hybridization signal that is typically compensated for correcting the abundance scores.

The probability of detection for each taxonomic node is determined by summarizing terminal node detection and the breadth of cross-hybridization relationships. Hierarchical probes are scored for evidence of novel organisms based on cluster analysis.

In some embodiments, the system is capable of analyzing other data in conjunction with that obtained from the analysis of probe hybridization signal strength. In some embodiments, the system can analyze sequencing reaction data including that obtained with high-through put sequencing techniques. In some embodiments, the sequencing data is from same regions of the same highly conserved sequence analyzed by the method disclosed herein using probes.

### High Capacity Analysis System Applications

Numerous subject-derived samples can be assayed to determine the sample's microbiome composition. By having an assay system capable of detecting in a single assay the presence and optionally quantity of at least 10,000, 20,000, 30,000, 40,000, 50,000, 60,000, 70,000, 80,000, 90,000, 100,000, 200,000, 500,000 or 1,000,000 bacterial or archeal taxa, a complete picture of a microbiotic ecosystem can be achieved quickly and at relatively low cost providing the ability to examine numerous subjects.

The elucidation of a specific microbiome associated with an ecosystem, animal, human, organ system, condition, and the like allows for the generation of a “signature,” “biosignature,” or “fingerprint” of the particular environment sampled, terms used interchangeably herein. If the biosignature is from a normal or healthy system or subject, or is from a subject free from a condition under examination, then the associated biosignature can be used as a reference for the comparison of later samples from the same or other subjects to monitor for changes that are associated with an abnormal or unhealthy state or condition. For example, if a later biosignature of a subject shows that the microbiome has shifted away from that associated with a healthy pulmonary status, then preemptive measures could be taken to prevent a continued shift, for example by identifying a disease-related organism or OTU and taking steps to treat it.

Similarly, a biosignature of an environment can be compared to a biosignature generated from a pool of samples that represent an average or normal biosignature for a population or collection of environments. For example, a sample from an unhealthy individual could be assayed and the microbial biosignature compared to the biosignature seen in a healthy population at large. If one or more microorganisms are detected in the unhealthy individual that are either not seen in the general population or not seen at the same prevalence then therapeutic measures can be taken to selectively eliminate or reduce in number the microorganisms associated with the unhealthy state. For instance, the microflora of the respiratory system can be compared between individuals that suffer from chronic obstructed pulmonary disease (COPD), such as during an exacerbation of the disease, and individuals not suffering from COPD or having COPD that is in remission. If the individuals with exacerbated COPD are shown to have one or more dominant pulmonary microorganisms compared to the other individuals, then an available drug and/or dietary therapy that specifically targets the prevalent, abnormal microorganisms can be administered. Alternatively or additionally, the pulmonary microorganism population in the COPD sufferer can be shifted through the introduction of large numbers of the microorganisms associated with healthy pulmonary status. Once a relationship is known between the prevalence of a particular microorganism or group of microorganisms (e.g. one or more OTUs) and a disease state, then disease progression or treatment response can also be monitored, diagnosed, and/or predicted using the present systems and methods.

Numerous microbiomes of animals or humans can be analyzed with the present systems and methods including the gut, respiratory system, urogenital tract, mammary glands, skin, oral cavity, auditory canal, and skin. Clinical samples such as blood, sputum, nares, feces, and urine can be used with the method. From the analysis of normal individuals and those suffering from a disease or condition, a large database of fingerprints or biosignatures can be assembled. By comparing the biosignatures between healthy and disease related states, associations can be made as to the influence and importance of individual components of the microbiome.

Once these associations are made, treatments can be designed and tested to alter the composition of the microbiota seen in the disease state. Additionally, by regularly monitoring the microbial composition of an affected organ system in a diseased individual, disease progress or response to therapy can be observed and if need, additional therapeutic measures taken to alter the microbiome composition to one that is more representative of that seen in a healthy population.

An interesting property of bacteria that has great importance in healthcare, water quality and food safety is quorum sensing. Many bacteria are able to sense the presence of other members of their species or related species and upon reaching a specific density the bacteria start producing various virulence or pathogenicity factors. In other words, the bacteria's gene expression is coordinated as a group. For example, some bacteria produce exopolysaccharides that are known as “slime layers.” The secretion of exopolysaccharidse can decrease the ability of white blood cells to phagocytize the microorganisms and make the microorganisms more resistant to therapeutics or cleaning agents. Traditional methodologies require the detection of specific gene expression in order to detect or study quorum sensing and other population induced effects. The present systems and methods can be used to understand the changes that occur in a microbiome that are associated with a given effect such as biofilm formation or toxicity production. One can develop protocols with the present systems and methods to look for and determine conditions that lead to quorum sensing. For example, testing samples at various timepoints and under varying conditions can lead to determining how and when to intervene or reverse population induced expression of virulence or pathogenicity factors.

In one embodiment, a method is provided to identify a new indicator species for an environmental or health condition with the present systems and methods. The condition can be that of a normal or healthy state. Alternatively, the indicator species can be for an unhealthy or abnormal condition. To identify a new indicator species, a normal sample is simultaneously assayed to determine the presence or quantity of each OTU associated with all known bacteria, archae, or fungi; this test result is compared to the results achieved in the simultaneous assay of sample from the environment of the condition where the presence or quantity of each OTU associated with all known bacteria, archae, or fungi was determined. Microorganisms that change in abundance at least 2-fold, 3-fold, 4-fold, 5-fold, 10-fold, 20-fold, 50-fold or 100-fold, either increasing in abundance or decreasing in abundance represent putative indicator species for a condition.

In other embodiments, methods are provided for identifying indicators species associated with a disease state, disease progression, treatment regimen, probiotic administration, including progression of disease. In some embodiments the disease is COPD. In some embodiments, the disease relates to a level of COPD activity in a subject, such as a subject having COPD that is not exacerbated (e.g. non-exacerbated COPD), COPD that is exacerbated (e.g. exacerbated COPD), or changing in the level of disease activity (e.g. intermediate COPD exacerbation). Intermediate COPD exacerbation may be indicative of a transition away from an exacerbated state, and may be used as an indication of successful response to therapy. Intermediate COPD exacerbation may be indicative of a transition towards an exacerbated state. Where intermediate COPD exacerbation indicates an onset of COPD exacerbation, intermediate COPD exacerbation can comprise a prediction of the onset of exacerbation of COPD in a subject. A prediction in onset can comprise a prediction in time to onset, for example, 1, 2, 3, 4, 5, 6, 7, 8, 9, 10, 11, 12, 13, 14, or more days before an onset of COPD exacerbation; or 1, 2, 3, 4, 5, 6, 7, 8, 9, 10, 11, 12, 13, 14, or more weeks before an onset of COPD exacerbation. A prediction of onset of COPD exacerbation may be used as a basis for taking medical action, such as therapeutic action, including but not limited to the administration of a therapeutic compound. In other embodiments, methods are provided for monitoring a change in the environment or health status associated with introducing one or more new microorganisms into a community. For example, measures to increase a particular microorganism's percentage of the gut microbiome in an individual, such as feeding a person yogurt or a food supplement containing L. casei, can be monitored using the present methods and systems.

### Combined Analysis

The ability to identify and quantitate the microorganisms in a sample can be combined with a gene expression technology such as a functional gene array to correlate populations with observed gene expression. Similarly, microbiome composition analysis can be correlated with the presence of chemicals, proteins including enzymes, toxins, drugs, antibiotics or other sample constituents. For instance, nucleic acids isolated from a soil sample can be analyzed to elucidate the microbiome composition (e.g. biosignature) and also to identify expressed genes. In the bare, nutrient-poor soils on the Antarctic, this analysis associated chitinase and mannanase expression with Bacteroidetes and CH₄-related genes with Alphaproteobacteria. (Yergeau et al., Environmental microarray analyses of Antarctic soil microbial communities. ISME J. 3:340-351, 2009). Significant correlations were also found between taxon abundances and C- and N-cycle gene abundance. From this data, one can predict that certain organisms or groups of organisms are required or account for the majority of an expected or observed enzymatic or degradative process. For example, members of the Bacteroidetes phylum probably degrade the majority of environmental chitin, a major constituent of exoskeletons of insect and arthropods and also of fungi cell walls, at the sample locale.

This methodology can be used to identify new antibiotic producing organisms, even ones that are unculturable. For instance, soil extracts can be tested for antibiotic activity. If a positive extract is found, a sample of the soil from which a portion was extracted for antibiotic can be analyzed for microbial composition and perhaps gene expression. Major constituents of the microbiome could be correlated with antibiotic activity with the correlation strengthened through gene expression data allowing one to predict that a particular organism or group of organisms is responsible for the observed antibiotic activity.

In one aspect, the invention provides a method for determining a condition in a sample. In one embodiment, the method comprises a) contacting said sample with a plurality of different probes; b) determining hybridization signal strength for each of said probes, wherein said determination establishes a biosignature for said sample; and, c) comparing the biosignature of said sample to a biosignature for COPD, including COPD exacerbation. In some embodiments, a method is provided for making a prediction about a sample comprising a) determining microorganism population data as the probability of the presence or absence of at least 100 OTUs of microorganisms in said sample; b) determining gene expression data of one or more genes by said microorganisms in said sample and c) using said expression data and population data to make a prediction about said sample. In some embodiments, the prediction entails the identity of a microorganism responsible for a characteristic or condition observed in an environment.

Other combined analysis methods include the use of a diffusion chamber to retain microorganisms in a sample while one or more constituents or parameters of the sample are changed. For instance, the salinity or pH of the sample can be changed abruptly or gradually over time. Following specific time intervals, the microbiome of the sample in the diffusion chamber can be determined. Microorganisms that cannot tolerate the new environment conditions will die, become reduced in number due to unfavorable conditions or predation, or remain static in their numbers. In contrast, microorganisms that can tolerate the new conditions will at least maintain their number or thrive, perhaps becoming a dominant population. Use of a diffusion chamber coupled with a system capable of detecting the presence or quantity of at least 10,000 OTUs can allow the identification of microorganisms that perish or fail to thrive when placed in a new environment. Such microorganisms are termed “transient”, meaning that their percent composition of the microbiome changes quickly. The identification of transient microorganisms can be used to ascertain the time and/or place they were introduced into an environment. Different transient microorganisms can have different half-lives for a particular condition.

Diffusion chambers can also take the form of a semi-permeable capsule, tube, rod, or sphere or other solid or semi-solid object. A microbiome or a select group of bacteria can be placed inside the capsule, that is then sealed and introduced into an environment for a specified period of time. Upon removal, the capsule is opened and the microbiome or select group of bacteria sampled to ascertain changes in the presence or quantity of the individual constituents. The capsule can be removed once or periodically to sample the microbiome. Alternatively, multiple single use capsules with identical quantities of the microbiome can be used, each one removed and sampled at a different time point. Microbiomes placed in capsules or other semi-permeable containers can be introduced into a living organism, usually through an orifice, to measure changes to the microbiome composition associated with a particular organ or system environment. For example, a semi-permeable capsule or tube containing a microbiome can be introduced into the gastrointestinal system through the mouth or anus. A microbiome from a healthy individual can be introduced in this manner into an unhealthy individual, such as a patient suffering from Crohn's disease or irritable bowel syndrome to ascertain the effect of the unhealthy condition on the normal, healthy individual associated microbiome. In this manner, the efficacy of drug effectiveness and treatment protocols could also be evaluated based on the effects of the gut ecology on a known microbiome.

### Low Density-Special Purpose Detection Systems

In some embodiments, probes are selected for constructing special purpose systems including those with arrays or microparticles. Typically, special purpose “low density” systems, are designed for use in a specific environment or for a particular application and usually feature a reduced number of probes, “down-selected” probes, that are specific to organisms that are known or expected to be present in the particular environment, such as associated with a particular biosignature. In some cases the biosignature is fecal contamination. Typically, a low density system comprises no more than 10, 20, 50, 100, 200, 500, 1,000, 2,000, 5,000 or 10,000 down selected probes or 5, 10, 25, 50, 100, 250, 500, 1,000, 2,500 or 5,000 down selected probes probe pairs (PM and MM probes). In some embodiments, only 1, 2, 3, 4, 5, 6, 7, 8, 9, or 10 probes are used per OTU. In further embodiments, only PM probes are used. Generally, these down-selected probes have robust hybridization signals and few or no cross hybridizations. In some embodiments, the collection of down selected probes have a median cross hybridization potential number of less than 20, 15, 10, 8, 7, 6, 5, 4, 3, 2, or 1 per probe. Frequently the down selected probes belong to OTUs that have reduced numbers of probes. In some embodiments, the OTUs of a down select probe collection have a median number of less than 25, 20, 15, 14, 13, 12, 11, 10, 9, 8, 7, 6, 5, 4, 3 or 2 probes per OTU. Generally, low density systems feature probes that recognize no more than 10, 25, 50, 100, 250, 500, 1,000, 2,000, or 5,000 taxa. For a set number of probes, a number of design strategies can be employed for low density systems. One approach is to maximize the number of OTUs identified, e.g., use one probe per OTU with no mismatch probes. Another approach is to select probes based on the desired confidence level. Here, multiple probes for each OTU along with corresponding mismatch probes may be required to achieve at least 95% confidence level for the presence and quantity of each OTU. The probes for a particular low density application can be selected by applying a sample from an appropriate environment to a high density analysis system, e.g., a detection system that can in a single assay determine the probability of the presence or quantity of at least 10,000, 20,000, 30,000, 40,000, 50,000, 60,000, 70,000, 80,000, 90,000, 100,000, 250,000, 500,00 or 1,000,000 OTUs of a single domain, such as bacteria, archea, or fungi, or alternatively, for each known OTU of a single domain. Probes associated with prevalent OTUs can be selected for a low density system. Alternately, the OTUs seen in a sample of interest can be compared with a control sample and shared OTUs subtracted out with the probes associated with the remaining OTUs selected for the low density system. Additionally, probes can be selected based on a change in prevalence of OTUs between the environment of interest and a control environment. For example, OTUs that are at least 2-fold 5-fold, 10-fold, 100-fold or 1,000-fold more abundant in the sample of interest compared to the control sample are included in the down selected probe set. Using this information, a down selected array, bead multiplex system or other low density assay system is designed.

“Low density” assays systems can be used to identify select microorganisms and determine the percentage composition of various select microorganisms in relation to each other. Low density assay systems can be constructed using probes selected through the disclosed methodologies. These low density systems can identify at least 1, 2, 3, 4, 5, 6, 7, 8, 9, 10, 15, 20, 30, 40, 50, 60, 70, 80, 90, 100, 200, 500, 1000 or more microorganisms. Representative microorganisms to be identified and optionally quantified are listed in Table 7. Additional representative microorganisms to be identified and optionally quantified are listed in Tables 3-5.

TABLE 7
Representative Microorganisms Recognized by Low
Density Assay Systems

| Species | Application |
|---|---|
| Listeria monocytogenes | Food safety, environmental surveillance |
| | of food processing plants |
| Salmonella enterica subsp. | Food safety, environmental surveillance |
| enterica serovar | of food processing plants |
| Enteritidis | |
| Pseudomonas aeruginosa | Pulmonary health |

Low density assays systems are useful for numerous environmental and clinical applications. Exemplary applications are listed in Table 7. Medical conditions that can be identified, diagnosed, prognosed, tracked, or treated based on data obtained with a low density system include but are not limited to, cystic fibrosis, chronic obstructive pulmonary disease, Crohn's Disease, irritable bowel syndrome, cancer, rhinitis, stomach ulcers, colitis, atopy, asthma, neonatal necrotizing enterocolitis, obesity, periodontal disease and any disease or disorder caused by, aggravated by or related to the presence, absence or population change of a microorganism. Through the judicious selection of OTUs to be included in a system, the system becomes a diagnostic device capable of diagnosing one or more conditions or diseases with a high level of confidence producing very low rates of false positive or false negative readings.

In some embodiments, the low density systems also feature confirmatory probes that are specific (complimentary) for genes or sequences expressed in specific organisms. For example, the call virulence gene of Yersinia pestis and the zonula occludens toxin (zot) gene of Vibrio cholerae and also confirmatory probes to Y. pestis or V. cholerae.

### Kits

As used herein a “kit” refers to any delivery system for delivering materials or reagents for carrying out a method of the invention. In the context of assays, such delivery systems include systems that allow for the storage, transport, or delivery of arrays or beads with probes, reaction reagents (e.g., probes, enzymes, etc. in the appropriate containers) and/or supporting materials (e.g., buffers, written instructions for performing the assay etc.) from one location to another. For example, kits include one or more enclosures (e.g., boxes) containing the relevant reaction reagents and/or supporting materials for assays of the invention.

In one aspect of the invention, kits for analysis of nucleic acid targets are provided. According to one embodiment, a kit includes a plurality of probes capable of determining the presence or quantity over 10, 20, 50, 100, 200, 500, 1,000, 2,000, 5,000, 10,000, 20,000, 30,000, 40,000 50,000 or 60,000 different OTUs in a single assay. Such probes can be coupled to, for example, an array or plurality of microbeads. In some aspects a kit comprises at least 5, 10, 15, 20, 50, 100, 200, 500, 1,000, 2,000, 5,000, 10,000, 20,000, 50,000, 100,000, 200,000, 500,000, 1,000,000 or 2,000,000 interrogation probes selected using the disclosed methodologies and/or for use in the identification and/or comparison of a biosignature of one or more samples.

The kit can also include reagents for sample processing. In some embodiments, the reagents comprise reagents for the PCR amplification of sample nucleic acids including primers to amplify regions of a highly conserved sequence, such as regions of the 16S rRNA gene. In some embodiments, the reagents comprise reagents for the direct labeling of RNA, such as rRNA. In further embodiments, the kit includes instructions for using the kit. In other embodiments, the kit includes a password or other permission for the electronic access to a remote data analysis and manipulation software program. Such kits will have a variety of uses, including environmental monitoring, diagnosing disease, monitoring disease progress or response to treatment, and identifying a contamination source and/or the presence, absence, or amount of one or more contaminants.

### Computer Implemented Methods

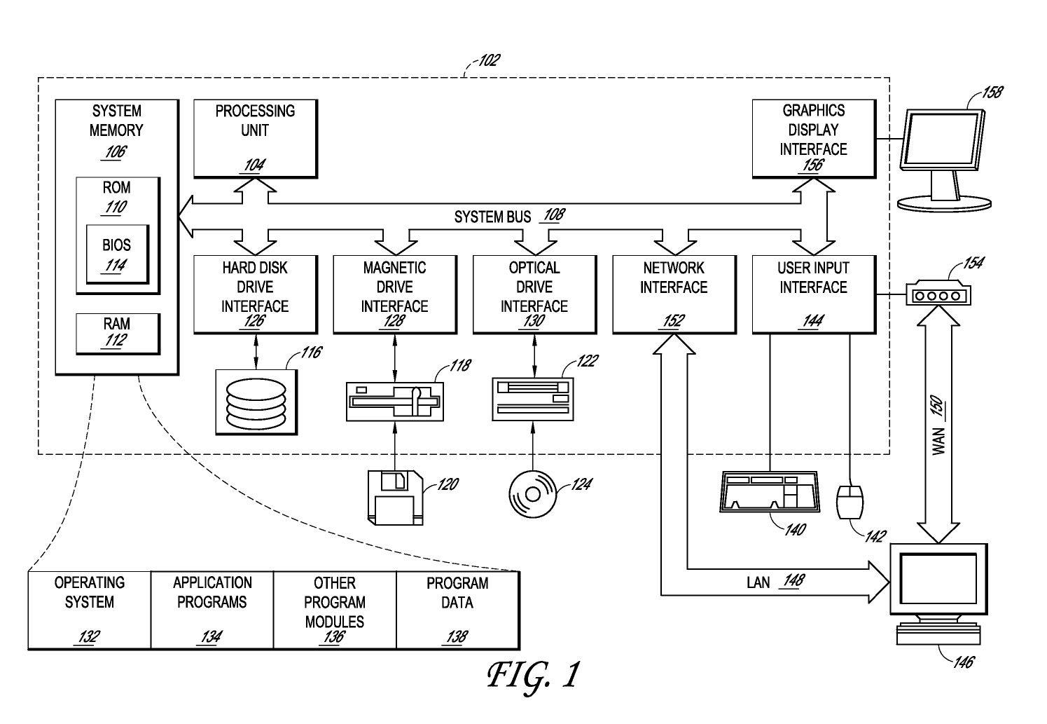

FIG. 1 illustrates an example of a suitable computing system environment or architecture in which computing subsystems may provide processing functionality to execute software embodiments of the present invention, including probe selection, analysis of samples, and remote networking. The method or system disclosed herein may also operational with numerous other general purpose or special purpose computing system including personal computers, server computers, hand-held or laptop devices, multiprocessor systems, and the like.

The method or system may be described in the general context of computer-executable instructions, such as program modules, being executed by a computer. The method or system may also be practiced in distributed computing environments where tasks are performed by remote processing devices that are linked through a communications network.

With reference to FIG. 1, an exemplary system for implementing the method or system includes a general purpose computing device in the form of a computer 102.

Components of computer 102 may include, but are not limited to, a processing unit 104, a system memory 106, and a system bus 108 that couples various system components including the system memory to the processing unit 104.

Computer 102 typically includes a variety of computer readable media. Computer readable media includes both volatile and nonvolatile media, removable and non-removable media and a may comprise computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 102, such as during start-up, is typically stored in ROM 110. RAM 112 typically contains data and/or program modules that are immediately accessible to and/or presently being operated on by processing unit 104. FIG. 1 illustrates operating system 132, application programs 134 such as sequence analysis, probe selection, signal analysis and cross-hybridization analysis programs, other program modules 136, and program data 138.

The computer 102 may also include other removable/non-removable, volatile/nonvolatile computer storage media. By way of example only, FIG. 1 illustrates a hard disk drive 116 that reads from or writes to non-removable, nonvolatile magnetic media, a magnetic disk drive 118 that reads from or writes to a removable, nonvolatile magnetic disk 120, and an optical disk drive 122 that reads from or writes to a removable, nonvolatile optical disk 124 such as a CD ROM or other optical media. Other removable/non-removable, volatile/nonvolatile computer storage media that can be used in the exemplary operating environment include magnetic tape cassettes, flash memory cards, digital versatile disks, digital video tape, solid state RAM, solid state ROM, and the like. The hard disk drive 116 is typically connected to the system bus 108 through a non-removable memory interface such as interface 126, and magnetic disk drive 118 and optical disk drive 122 are typically connected to the system bus 108 by a removable memory interface, such as interface 128 or 130.

The drives and their associated computer storage media discussed above and illustrated in FIG. 1, provide storage of computer readable instructions, data structures, program modules and other data for the computer 102. In FIG. 1, for example, hard disk drive 116 is illustrated as storing operating system 132, application programs 134, other program modules 136, and program data 138. A user may enter commands and information into the computer 102 through input devices such as a keyboard 140 and a mouse, trackball or touch pad 142. These and other input devices are often connected to the processing unit 104 through a user input interface 144 that is coupled to the system bus, but may be connected by other interface and bus structures, such as a parallel port or a universal serial bus (USB). A monitor 158 or other type of display device is also connected to the system bus 108 via an interface, such as a video interface or graphics display interface 156. In addition to the monitor 158, computers may also include other peripheral output devices such as speakers (not shown) and printer (not shown), which may be connected through an output peripheral interface (not shown).

The computer 102 can be integrated into an analysis system, such as a microarray or other probe system described herein. Alternatively, the data generated by an analysis system can be imported into the computer system using various means known in the art.

The computer 102 may operate in a networked environment using logical connections to one or more remote computers or analysis systems. The remote computer may be a personal computer, a server, a router, a network PC, a peer device or other common network node, and typically includes many or all of the elements described above relative to the computer 102. The logical connections depicted in FIG. 1 include a local area network (LAN) 148 and a wide area network (WAN) 150, but may also include other networks. Such networking environments are commonplace in offices, enterprise-wide computer networks, intranets and the Internet. When used in a LAN networking environment, the computer 102 is connected to the LAN 148 through a network interface or adapter 152. When used in a WAN networking environment, the computer 102 typically includes a modem 154 or other means for establishing communications over the WAN 150, such as the Internet. The modem 154, which may be internal or external, may be connected to the system bus 108 via the user input interface 144, or other appropriate mechanism. In a networked environment, program modules depicted relative to the computer 102, or portions thereof, may be stored in the remote memory storage device.

In further aspects of the invention, computer-implemented methods are provided for analyzing the presence or quantity of over 20, 50, 100, 200, 500, 1,000, 2,000, 5,000, 10,000, 20,000, 30,000, 40,000 50,000 or 60,000 different OTUs in a single assay. In one embodiment, computer executable logic is provided for determining the presence or quantity of one or more microorganisms in a sample comprising: logic for analyzing intensities from a set of probes that selectively binds each of at least 20, 50, 100, 200, 500, 1,000, 2,000, 5,000, 10,000, 20,000, 30,000, 40,000 50,000 or 60,000 unique and highly conserved polynucleotides and determining the presence of at least 97% of all species present in said sample with at least 90%, 95%, 96%, 97%, 98%, 99% or 99.5% confidence level.

In one embodiment, computer executable logic is provided for determining probability that one or more organisms, from a set of different organisms, are present in a sample. The computer logic comprises processes or instructions for determining the likelihood that individual interrogation probe intensities are accurate based on comparison with intensities of negative control probes and positive control probes; a process or instructions for determining likelihood that an individual OTU is present based on intensities of interrogation probes from OTUs that pass a first quantile threshold; and a process or instructions for penalizing one or more OTUs that have passed the first quantile threshold based on their potential for cross-hybridizing with other probes that have also passed the first quantile threshold.

In a further embodiment, computer executable logic is provided for determining the presence of one or more microorganisms in a sample. The logic allows for the analysis of a set of at least 1000 different interrogation perfect probes. The logic further provides for the discarding of information from at least 10% of the interrogation perfect match probes in the process of making the determination. In some embodiments, the computer executable logic is stored on computer readable media and represents a computer software product.

In other embodiments, computer software products are provided wherein computer executable logic embodying aspects of the invention is stored on computer media like hard drives or optical drives. In one embodiment, the computer software products comprise instructions that when executed perform the methods described herein for determining candidate probes.

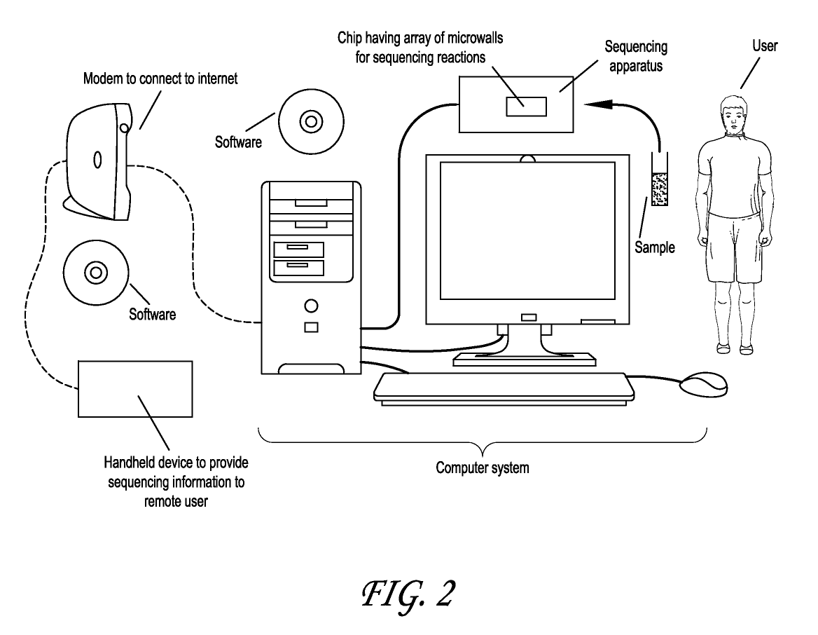

In further embodiments, computer systems are provided that can perform the methods of the inventions. In some embodiments, the computer system is integrated into and is part of an analysis system, like a flow cytometer or a microarray imaging device. In other embodiments, the computer system is connected to or ported to an analysis system. In some embodiments, the computer system is connected to an analysis system by a network connection. FIG. 2 illustrates one embodiment of a networked system for remote data acquisition or analysis that utilizes a computer system illustrated in FIG. 1. In this example, a sample is imaged using a commercially available imaging system and software. The data is outputted using a standard data format like a CEL file (AFFYMETRIX®), or a Feature Report file (NIMBLEGEN®). Then the data is sent to a remote or central location for analysis using a method of the invention. In some embodiments, a standardized analysis is performed providing signal normalization, OTU quantification, and visual analytics. In other embodiments, a customized analysis is performed using a fixed protocol designed for the user's particular needs. In still other embodiments, a user configurable analysis is used, include a protocol that allows for the user to adjust at least one variable before each analysis run.

After processing, the results are stored in an exchangeable binary format for later use or sharing. Additionally, hybridization scores and OTU probability values may be exported to a tab delimited file or in a format compatible with UniFrac (Lozupone, et al., UniFrac—an online tool for comparing microbial community diversity in a phylogenetic context, BMC Bioinformatics, 7, 371; 2006) for further statistical analysis of the detected sample communities.

In some embodiments, multiple, interactive views of the data are available, including taxonomic trees, heatmaps, hierarchical clustering, parallel coordinates (time series), bar plots, and multidimensional scaling scatterplots. In some embodiments, the taxonomy tree displays the mean intensities for each detected OTU and displays the leaves of the tree as a heatmap of samples. The tree may be dynamically pruned by filtering OTUs below a certain intensity or probability threshold. Additionally, the tree may be summarized at any level from phylum to subfamily. In other embodiments, the user can hierarchically cluster both OTUs and samples using any of the standard distance and linkage methods from the integrated C Clustering Library (de Hoon, et al., Open source clustering software, Bioinformatics, 20, 1453-1454; 2004), and the resulting dendrograms displayed in a secondary heatmap window. In some embodiments, a third window is provided that displays interactive bar plots of differential OTU intensities to facilitate pairwise comparison of samples. For any two samples, the height of the difference bars displays either the absolute or relative difference in mean intensity between OTUs. The bars may be grouped and sorted along the horizontal axis by any taxonomic rank for easy identification and comparison. Synchronized selection and filtering affords users the unique ability to seamlessly navigate between multiple views of the data. For example, users can select a cluster in the hierarchical clustering window and simultaneously view the selected organisms in the taxonomy tree, immediately revealing both their phylogenetic and environmental relationship. In further embodiments, the data from the analysis system, i.e., analysis system or flow cytometer, can be co-analyzed and displayed with high-throughput sequencing data. In some embodiments, for each organism identified as present in the sample, the user is able to view a list of other environments where the particular organism is found.

In some embodiments, the screen displays are dynamic and synchronized to allow the selection or filtration of OTUs with changes to any view simultaneously reflected in all other views. Additionally, OTUs confirmed by 16S rRNA gene, 18S rRNA gene, or 23S rRNA gene sequencing can be co-displayed in all views.

### Business Methods

In some aspects of the invention, a business method is provided wherein a client images an array or scans a lot of microparticles and sends a file containing the data to a service provider for analysis. The service provider analyzes the data and provides a report to the user in return for financial compensation. In some embodiments, the user has access to the service provider's analysis system and can manipulate and adjust the analysis parameters or the display of the results.

In another aspect of the invention, a business method is provided wherein a client sends a sample to be processed, imaged or scanned and the data analyzed for the presence or quantity of organisms. The service provider sends a report to the client in return for financial compensation. In some embodiments of the invention, the client has access to a suite of data analysis and display programs for the further analysis and viewing of the data. In further embodiments, the service provider first provides a system or kit to the client. The kit can include a system to assay a majority, or the entirety of the microbiome present or the system can contain “down-selected” probes designed for particular applications. After sample processing and imaging, the client sends the data for analysis by the service provider. In some embodiments of the invention, the client report is electronic. In other embodiments, the client is provided access to a suite of data analysis and display programs for the further viewing, manipulation, comparison and analysis of the data. In some embodiments, the client is provided access to a proprietary database in which to compare results. In other embodiments, the client is provided access to one or more public databases, or a combination of private and public database for the comparison of results. In some embodiments, the proprietary database includes the pooled results (fingerprints, biosignatures) for normal samples or the pooled results from particular abnormal situations such as a disease state. In some embodiments, the biosignatures are continuously and automatically updated upon receipt of a new sample analysis.

In some embodiments, the database further comprises highly conserved sequence listings. In some embodiments, the database is updated automatically as new sequence information becomes available, for instance, from the National Institutes of Health's Human Microbiome Project. In further embodiments, probe sets are automatically updated based on the new sequence information. Continuous upgrading of the sequence information and refinement of the probe sets allow for increasing accuracy and resolution in determining the composition of microbiomes and the quantity of their individual constituents. In some embodiments, the system compares earlier microbiome biosignatures with later microbiome biosignatures from the same or substantially similar environments and analyzes the changes in probe set composition and hybridization signal analysis parameters for information that is useful in improving or refining the discrimination between related OTUs, identification and quantification of microbiome constituents, or increasing accuracy of the determinations.

In some embodiments, the database compiles information about specific microbiomes, for example, the microbiota associated with healthy and unhealthy human intestinal microflora including, age, gender and general health status of host, geographical location of host, host's diet (i.e., Western, Asian or vegetarian), water source, host's occupation or social status, host's housing status.

In some embodiments, the reference healthy/normal signatures for adults, male and female, and children can be used as benchmarks to identify presymptomatic and symptomatic disease states, response to treatments/therapies, infection, and/or secondary infection associated with disease.

In some embodiments, the client is provided with a diagnosis or treatment recommendation based on the comparison between the client's sample microbiome and one or more reference microbiome.

### EXAMPLES

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

### Example 1

### PhyloChip Array Analysis

Following sample preparation, application, incubation and washing, using standard techniques, PhyloChip G3 arrays were scanned using a GeneArray Scanner from Affymetrix. The scan was captured as a pixel image using standard AFFYMETR1X® software (GCOS v1.6 using parameter: Percentile v6.0) that reduces the data to an individual row in a text-encoded table for each probe. See Table 8.

TABLE 8
Exemplary Display of Array Data
[INTENSITY]
NumberCells = 506944
CellHeader = XY

| NPIXELS | MEAN | STDV |
|---|---|---|
| 0 | 0 | 167.0 |
| 47.9 | 25 | |
| 1 | 0 | 4293.0 |
| 1060.2 | 25 | |
| 2 | 0 | 179.3 |
| 43.7 | 36 | |
| 3 | 0 | 4437.0 |
| 681.5 | 25 | |

Each analysis system had approximately 1,016,000 cells, with 1 probe sequence per cell. The analysis system scanner recorded the signal intensity across the array, which ranges from 0 to 65,000 arbitrary units (a.u) in a regular grid with −30-45 pixels per cell. A 2 pixel margin was used between adjacent cells, leaving approximately 25-40 pixels per probe of usable signal. From these pixels, the AFFYMETR1X® software computed the 75th percentile average pixel intensity (denoted as the “MEAN”), the standard deviation of signal intensity among the about 25-40 pixels (denoted as the “STDV”), and the number of pixels used per cell (denoted as “NPIXELS”). Any cells that had pixels that were three standard deviations apart in signal intensity were classified as outliers.

The analysis systems were divided into a user-defined number of horizontal and vertical divisions. By default, four horizontal and four vertical divisions were created resulting in 16 regularly spaced sectors for independent background subtraction. The background intensity was computed independently for each quadrant, as the average signal intensity of the least intense 2% (by default) of probes in that quadrant. The background intensity was then subtracted from all probes before further computation.

The noise value was estimated according to recommendations in the AFFYMETRIX® GeneChip User Guide v3.3. Noise (N) was due to variations in pixel intensity signals observed by the scanner as it read the array surface and was calculated as the standard deviation of the pixel intensities within each of the identified background cells divided by the square root of the number of pixels comprising that cell. The average of the resulting quotients was used for N in the calculations described below:

$$N = \frac{{\sum }_{i ∈ B} \frac{{S}_{i}}{\sqrt{{pix}_{i}}}}{scalarB}$$

where
B is a background cell
Sᵢ is the standard deviation among the pixels in B
pixᵢ is the count of pixels in B
scalarB is the count of all background cells, cumulative

The intensities of all probes were then scaled so that the average observed signal intensity of the spiked in probes had a pre-determined signal strength. This was accomplished by finding a scaling factor (Sf) in order to force the mean response of the corresponding PM probes to a target mean using the equation below:

$${S}_{f} = \frac{{\overline{e}}_{t}}{\frac{{\sum }_{i ∈ Kpm} {e}_{i}}{{scalarK}_{pm}}} .$$

where
ēₜ=targeted mean intensity (default: 2500)
scalarKₚₘ=count of probes complementing any spike-in
S_{f}=scaling factor

Typically, the pre-determined signal strengths ranged from about 0 to about 65,000. Once the scaling factor was derived, all cell intensities were multiplied by the scaling factor.

The noise (N) was scaled by the same factor: Nₛ=N×S_{f}; where Nₛ=scaled noise, N=unscaled noise, and S_{f}=scaling factor.

As an alternative or optional step, MM probes with high hybridization signal responses were identified and the probe pair eliminated where:

$$[ ( \frac{MM}{PM} > {srt}_{r} ) ⋀ ( MM - PM > {N}_{s} \times {sdtm}_{r} ) ] ⋁ [ PM ∈ O ] ⋁ [ MM ∈ O ]$$

where
PM=scaled intensity of the perfect match probe
MAI=scaled intensity of the perfect match probe
stir=reverse standard ratio threshold (default:1.3)
sdtmᵣ=reverse standard difference threshold multiplier (default:130)
Nₛ=scaled noise
O=outlier set
   The remaining probe pairs were scored by:

$$( \frac{PM}{MM} > srt ) ⋀ ( PM - MM > {N}_{s}^{2} \times sdtm )$$

where:
PM=scaled intensity of the perfect match probe
MM=scaled intensity of the perfect match robe
srt=standard ratio threshold (default:1.3
sdtm=standard difference threshold multiplier (default:130)
Nₛ=scaled noise

After classifying an OTU as “present”, the present call was propagated upwards through the taxonomic hierarchy by considering any node (subfamily, family, order, etc.) as ‘present’ if at least one of its subordinate OTUs was present.

Hybridization intensity was the measure of OTU abundance and was calculated in arbitrary units for each probe set as the trimmed average (maximum and minimum values removed before averaging) of the PM minus MM intensity differences across the probe pairs in a given probe set.

### Example 2

### Water Quality Testing—Fecal Contamination Assay

The dry weather water flow in the lower Mission Creek and Laguna watersheds of Santa Barbara, Calif., a place associated with elevated fecal indicator bacteria concentrations and human fecal contamination will be sampled with an array of the present invention. The goal is to characterize whole bacterial community composition and biogeographic pattern in an urbanized creek, 2) compare taxa detected by molecular methods to conventional fecal indicator bacteria, and 3) elucidate reliable groups of bacterial taxa to be used in culture-independent community-based fecal contamination monitoring (indicator species for fecal contamination).

The watersheds flow through an urbanized area of downtown Santa Barbara. Places to be sampled include storm drains, sections of the flowing creek, lagoon (M2, M4) and ocean. Additionally sites include where Old Mission Creek tributary discharges into Mission Creek. The dry creek flow can have many sources including underground springs in the upstream reaches, urban runoff associated with irrigation and washing, groundwater seepage, sump or basement pumps, and potentially illicit sewer connections. Sampling will be done during a period when there will not have been rain for at least 48 hours prior to or during the sampling. Besides the watershed samples, human feces and sewage will be sampled.

### Materials and Methods

Sample description, collection and extraction. Water samples are collected over 3-5 days from a watershed during a period of dry weather. Additionally, fecal samples including human feces sewage inflow are collected. Dissolved oxygen (DO), pH, temperature and salinity are measured along with each sampling. Water samples are filtered in the lab on 0.22 pm filters and extracted for DNA using the UltraClean Water DNA kit (MoBio Laboratories), and archived at −20° C. Concentrations (by IDEXX) of Total Coliforms, E. coli, and Enterococcus spp., as well as quantitative PCR (qPCR) measurements of Human-specific Bacteroides Marker (HBM) are also performed.

16S rRNA gene amplification for analysis system analysis. The 16S rDNA is amplified from the gDNA using non-degenerate Bacterial primers 27F.jgi and 1492R. Polymerase chain reaction (PCR) is carried out using the TaKaRa Ex Taq system (Takara Bio Inc, Japan). The amplification protocol is previously described (Brodie et al., Application of a High Density Oligonucleotide Analysis system Approach to Study Bacterial Population Dynamics during Uranium Reduction and Reoxidation. Applied Environ Microbio. 72:6288-6298, 2006).

Analysis system processing, and image data analysis. Analysis system analysis is performed using a high-density phylogenetic analysis system (PhyloChip). The protocols are previously reported (Brodie et al., 2006). Briefly, amplicons are concentrated to a volume less than 400 by isopropanol precipitation. The DNA amplicons are fragmented with DNAse, biotin labeled, denatured, and hybridized to the DNA analysis system at 48° C. overnight (>16 hr). The arrays are subsequently washed and stained. Arrays are scanned using a GeneArray Scanner (Affymetrix, Santa Clara, Calif., USA). The CEL files obtained from the Affymetrix software that produces information about the fluorescence intensity of each probe (PM, MM, and control probes) are analyzed using the CELanalysis software designed by Todd DeSantis (LBNL, Berkeley, USA).

PhyloChip data normalization. All statistical analyses are carried out in R (Team RCD (2008) R: A language and environment for statistical computing)). To correct for variation associated with quantification of amplicon target (quantification variation), and downstream variation associated with target fragmentation, labeling, hybridization, washing, staining and scanning (analysis system technical variation) a two-step normalization procedure is developed: First, for each PhyloChip experiment, a scaling factor best explaining the intensities of the spiked control probes under a multiplicative error model is estimated using a maximum-likelihood procedure. The intensities in each experiment are multiplied with its corresponding optimal scaling factor. In addition, the intensities for each experiment are corrected for the variation in total array intensity by dividing the intensities by its corresponding total array intensity separately for bacteria and archea.

Statistical Analysis. All statistical analyses were carried out in R. Bray-Curtis distances were calculated using normalized fluorescence intensity with the bcdist function in the ecodist package (Goslee S C & Urban D L (2007) The ecodist package for dissimilarity-based analysis of ecological data. J Stat Softw 22(7):1-19). Mantel correlation between Bray-Curtis distance matrices of community data, geographical distance and environmental variables are calculated using the mantel function in the vegan package. Pearson's correlation is calculated with 1000 permutations of the Monte Carlo (randomization) test. Non-metric multidimensional scaling (NMDS) is performed using the metaMDS function of the vegan package. A relaxed neighbor-joining tree is generated using Clearcut (Evans J, Sheneman L, & Foster J A (2006) Relaxed neighbor-joining: a fast distance-based phylogenetic tree. Construction method. Mol Evol 62:785-792.). Separate clearcut trees are generated for the ‘resident’ and ‘transient’ communities for each site. Unweighted UniFrac distances (Lozupone C & Knight R (2005) UniFrac: a new phylogenetic method for comparing microbial communities. Applied and Environmental Microbiology 71(12):8228-8235) are calculated for each of the sites.

### PhyloChip Derived Parameters

Fecal Taxa. Taxa that are present in all three fecal samples, and in all 27 water samples are tabulated separately. The list of ‘Fecal Taxa’ is derived by removing those taxa found in all water samples from the taxa that are present in all three fecal samples.

Transient and resident subpopulations. Taxa that are present in at least one sample from each site across the sampling period are tabulated and variances of the fluorescence intensities for those taxa are generated. The taxa in the top deciles are defined as the ‘transient’ subpopulation, and taxa in the bottom deciles were defined as the ‘resident’ subpopuation.

BBC:A. The number of taxa in the classes of Bacilli, Bacteroidetes, Clostridia, and a-proteobacteria are tallied. The ratio is calculated using the following formula:

$$BBC \text{:} A = \frac{Bac + Bct + Cls}{A}$$

The count for unique taxa in each of the class is normalized by dividing by the total taxa in each class detected by the analysis system.

Aligned sequences from published studies are downloaded from Greengenes (DeSantis T Z, et al. (2006) Greengenes, a chimera-checked 16S rRNA gene database and workbench compatible with ARB. Applied and Environmental Microbiology 72(7):5069-5072) and re-classified using PhyloChip taxonomy. The counts of unique taxa are tallied for each Bacterial class. BBC:A are calculated using the formula above. If no taxon is detect for a class, the count for the class is set as 0.5.

### Resolving Community Differences Among Habitats

Mission Creek samples are delineated into three habitat types: ocean, estuarine lagoon, and fresh water (creeks and storm drain effluent). Bray-Curtis distances of the watershed samples and three fecal samples (two sewage and one human feces) are calculated. Non-metric multidimensional scaling (NMDS) ordination and plotting of the first two axes are used to display the distances between samples. Bacterial communities are clearly separated by habitat types. The drain samples are most similar to the fecal samples. Lagoon samples are most similar to the ocean samples.

Signature taxa that account for the majority of differences in bacterial communities observed between habitats are identified by comparing the detected taxa at the class level among all habitat types. The number of taxas in each habitat type are divided by the total detected for each sample type to obtain a percent detection. Comparing the fecal samples to samples taken above the urban zone or those from the lagoon or ocean show that there are lower fractions of α-proteobacteria and higher fractions of Bacilli and Clostridia. Moreover, five classes are only detected in the fecal samples: Solibacteres, Unclassified Acidobacteria, Chloroflexi-4, Coprothermobacteria and Fusobacteria. Chloroflexi-3 are only detected in creek samples, and Thermomicrobia, Unclassified Termite group 1, and Unclassified Chloroflexi only in the ocean samples. The top 10 classes with the highest standard deviations across the four habitats are (in descending order): Clostridia, α-proteobacteria, Bacilli, γ-proteobacteria, β-proteobacteria, Actinobacteria, Flavobacteria, Bacteroidetes, Cyanobacteria, and c-proteobacteria. Of those classes, Clostridia, Bacilli, and Bacteroidetes fractions are higher, but a-proteobacteria fractions were lower. These four taxa can be used as indicators of fecal contamination.

### “Transient” and “Resident” Subpopulations

Subpopulations of taxa are identified that fluctuate the most between samplings. These are term “transient” populations. Populations that remain stable the sampling period are term “resident” populations. A comparison of taxa found in the “transient” and “resident” subpopulations illustrate differences in community composition from site to site. The six major orders (Enterobacteriales, Lactobacillales, Actinomycetales, Bacteroidales, Clostridiales and Bacillales) of the Fecal Taxa are compared to further dissect the distribution of fecal bacteria over time. The number of transient Enterobacteriales in samples from some sites are extremely high compare to the rest of the sites. While others have high resident subpopulations of Bacillales. Bacteria are identified that are ubiquitous and not affected by changes in the environmental variables measured, as measured by PhyloChip. Bacteria classes that have similar numbers of taxa throughout the watershed and fecal samples included Verrucomicrobiae, Planctomycetacia, α-proteobacteria, Anaerolinaea, Acidobacteria, Sphingobacteria, and Spirochaetes

Bacilli, Bacteroidetes and Clostridia to α-proteobacteria Ratio

Four bacterial classes: Bacilli, Bacteroidetes, Clostridia and α-Proteobacteria are identified as having the highest variance among the habitat types and are further developed as fecal indicators.

The combined percentage of Bacilli, Bacteroidetes and Clostridia represent about 20-35% of total classes detected in the fecal samples, whereas their percentages at sites with expected cleaner water such as creek, lagoon and ocean are less than 10-15%. At least 45% of the taxa detected in creek water, lagoon and ocean samples are α-Proteobacteria. These microorganisms were classified as Clean Water Taxa as the percentage of Proteobacteria found in fecal samples is significantly lower at about 35-45%. The ratio of Bacilli, Bacteroidetes and Clostridia to α-proteobacteria (BBC:A) for fecal samples is about 3-5-fold higher than the ratios found in other habitat types. The BBC:A ratios are calculated for each site, and exhibit the same pattern as Fecal Taxa counts across all sites with ocean water having the lowest BBC:A of about 0.75-0.90 with samples close to observed sites of fecal contamination at around 1.50 to about 1.90.

This ratio contains non-coliform associated bacteria, and avoids the potential of false positive fecal detection due to growth of coliforms in the environment. Bacteroidetes and Clostridia are well known fecal-associated anaerobic bacteria. Bacilli are not especially fecal-associated but have been found in aerobic thermophilic swine wastewater bioreactors (Juteau P, Tremblay D, Villemur R, Bisaillon J G, & Beaudet R (2005) Analysis of the bacterial community inhabiting an aerobic thermophilic sequencing batch reactor (AT-SBR) treating swine waste Applied Microbiology and Biotechnology 66:115-122.). Therefore, the presence of Bacilli, Bacteroides and Clostridiales is a good indication of wastewater-, waste treatment-, and human-derived fecal pollution. α-proteobacteria are mostly phototrophic bacteria that are abundant in the environment, and play key roles in global carbon, sulfur and nitrogen cycles. Many α-proteobacteria thrive under low-nutrient conditions, and will be a good proxy for non-fecal bacteria found in non contaminated aquatic environments.

The results compare well to BBC:A found in other fecal-associated sources that are analyzed by the PhyloChip with mouse cecum, cow colon, sewage contaminated groundwater, human colon, and secondary sewage. These sources have BBC:A of above 1.2. In contrast, anaerobic groundwater has a BBC:A of 0.80-0.99.

To confirm the value of the BBC:A ratio for detecting fecal contamination, published studies of bacterial communities obtained by sequencing are analyzed. Ratios from mammalian guts, anaerobic digester sludge, ocean, Antarctic lake ice, and drinking water also demonstrate that there are differences between fecal and non-fecal samples. Mammalian gut samples have BBC:A ranging from about 10 to about 260. Anaerobic digester sludge samples have BBC:A of at least 1 to about 10. These results may reflect the highly-selected community in anaerobically-digested waste activated sludge in wastewater treatment. Non-fecal samples have BBC:A from 0 to 0.94. The sequencing results confirm that a BBC:A threshold of 1.0 can be used as a cutoff for identifying fecal pollution in water with values of 1 and above indicating polluted water. This method of calculating a BBC:A value offers numerous advantages including speed, as culturing is not required, greater detection ability as it can detect microorganisms that are currently unculturable and also avoids expense and technical problems associated with PCR cloning and high through-put sequencing.

The BBC:A ratio can be used to track the source of fecal pollution as the number usually increases in samples obtained from sites closer to a source of fecal pollution.

### Example 3

### PhyloChip Array

An array system, “PhyloChip”, was fabricated with some of the organism-specific and OTU-specific 16s rRNA probes selected by the methods described herein. The PhyloChip array consisted of 1,016,064 probe features, arranged as a grid of 1,008 rows and columns. Of these features, −90% were oligonucleotide PM or MM probes with exact or inexact complementarity, respectively, to 16s rRNA genes. Each probe is paired with a mismatch control probe to distinguish target-specific hybridization from background and non-target cross-hybridization. The remaining probes were used for image orientation, normalization controls, or for pathogen-specific signature amplicon detection using additional targeted regions of the chromosome. Each high-density 16s rRNA gene microarray was designed with additional probes that (1) targeted amplicons of prokaryotic metabolic genes spiked into the 16s rRNA gene amplicon mix in defined quantities just prior to fragmentation and (2) were complementary to pre-labelled oligonucleotides added into the hybridization mix. The first control collectively tested the target fragmentation, labeling by biotinylation, array hybridization, and staining/scanning efficiency. It also allowed the overall fluorescent intensity to be normalized across all the arrays in an experiment. The second control directly assayed the hybridization, staining and scanning.

Complementary targets to the probe sequences hybridize to the array and fluorescent signals were captured as pixel images using standard AFFYMETRIX® software (GeneChip Microarray Analysis Suite, version 5.1) that reduced the data to an individual signal value for each probe and was typically exported as a human readable CEL' file. Background probes were identified from the CEL file as those producing intensities in the lowest 2% of all intensities. The average intensity of the background probes was subtracted from the fluorescence intensity of all probes. The noise value (N) was the variation in pixel intensity signals observed by the scanner as it reads the array surface. The standard deviation of the pixel intensities within each of the identified background probe intensities was divided by the square root of the number of pixels comprising that feature. The average of the resulting quotients was used for N in the calculations described below.

Using previous methods, probe pairs scored as positive are those that meet two criteria: (i) the fluorescence intensity from the perfectly matched probe (PM) was at least 1.3 times greater than the intensity from the mismatched control (MM), and (ii) the difference in intensity, PM minus MM, was at least 130 times greater than the squared noise value (>130 N2). The positive fraction (PosFrac) was calculated for each probe set as the number of positive probe pairs divided by the total number of probe pairs in a probe set. An OTU was considered ‘present’ when its PosFrac for the corresponding probe set was >0.92 (based on empirical data from clone library analyses). Replicate arrays cuold be used collectively in determining the presence of each OTU by requiring each to exceed a PosFrac threshold. Present calls were propagated upwards through the taxonomic hierarchy by considering any node (subfamily, family, order, etc.) as ‘present’ if at least one of its subordinate OTUs was present.

Hybridization intensity was the measure of OTU abundance and was calculated in arbitrary units for each probe set as the trimmed average (maximum and minimum values removed before averaging) of the PM minus MM intensity differences across the probe pairs in a given probe set. All intensities<1 were shifted to 1 to avoid errors in subsequent logarithmic transformations.

The analysis methods described in Example 1 can also be applied to a sample that has been applied to the presently described PhyloChip G3 array.

A Latin Square Validation was carried out on the PhyloChip G3 array. The novel PhyloChip microarray (G3) was manufactured containing multiple probes for each known Bacterial and Archaeal taxon. The array was challenged with triplicate mixtures of 26 organisms combined in known but randomly assigned concentrations spanning over several orders of magnitude using a Latin Square experimental design. Probe-target complexes were quantified by flourescence intensity. To monitor community dynamics within the environment, water samples were taken from the San Francisco Bay (CA) at two time points following a point-source sewage spill. Entire 16S rRNA gene amplicon pools (−100 billion molecules/time point) were evaluated with the array. Three replicates were tested on different days with 78 Latin Square chips and 1 Quantitative Standards only control. The amplicon concentration range was >4.5 log₁₀. The target concentration was from 0.25 pM to 477.79 pM, increasing 37% per step plus a 0 pM (26 different concentrations). Each chip contained all 26 targets, each with a different concentration 0-66 ng each for 243 ng total spike. The Latin Square matrix is not shown.

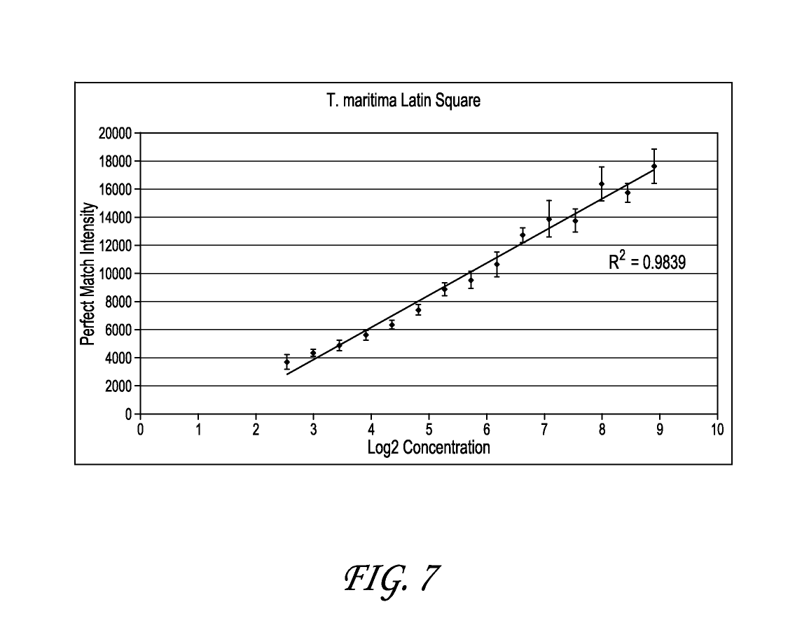

FIG. 7 is a chart showing the concentration of 16S amplicon versus PhyloChip response. Concentration is displayed as the log base 2 picomolar concentration within the PhyloChip hybridization chamber. The y-axis is the average of the multiple perfect match probes in the probe set. The vertical error bars denote the standard deviation of 3 replicate trials. The r-squared value over 0.98 indicates that the PhyloChip G3 array is quantitative in its ability to track changes in concentration.

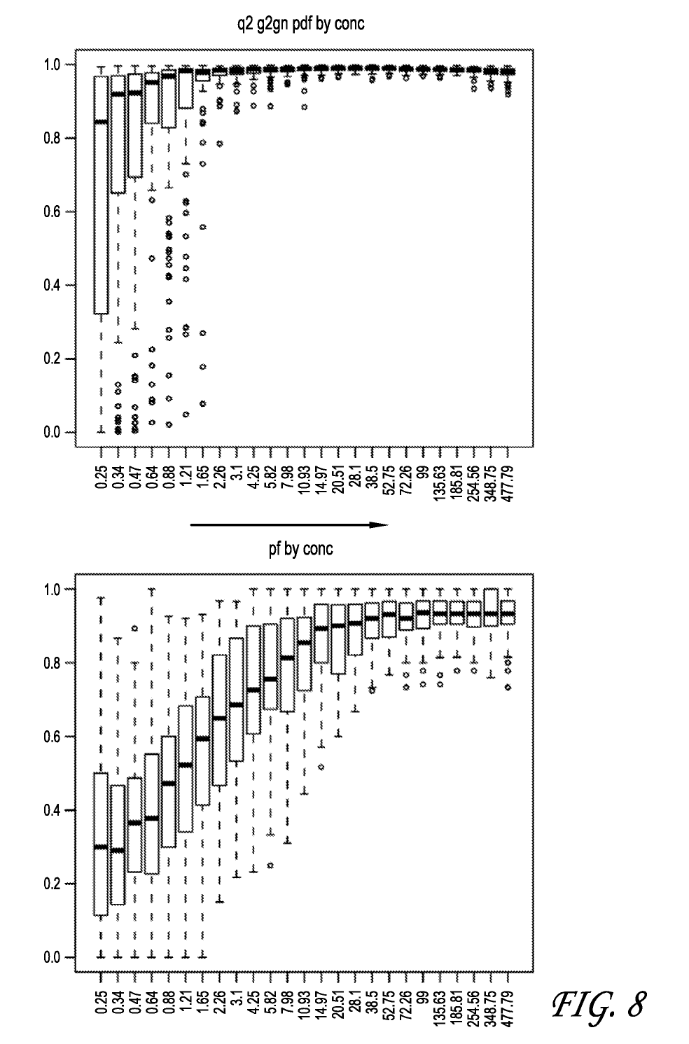

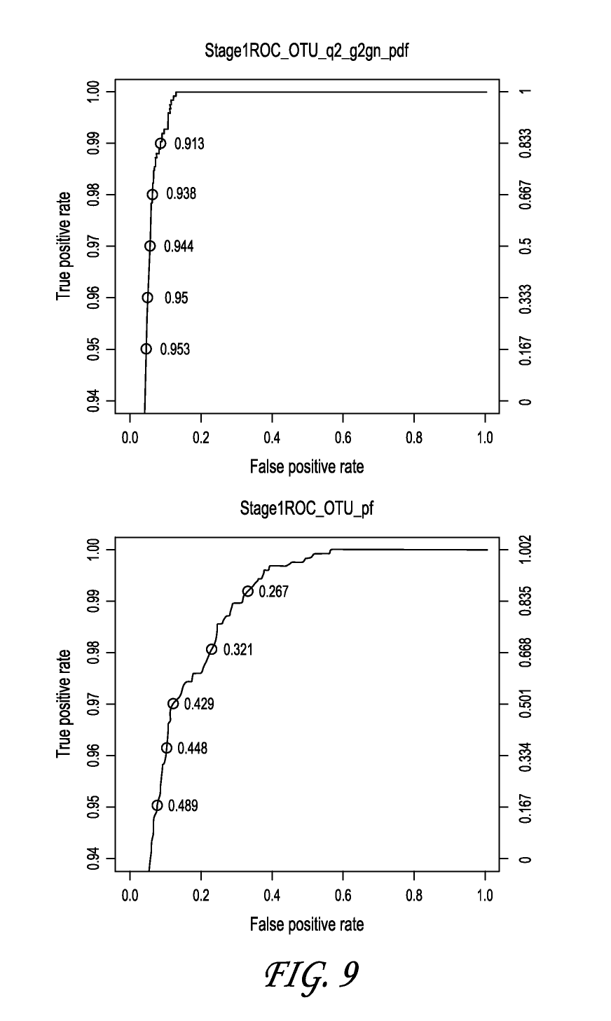

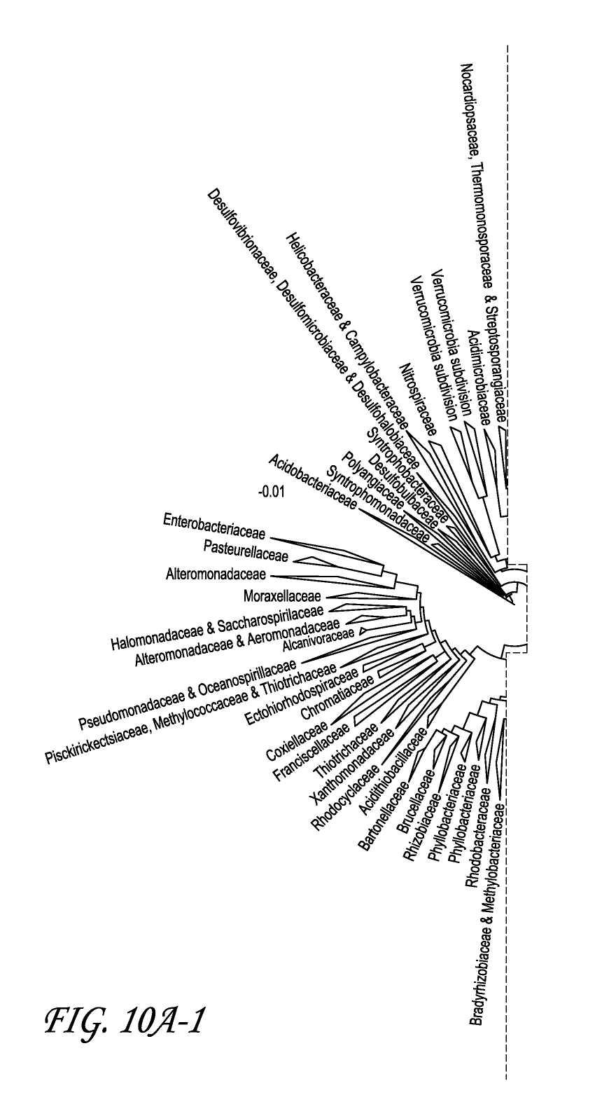

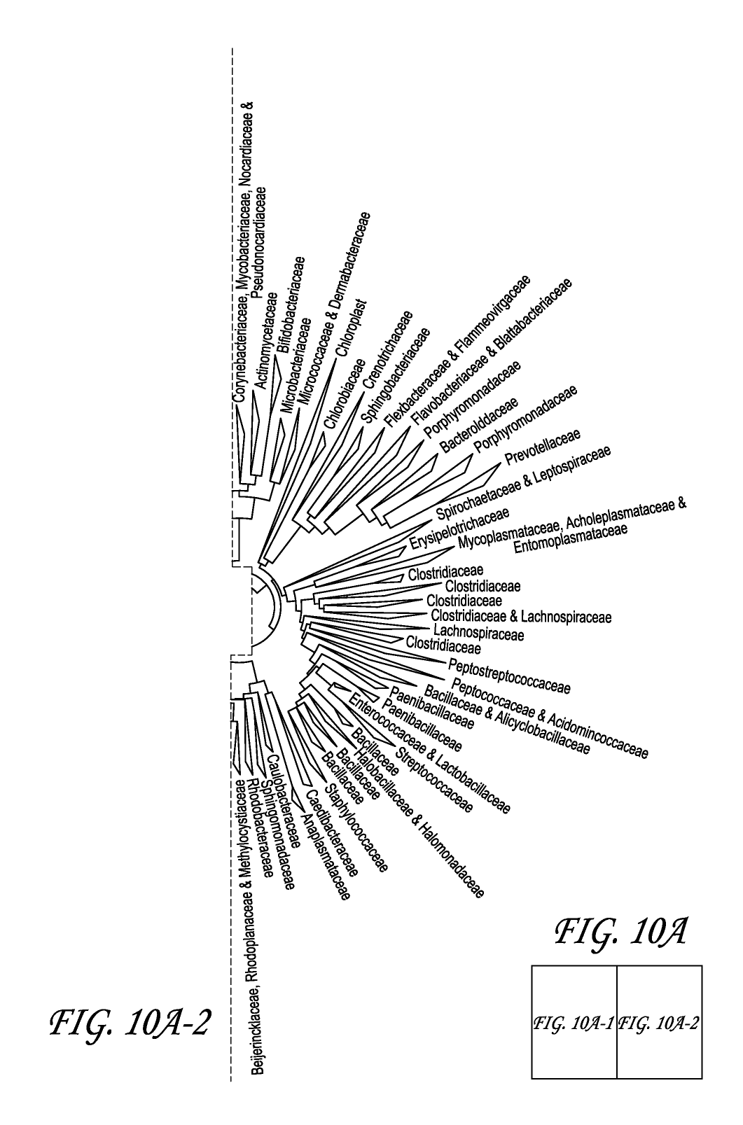

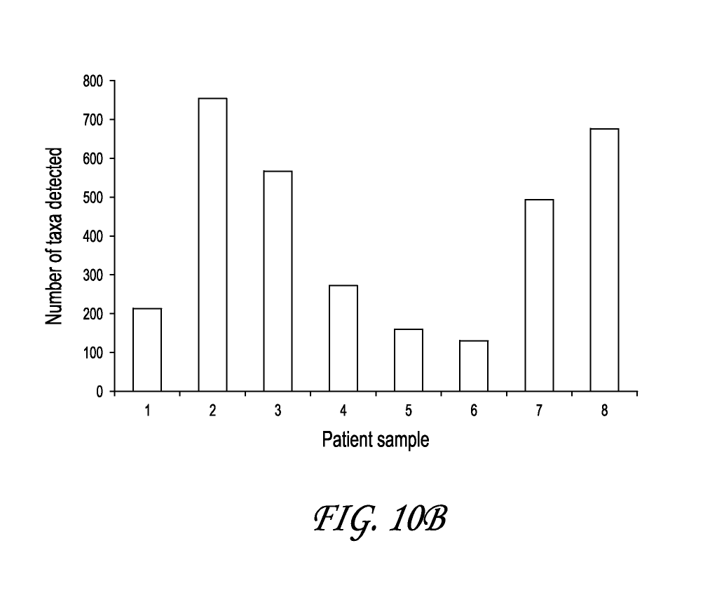

FIGS. 8 and 9 shows that model-based detection is an improvement over positive fraction detection of probe sets. Low concentrations (down to 2 pM) are differentiated from background in Latin Square.

FIG. 8 is boxplot comparison of the detection algorithm based on pair “response score”, r, distribution (novel) versus the positive fraction calculation (previously used with the G2 PhyloChip). In both plots the x-axis is the concentration of the spiked-in 16S amplicon (The arrow begins at 2 picomolar and extends through 500 picomolar). The y-axis ranges between 0 and 1 in both plots. The top plot's y-axis displays the median r score of all the probes within a probe set whereas the bottom plot's y-axis displays the positive fraction from the same data set. At low concentrations, 0.25 pM, both plots show a wide distribution of scores (see long whiskers), at 2 pM the top boxplots have short whiskers indicating that multiple measurements using a variety of bacterial and archaeal species all have very similar median r scores. The corresponding concentration on the positive fraction graph has a wide range of positive fraction scores. At nearly all concentrations, the r score outperforms the positive fraction.

FIG. 9 is two graphs that show the comparison of the r score metric versus the pf by receiver operator characteristic (R.O.C) plots. The steeper slope of the top curve compared to the bottom curve demonstrates that the r score metric can differentiate true positives from false positives more efficiently than the pf metric. The grayscale bar indicates the cutoff values (for either r scores or pf) at each point along the curve.

The validation shows that the novel PhyloChip G3 array is capable of excellent organism detection and quantification in a sample over the prior G2 array.

### Example 4

### Profiling Bacterial Communities in Patient Samples

This example describes profiling of airway bacterial communities of a cohort of patients with chronic obstructive pulmonary disease (COPD), using apparatuses and methods of the invention.

### Materials and Methods

Subject selection and sample collection. Potential subjects for this study were screened from a database of airway specimens collected between August 2004 and April 2006 from mechanically ventilated patients admitted to the intensive care units at Moffitt-Long Hospital (University of California, San Francisco), who were enrolled in a study of Pseudomonas aeruginosa in intubated patients (Flanagan et al., 2007, J. Clin Microbiol 45: 1954-1962). Subjects admitted to the ICU with a primary diagnosis of “COPD exacerbation” were identified for inclusion in this study. Available endotracheal aspirates (ETAs) from eight patients were processed for 16S rRNA PhyloChip analysis, as described in the herein and also detailed below. To compare results from PhyloChip analysis with conventional clinical cultures, results were obtained for quantitative clinical laboratory bacterial cultures (blood agar, chocolate agar, and EMB media) performed on minibronchoalveolar lavage (m-BAL) airway samples, collected within 1-5 days of the ETA specimen analyzed by PhyloChip, as previously described (Flanagan et al., 2007). In general, m-BALs possess a similar bacterial community composition to that of ETAs obtained concurrently from the same patient. Clinical data (Table 1) were recorded in a secure database, including whether a diagnosis of pneumonia by conventional clinical and radiologic criteria was made during the patient's hospitalization and the time frame between diagnosis and collection of airway samples. The Committee on Human Research at UCSF approved all study protocols, and all patients or their surrogates provided written, informed consent.

TABLE 1
Clinical characteristic of subjects and samples

| | | | Intubation | | Days of active | |
|---|---|---|---|---|---|---|
| | | | days at | Antimicrobial therapy | antimicrobial | |
| | | | sample | received within the past | therapy at time of | Culture |
| Patient | Age | Gender | collection | month | sample collection | Results^{a} |
| 1 | 63 | M | 16 | ceftazidime | 16 | PA^{b*} |
| 2 | 69 | F | 6 | vancomycin, tobramycin, | 5 | PA^{b*} |
| | | | | levofloxacin | | |
| 3 | 78 | M | 1 | vancomycin, | 1 | PA^{b*}, KP^{b*}, |
| | | | | piperacillin/tazobactam, | | AF |
| | | | | levofloxacin | | |
| 4 | 78 | M | 21 | piperacillin/tazobactam | 31 | PA^{b*}, SM^{b*} |
| 5 | 86 | F | 17 | levofloxacin | 17 | PA^{b*} |
| 6 | 85 | F | 16 | doxycycline, | 1 | PA^{b*} |
| | | | | moxifloxacin, vancomycin | | |
| 7 | 61 | M | 5 | vancomycin, | 7 | PA^{b*}, SA^{b} |
| | | | | piperacillin/tazobactam | | |
| 8 | 73 | M | 3 | piperacillin/tazobactam | 3 | PA^{b}, EA^{b*} |

^{a}mini-BAL, minibronchoalveolar lavage clinical culture. The most recent, available culture data were obtained from within 1-5 days prior to the endotracheal aspirate sample analyzed by PhyloChip.
^{b}Detected by PhyloChip; *≧10,000 colony-forming units on quantitative mini-BAL culture. PA, Pseudomonas aeruginosa; KP, Klebsiella pneumoniae; SA, Staphylococcus aureus; EA, Enterobacter aerogenes; SM, Stenotrophomonas maltophilia; AF, Aspergillus fumigatus.

DNA extraction, 16S rRNA gene amplification, PhyloChip processing. Total DNA eas extracted from ETAs (200 μL) using a bead-beating step (5.5 ms⁻¹ for 30 seconds, FastPrep system) (MP Biomedicals, Cleveland, Ohio) prior to nucleic acid extraction using the Wizard Genomic DNA Purification kit (Promega, Madison, Wis.). Twelve, 25-cycle PCR reactions, containing 100 ng of DNA, 2.5 mM each of dNTPs, 1.5 μM each primer (Bact-27F and Bact-1492R) and 0.02 U/μL of ExTaq (Takara Bio, Japan), were performed for each sample across a gradient of annealing temperatures (48-58° C.), to maximize the diversity recovered. The resulting PCR products were pooled and gel-purified using the MinElute Gel Extraction kit (Qiagen, Chatsworth, Calif.). Known concentrations of synthetic 16S rRNA gene fragments and non-16S rRNA gene fragments were spiked into the pooled, purified PCR product, which served as internal standards for normalization. A total of 250 ng of purified PCR product per sample was fragmented, biotin-labeled, and hybridized to the microarray as described in Example 2. Washing, staining, and scanning of arrays were conducted according to standard Affymetrix protocols. Background subtraction, noise calculations and scaling were carried out as described in Examples 1 and 2.

Analysis of PhyloChip data. Detection and quantification criteria for each taxon were applied, as described in Examples 1 and 2. Briefly, probe-pairs consisting of a perfectly matched and mismatched cross hybridization control probe (containing a mismatch at the 13th nucleotide) were scored as positive if they met two criteria: (1) the fluorescence intensity of the perfectly matched probe was times greater than that of the mismatched probe, and (2) the difference in intensity in each probe pair was 130 times greater than the squared noise value for that array. The positive fraction (pf)) of probe sets (minimum of 11, median of 24 probe-pairs per taxon) was calculated, and a taxon was considered “present” if the calculated pf was 90%. Statistical analyses were performed in the R environment (www.Rproject.org), using the ecological community analysis package vegan (version 1.16-1). Log-transformed fluorescence intensities were used to calculate Bray-Curtis dissimilarity measures of ecological distance. Nonmetric multidimensional scaling (NMDS), a nonparametric ordination method that maps community relatedness, in this case using the Bray-Curtis distance metric, was used to assess variability in bacterial community structure. The function adonis (Anderson, 2001, Aust. Ecol. 26: 32-46.), which conducts a matrix-based nonparametric analysis of variance, was applied to explore relationships between community composition and clinical variables, including age, gender, number of intubation days, presence of pneumonia, time frame between pneumonia diagnosis and sample collection, antibiotic and corticosteroid treatments, and survival to ICU discharge. Between-group differences in taxon abundance were assessed by two-tailed t-testing with significance adjusted for false discovery using q-values. Taxa exhibiting q values<0.05, a p-value ≦0.02 and a change of >1,000 fluorescence units (log-fold change in 16S rRNA copy number) were considered statistically and biologically significant. Phylogenetic trees were constructed using representative 16S rRNA sequences from the Greengenes database. A neighbor-joining tree with nearest-neighbor interchange was produced using FastTree (Price et al., 2009, Mol Biol Evol 26: 1641-1650) and uploaded to the Interactive Tree of Life project (itol.embl.de) for annotation.

Quantitative polymerase chain reaction (Q-PCR). To confirm that changes in array fluorescence intensities were reflective of changes in target organism abundance, triplicate, Q-PCR reactions were performed for selected taxa containing species of interest, using a Stratagene MxP3000 real-time system and the QuantiTect SYBR Green PCR kit (Qiagen). Primers for taxa containing selected species of interest were designed based on PhyloChip probes for the target taxon (Table 2). Reaction conditions included use of 10 ng of DNA extract and 40 cycles of using the annealing temperatures listed in Table 2 for each primer set. Regression analyses of inverse cycle threshold values plotted against PhyloChip fluorescence intensities were determined for each targeted taxon.

TABLE 2
Primers used for Q-PCR validation of targeted species

| | | Annealing |
|---|---|---|
| Species | Primers | temperature |
| P. aeruginosa | 5′-CAGTAAGTTAATACCTTGCTGTGCTG-3′ | 55° C. |
| | 5′-TGCTGAACCACCTACGCGC-3′ | |
| S. maltophilia | 5′-GCCGGCTAATACCTGGTTGGGA-3′ | 55° C. |
| | 5′-CTACCCTCTACCACACTCTAGTCGC-3′ | |
| H. cetorum | 5′-GCGTTACTCGGAATCACTGGGCGTA-3′ | 48° C. |
| | 5′-ATGAGTATTCCTCTTGATCTCTACG-3′ | |
| C. mucosalis | 5′-ATGTGGTTTAATTCGAAGATACGCG-3′ | 52° C. |
| | 5′-CACGAGCTGACGACAGCCGTGCAGC-3′ | |

### Results

16S rRNA PhyloChip analysis identified a total of 1,213 bacterial taxa present in airway samples from COPD patients obtained during the course of acute exacerbations (the complete list is provided in Table 3). Despite recent or ongoing exposure to antibiotics across the group, the mean number of taxa detected in each sample was 411±246 taxa (SD). Identified taxa represented a diverse group of species belonging to 38 bacterial phyla and 140 distinct families (FIG. 10A). Bacterial families detected included members of the Pseudomonadaceae, Pasteurellaceae, Helicobacteraceae, Enterobacteriaceae, Comamonadaceae, Burkholderiaceae, and Alteromonadaceae, among many others. In addition, recently described phyla such as the TM7 subgroup of Gram-positive uncultivable bacteria were also detected in the airways of these patients (Table 3).

Interpersonal variation in bacterial richness (number of taxa detected) was noted across the patient samples (FIG. 10B). Four subjects (patients 1, 4, 5, and 6) exhibited communities with significantly fewer taxa (p<0.002) compared with the other four subjects. Patients in which fewer bacterial taxa were detected tended to possess more members of the Pseudomonadaceae. In contrast, members of the Clostridiaceae, Lachnospiraceae, Bacillaceae, and Peptostreptococcaceae were detected more commonly in those patients with richer communities (patients 2, 3, 7). Patient 8 had a large proportion of taxa belonging to the Enterobacteriaceae family, which have been associated with more advanced COPD lung disease. This patient also had radiographic evidence of coexisting bronchiectasis, which was not present in the other patients.

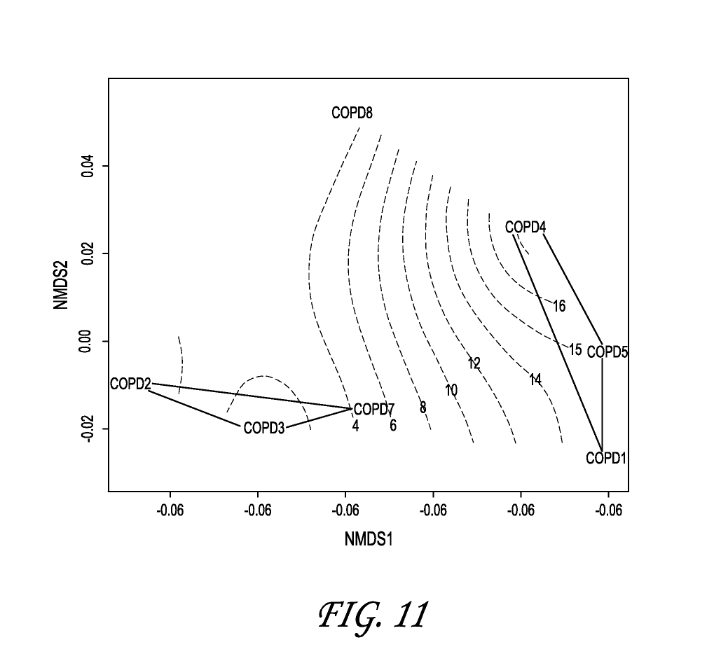

Given the variation in bacterial richness among samples, which suggested differences in bacterial community composition, NMDS was used to assess variation in bacterial community structure (based on Bray-Curtis dissimilarity measures) across the sample cohort. This revealed two distinct groups of patient samples and confirmed that patient 8 represented a structurally distinct airway community (FIG. 11). Given this separation of subjects based on differing bacterial community structures, the influence of available clinical parameters on community composition was explored. Matrix-based, nonparametric multivariate analysis of variance revealed that across the cohort, the number of elapsed intubation days was significantly associated with bacterial community composition and structure, accounting for the greatest percentage of the observed variability (44%, p<0.03; FIG. 11). Group 1 patient samples (patients 2, 3, and 7) were characterized by a shorter intubation duration prior to ETA sample collection days), while those in Group 2 were intubated for significantly longer periods of time (p<0.0007; patients 1, 4, 5, and 6; days) and exhibited a significantly less rich community composition compared to that of Group 1 (p<0.025). Given the community variation between Group 1 and Group 2, differences in the relative abundance of all detected taxa were assessed between the groups, which identified 153 taxa with significantly different relative abundances (Table 4). All of these significant taxa were present in higher abundance in Group 1, the majority of which (77%) belonged to the phylum Firmicutes. These included species such as Lactobacillus kitasatonis, L. perolens, L. sakei, and Bacillus clausii, as well as known pathogenic species such as Streptococcus constellatus, which is a member of the Streptoccocus milleri group (SMG; Table 4). No other clinical variable [including diagnosis of pneumonia (n=6; p<0.4) or the number of days between pneumonia diagnosis and sample collection (range: 3-52 days; p<0.6)] demonstrated a significant association with bacterial community composition in this cohort.

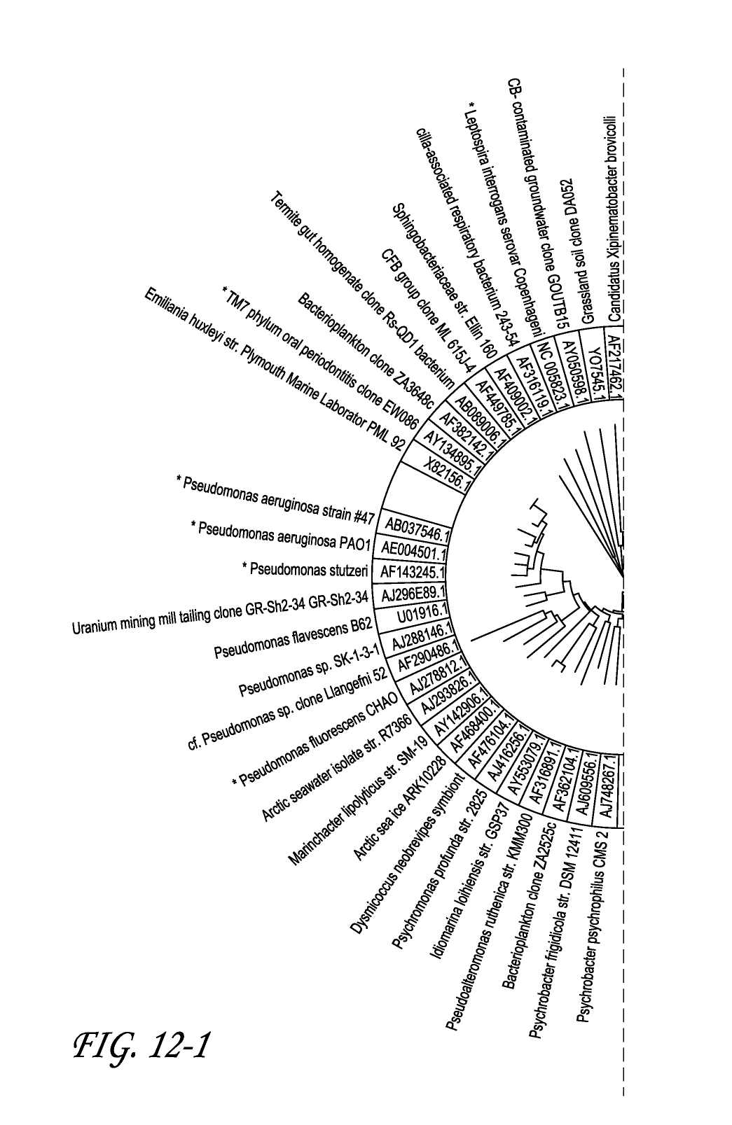

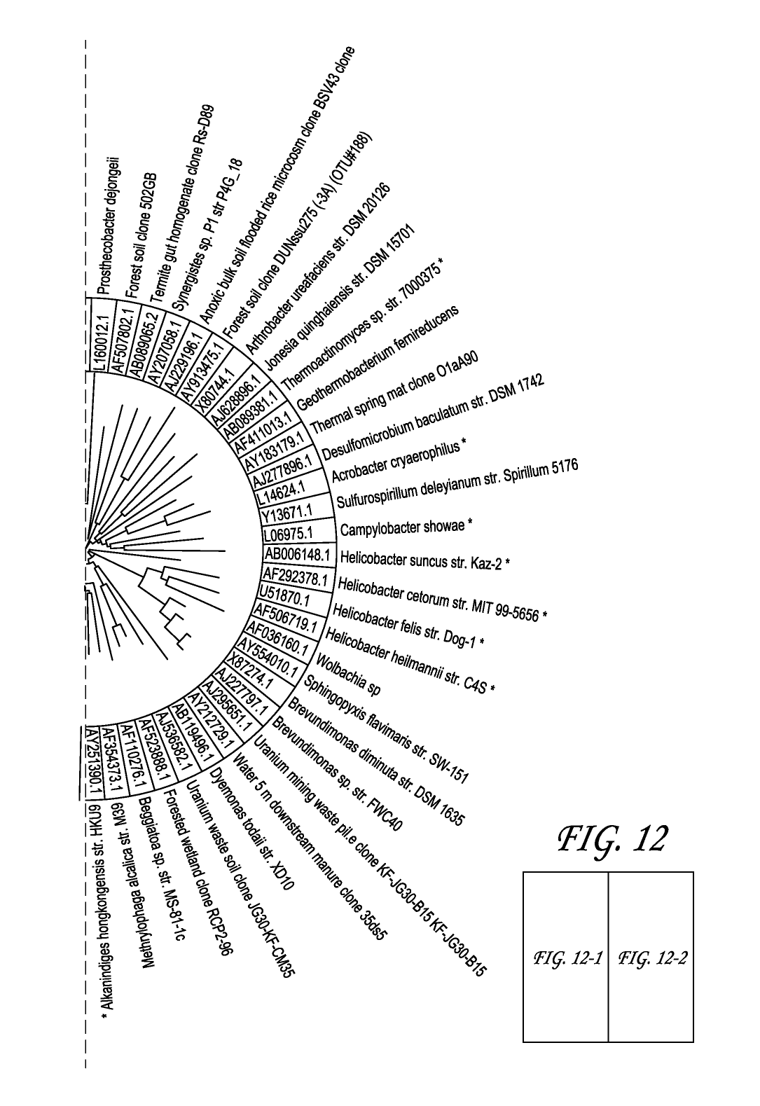

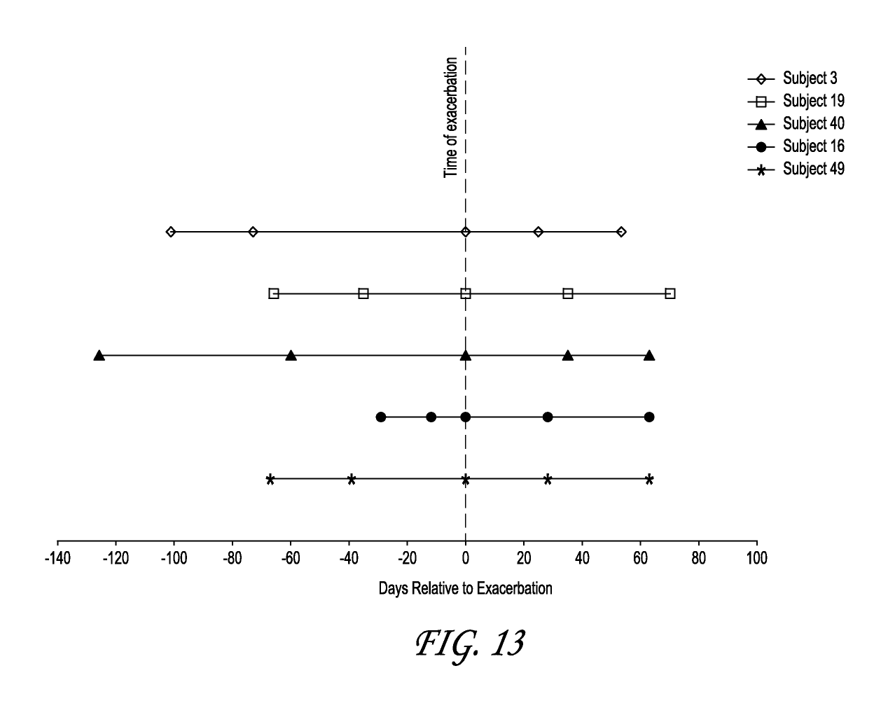

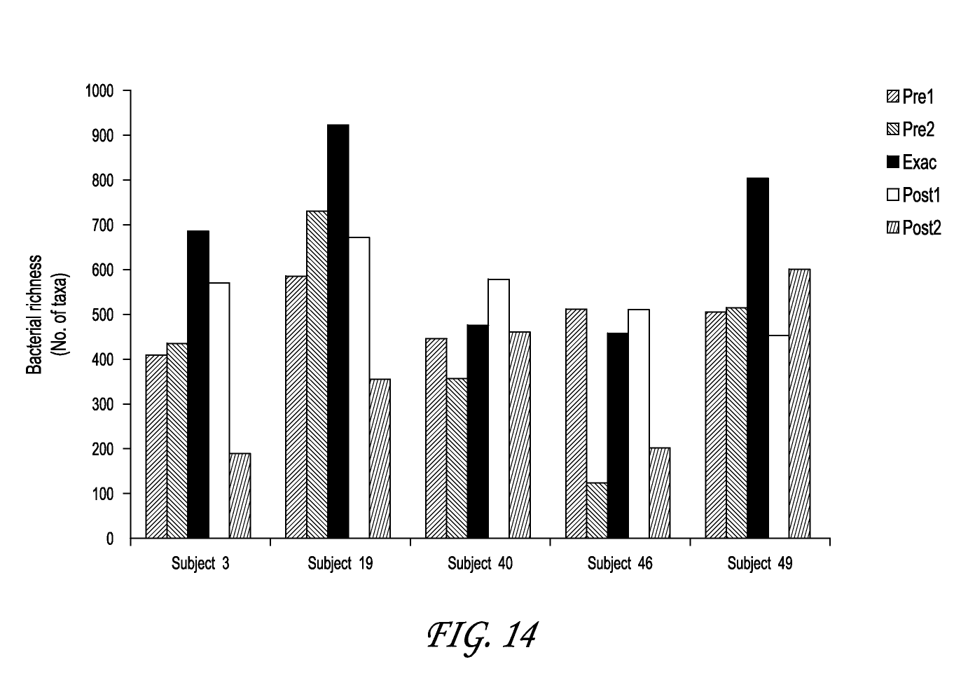

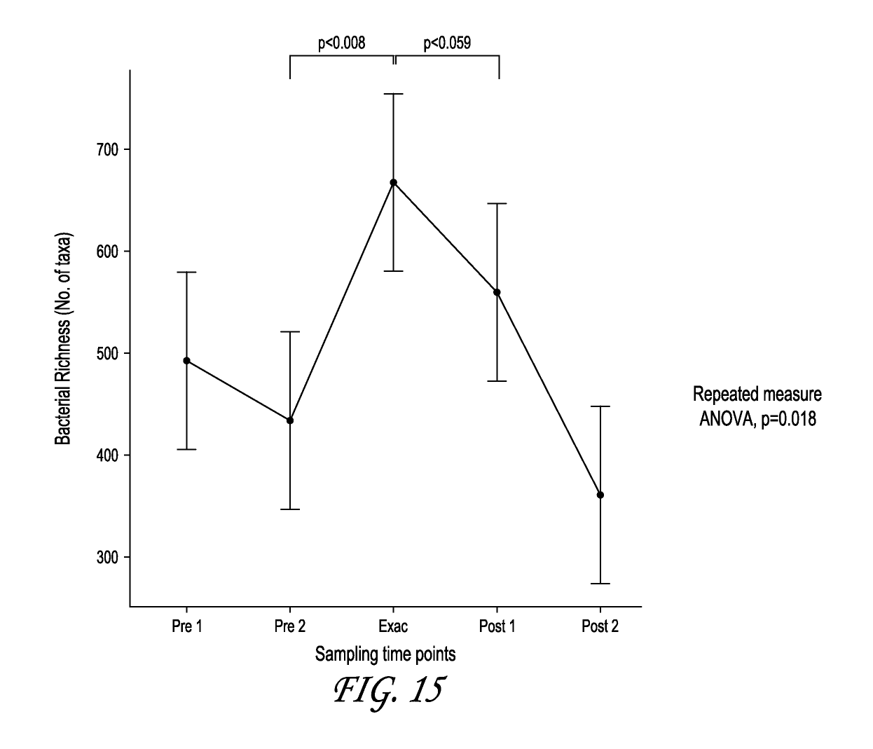

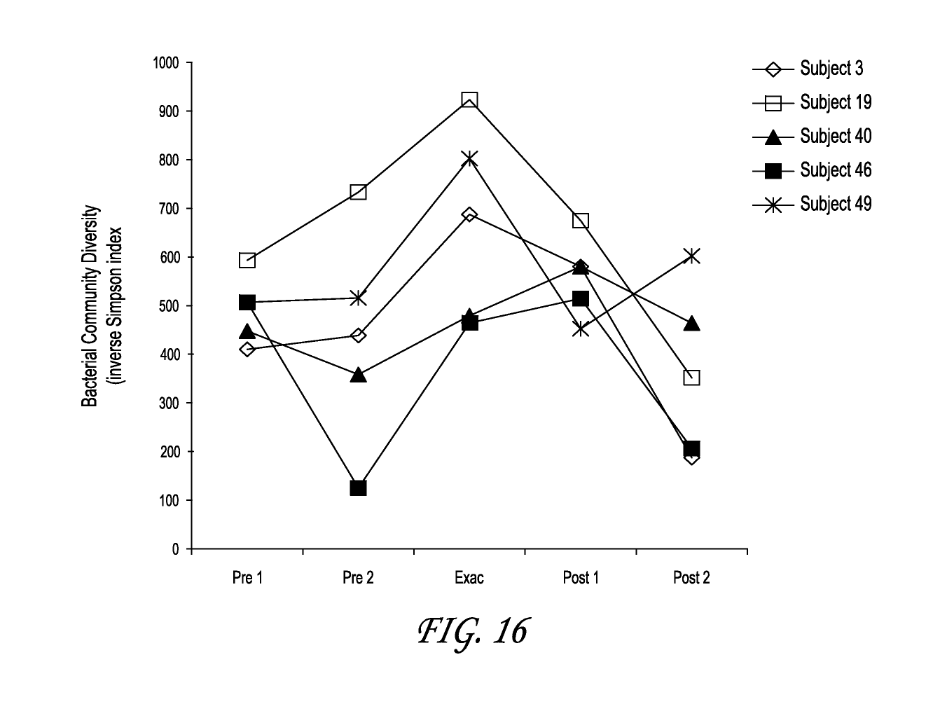

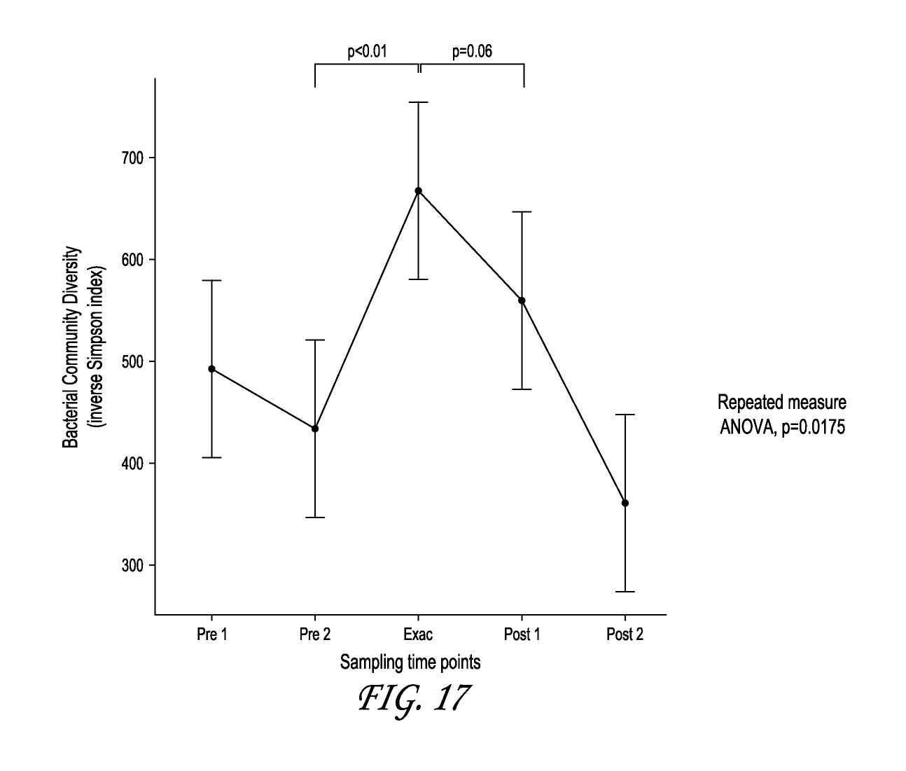

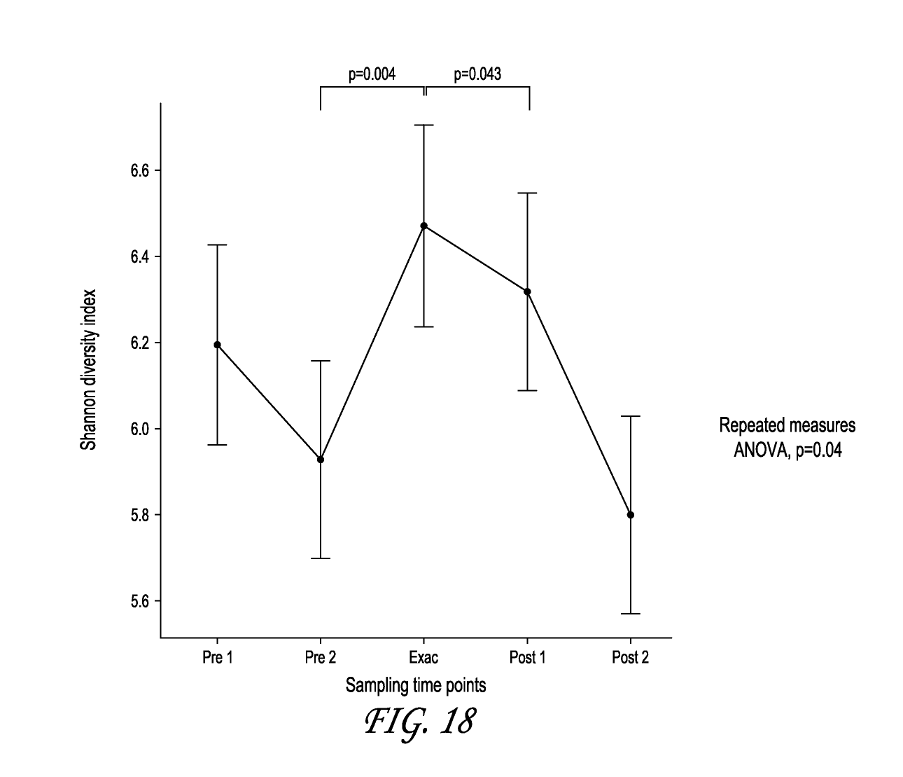

A common core of 75 bacterial taxa representing 27 classified bacterial families was identified in all patients analyzed (FIG. 12). This core group included members of the Pseudomonadaceae, Enterobacteriaceae, Campylobacteraceae, and Helicobacteraceae, amongst others. In addition, taxa containing species of pathogenic potential, such as Arcobacter cryaerophilus, Brevundimonas diminuta, Leptospira interrogans, as well as P. aeruginosa, were detected in all patients (a complete list of the core taxa is provided in Table 5). The array data for organisms that have previously been associated with COPD airways was also analyzed. Haemophilus influenzae was detected by the array in two subjects (patients 2 and 8), although corresponding m-BAL cultures were negative for this organism. Moraxella catarrhalis was not detected by PhyloChip or culture in any patient sample. However, other phylogenetically related members in the Moraxellaceae family, including Moraxella oblonga, Acinetobacter haemolyticus, and Psychrobacter psychrophilus were identified by the array in 80-100% of subjects (Table 3). Streptococcus pneumoniae was detected in four subjects (patients 2, 3, 7 and 8) despite all m-BALs being culture-negative for this species. Finally, PhyloChip data was also examined for the presence of the atypical bacteria, Mycoplasma pneumoniae and Chlamydophila pneumoniae, which are associated with 3-5% percent of exacerbations. Neither was detected by the PhyloChip, although a related species, Mycoplasma pulmonis, was identified in a single individual (patient 3).

Quantitative PCR was performed to validate that changes in reported array fluorescence intensities for targeted taxa correlated with changes in target species copy number for a selection of known airway pathogens (P. aeruginosa and Stenotrophomonas maltophilia) and two characteristic gastrointestinal organisms (Campylobacter mucosalis and Helicobacter cetorum). Regression analysis of species abundance determined by Q-PCR and array fluorescence intensity demonstrated strong concordance between the two independent methods for each target organism (Table 9), confirming their presence in these COPD airway samples and the ability of the array to accurately reflect changes in organism relative abundance.

TABLE 9
Correlation results for species abundance by Q-PCR and
16S rRNA PhyloChip

| Target species | R value | p Value |
|---|---|---|
| P. aeruginosa | 0.77 | <0.05 |
| S. maltophilia | 0.80 | <0.05 |
| Campylobacter mucosalis | 0.68 | <0.10 |
| Helicobacter cetorum | 0.79 | <0.05 |

### Example 5

### Airway Microbiota Dynamics During COPD Exacerbations

This examples describes the characterization of bacterial microbiota of the airway microbiome around the time of acute COPD exacerbations.

Twenty-five sputum specimens collected over periods before, during, and after acute exacerbations in five patients were analyzed using a PhyloChip microarray, as described herein. Data was analyzed for changes in community diversity, relative abundance of individual OTUs, and association with clinical variables using repeated measures ANOVA, ordination and cluster analysis methods, and Spearman rank correlations, performed using R statistical software.

Three subjects had exacerbations deemed infectious-related by a clinician and treated with oral steroids plus antibiotics (e.g. azithromycin), while two individuals were treated with oral steroids and decongestants only. Five time points per subject were analyzed, spanning a pre-exacerbation clinically stable period (range: 12-126 days before exacerbation onset), at exacerbation before start of new treatments, and post-exacerbation when the subject was clinically stable/improved (range: 25-70 days after exacerbation onset). There were significant changes in bacterial diversity over time across all subjects (p=0.018), which also correlated strongly with clinical symptom scores (Spearman rho=0.5, p≦0.01). Greatest bacterial diversity was observed in samples from at the onset of exacerbation, particularly in subjects with ‘infectious-related’ events and in whom diversity decreased significantly following antibiotic therapy. Leading up to exacerbation, increased diversity was reflected by all of the following: 1) significant changes in the relative abundance of multiple, existing (i.e. detected in a previous sample from the subject) bacterial OTUs; 2) expansions in existing OTUs or classes of bacteria through the addition of new members; and 3) the appearance of new OTUs not previously detected in the subject. Microarray analysis confirmed culture-based identification and increased abundance of individual species previously implicated in exacerbations. However, members of additional OTUs, including other potentially pathogenic species, demonstrated contemporaneous shifts in relative abundance, including the Enterobacteriaceae family, Actinobacteria and Clostridia classes of bacteria.

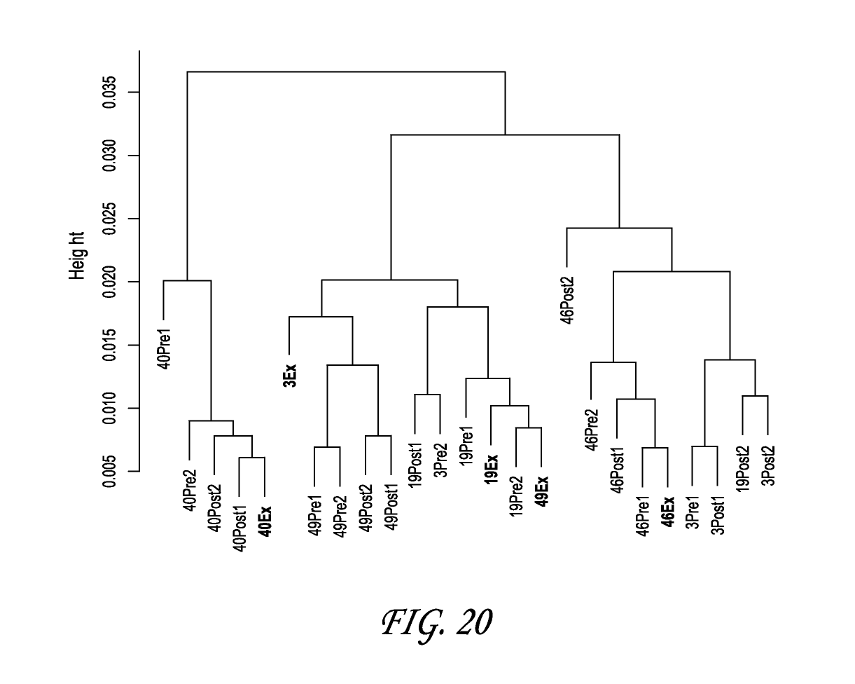

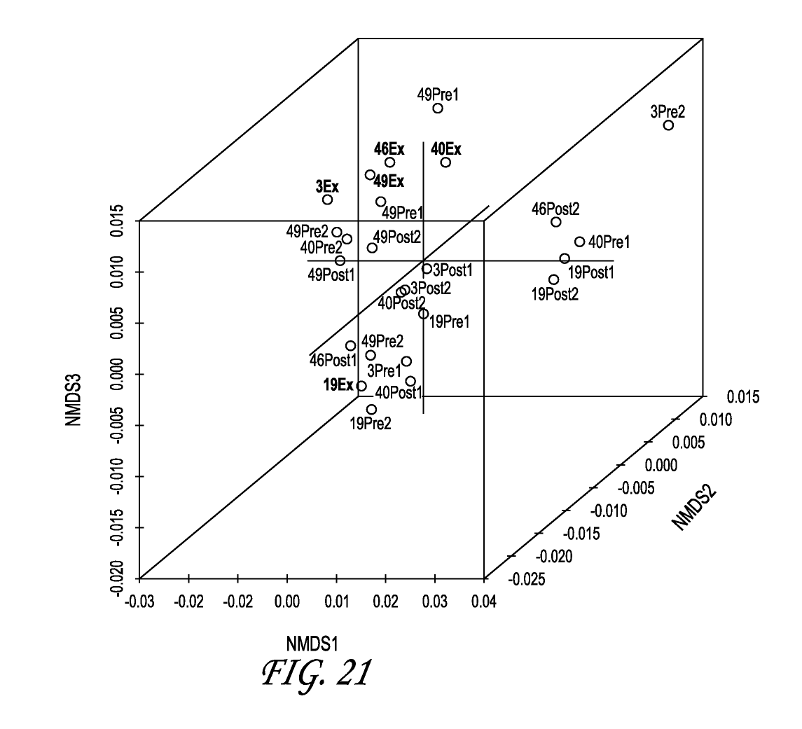

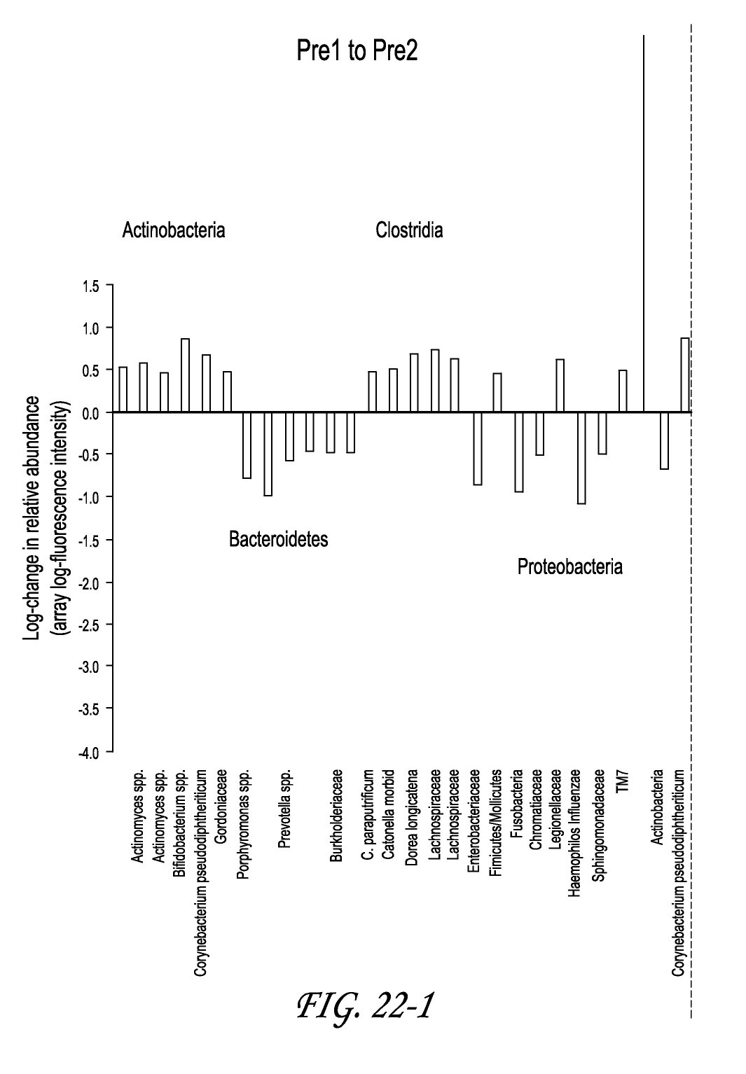

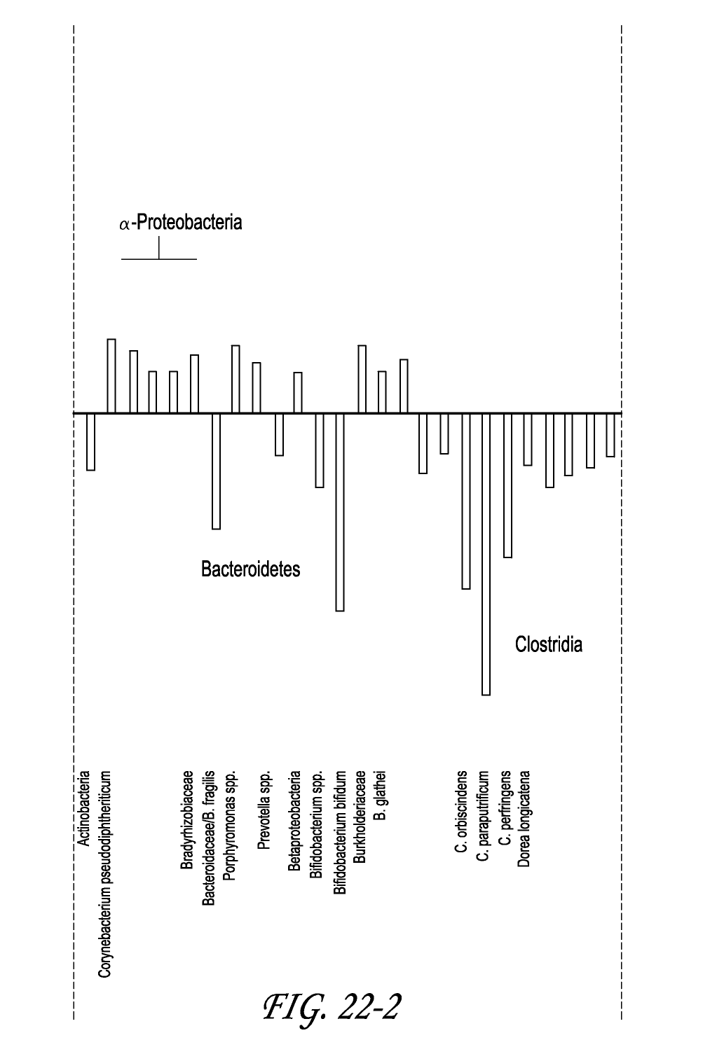

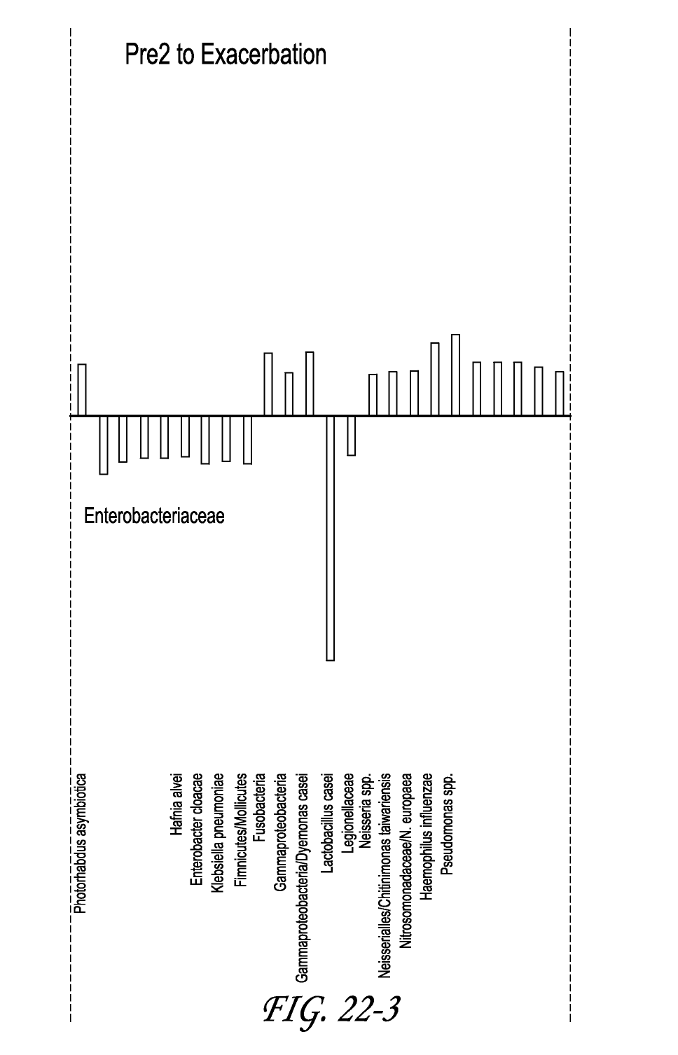

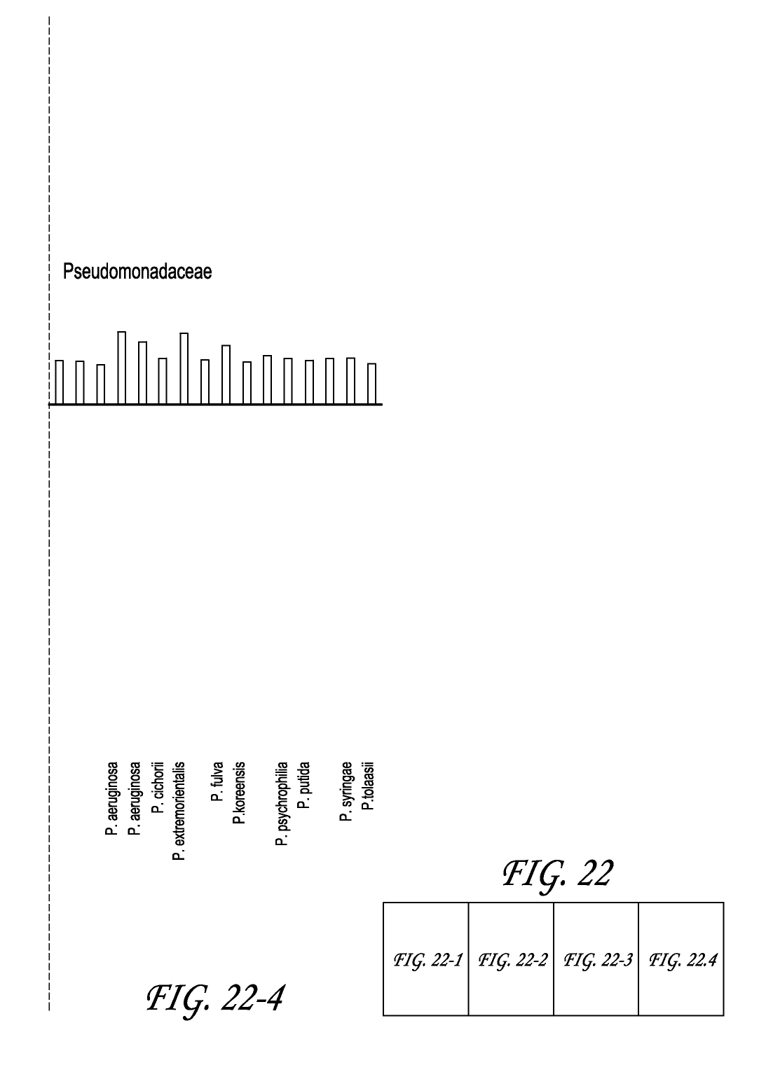

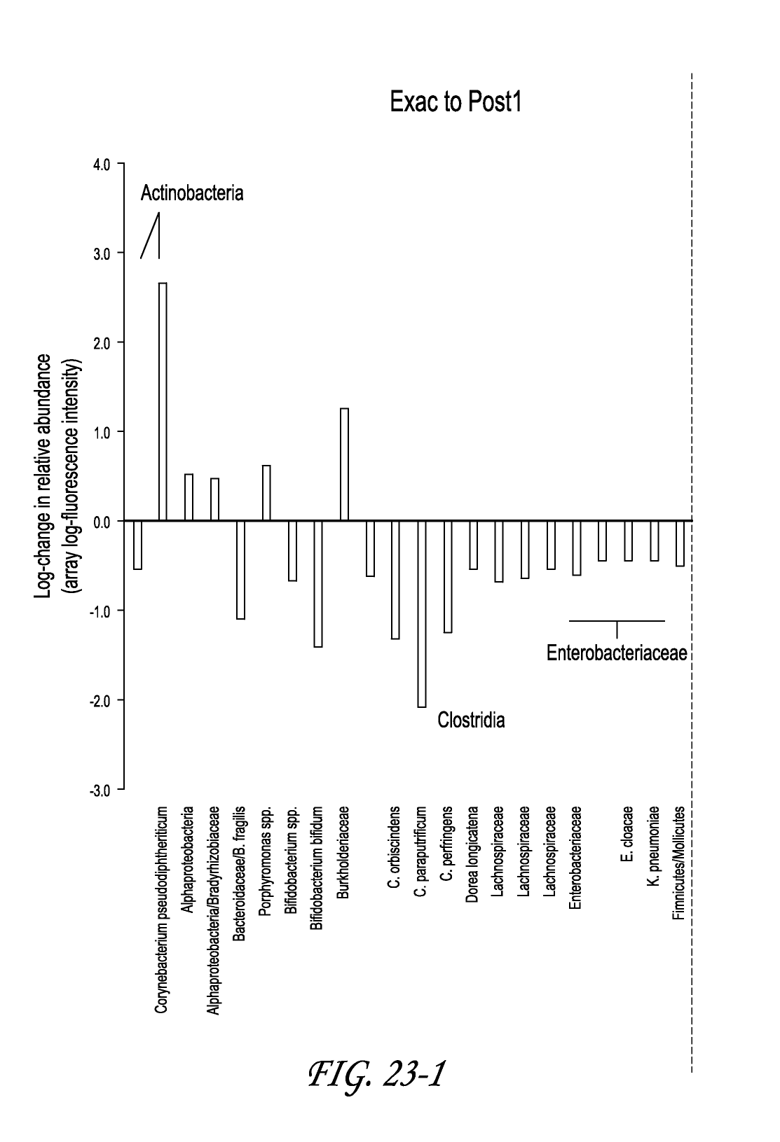

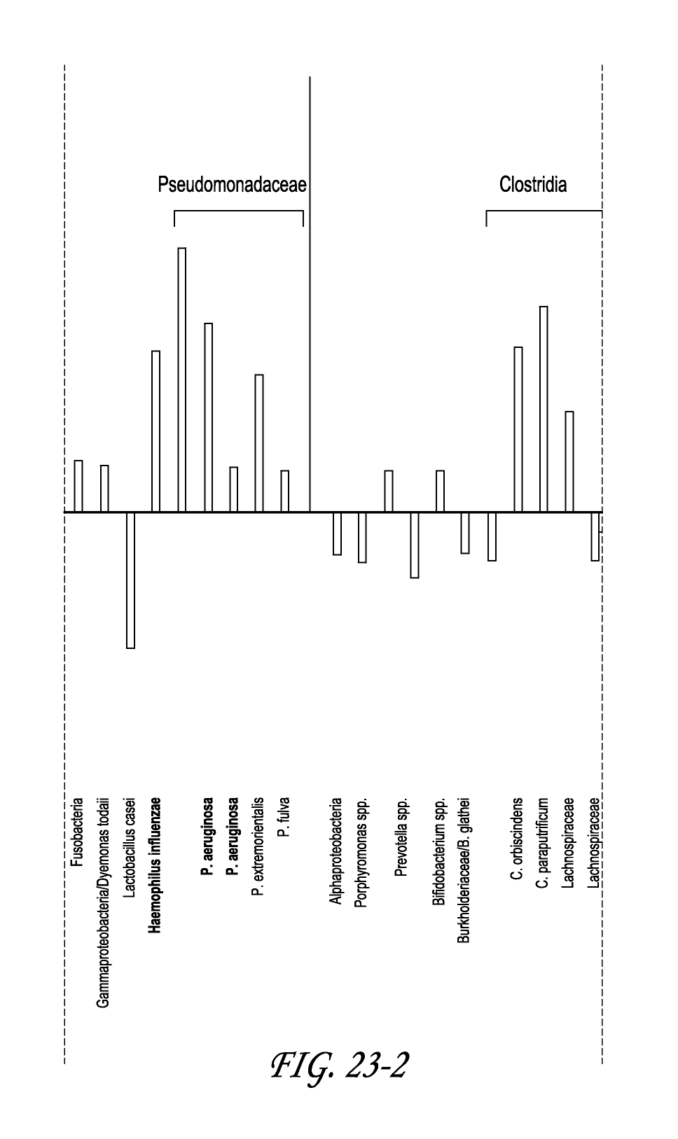

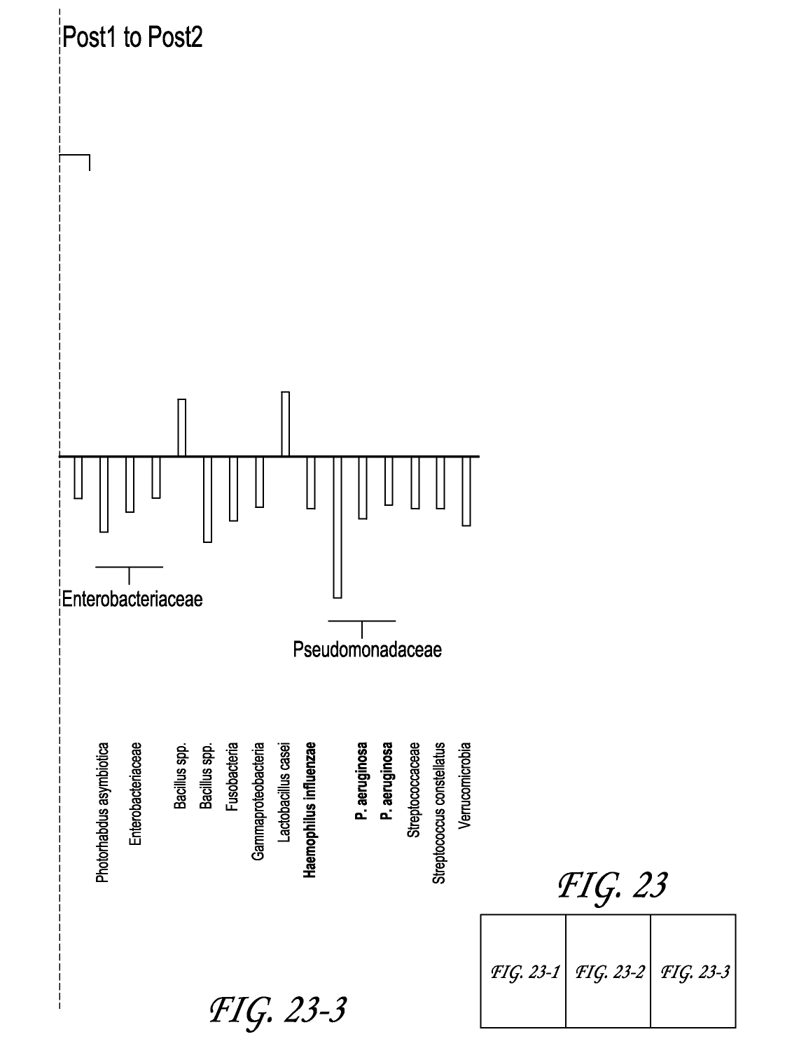

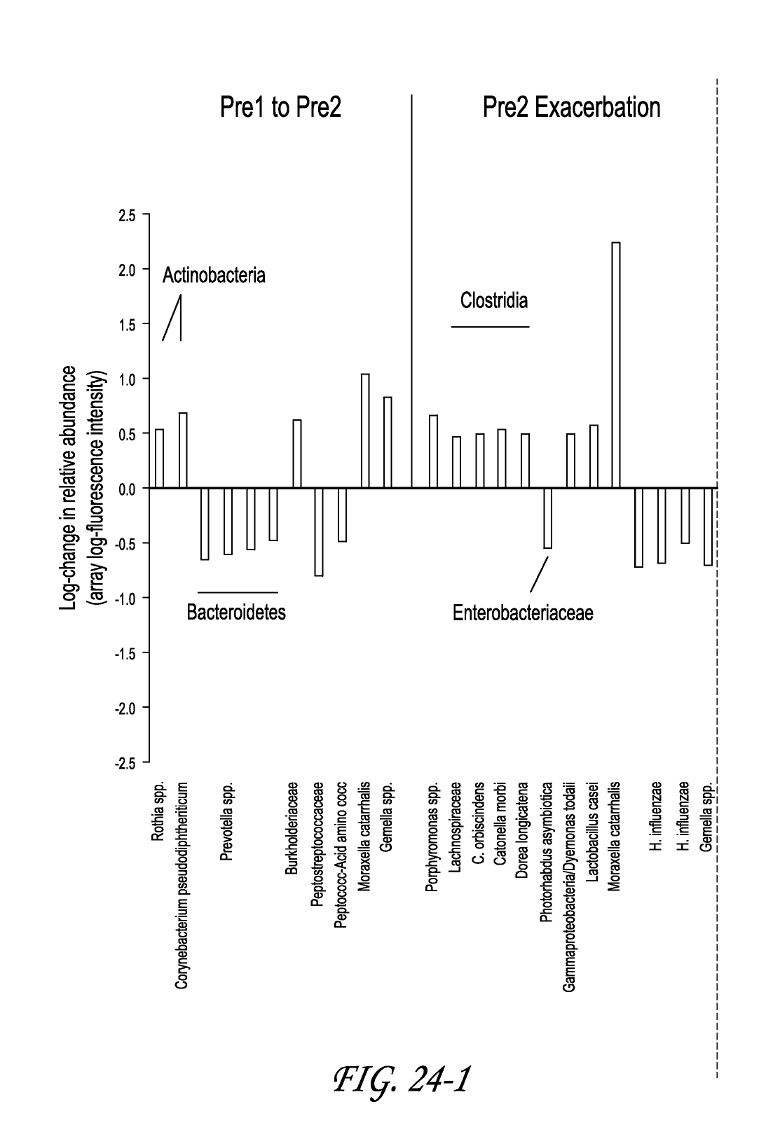

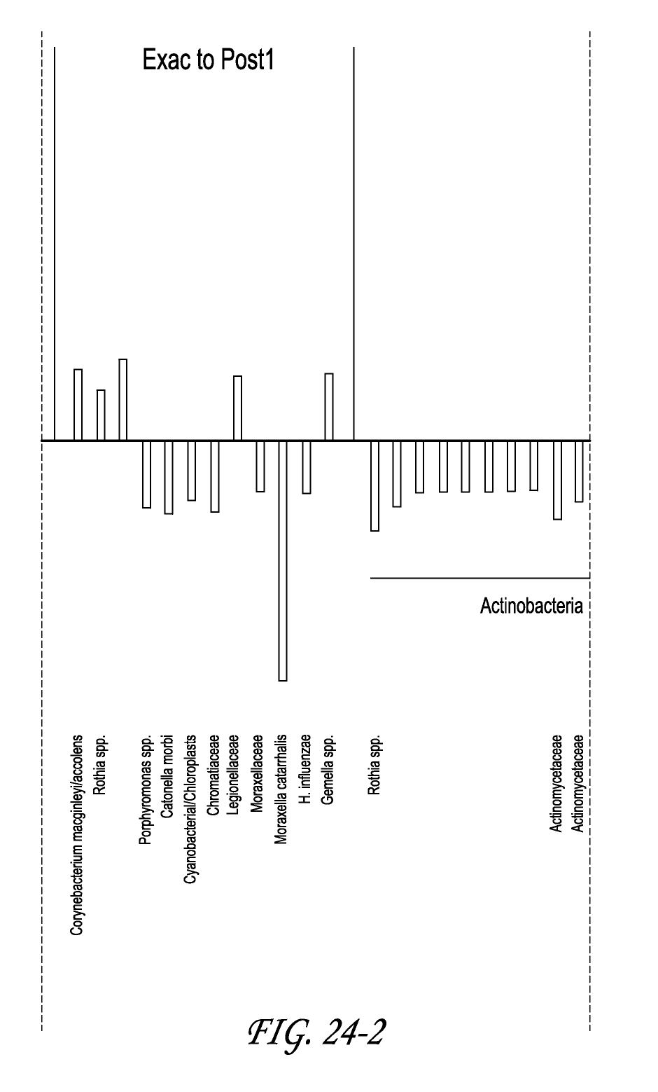

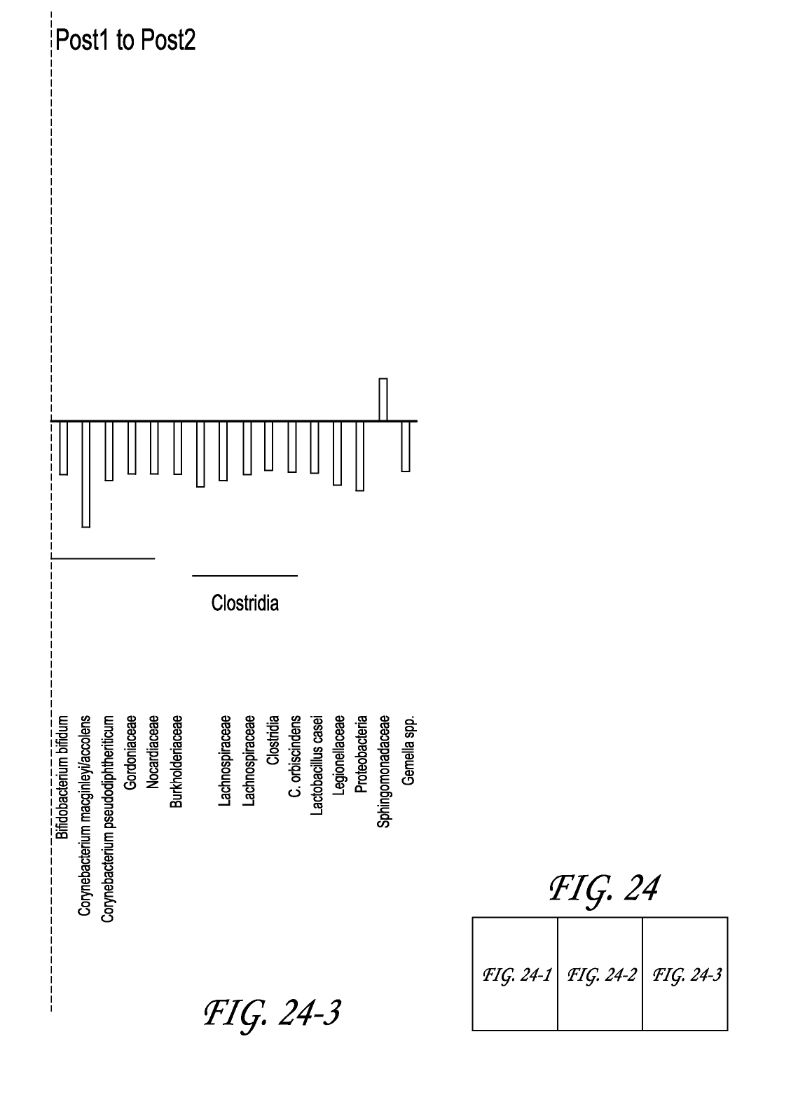

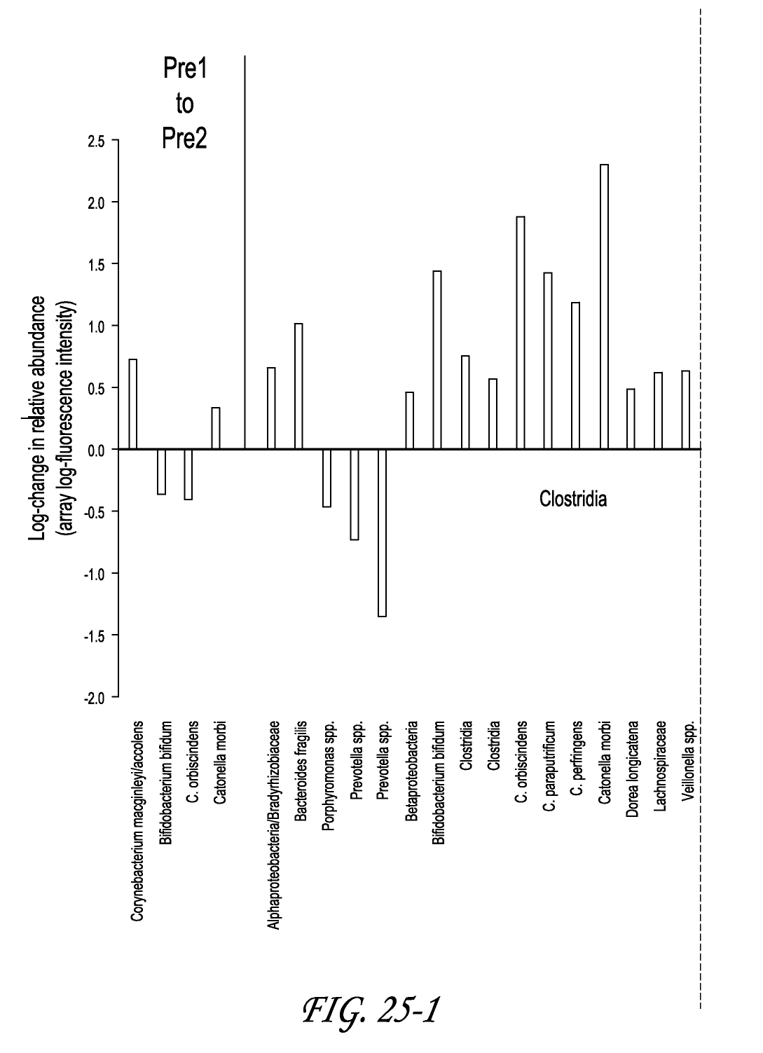

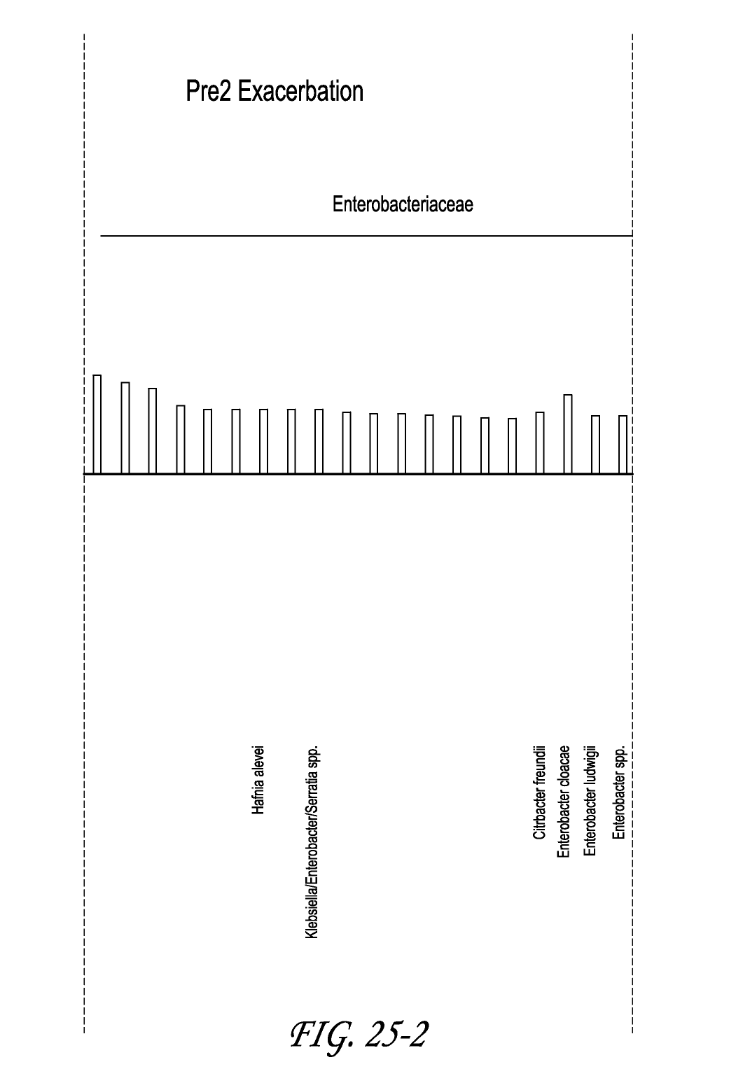

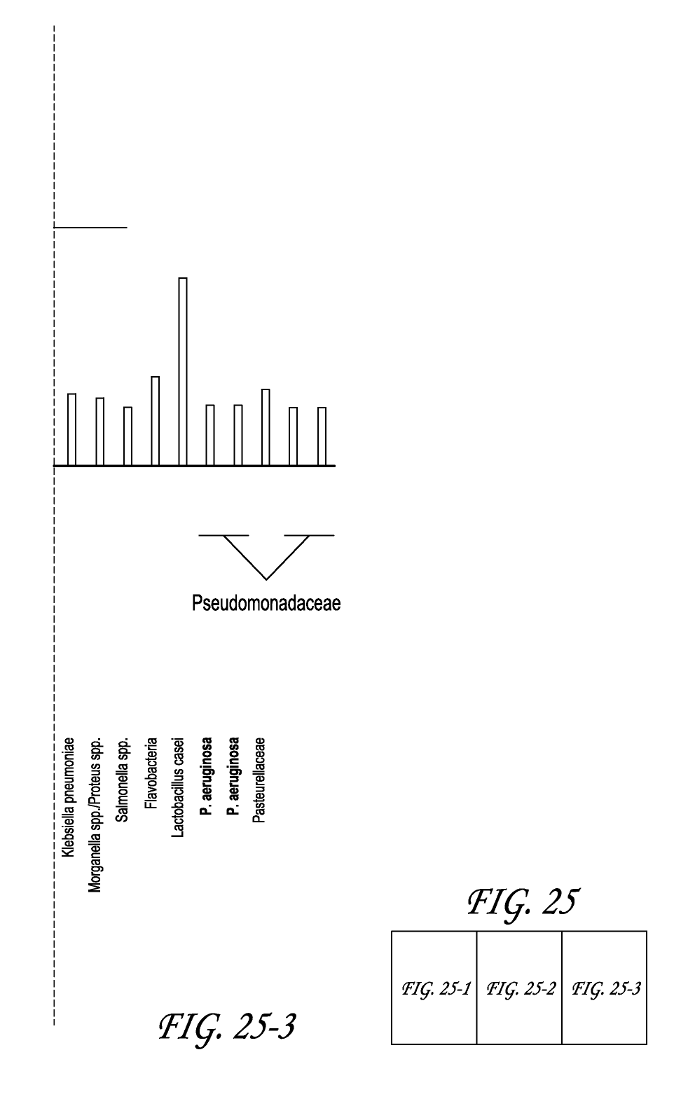

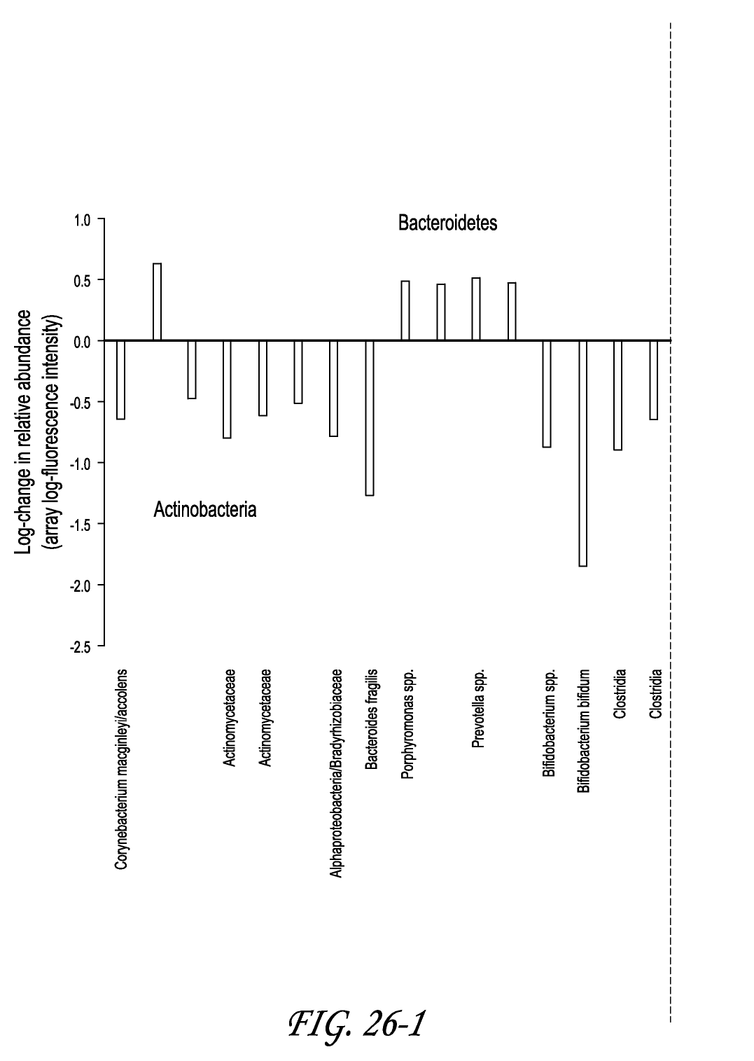

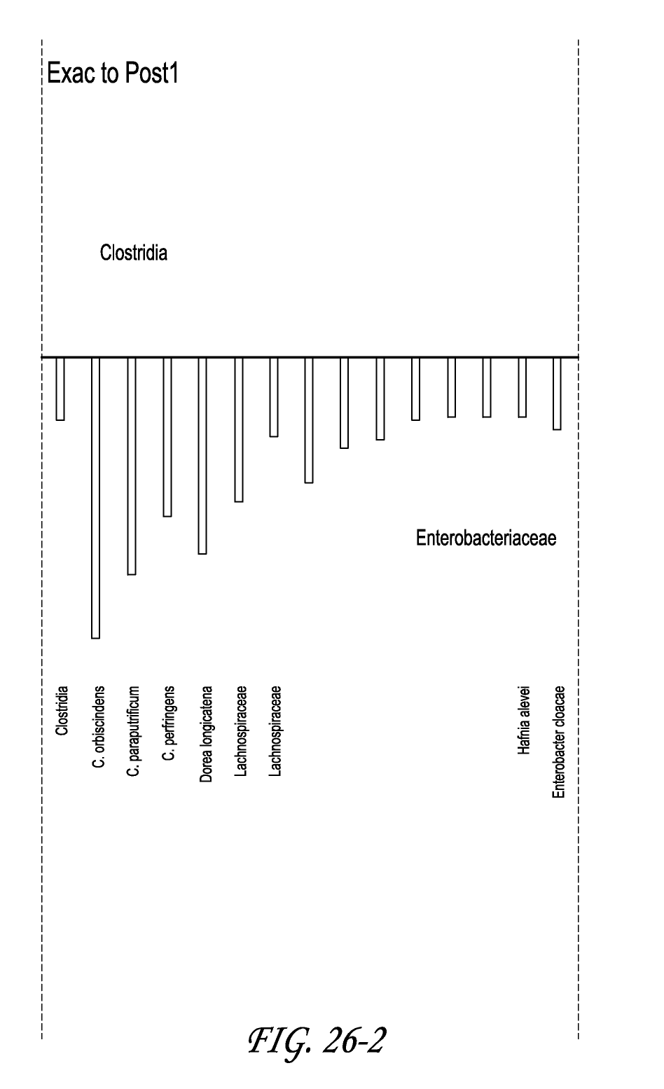

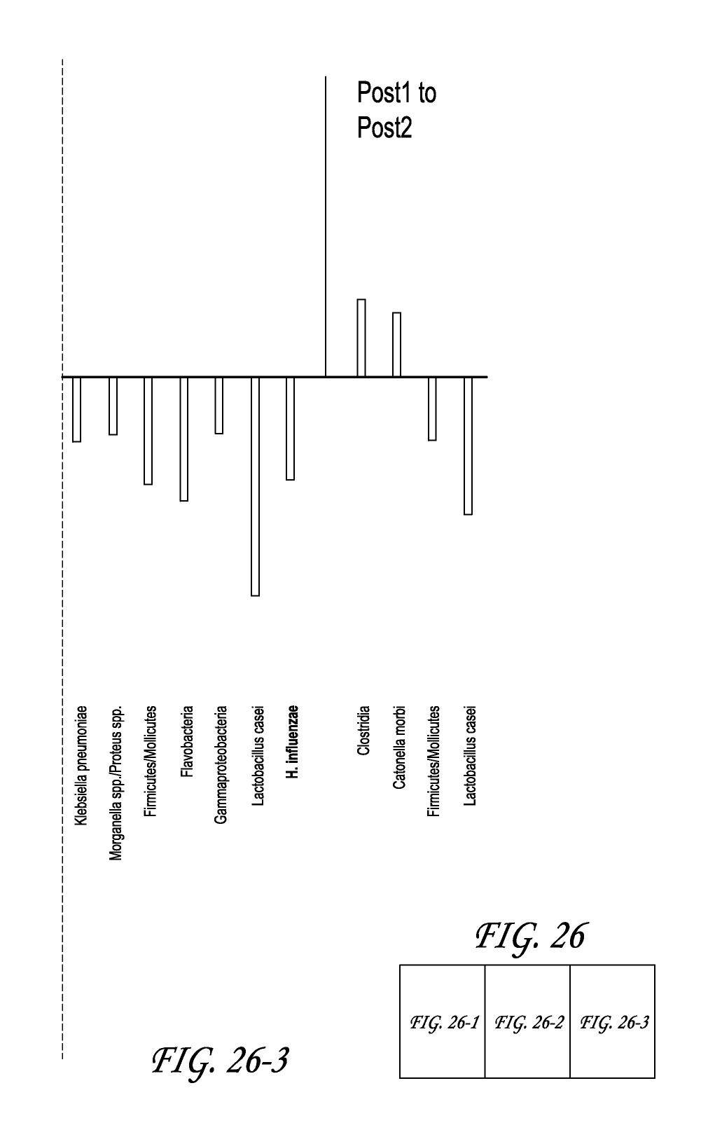

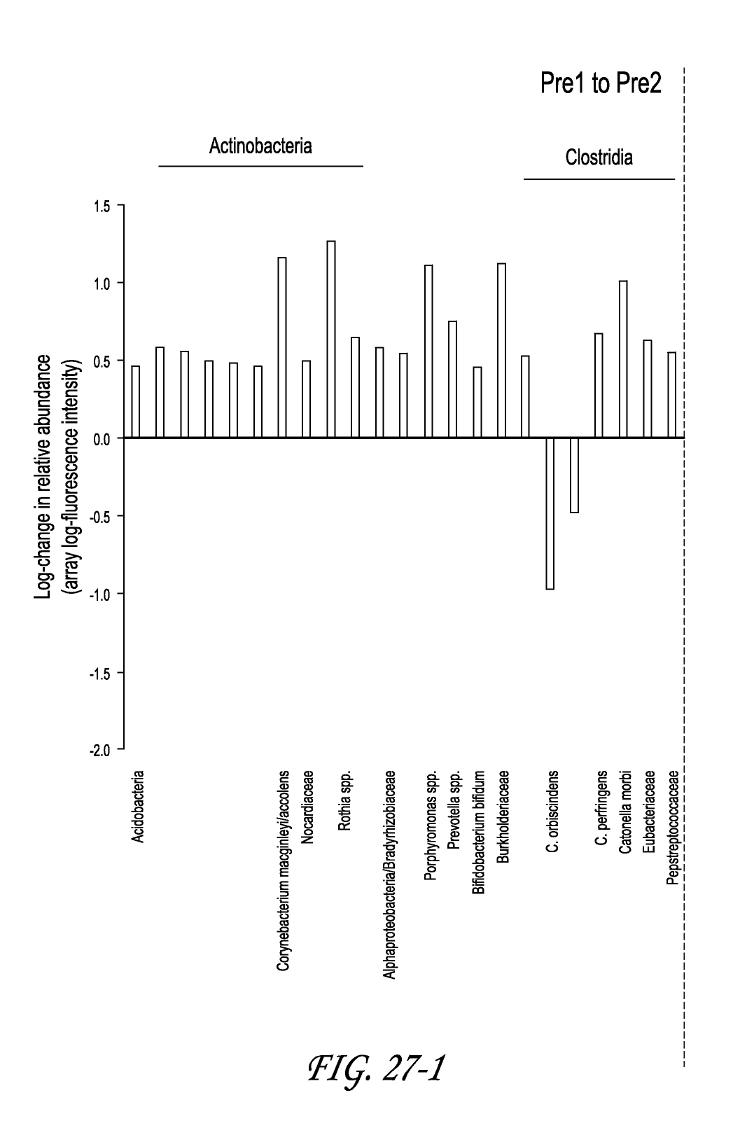

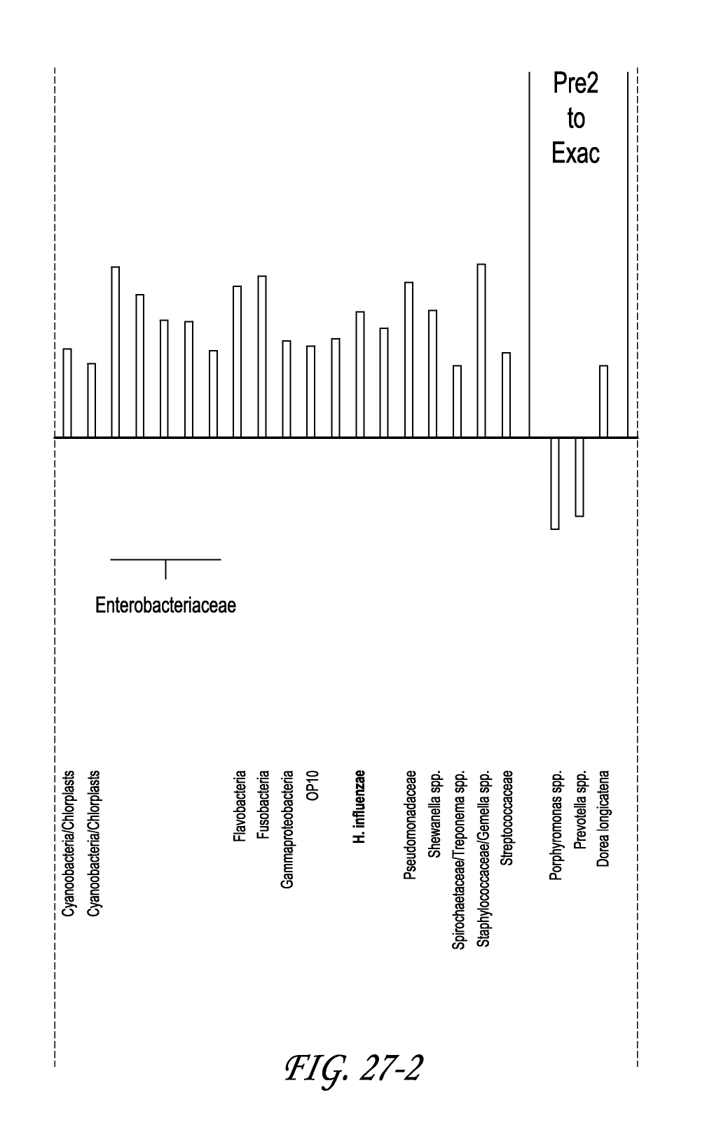

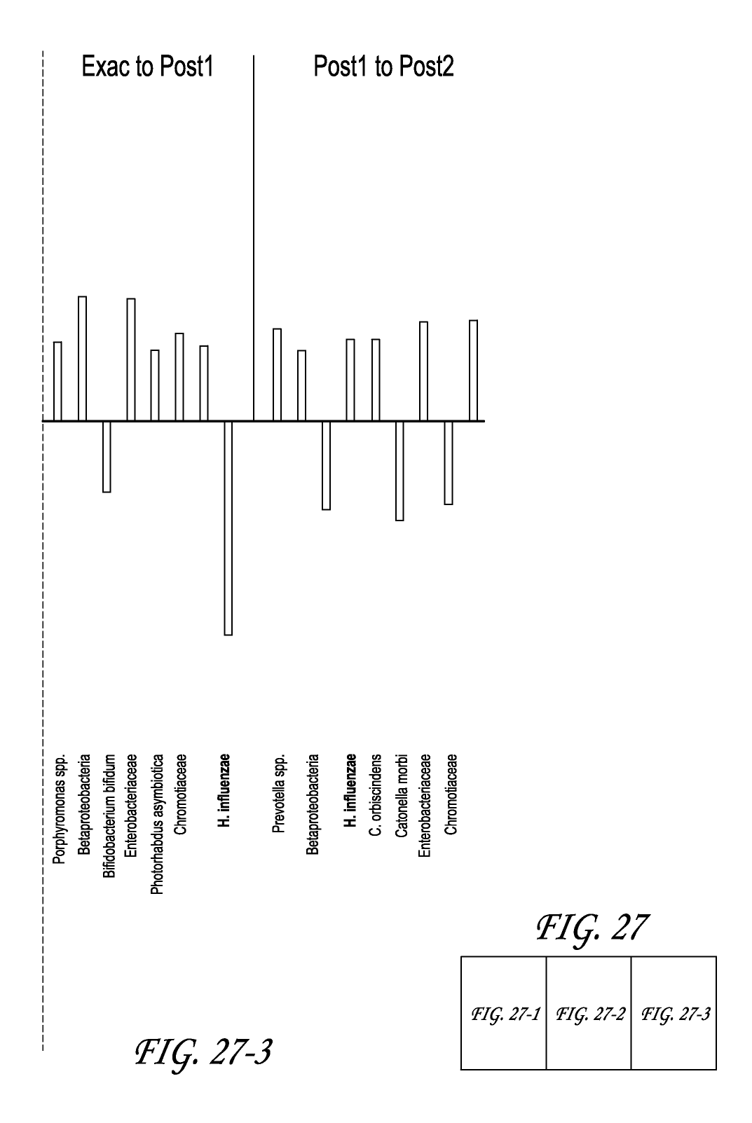

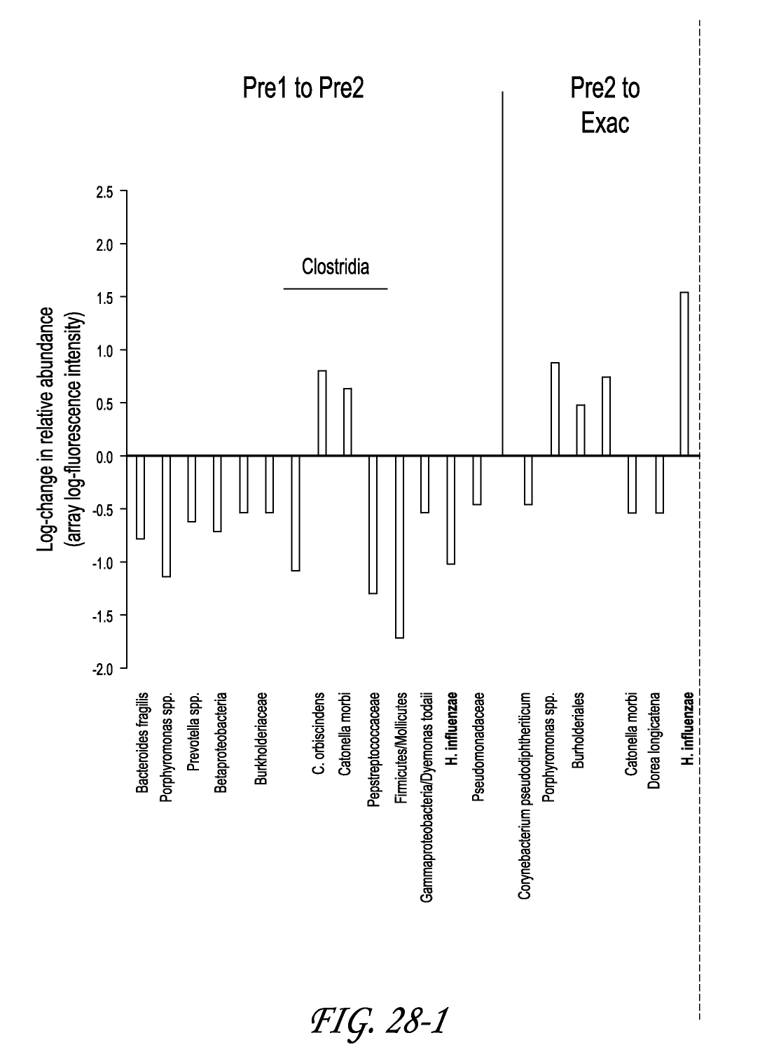

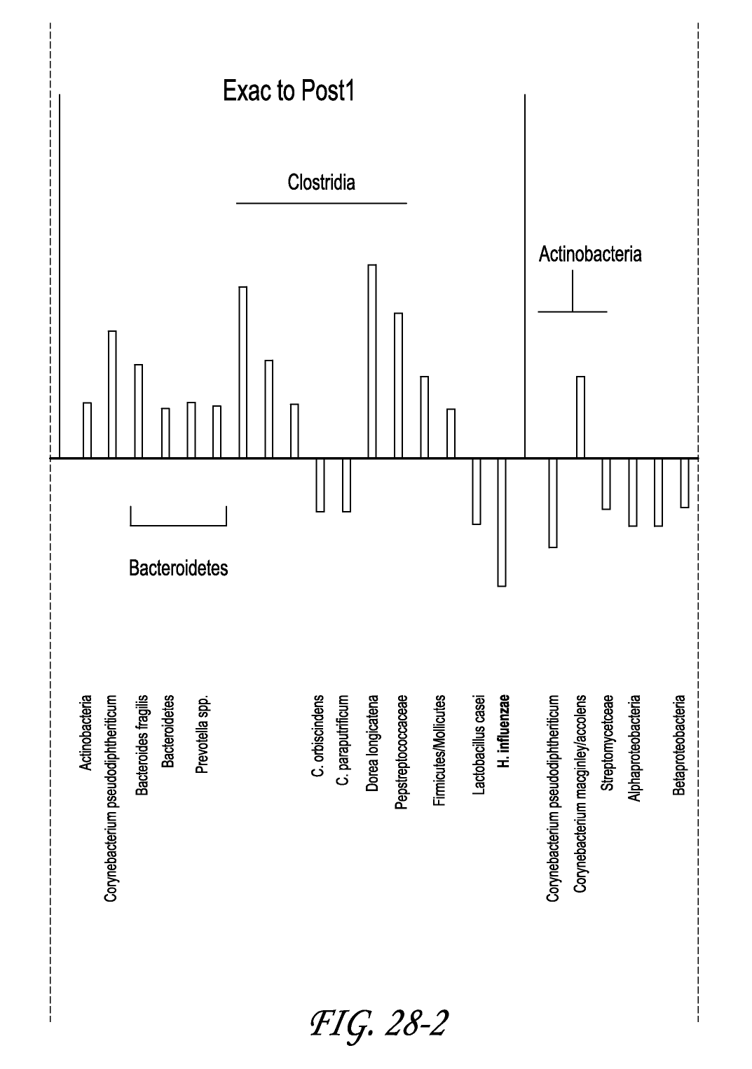

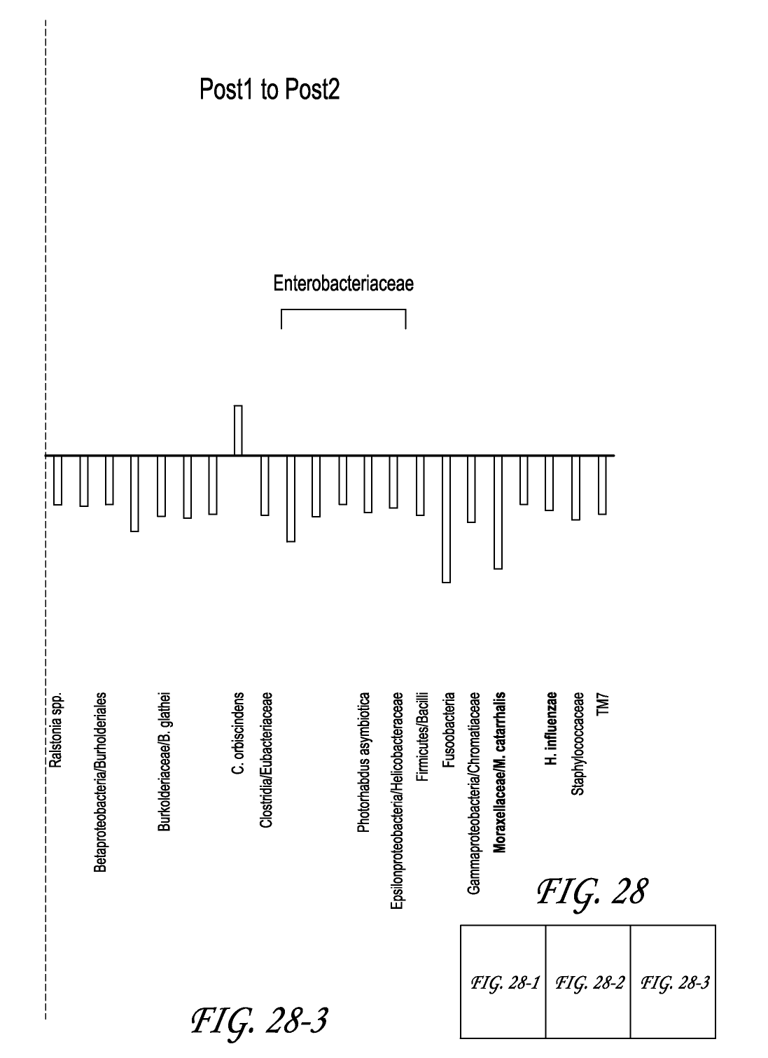

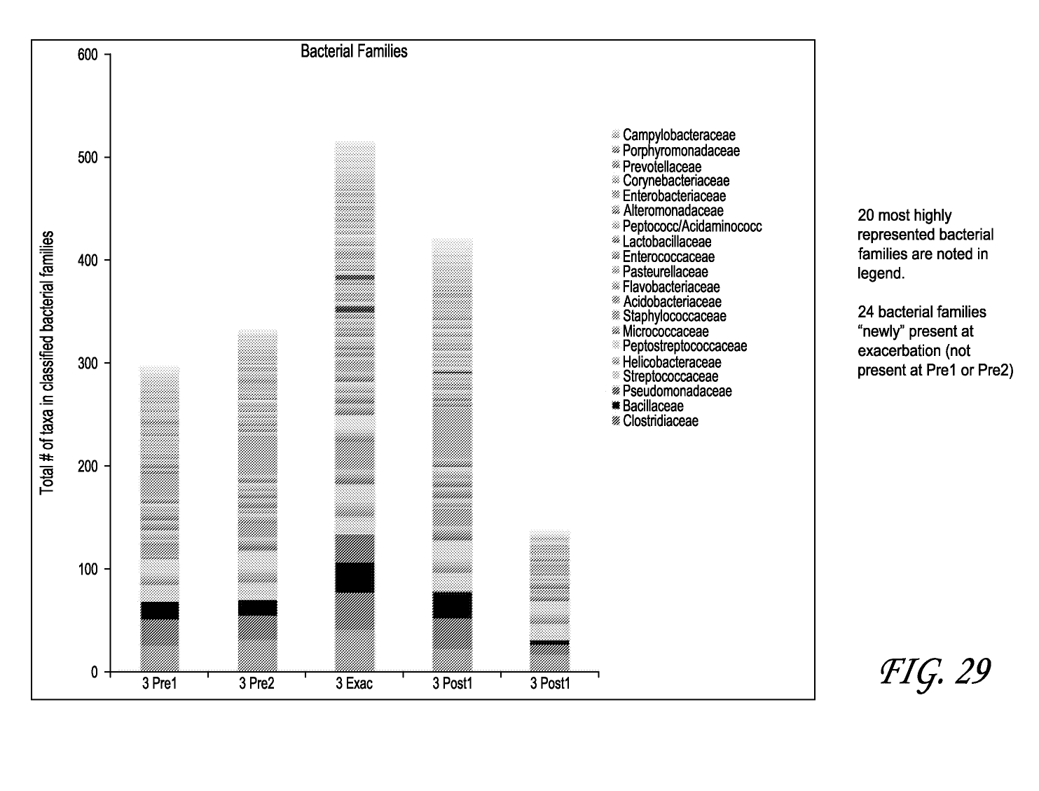

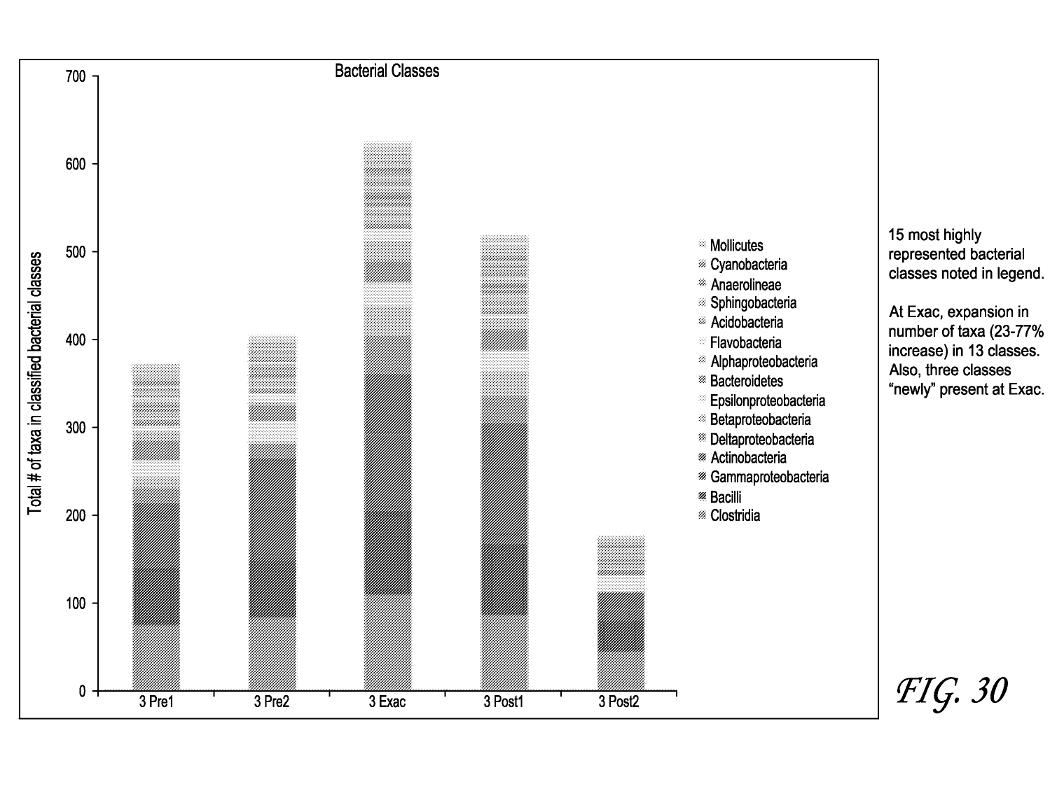

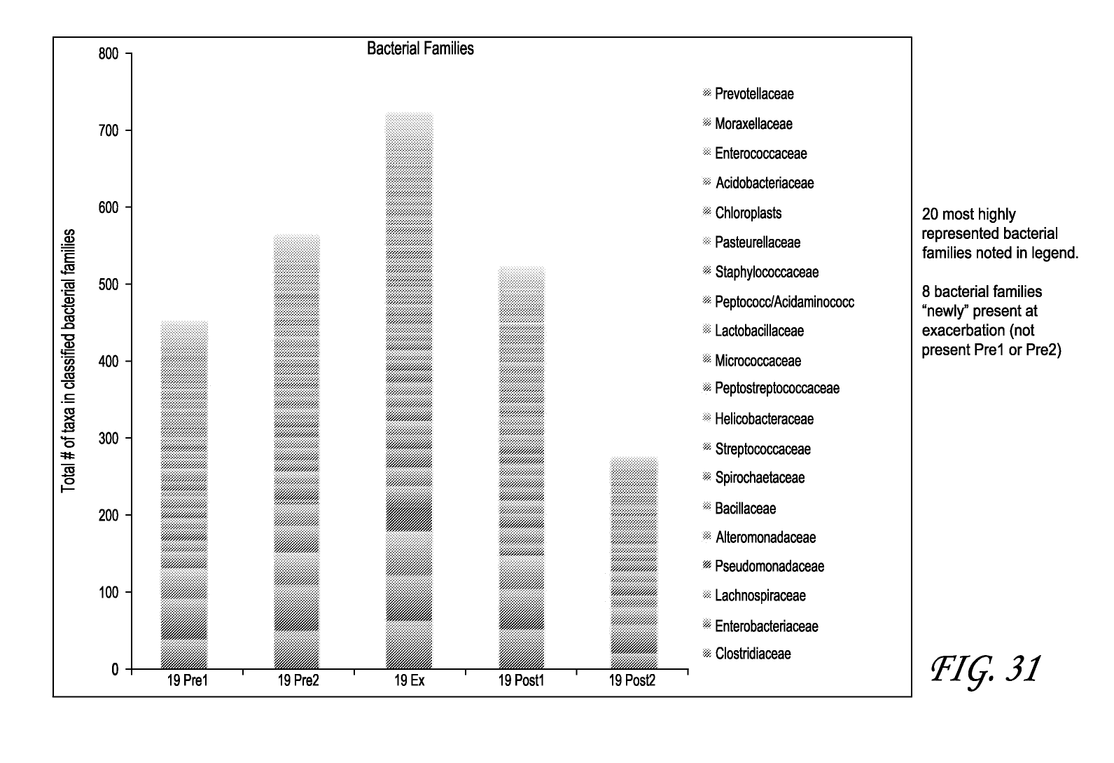

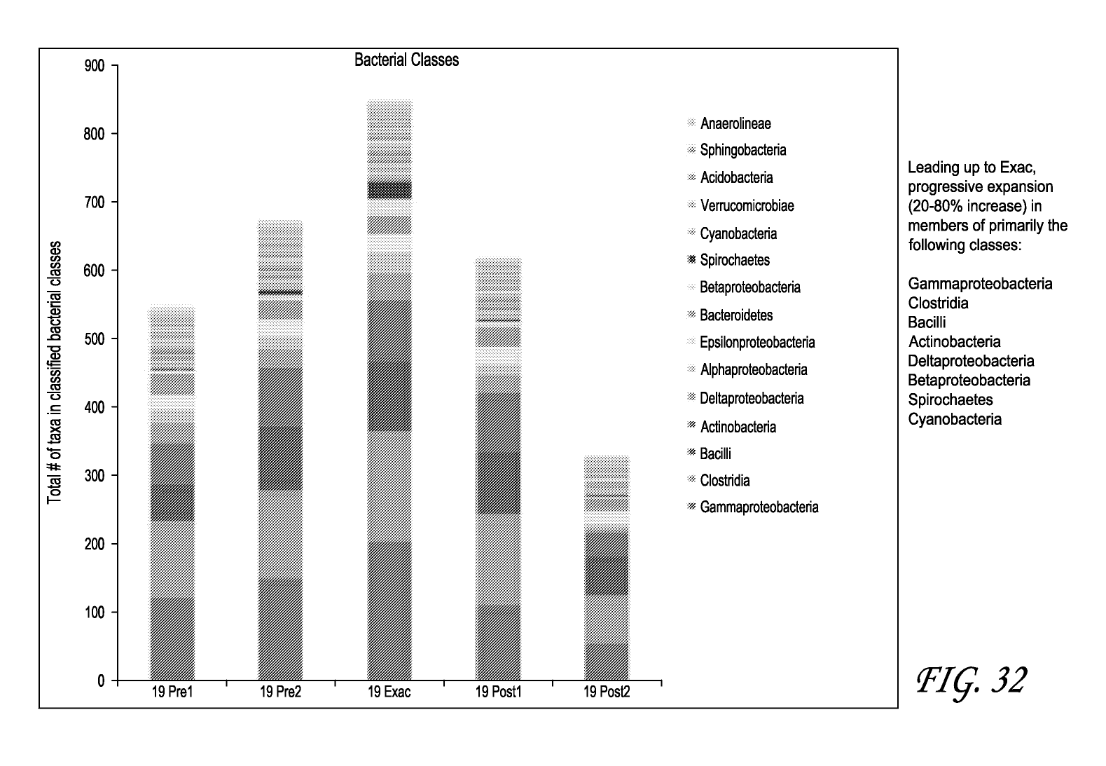

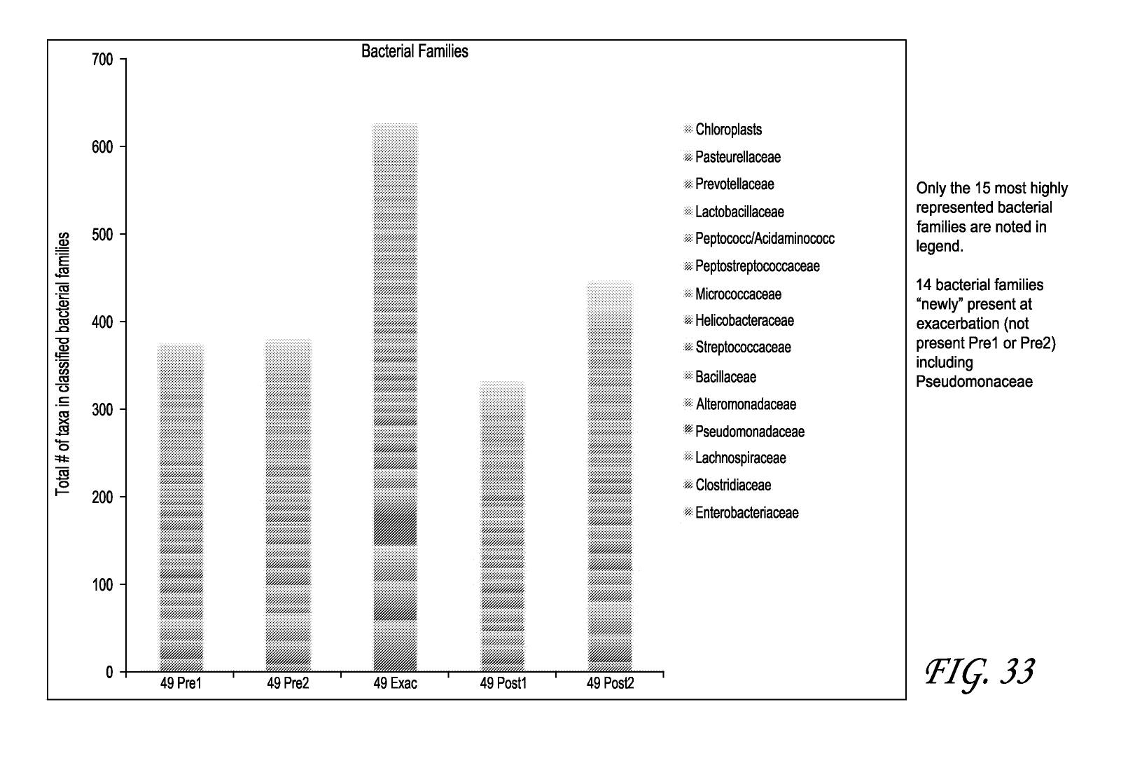

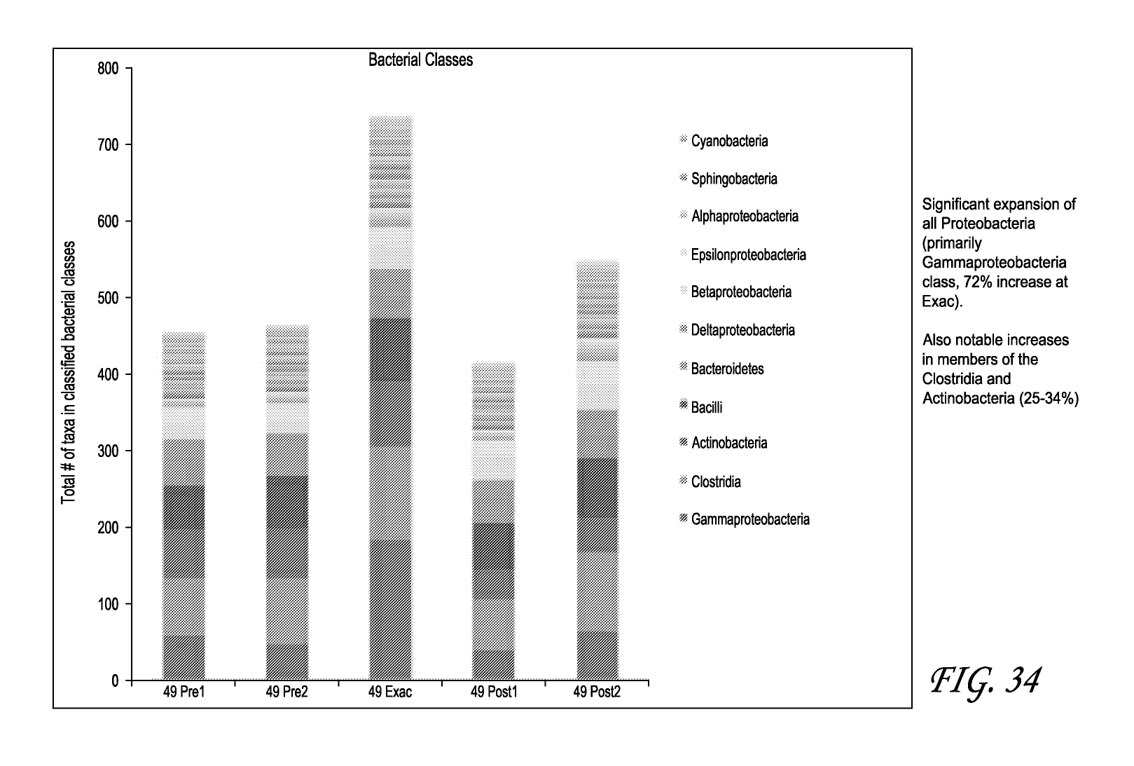

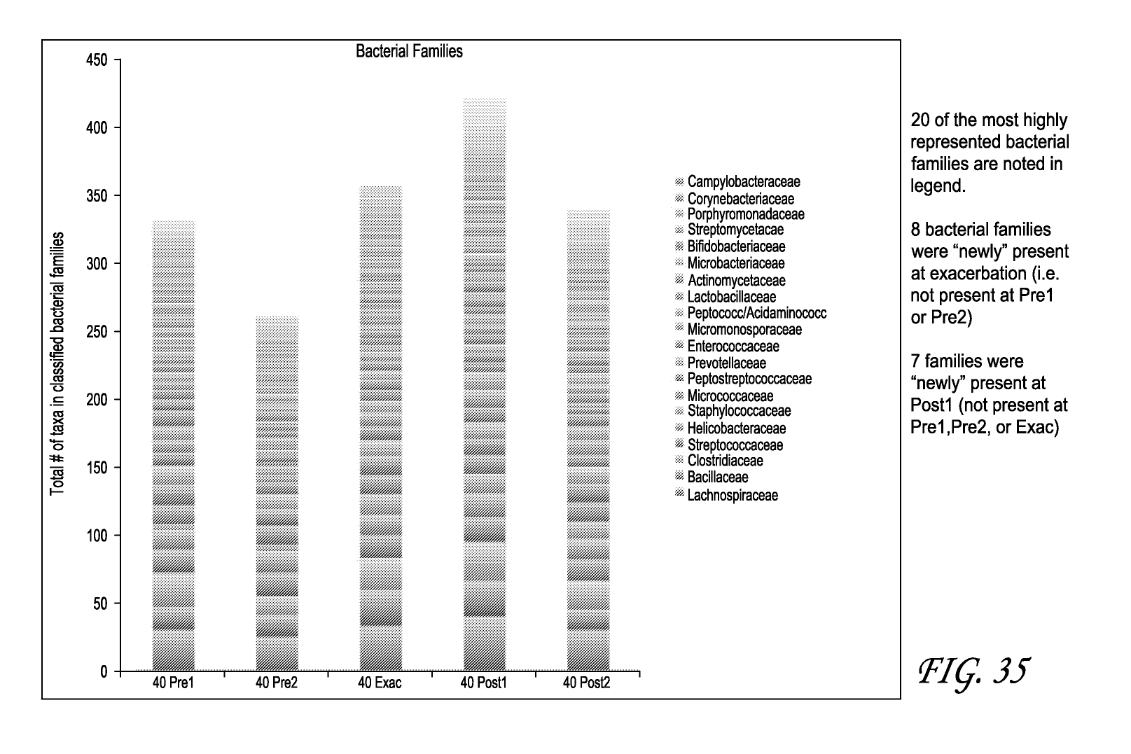

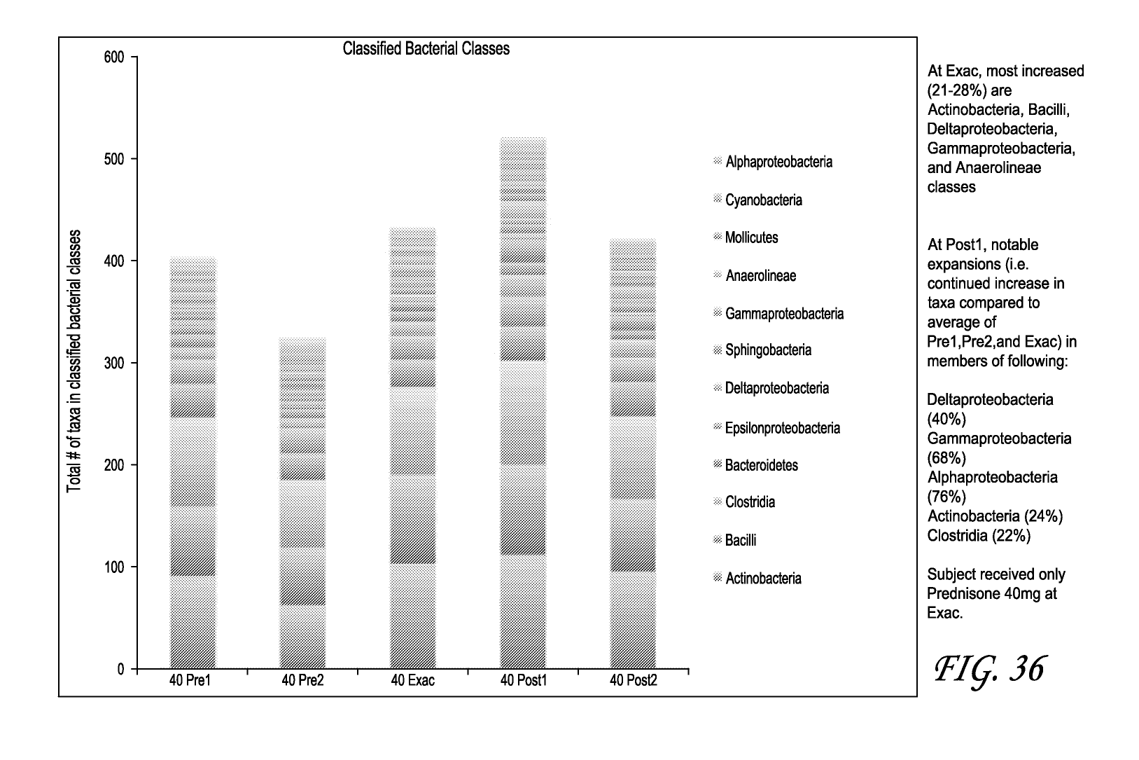

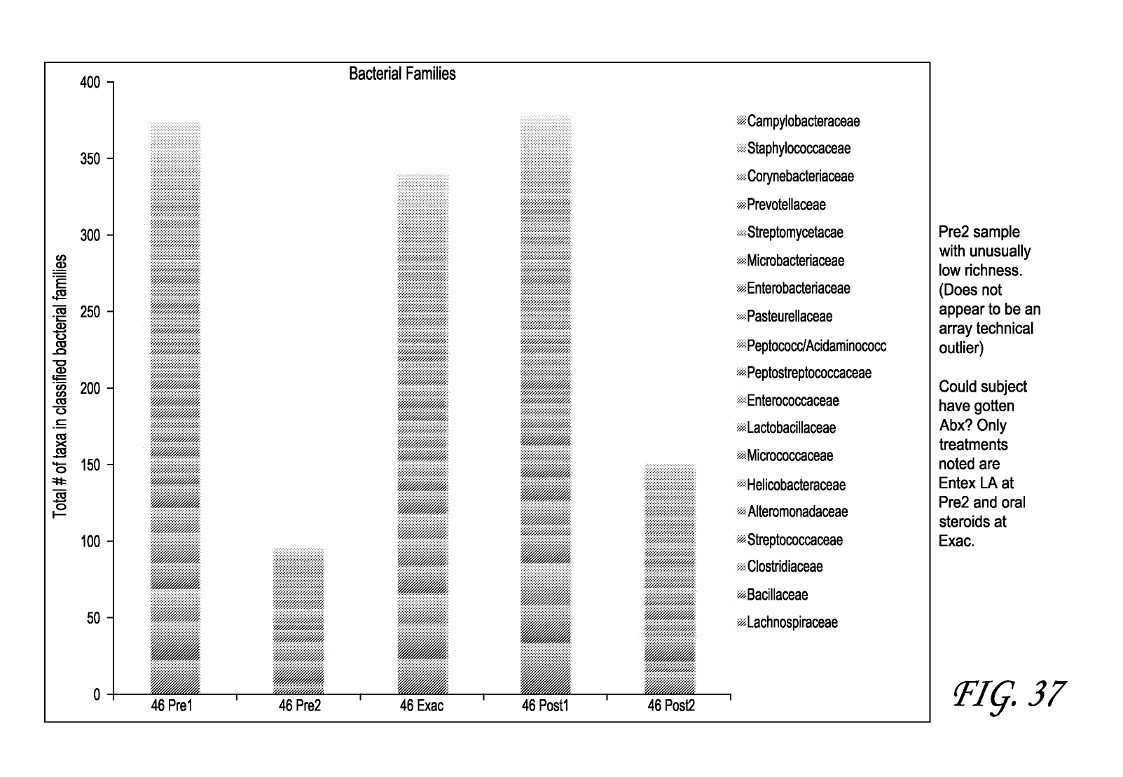

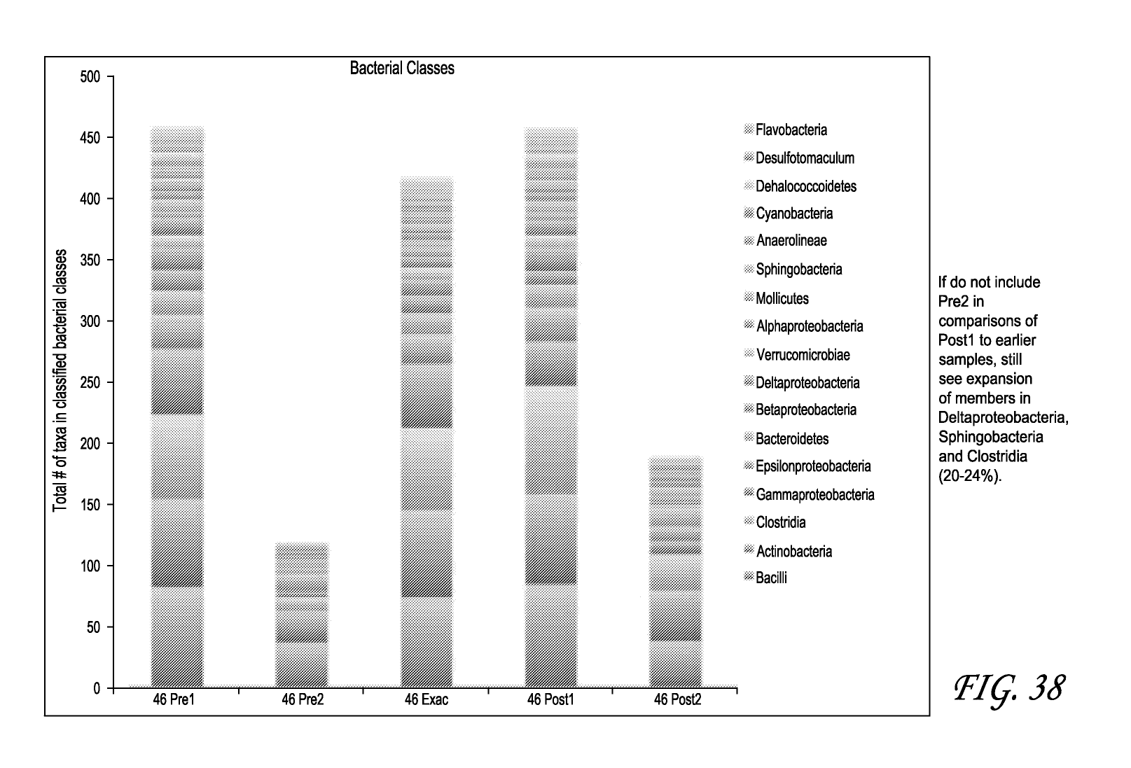

FIG. 20 illustrates a hierarchical cluster analysis of bacterial community composition across samples based on a Bray-Curtis distance metric of dissimilarities in community composition. Samples of subjects 40 and 46 are more closely clustered with themselves. Also illustrated is that samples taken from subject 3 and subject 49 during exacerbation of COPD (3Ex and 49Ex) have different community composition from the pre- and post-exacerbation samples from the respective subjects. In addition, Azithromycin treatment in subject 19 and subject 49 alters overall community composition, which is reflected by less closely-related post-exacerbation samples.

### Example 5

### Diagnosis of COPD using a Biosignature

In this example, methods and apparatus of the present invention are used to determine the biosignature and disease state of a subject having an unknown medical condition. A sample can be collected and nucleic acid extracted as described in Example 4. The sample is then tested for the presence, absence, and/or quanitity of OTUs using an array as described in Example 4. The resulting biosignature is then compared to biosignatures for numerous conditions, such as COPD exacerbation, such as a biosignature as determined in Example 4. Based on a comparison of the biosignatures, a clinician makes a diagnosis of healthy, exacerbated COPD, non-exacerbated COPD, or intermediate exacerbated COPD. Based on the diagnosis, and/or on the biosignature, the then prescribes a treatment for the condition, such as a therapeutic compound.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

TABLE 3
ALL BACTERIAL TAXA DETECTED BY 16S RRNA PHYLOCHIP IN AIRWAY SAMPLES OF COPD PATIENTS BEING TREATED FOR SEVERE EXACERBATIONS

| Phylum | Class | Order | Family | S-F^{a} | Taxon ID^{b} | Representative species^{c} |
|---|---|---|---|---|---|---|
| Acidobacteria | Acidobacteria | Acidobacteriales | Acidobacteriaceae | sf_14 | 508 | uranium mining waste pile clone JG37-AG-81 sp. |
| Acidobacteria | Acidobacteria | Acidobacteriales | Acidobacteriaceae | sf_14 | 541 | uranium mill tailings soil sample clone GuBH2-AG-47 sp. |
| Acidobacteria | Acidobacteria | Acidobacteriales | Acidobacteriaceae | sf_14 | 209 | uranium mining waste pile clone JG37-AG-29 sp. |
| Acidobacteria | Acidobacteria | Acidobacteriales | Acidobacteriaceae | sf_14 | 6425 | Great Artesian Basin clone B27 |
| Acidobacteria | Acidobacteria | Acidobacteriales | Acidobacteriaceae | sf_14 | 6335 | forested wetland clone FW45 |
| Acidobacteria | Acidobacteria | Acidobacteriales | Acidobacteriaceae | sf_6 | 6345 | soil sample uranium mining waste pile near town Johanngeorgenstadt |
| | | | | | | clone JG36-TzT-77 bacterium |
| Acidobacteria | Acidobacteria | Acidobacteriales | Acidobacteriaceae | sf_14 | 6350 | soil isolate Ellin337 |
| Acidobacteria | Acidobacteria | Acidobacteriales | Acidobacteriaceae | sf_14 | 6356 | forested wetland clone FW47 |
| Acidobacteria | Acidobacteria | Acidobacteriales | Acidobacteriaceae | sf_6 | 6359 | PCE-contaminated site clone CLi114 |
| Acidobacteria | Acidobacteria | Acidobacteriales | Acidobacteriaceae | sf_6 | 6362 | grassland soil clone DA052 |
| Acidobacteria | Acidobacteria | Acidobacteriales | Acidobacteriaceae | sf_14 | 6366 | PCB-polluted soil clone WD228 |
| Acidobacteria | Acidobacteria | Acidobacteriales | Acidobacteriaceae | sf_14 | 6368 | soil clone UA2 |
| Acidobacteria | Acidobacteria | Acidobacteriales | Acidobacteriaceae | sf_14 | 6378 | Acidobacterium capsulatum |
| Acidobacteria | Acidobacteria | Acidobacteriales | Acidobacteriaceae | sf_14 | 6410 | |
| Acidobacteria | Acidobacteria | Acidobacteriales | Acidobacteriaceae | sf_14 | 6412 | acid mine drainage clone TRB82 |
| Acidobacteria | Acidobacteria | Acidobacteriales | Acidobacteriaceae | sf_16 | 6414 | PCE-contaminated site clone CLs73 |
| Acidobacteria | Acidobacteria | Acidobacteriales | Acidobacteriaceae | sf_14 | 6421 | PCB-polluted soil clone WD217 |
| Acidobacteria | Acidobacteria | Acidobacteriales | Acidobacteriaceae | sf_6 | 6423 | coal effluent wetland clone FW92 |
| Acidobacteria | Acidobacteria | Acidobacteriales | Acidobacteriaceae | sf_14 | 6424 | sphagnum peat bog clone K-5b10 |
| Acidobacteria | Unclassified | Unclassified | Unclassified | sf_1 | 572 | forested wetland clone FW144 |
| Acidobacteria | Acidobacteria-4 | Ellin6075/11-25 | Unclassified | sf_1 | 435 | anaerobic VC-degrading enrichment clone VC47 bacterium |
| Acidobacteria | Acidobacteria-5 | Unclassified | Unclassified | sf_1 | 523 | soil metagenomic library clone 17F9 |
| Acidobacteria | Acidobacteria-4 | Ellin6075/11-25 | Unclassified | sf_1 | 790 | soil clone 11-25 |
| Acidobacteria | Acidobacteria-4 | Ellin6075/11-25 | Unclassified | sf_1 | 87 | activated sludge clone 2951 |
| Acidobacteria | Acidobacteria-6 | Unclassified | Unclassified | sf_1 | 350 | Mammoth cave clone CCM15a |
| Acidobacteria | Acidobacteria-6 | Unclassified | Unclassified | sf_1 | 897 | Mammoth cave clone CCM8b |
| Acidobacteria | Acidobacteria-6 | Unclassified | Unclassified | sf_1 | 1049 | soil clone C112 |
| Acidobacteria | Solibacteres | Unclassified | Unclassified | sf_1 | 6426 | Great Artesian Basin clone B11 |
| Acidobacteria | Acidobacteria-4 | Unclassified | Unclassified | sf_1 | 6363 | soil clone 32-11 |
| Acidobacteria | Unclassified | Unclassified | Unclassified | sf_1 | 4222 | forested wetland clone FW105 |
| Actinobacteria | Actinobacteria | Acidimicrobiales | Acidimicrobiaceae | sf_1 | 1090 | |
| Actinobacteria | Actinobacteria | Acidimicrobiales | Acidimicrobiaceae | sf_1 | 1749 | forest soil clone DUNssu275 (-3A) (OTU#188) |
| Actinobacteria | Actinobacteria | Acidimicrobiales | Acidimicrobiaceae | sf_1 | 1856 | forested wetland clone RCP2-105 |
| Actinobacteria | Actinobacteria | Acidimicrobiales | Acidimicrobiaceae | sf_1 | 1360 | forested wetland clone RCP2-103 |
| Actinobacteria | Actinobacteria | Actinomycetales | Acidothermaceae | sf_1 | 1399 | uranium mill tailings clone Gitt-KF-183 |
| Actinobacteria | Actinobacteria | Actinomycetales | Actinomycetaceae | sf_1 | 1684 | Varibaculum cambriense str. CCUG 44998 |
| Actinobacteria | Actinobacteria | Actinomycetales | Actinomycetaceae | sf_1 | 1227 | Actinomyces naeslundii |
| Actinobacteria | Actinobacteria | Actinomycetales | Actinomycetaceae | sf_1 | 1672 | Actinomyces odontolyticus str. CCUG 28084 |
| Actinobacteria | Actinobacteria | Actinomycetales | Actinosynnemataceae | sf_1 | 1463 | Saccharothrix texasensis str. NRRL B-16107T |
| Actinobacteria | Actinobacteria | Bifidobacteriales | Bifidobacteriaceae | sf_1 | 1351 | Bifidobacterium psychraerophilum str. T16 |
| Actinobacteria | Actinobacteria | Bifidobacteriales | Bifidobacteriaceae | sf_1 | 1967 | Bifidobacterium pseudocatenulatum str. JCM1200 |
| Actinobacteria | Actinobacteria | Bifidobacteriales | Bifidobacteriaceae | sf_1 | 2040 | Bifidobacterium adolescentis str. E-981074T |
| Actinobacteria | Actinobacteria | Bifidobacteriales | Bifidobacteriaceae | sf_1 | 1109 | Bifidobacterium thermacidophilum porcinum subsp. suis |
| | | | | | | str. P3-14 subsp. |
| Actinobacteria | Actinobacteria | Bifidobacteriales | Bifidobacteriaceae | sf_1 | 1987 | human subgingival plaque clone CX010 |
| Actinobacteria | Actinobacteria | Bifidobacteriales | Bifidobacteriaceae | sf_1 | 1444 | Bifidobacteriaceae genomosp. C1 |
| Actinobacteria | Actinobacteria | Bifidobacteriales | Bifidobacteriaceae | sf_1 | 1835 | Bifidobacterium breve str. KB 92 |
| Actinobacteria | Actinobacteria | Bifidobacteriales | Bifidobacteriaceae | sf_1 | 1875 | |
| Actinobacteria | Actinobacteria | Actinomycetales | Cellulomonadaceae | sf_1 | 1586 | Cellulomonas gelida str. DSM 20111T |
| Actinobacteria | Actinobacteria | Actinomycetales | Cellulomonadaceae | sf_1 | 1748 | Beutenbergia cavernosa str. DSM 12333 |
| Actinobacteria | Actinobacteria | Coriobacteriales | Coriobacteriaceae | sf_1 | 1258 | ground water deep-well injection disposal site |
| | | | | | | radioactive wastes Tomsk-7 clone S15A-MN25 |
| Actinobacteria | Actinobacteria | Coriobacteriales | Coriobacteriaceae | sf_1 | 1800 | ground water deep-well injection disposal site |
| | | | | | | radioactive wastes Tomsk-7 clone S15A-MN100 |
| Actinobacteria | Actinobacteria | Coriobacteriales | Coriobacteriaceae | sf_1 | 1958 | Atopobium vaginae VA14183_00 |
| Actinobacteria | Actinobacteria | Actinomycetales | Corynebacteriaceae | sf_1 | 1517 | Corynebacterium xerosis str. DSM 20743 |
| Actinobacteria | Actinobacteria | Actinomycetales | Corynebacteriaceae | sf_1 | 1492 | Corynebacterium tuscaniae str. ISS-5309 |
| Actinobacteria | Actinobacteria | Actinomycetales | Corynebacteriaceae | sf_1 | 1820 | Corynebacterium jeikeium str. ATCC 43734 |
| Actinobacteria | Actinobacteria | Actinomycetales | Corynebacteriaceae | sf_1 | 1089 | Corynebacterium mucifaciens National |
| | | | | | | Microbiology Laboratory Special identifier 01-0118 |
| Actinobacteria | Actinobacteria | Actinomycetales | Corynebacteriaceae | sf_1 | 1374 | |
| Actinobacteria | Actinobacteria | Actinomycetales | Corynebacteriaceae | sf_1 | 1428 | Corynebacterium simulans National Microbiology |
| | | | | | | Laboratory Special identifier 00-0186 |
| Actinobacteria | Actinobacteria | Actinomycetales | Corynebacteriaceae | sf_1 | 1493 | Corynebacterium tuberculostearicum str. CIP102346 |
| Actinobacteria | Actinobacteria | Actinomycetales | Corynebacteriaceae | sf_1 | 1803 | Corynebacterium spheniscorum str. CCUG 45512 |
| Actinobacteria | Actinobacteria | Actinomycetales | Dermabacteraceae | sf_1 | 2053 | Brachybacterium nesterenkovii str. DSM 9573 |
| Actinobacteria | Actinobacteria | Actinomycetales | Kineosporiaceae | sf_1 | 1598 | lichen-dominated Antarctic cryptoendolithic |
| | | | | | | community clone FBP402 |
| Actinobacteria | Actinobacteria | Actinomycetales | Kineosporiaceae | sf_1 | 1961 | Kineococcus aurantiacus str. IFO 15268 |
| Actinobacteria | Actinobacteria | Actinomycetales | Microbacteriaceae | sf_1 | 1667 | Microbacterium lacticum |
| Actinobacteria | Actinobacteria | Actinomycetales | Microbacteriaceae | sf_1 | 1197 | Arctic sea ice ARK10173 |
| Actinobacteria | Actinobacteria | Actinomycetales | Microbacteriaceae | sf_1 | 1437 | freshwater clone SV1-16 |
| Actinobacteria | Actinobacteria | Actinomycetales | Micrococcaceae | sf_1 | 1266 | Arthrobacter psychrolactophilus |
| Actinobacteria | Actinobacteria | Actinomycetales | Micrococcaceae | sf_1 | 1557 | Arthrobacter oxydans str. DSM 20119 |
| Actinobacteria | Actinobacteria | Actinomycetales | Micrococcaceae | sf_1 | 1593 | Arthrobacter globiformis |
| Actinobacteria | Actinobacteria | Actinomycetales | Micrococcaceae | sf_1 | 1610 | Arthrobacter sp str. AC-51 |
| Actinobacteria | Actinobacteria | Actinomycetales | Micrococcaceae | sf_1 | 1966 | TCE-contaminated site clone ccspost2208 |
| Actinobacteria | Actinobacteria | Actinomycetales | Micrococcaceae | sf_1 | 1324 | glacial ice isolate str. CanDirty1 |
| Actinobacteria | Actinobacteria | Actinomycetales | Micrococcaceae | sf_1 | 1494 | Arthrobacter agilis str. DSM 20550 |
| Actinobacteria | Actinobacteria | Actinomycetales | Micrococcaceae | sf_1 | 1573 | Arthrobacter nicotianae str. SB42 |
| Actinobacteria | Actinobacteria | Actinomycetales | Micrococcaceae | sf_1 | 1889 | Citricoccus sp. str. 2216.25.22 |
| Actinobacteria | Actinobacteria | Actinomycetales | Micrococcaceae | sf_1 | 2019 | Micrococcus luteus str. HN2-11 |
| Actinobacteria | Actinobacteria | Actinomycetales | Micrococcaceae | sf_1 | 1724 | Rothia mucilaginosa str. DSM |
| Actinobacteria | Actinobacteria | Actinomycetales | Micrococcaceae | sf_1 | 2020 | Rothia dentocariosa str. ChDC B200 |
| Actinobacteria | Actinobacteria | Actinomycetales | Micrococcaceae | sf_1 | 2063 | Rothia dentocariosa str. ATCC 17931 |
| Actinobacteria | Actinobacteria | Actinomycetales | Micrococcaceae | sf_1 | 1213 | Kocuria roseus |
| Actinobacteria | Actinobacteria | Actinomycetales | Micromonosporaceae | sf_1 | 1876 | Couchioplanes subsp. caeruleus str. IFO13939 |
| Actinobacteria | Actinobacteria | Actinomycetales | Mycobacteriaceae | sf_1 | 1175 | Mycobacterium cf. xenopi ‘Hymi_Wue Tb_939/99’ str. |
| | | | | | | Hymi_Wue Tb_939/99 |
| Actinobacteria | Actinobacteria | Actinomycetales | Mycobacteriaceae | sf_1 | 1262 | Mycobacterium holsaticum str. 1406 |
| Actinobacteria | Actinobacteria | Actinomycetales | Mycobacteriaceae | sf_1 | 1308 | Mycobacterium pyrenivorans str. DSM 44605 |
| Actinobacteria | Actinobacteria | Actinomycetales | Mycobacteriaceae | sf_1 | 1365 | Mycobacterium chelonae str. CIP 104535T |
| Actinobacteria | Actinobacteria | Actinomycetales | Mycobacteriaceae | sf_1 | 1650 | Mycobacterium tuberculosis str. NCTC 7416 H37Rv |
| Actinobacteria | Actinobacteria | Actinomycetales | Mycobacteriaceae | sf_1 | 1726 | Mycobacterium terrae str. ATCC 15755 |
| Actinobacteria | Actinobacteria | Actinomycetales | Nocardiaceae | sf_1 | 1834 | Nocardia transvalensis str. DSM 43405 |
| Actinobacteria | Actinobacteria | Actinomycetales | Nocardiopsaceae | sf_1 | 1385 | Streptomonospora salina str. YIM90002 |
| Actinobacteria | Actinobacteria | Actinomycetales | Promicromonosporaceae | sf_1 | 1671 | Cellulosimicrobium cellulans str. NCIMB 11025 |
| Actinobacteria | Actinobacteria | Actinomycetales | Promicromonosporaceae | sf_1 | 1711 | Promicromonospora sukumoe str. DSM 44121 |
| Actinobacteria | Actinobacteria | Actinomycetales | Pseudonocardiaceae | sf_1 | 1863 | |
| Actinobacteria | Actinobacteria | Actinomycetales | Pseudonocardiaceae | sf_1 | 1343 | Saccharomonospora azurea str. M. Goodfel |
| | | | | | | K161 = NA128 (type st |
| Actinobacteria | Actinobacteria | Rubrobacterales | Rubrobacteraceae | sf_1 | 1551 | soil isolate Ellin301 |
| Actinobacteria | Actinobacteria | Rubrobacterales | Rubrobacteraceae | sf_1 | 1739 | |
| Actinobacteria | Actinobacteria | Rubrobacterales | Rubrobacteraceae | sf_1 | 1843 | uranium mining waste pile soil sample clone |
| | | | | | | JG30-KF-A23 |
| Actinobacteria | Actinobacteria | Actinomycetales | Sporichthyaceae | sf_1 | 1695 | lichen-dominated Antarctic cryptoendolithic |
| | | | | | | community clone FBP417 |
| Actinobacteria | Actinobacteria | Actinomycetales | Streptosporangiaceae | sf_1 | 1190 | Nonomuraea polychroma str. IFO 14345 |
| Actinobacteria | Actinobacteria | Actinomycetales | Thermomonosporaceae | sf_1 | 1741 | Actinomadura pelletieri str. IMSNU 22169T |
| Actinobacteria | Actinobacteria | Actinomycetales | Thermomonosporaceae | sf_1 | 1546 | Actinomadura fulvescens str. DSM 43923T |
| Actinobacteria | Actinobacteria | Unclassified | Unclassified | sf_2 | 1233 | |
| Actinobacteria | Actinobacteria | Unclassified | Unclassified | sf_1 | 1898 | termite gut homogenate clone Rs-J10 bacterium |
| Actinobacteria | Actinobacteria | Unclassified | Unclassified | sf_1 | 1367 | |
| Actinobacteria | Actinobacteria | Unclassified | Unclassified | sf_1 | 1370 | forested wetland clone RCP1-37 |
| Actinobacteria | Actinobacteria | Acidimicrobiales | Unclassified | sf_1 | 1666 | |
| Actinobacteria | Actinobacteria | Actinomycetales | Unclassified | sf_4 | 1337 | Sturt arid-zone soil clone #0425-2M17 |
| Actinobacteria | Actinobacteria | Actinomycetales | Unclassified | sf_3 | 1486 | deep marine sediment clone MB-A2-108 |
| Actinobacteria | Actinobacteria | Unclassified | Unclassified | sf_1 | 1676 | |
| Actinobacteria | Actinobacteria | Acidimicrobiales | Unclassified | sf_1 | 1217 | DCP-dechlorinating consortium clone SHA-34 |
| Actinobacteria | BD2-10 group | Unclassified | Unclassified | sf_2 | 1652 | marine sediment clone Bol7 |
| Actinobacteria | Actinobacteria | Actinomycetales | Unclassified | sf_3 | 2045 | hypersaline lake clone ML602J-44 |
| Actinobacteria | Actinobacteria | Actinomycetales | Unclassified | sf_3 | 1130 | Georgenia muralis str. 1A-C |
| Actinobacteria | Actinobacteria | Actinomycetales | Unclassified | sf_3 | 1687 | Jonesia quinghaiensis str. DSM 15701 |
| Actinobacteria | Actinobacteria | Actinomycetales | Unclassified | sf_3 | 1243 | termite gut homogenate clone Rs-M95 bacterium |
| Actinobacteria | Actinobacteria | Actinomycetales | Unclassified | sf_3 | 1577 | termite gut homogenate clone Rs-N91 bacterium |
| Actinobacteria | Actinobacteria | Actinomycetales | Unclassified | sf_3 | 1405 | Arthrobacter ureafaciens str. DSM 20126 |
| AD3 | Unclassified | Unclassified | Unclassified | sf_1 | 2338 | uranium mining waste pile soil clone |
| | | | | | | JG30-KF-C12 |
| Bacteroidetes | Bacteroidetes | Bacteroidales | Bacteroidaceae | sf_12 | 5256 | termite gut homogenate clone Rs-D38 bacterium |
| Bacteroidetes | Bacteroidetes | Bacteroidales | Bacteroidaceae | sf_12 | 5320 | Bacteroides distasonis |
| Bacteroidetes | Bacteroidetes | Bacteroidales | Bacteroidaceae | sf_12 | 5474 | Bacteroides acidofaciens str.A24 |
| Bacteroidetes | Bacteroidetes | Bacteroidales | Bacteroidaceae | sf_12 | 5551 | Bacteroides uniformis |
| Bacteroidetes | Bacteroidetes | Bacteroidales | Bacteroidaceae | sf_12 | 5979 | Bacteroides fragilis str. YCH46 |
| Bacteroidetes | Flavobacteria | Flavobacteriales | Blattabacteriaceae | sf_1 | 5828 | Blattabacterium species |
| Bacteroidetes | Sphingobacteria | Sphingobacteriales | Crenotrichaceae | sf_11 | 5334 | autotrophic nitrifying biofilm clone NB-11 |
| Bacteroidetes | Sphingobacteria | Sphingobacteriales | Crenotrichaceae | sf_11 | 5619 | anaerobic VC-degrading enrichment clone VC10 bacterium |
| Bacteroidetes | Sphingobacteria | Sphingobacteriales | Crenotrichaceae | sf_11 | 5888 | penguin droppings sediments clone KD9-169 |
| Bacteroidetes | Sphingobacteria | Sphingobacteriales | Crenotrichaceae | sf_11 | 6123 | Flexibacter japonensis str. IFO 16041 |
| Bacteroidetes | Sphingobacteria | Sphingobacteriales | Crenotrichaceae | sf_11 | 6267 | Cilia-respiratory isolate str. 243-54 |
| Bacteroidetes | Sphingobacteria | Sphingobacteriales | Crenotrichaceae | sf_11 | 6249 | Haliscomenobacter hydrossis |
| Bacteroidetes | Sphingobacteria | Sphingobacteriales | Flammeovirgaceae | sf_5 | 6084 | Microscilla arenaria str. IFO 15982 |
| Bacteroidetes | Flavobacteria | Flavobacteriales | Flavobacteriaceae | sf_1 | 6079 | synonym: CFB group clone APe4_42 |
| Bacteroidetes | Flavobacteria | Flavobacteriales | Flavobacteriaceae | sf_1 | 5367 | patient's bronchoalveolar lavage isolate str. |
| | | | | | | MDA2507 sp. |
| Bacteroidetes | Flavobacteria | Flavobacteriales | Flavobacteriaceae | sf_1 | 5915 | groundwater deep-well injection disposal site |
| | | | | | | radioactive wastes Tomsk-7 clone S15A-MN27 |
| | | | | | | bacterium |
| Bacteroidetes | Flavobacteria | Flavobacteriales | Flavobacteriaceae | sf_1 | 5997 | Flavobacterium aquatile |
| Bacteroidetes | Flavobacteria | Flavobacteriales | Flavobacteriaceae | sf_1 | 6274 | |
| Bacteroidetes | Flavobacteria | Flavobacteriales | Flavobacteriaceae | sf_1 | 5317 | Tenacibaculum maritimum str. IFO 15946 |
| Bacteroidetes | Flavobacteria | Flavobacteriales | Flavobacteriaceae | sf_1 | 5991 | Tenacibaculum ovolyticum str. IAM14318 |
| Bacteroidetes | Flavobacteria | Flavobacteriales | Flavobacteriaceae | sf_1 | 6252 | Riftia pachyptila's tube clone R103-B20 |
| Bacteroidetes | Flavobacteria | Flavobacteriales | Flavobacteriaceae | sf_1 | 5263 | subgingival plaque clone DZ074 |
| Bacteroidetes | Flavobacteria | Flavobacteriales | Flavobacteriaceae | sf_1 | 5401 | Capnocytophaga gingivalis str. ChDC OS45 |
| Bacteroidetes | Flavobacteria | Flavobacteriales | Flavobacteriaceae | sf_1 | 5836 | Capnocytophaga granulosa str. LMG 12119; FDC |
| | | | | | | SD4 |
| Bacteroidetes | Flavobacteria | Flavobacteriales | Flavobacteriaceae | sf_1 | 5423 | Aequorivita antarctica str. QSSC9-14 |
| Bacteroidetes | Flavobacteria | Flavobacteriales | Flavobacteriaceae | sf_1 | 5942 | |
| Bacteroidetes | Flavobacteria | Flavobacteriales | Flavobacteriaceae | sf_1 | 5955 | Flavobacterium sp. str. V4.MS.29 = MM_2747 |
| Bacteroidetes | Flavobacteria | Flavobacteriales | Flavobacteriaceae | sf_1 | 5971 | Cytophaga uliginosa |
| Bacteroidetes | Flavobacteria | Flavobacteriales | Flavobacteriaceae | sf_1 | 5436 | Arctic sea ice ARK10004 |
| Bacteroidetes | Flavobacteria | Flavobacteriales | Flavobacteriaceae | sf_1 | 5473 | |
| Bacteroidetes | Flavobacteria | Flavobacteriales | Flavobacteriaceae | sf_1 | 5267 | bacterioplankton clone AEGEAN_179 |
| Bacteroidetes | Flavobacteria | Flavobacteriales | Flavobacteriaceae | sf_1 | 5914 | Psychroserpens burtonensis str. S2-64 |
| Bacteroidetes | Sphingobacteria | Sphingobacteriales | Flexibacteraceae | sf_19 | 5563 | Cytophaga sp. I-545 |
| Bacteroidetes | Sphingobacteria | Sphingobacteriales | Flexibacteraceae | sf_19 | 5542 | Cytophaga sp. I-1787 |
| Bacteroidetes | Sphingobacteria | Sphingobacteriales | Flexibacteraceae | sf_19 | 5307 | Microscilla sericea str. IFO 16561 |
| Bacteroidetes | Sphingobacteria | Sphingobacteriales | Flexibacteraceae | sf_19 | 5357 | Flexibacter tuber str. IFO 16677 |
| Bacteroidetes | Sphingobacteria | Sphingobacteriales | Flexibacteraceae | sf_19 | 5372 | |
| Bacteroidetes | Sphingobacteria | Sphingobacteriales | Flexibacteraceae | sf_19 | 5566 | Hongiella mannitolivorans str. IMSNU 14012 JC2050 |
| Bacteroidetes | Sphingobacteria | Sphingobacteriales | Flexibacteraceae | sf_19 | 5667 | penguin droppings sediments clone KD6-118 |
| Bacteroidetes | Sphingobacteria | Sphingobacteriales | Flexibacteraceae | sf_19 | 5994 | Hymenobacter sp. str. NS/50 |
| Bacteroidetes | Sphingobacteria | Sphingobacteriales | Flexibacteraceae | sf_19 | 6124 | Flexibacter flexilis subsp. pelliculosus str. IFO |
| | | | | | | 16028 subsp. |
| Bacteroidetes | Sphingobacteria | Sphingobacteriales | Flexibacteraceae | sf_19 | 6297 | EBPR sludge lab scale clone HP1A92 |
| Bacteroidetes | Sphingobacteria | Sphingobacteriales | Flexibacteraceae | sf_20 | 10311 | Cytophaga sp. str. BHI60-57B |
| Bacteroidetes | Bacteroidetes | Bacteroidales | Porphyromonadaceae | sf_1 | 5295 | swine intestine clone p-987-s962-5 |
| Bacteroidetes | Bacteroidetes | Bacteroidales | Porphyromonadaceae | sf_1 | 5680 | termite gut clone Rs-106 |
| Bacteroidetes | Bacteroidetes | Bacteroidales | Porphyromonadaceae | sf_1 | 5800 | Porphyromonas endodontalis str. ATCC 35406 |
| Bacteroidetes | Bacteroidetes | Bacteroidales | Porphyromonadaceae | sf_1 | 5817 | termite gut homogenate clone Rs-N56 bacterium |
| Bacteroidetes | Bacteroidetes | Bacteroidales | Porphyromonadaceae | sf_1 | 5961 | chlorobenzene-degrading consortium clone |
| | | | | | | IA-16 |
| Bacteroidetes | Bacteroidetes | Bacteroidales | Porphyromonadaceae | sf_1 | 5454 | Dysgonomonas wimpennyi str. ANFA2 |
| Bacteroidetes | Bacteroidetes | Bacteroidales | Porphyromonadaceae | sf_1 | 5510 | sphagnum peat bog clone 26-4b2 |
| Bacteroidetes | Bacteroidetes | Bacteroidales | Porphyromonadaceae | sf_1 | 6012 | mouse feces clone L11-6 |
| Bacteroidetes | Bacteroidetes | Bacteroidales | Porphyromonadaceae | sf_1 | 5460 | mouse feces clone F8 |
| Bacteroidetes | Bacteroidetes | Bacteroidales | Prevotellaceae | sf_1 | 5718 | Prevotella tannerae str. 29-1 |
| Bacteroidetes | Bacteroidetes | Bacteroidales | Prevotellaceae | sf_1 | 5437 | cow rumen clone BE1 |
| Bacteroidetes | Bacteroidetes | Bacteroidales | Prevotellaceae | sf_1 | 5916 | cow rumen clone BE14 |
| Bacteroidetes | Bacteroidetes | Bacteroidales | Prevotellaceae | sf_1 | 6011 | rumen clone F24-B03 |
| Bacteroidetes | Bacteroidetes | Bacteroidales | Prevotellaceae | sf_1 | 6152 | rumen clone RF37 |
| Bacteroidetes | Bacteroidetes | Bacteroidales | Prevotellaceae | sf_1 | 6259 | |
| Bacteroidetes | Bacteroidetes | Bacteroidales | Prevotellaceae | sf_1 | 5249 | Prevotella denticola str. ATCC 35308 |
| Bacteroidetes | Bacteroidetes | Bacteroidales | Prevotellaceae | sf_1 | 5484 | oral periodontitis clone FX046 |
| Bacteroidetes | Bacteroidetes | Bacteroidales | Prevotellaceae | sf_1 | 5706 | oral cavity clone 3.3 |
| Bacteroidetes | Bacteroidetes | Bacteroidales | Prevotellaceae | sf_1 | 5769 | Bacteroidaceae str. A42 |
| Bacteroidetes | Bacteroidetes | Bacteroidales | Prevotellaceae | sf_1 | 5905 | swine intestine clone p-2443-18B5 |
| Bacteroidetes | Bacteroidetes | Bacteroidales | Prevotellaceae | sf_1 | 5940 | Prevotella sp. str. E7_34 |
| Bacteroidetes | Bacteroidetes | Bacteroidales | Prevotellaceae | sf_1 | 5946 | tongue dorsa clone DO027 |
| Bacteroidetes | Bacteroidetes | Bacteroidales | Prevotellaceae | sf_1 | 6047 | deep marine sediment clone MB-A2-107 |
| Bacteroidetes | Bacteroidetes | Bacteroidales | Prevotellaceae | sf_1 | 6239 | tongue dorsa clone DO033 |
| Bacteroidetes | Bacteroidetes | Bacteroidales | Rikenellaceae | sf_5 | 5892 | anoxic bulk soil flooded rice microcosm clone BSV73 |
| Bacteroidetes | Sphingobacteria | Sphingobacteriales | Sphingobacteriaceae | sf_1 | 5513 | crevicular epithelial cells clone AZ123 |
| Bacteroidetes | Sphingobacteria | Sphingobacteriales | Sphingobacteriaceae | sf_1 | 5913 | Sphingobacteriaceae str. Ellin160 |
| Bacteroidetes | Bacteroidetes | Bacteroidales | Unclassified | sf_15 | 5573 | termite gut homogenate clone Rs-D44 bacterium |
| Bacteroidetes | Sphingobacteria | Sphingobacteriales | Unclassified | sf_6 | 5439 | Mono Lake at depth 35 m station 6 Jul. 2000 |
| | | | | | | clone ML635J-40 bacterium |
| Bacteroidetes | Bacteroidetes | Bacteroidales | Unclassified | sf_15 | 5475 | SHA-25 clone |
| Bacteroidetes | Bacteroidetes | Bacteroidales | Unclassified | sf_15 | 5544 | marine? clone KD3-17 |
| Bacteroidetes | Bacteroidetes | Bacteroidales | Unclassified | sf_15 | 5783 | Mono Lake at depth 35 m station 6 Jul. 2000 |
| | | | | | | clone ML635J-15 bacterium |
| Bacteroidetes | Bacteroidetes | Bacteroidales | Unclassified | sf_15 | 5874 | Paralvinella palmiformis mucus secretions clone |
| | | | | | | P. palm 53 bacterium |
| Bacteroidetes | Bacteroidetes | Bacteroidales | Unclassified | sf_15 | 5890 | penguin droppings sediments clone KD1-125 |
| Bacteroidetes | Bacteroidetes | Bacteroidales | Unclassified | sf_15 | 6046 | chlorobenzene-degrading consortium clone |
| | | | | | | IIIB-1 |
| Bacteroidetes | Bacteroidetes | Bacteroidales | Unclassified | sf_15 | 5820 | cow rumen clone BF24 |
| Bacteroidetes | Unclassified | Unclassified | Unclassified | sf_1 | 5745 | |
| Bacteroidetes | Flavobacteria | Flavobacteriales | Unclassified | sf_3 | 5248 | Delaware River estuary clone 1G12 |
| Bacteroidetes | Bacteroidetes | Bacteroidales | Unclassified | sf_15 | 5355 | DCP-dechlorinating consortium clone SHA-5 |
| Bacteroidetes | Bacteroidetes | Bacteroidales | Unclassified | sf_15 | 5481 | marine sediment above hydrate ridge clone |
| | | | | | | Hyd89-72 bacterium |
| Bacteroidetes | Unclassified | Unclassified | Unclassified | sf_4 | 5703 | |
| Bacteroidetes | Unclassified | Unclassified | Unclassified | sf_4 | 5785 | Mono Lake at depth 35 m station 6 Jul. 2000 |
| | | | | | | clone ML635J-56 |
| Bacteroidetes | Unclassified | Unclassified | Unclassified | sf_4 | 5787 | Mono Lake at depth 35 m station 6 Jul. 2000 |
| | | | | | | clone ML635J-1 bacterium |
| Bacteroidetes | Bacteroidetes | Bacteroidales | Unclassified | sf_15 | 5957 | Paralvinella palmiformis mucus secretions clone |
| | | | | | | P. palm C/20 bacterium |
| Bacteroidetes | Bacteroidetes | Bacteroidales | Unclassified | sf_15 | 6324 | temperate estuarine mud clone KM02 |
| Bacteroidetes | Sphingobacteria | Sphingobacteriales | Unclassified | sf_3 | 6168 | Toolik Lake main station at 3 m depth clone |
| | | | | | | TLM11/TLMdgge04 |
| Bacteroidetes | KSA1 | Unclassified | Unclassified | sf_1 | 5951 | CFB group clone ML615J-4 |
| Bacteroidetes | Sphingobacteria | Sphingobacteriales | Unclassified | sf_3 | 6298 | travertine hot spring clone SM1C04 |
| BRC1 | Unclassified | Unclassified | Unclassified | sf_2 | 118 | penguin droppings sediments clone KD1-1 |
| BRC1 | Unclassified | Unclassified | Unclassified | sf_1 | 5051 | soil clone PBS-III-24 |
| BRC1 | Unclassified | Unclassified | Unclassified | sf_1 | 5143 | soil clone PBS-II-1 |
| Caldithrix | Unclassified | Caldithrales | Caldithraceae | sf_2 | 91 | benzoate-degrading consortium clone BA059 |
| Caldithrix | Unclassified | Caldithrales | Caldithraceae | sf_1 | 2384 | saltmarsh clone LCP-89 |
| Chlamydiae | Chlamydiae | Chlamydiales | Chlamydiaceae | sf_1 | 4820 | Chlamydophila pneumoniae str. AR39 |
| Chlamydiae | Chlamydiae | Chlamydiales | Parachlamydiaceae | sf_1 | 4964 | neutral pH mine biofilm clone 44a-B1-34 |
| Chlorobi | Chlorobia | Chlorobiales | Chlorobiaceae | sf_1 | 262 | Chlorobium ferrooxidans DSM 13031 str. KofoX |
| Chlorobi | Chlorobia | Chlorobiales | Chlorobiaceae | sf_1 | 859 | Chlorobium phaeovibrioides str. 2631 |
| Chlorobi | Chlorobia | Chlorobiales | Chlorobiaceae | sf_1 | 995 | Chlorobium limicola str. M1 |
| Chlorobi | Unclassified | Unclassified | Unclassified | sf_8 | 5822 | Saltmarsh mud clone K-790 |
| Chlorobi | Unclassified | Unclassified | Unclassified | sf_6 | 5294 | Mammoth cave clone CCM9b |
| Chlorobi | Unclassified | Unclassified | Unclassified | sf_9 | 6146 | sludge clone A12b |
| Chlorobi | Unclassified | Unclassified | Unclassified | sf_8 | 549 | benzene-degrading nitrate-reducing consortium |
| | | | | | | clone Cart-N2 bacterium |
| Chlorobi | Unclassified | Unclassified | Unclassified | sf_8 | 636 | benzene-degrading nitrate-reducing consortium |
| | | | | | | clone Cart-N3 bacterium |
| Chloroflexi | Thermomicrobia | Unclassified | Unclassified | sf_1 | 1041 | Antarctic cryptoendolith clone FBP471 |
| Chloroflexi | Unclassified | Unclassified | Unclassified | sf_2 | 818 | |
| Chloroflexi | Unclassified | Unclassified | Unclassified | sf_5 | 1051 | forest soil clone DUNssu055 (-2B) (OTU#087) |
| Chloroflexi | Anaerolineae | Chloroflexi-1a | Unclassified | sf_1 | 927 | Paralvinella palmiformis mucus secretions clone |
| | | | | | | P. palm C 37 bacterium |
| Chloroflexi | Thermomicrobia | Unclassified | Unclassified | sf_2 | 652 | uranium mining waste pile soil sample clone |
| | | | | | | JG30-KF-CM45 |
| Chloroflexi | Anaerolineae | Chloroflexi-1a | Unclassified | sf_1 | 106 | DCP-dechlorinating consortium clone SHD-231 |
| Chloroflexi | Anaerolineae | Unclassified | Unclassified | sf_9 | 375 | forest soil clone C043 |
| Chloroflexi | Anaerolineae | Chloroflexi-1a | Unclassified | sf_1 | 487 | thermophilic UASB granular sludge isolate str. |
| | | | | | | IMO-1 bacterium |
| Chloroflexi | Anaerolineae | Unclassified | Unclassified | sf_9 | 576 | DCP-dechlorinating consortium clone SHA-36 |
| Chloroflexi | Anaerolineae | Chloroflexi-1a | Unclassified | sf_1 | 583 | anaerobic bioreactor clone SHD-238 |
| Chloroflexi | Anaerolineae | Unclassified | Unclassified | sf_9 | 72 | sediments collected at Charon's Cascade near |
| | | | | | | Echo River October 2000 clone CCD21 |
| Chloroflexi | Anaerolineae | Unclassified | Unclassified | sf_9 | 727 | forest soil clone S0208 |
| Chloroflexi | Unclassified | Unclassified | Unclassified | sf_7 | 757 | DCP-dechlorinating consortium clone SHA-8 |
| Chloroflexi | Anaerolineae | Chloroflexi-1a | Unclassified | sf_1 | 76 | DCP-dechlorinating consortium clone SHA-147 |
| Chloroflexi | Anaerolineae | Chloroflexi-1b | Unclassified | sf_2 | 789 | travertine hot spring clone SM1D10 |
| Chloroflexi | Anaerolineae | Unclassified | Unclassified | sf_9 | 946 | temperate estuarine mud clone KM87 |
| Chloroflexi | Dehalococcoidetes | Unclassified | Unclassified | sf_1 | 2339 | uranium mill tailings soil sample clone |
| | | | | | | Sh765B-TzT-20 bacterium |
| Chloroflexi | Dehalococcoidetes | Unclassified | Unclassified | sf_1 | 2367 | deep marine sediment clone MB-B2-113 |
| Chloroflexi | Dehalococcoidetes | Unclassified | Unclassified | sf_1 | 2438 | deep marine sediment clone MB-A2-110 |
| Chloroflexi | Dehalococcoidetes | Unclassified | Unclassified | sf_1 | 2445 | deep marine sediment clone MB-A2-103 |
| Chloroflexi | Dehalococcoidetes | Unclassified | Unclassified | sf_1 | 2485 | |
| Chloroflexi | Dehalococcoidetes | Unclassified | Unclassified | sf_1 | 2497 | forested wetland clone FW60 |
| Chloroflexi | Unclassified | Unclassified | Unclassified | sf_12 | 2523 | sponge clone TK10 |
| Chloroflexi | Chloroflexi-4 | Unclassified | Unclassified | sf_2 | 2344 | forest soil clone C083 |
| Chloroflexi | Unclassified | Unclassified | Unclassified | sf_1 | 2534 | forest soil clone S085 |
| Coprothermobacteria | Unclassified | Unclassified | Unclassified | sf_1 | 751 | Coprothermobacter sp. str. Dex80-3 |
| Cyanobacteria | Cyanobacteria | Chloroplasts | Chloroplasts | sf_5 | 4967 | Toolik Lake main station at 3 m depth clone |
| | | | | | | TLM14 |
| Cyanobacteria | Cyanobacteria | Chloroplasts | Chloroplasts | sf_5 | 5147 | Emiliania huxleyi str. Plymouth Marine Laborator |
| | | | | | | PML 92 |
| Cyanobacteria | Cyanobacteria | Chloroplasts | Chloroplasts | sf_5 | 5112 | Cyanidium caldarium str. 14-1-1 |
| Cyanobacteria | Cyanobacteria | Chloroplasts | Chloroplasts | sf_5 | 5006 | |
| Cyanobacteria | Cyanobacteria | Chloroplasts | Chloroplasts | sf_11 | 5098 | Euglena tripteris str. UW OB |
| Cyanobacteria | Cyanobacteria | Chloroplasts | Chloroplasts | sf_11 | 5123 | Lepocinclis fusiformis str. ACOI 1025 |
| Cyanobacteria | Cyanobacteria | Chloroplasts | Chloroplasts | sf_5 | 4966 | Adiantum pedatum |
| Cyanobacteria | Cyanobacteria | Chloroplasts | Chloroplasts | sf_5 | 4976 | Calypogeia muelleriana |
| Cyanobacteria | Cyanobacteria | Chloroplasts | Chloroplasts | sf_13 | 5000 | Mitrastema yamamotoi |
| Cyanobacteria | Cyanobacteria | Chloroplasts | Chloroplasts | sf_5 | 5040 | Solanum nigrum |
| Cyanobacteria | Cyanobacteria | Chloroplasts | Chloroplasts | sf_5 | 5182 | Epifagus virginiana - chloroplast |
| Cyanobacteria | Cyanobacteria | Chloroplasts | Chloroplasts | sf_5 | 5183 | Pisum sativum - chloroplast |
| Cyanobacteria | Cyanobacteria | Chloroplasts | Chloroplasts | sf_5 | 5192 | VCycas revoluta |
| Cyanobacteria | Unclassified | Unclassified | Unclassified | sf_5 | 4998 | |
| Cyanobacteria | Cyanobacteria | Thermosynechococcus | Unclassified | sf_1 | 5012 | Synechococcus sp. str. PCC 6312 |
| Cyanobacteria | Unclassified | Unclassified | Unclassified | sf_9 | 5038 | Rumen isolate str. YS2 |
| Cyanobacteria | Unclassified | Unclassified | Unclassified | sf_9 | 5164 | termite gut homogenate clone Rs-H34 |
| Cyanobacteria | Cyanobacteria | Oscillatoriales | Unclassified | sf_1 | 5189 | Oscillatoria sancta str. PCC 7515 |
| Cyanobacteria | Unclassified | Unclassified | Unclassified | sf_5 | 5015 | Chlorogloeopsis fritschii str. PCC 6912 |
| Cyanobacteria | Unclassified | Unclassified | Unclassified | sf_5 | 5030 | Hapalosiphon welwitschii |
| Cyanobacteria | Cyanobacteria | Nostocales | Unclassified | sf_1 | 5057 | Nodularia sphaerocarpa str. UTEX B 2093 |
| Cyanobacteria | Cyanobacteria | Oscillatoriales | Unclassified | sf_1 | 5049 | Oscillatoria spongeliae str. 520 bg |
| Cyanobacteria | Cyanobacteria | Plectonema | Unclassified | sf_1 | 5190 | Plectonema sp. str. F3 |
| Cyanobacteria | Unclassified | Unclassified | Unclassified | sf_8 | 5206 | |
| Deinococcus-Thermus | Unclassified | Unclassified | Unclassified | sf_1 | 178 | Thermus sp. str. C4 |
| Deinococcus-Thermus | Unclassified | Unclassified | Unclassified | sf_1 | 563 | Vulcanithermus mediatlanticus str. TR |
| Deinococcus-Thermus | Unclassified | Unclassified | Unclassified | sf_2 | 637 | hypersaline pond clone LA7-B27N |
| Deinococcus-Thermus | Unclassified | Unclassified | Unclassified | sf_3 | 920 | |
| DSS1 | Unclassified | Unclassified | Unclassified | sf_2 | 38 | DCP-dechlorinating consortium clone SHA-109 |
| DSS1 | Unclassified | Unclassified | Unclassified | sf_1 | 4405 | benzoate-degrading consortium clone BA143 |
| Firmicutes | Mollicutes | Acholeplasmatales | Acholeplasmataceae | sf_1 | 3955 | Weeping tea tree witches' broom phytoplasma |
| | | | | | | tree |
| Firmicutes | Mollicutes | Acholeplasmatales | Acholeplasmataceae | sf_1 | 3961 | Clover yellow edge mycoplasma-like organism |
| Firmicutes | Mollicutes | Acholeplasmatales | Acholeplasmataceae | sf_1 | 3975 | Black raspberry witches' broom phytoplasma |
| | | | | | | str. BRWB witches' broom room |
| Firmicutes | Mollicutes | Acholeplasmatales | Acholeplasmataceae | sf_1 | 3976 | |
| Firmicutes | Mollicutes | Acholeplasmatales | Acholeplasmataceae | sf_1 | 4044 | |
| Firmicutes | Mollicutes | Acholeplasmatales | Acholeplasmataceae | sf_1 | 4045 | Chinaberry yellows phytoplasma |
| Firmicutes | Mollicutes | Acholeplasmatales | Acholeplasmataceae | sf_1 | 4046 | Pigeon pea witches' broom mycoplasma-like |
| | | | | | | organism |
| Firmicutes | Bacilli | Lactobacillales | Aerococcaceae | sf_1 | 3386 | feedlot manure clone B87 |
| Firmicutes | Bacilli | Lactobacillales | Aerococcaceae | sf_1 | 3522 | Aerococcus viridans |
| Firmicutes | Bacilli | Lactobacillales | Aerococcaceae | sf_1 | 3631 | Abiotrophia defectiva str. GIFU12707 |
| | | | | | | (ATCC49176) |
| Firmicutes | Bacilli | Lactobacillales | Aerococcaceae | sf_1 | 3870 | Abiotrophia para-adiacens str. TKT1 |
| Firmicutes | Bacilli | Lactobacillales | Aerococcaceae | sf_1 | 3323 | Trichococcus flocculiformis str. DSM 2094 |
| Firmicutes | Bacilli | Lactobacillales | Aerococcaceae | sf_1 | 3326 | Nostocoida limicola I str. Ben206 |
| Firmicutes | Bacilli | Lactobacillales | Aerococcaceae | sf_1 | 3504 | Marinilactibacillus psychrotolerans str. O21 |
| Firmicutes | Bacilli | Lactobacillales | Aerococcaceae | sf_1 | 3553 | Desemzia incerta str. DSM 20581 |
| Firmicutes | Bacilli | Lactobacillales | Aerococcaceae | sf_1 | 3833 | Carnobacterium alterfunditum |
| Firmicutes | Bacilli | Lactobacillales | Aerococcaceae | sf_1 | 3840 | Trichococcus pasteurii str. KoTa2 |
| Firmicutes | Bacilli | Bacillales | Alicyclobacillaceae | sf_1 | 3368 | geothermal site isolate str. G1 |
| Firmicutes | Bacilli | Bacillales | Bacillaceae | sf_1 | 3612 | Bacillus schlegelii str. ATCC 43741T |
| Firmicutes | Bacilli | Bacillales | Bacillaceae | sf_1 | 3419 | Bacillus algicola str. KMM 3737 |
| Firmicutes | Bacilli | Bacillales | Bacillaceae | sf_1 | 3424 | uranium mill tailings clone Gitt-KF-76 |
| Firmicutes | Bacilli | Bacillales | Bacillaceae | sf_1 | 3661 | Bacillus sp. str. 2216.25.2 |
| Firmicutes | Bacilli | Bacillales | Bacillaceae | sf_1 | 3688 | Bacillus sp. str. SAFN-006 |
| Firmicutes | Bacilli | Bacillales | Bacillaceae | sf_1 | 3926 | Lake Bogoria isolate 64B4 |
| Firmicutes | Bacilli | Bacillales | Bacillaceae | sf_1 | 234 | Bacillus vulcani str. 3S-1 |
| Firmicutes | Bacilli | Bacillales | Bacillaceae | sf_1 | 283 | Geobacillus thermocatenulatus str. DSM 730 |
| Firmicutes | Bacilli | Bacillales | Bacillaceae | sf_1 | 305 | Bacillus thermoleovorans |
| Firmicutes | Bacilli | Bacillales | Bacillaceae | sf_1 | 3460 | Geobacillus jurassicus str. DS1 |
| Firmicutes | Bacilli | Bacillales | Bacillaceae | sf_1 | 3540 | Geobacillus thermoleovorans str. B23 |
| Firmicutes | Bacilli | Bacillales | Bacillaceae | sf_1 | 3763 | Geobacillus stearothermophilus |
| Firmicutes | Bacilli | Bacillales | Bacillaceae | sf_1 | 3836 | Geobacillus stearothermophilus str. 46 |
| Firmicutes | Bacilli | Bacillales | Bacillaceae | sf_1 | 385 | Geobacillus stearothermophilus str. T10 |
| Firmicutes | Bacilli | Bacillales | Bacillaceae | sf_1 | 462 | Geobacillus thermodenitrificans str. DSM 466 |
| Firmicutes | Bacilli | Bacillales | Bacillaceae | sf_1 | 571 | Bacillus caldotenax str. DSM 406 |
| Firmicutes | Bacilli | Bacillales | Bacillaceae | sf_1 | 829 | Geobacillus sp. str. YMTC1049 |
| Firmicutes | Bacilli | Bacillales | Bacillaceae | sf_1 | 3635 | Bacillus aeolius str. 4-1 |
| Firmicutes | Bacilli | Bacillales | Bacillaceae | sf_1 | 3827 | Bacillus acidogenesis str. 105-2 |
| Firmicutes | Bacilli | Bacillales | Bacillaceae | sf_1 | 3845 | hot synthetic compost clone pPD15 |
| Firmicutes | Bacilli | Bacillales | Bacillaceae | sf_1 | 3895 | Bacillus sporothermodurans str. M215 |
| Firmicutes | Bacilli | Bacillales | Bacillaceae | sf_1 | 3283 | Bacillus niacini str. IFO15566 |
| Firmicutes | Bacilli | Bacillales | Bacillaceae | sf_1 | 3439 | Bacillus siralis str. 171544 |
| Firmicutes | Bacilli | Bacillales | Bacillaceae | sf_1 | 3589 | Bacillus senegalensis str. RS8; CIP 106 669 |
| Firmicutes | Bacilli | Bacillales | Bacillaceae | sf_1 | 3650 | |
| Firmicutes | Bacilli | Bacillales | Bacillaceae | sf_1 | 1050 | Bacillus firmus CV93b |
| Firmicutes | Bacilli | Bacillales | Bacillaceae | sf_1 | 246 | Bacillus sp. 6160m-C1 |
| Firmicutes | Bacilli | Bacillales | Bacillaceae | sf_1 | 3550 | Bacillus megaterium str. QM B1551 |
| Firmicutes | Bacilli | Bacillales | Bacillaceae | sf_1 | 3345 | Bacillus pumilus str. S9 |
| Firmicutes | Bacilli | Bacillales | Bacillaceae | sf_1 | 3328 | Pseudobacillus carolinae |
| Firmicutes | Bacilli | Bacillales | Bacillaceae | sf_1 | 3370 | Bacillus sp. str. TGS437 |
| Firmicutes | Bacilli | Bacillales | Bacillaceae | sf_1 | 3492 | Bacillus subtilis str. IAM 12118T |
| Firmicutes | Bacilli | Bacillales | Bacillaceae | sf_1 | 3579 | Bacillus sp. str. TGS750 |
| Firmicutes | Bacilli | Bacillales | Bacillaceae | sf_1 | 3675 | Bacillus mojavensis str. M-1 |
| Firmicutes | Bacilli | Bacillales | Bacillaceae | sf_1 | 3706 | Bacillus sonorensis str. NRRL B-23155 |
| Firmicutes | Bacilli | Bacillales | Bacillaceae | sf_1 | 3831 | Bacillus licheniformis str. KL-068 |
| Firmicutes | Bacilli | Bacillales | Bacillaceae | sf_1 | 3900 | Bacillus licheniformis str. DSM 13 |
| Firmicutes | Bacilli | Bacillales | Bacillaceae | sf_1 | 3909 | Bacillus subtilis subsp. Marburg str. 168 |
| Firmicutes | Bacilli | Bacillales | Bacillaceae | sf_1 | 3918 | Bacillus subtilis |
| Firmicutes | Bacilli | Bacillales | Bacillaceae | sf_1 | 3467 | Bacillus luciferensis str. LMG 18422 |
| Firmicutes | Bacilli | Bacillales | Bacillaceae | sf_1 | 3489 | Bacillus silvestris str. SAFN-010 |
| Firmicutes | Bacilli | Bacillales | Bacillaceae | sf_1 | 3482 | garbage compost isolate str. M32 |
| Firmicutes | Bacilli | Bacillales | Bacillaceae | sf_1 | 3383 | |
| Firmicutes | Bacilli | Bacillales | Bacillaceae | sf_1 | 3517 | Planococcus maritimus str. TF-9 |
| Firmicutes | Bacilli | Lactobacillales | Carnobacteriaceae | sf_1 | 3536 | |
| Firmicutes | Bacilli | Lactobacillales | Carnobacteriaceae | sf_1 | 3792 | Carnobacterium sp. str. D35 |
| Firmicutes | Bacilli | Bacillales | Caryophanaceae | sf_1 | 3285 | Caryophanon latum str. DSM 14151 |
| Firmicutes | Clostridia | Clostridiales | Clostridiaceae | sf_12 | 2764 | |
| Firmicutes | Clostridia | Clostridiales | Clostridiaceae | sf_12 | 3021 | Clostridium caminithermale str. DVird3 |
| Firmicutes | Clostridia | Clostridiales | Clostridiaceae | sf_12 | 2915 | Tepidibacter thalassicus str. SC 562 |
| Firmicutes | Clostridia | Clostridiales | Clostridiaceae | sf_12 | 3049 | Clostridium paradoxum str. DSM 7308T |
| Firmicutes | Clostridia | Clostridiales | Clostridiaceae | sf_12 | 3077 | Clostridium glycolicum str. DSM 1288 |
| Firmicutes | Clostridia | Clostridiales | Clostridiaceae | sf_12 | 4156 | MCB-contaminated groundwater-treating |
| | | | | | | reactor clone RA9C1 |
| Firmicutes | Clostridia | Clostridiales | Clostridiaceae | sf_12 | 4173 | termite gut homogenate clone Rs-D81 bacterium |
| Firmicutes | Clostridia | Clostridiales | Clostridiaceae | sf_12 | 4187 | Clostridiales oral clone P4PB_122 P3 |
| Firmicutes | Clostridia | Clostridiales | Clostridiaceae | sf_12 | 4278 | granular sludge clone R1p16 |
| Firmicutes | Clostridia | Clostridiales | Clostridiaceae | sf_12 | 4297 | |
| Firmicutes | Clostridia | Clostridiales | Clostridiaceae | sf_12 | 4300 | termite gut clone Rs-060 |
| Firmicutes | Clostridia | Clostridiales | Clostridiaceae | sf_12 | 4310 | termite gut clone Rs-056 |
| Firmicutes | Clostridia | Clostridiales | Clostridiaceae | sf_12 | 4364 | oral endodontic infection clone MCF3_9 |
| Firmicutes | Clostridia | Clostridiales | Clostridiaceae | sf_12 | 4406 | termite gut homogenate clone Rs-J39 bacterium |
| Firmicutes | Clostridia | Clostridiales | Clostridiaceae | sf_12 | 4477 | termite gut homogenate clone Rs-N85 bacterium |
| Firmicutes | Clostridia | Clostridiales | Clostridiaceae | sf_12 | 4502 | |
| Firmicutes | Clostridia | Clostridiales | Clostridiaceae | sf_12 | 4584 | Clostridium papyrosolvens str. DSM 2782 |
| Firmicutes | Clostridia | Clostridiales | Clostridiaceae | sf_12 | 4614 | Clostridium sp. str. JC3 |
| Firmicutes | Clostridia | Clostridiales | Clostridiaceae | sf_12 | 4622 | termite gut clone Rs-L36 |
| Firmicutes | Clostridia | Clostridiales | Clostridiaceae | sf_12 | 4638 | |
| Firmicutes | Clostridia | Clostridiales | Clostridiaceae | sf_12 | 4554 | termite gut clone Rs-068 |
| Firmicutes | Clostridia | Clostridiales | Clostridiaceae | sf_12 | 4180 | termite gut homogenate clone Rs-M23 bacterium |
| Firmicutes | Clostridia | Clostridiales | Clostridiaceae | sf_12 | 4225 | termite gut clone Rs-116 |
| Firmicutes | Clostridia | Clostridiales | Clostridiaceae | sf_12 | 4265 | termite gut homogenate clone Rs-N70 bacterium |
| Firmicutes | Clostridia | Clostridiales | Clostridiaceae | sf_12 | 4266 | termite gut homogenate clone Rs-M86 bacterium |
| Firmicutes | Clostridia | Clostridiales | Clostridiaceae | sf_12 | 4272 | termite gut homogenate clone Rs-M34 bacterium |
| Firmicutes | Clostridia | Clostridiales | Clostridiaceae | sf_12 | 4321 | termite gut homogenate clone Rs-C76 bacterium |
| Firmicutes | Clostridia | Clostridiales | Clostridiaceae | sf_12 | 4357 | Lachnospiraceae bacterium 19gly4 |
| Firmicutes | Clostridia | Clostridiales | Clostridiaceae | sf_12 | 4359 | termite gut homogenate clone Rs-C69 bacterium |
| Firmicutes | Clostridia | Clostridiales | Clostridiaceae | sf_12 | 4369 | termite gut homogenate clone Rs-N73 bacterium |
| Firmicutes | Clostridia | Clostridiales | Clostridiaceae | sf_12 | 4415 | termite gut homogenate clone Rs-K32 bacterium |
| Firmicutes | Clostridia | Clostridiales | Clostridiaceae | sf_12 | 4418 | termite gut homogenate clone Rs-H18 bacterium |
| Firmicutes | Clostridia | Clostridiales | Clostridiaceae | sf_12 | 4475 | termite gut homogenate clone Rs-N02 bacterium |
| Firmicutes | Clostridia | Clostridiales | Clostridiaceae | sf_12 | 4507 | termite gut homogenate clone Rs-N21 bacterium |
| Firmicutes | Clostridia | Clostridiales | Clostridiaceae | sf_12 | 4524 | termite gut clone Rs-093 |
| Firmicutes | Clostridia | Clostridiales | Clostridiaceae | sf_12 | 4550 | swine intestine clone p-320-a3 |
| Firmicutes | Clostridia | Clostridiales | Clostridiaceae | sf_12 | 4559 | cow rumen clone BF30 |
| Firmicutes | Clostridia | Clostridiales | Clostridiaceae | sf_12 | 4566 | swine intestine clone p-2657-65A5 |
| Firmicutes | Clostridia | Clostridiales | Clostridiaceae | sf_12 | 4582 | swine intestine clone p-2600-9F5 |
| Firmicutes | Clostridia | Clostridiales | Clostridiaceae | sf_12 | 4627 | termite gut homogenate clone Rs-A13 bacterium |
| Firmicutes | Clostridia | Clostridiales | Clostridiaceae | sf_12 | 4306 | UASB reactor granular sludge clone PD-UASB-4 |
| | | | | | | bacterium |
| Firmicutes | Clostridia | Clostridiales | Clostridiaceae | sf_12 | 4607 | Clostridium novyi str. NCTC538 |
| Firmicutes | Clostridia | Clostridiales | Clostridiaceae | sf_12 | 4229 | |
| Firmicutes | Clostridia | Clostridiales | Clostridiaceae | sf_12 | 4551 | Clostridium acetobutylicum str. ATCC 824 (T) |
| Firmicutes | Clostridia | Clostridiales | Clostridiaceae | sf_12 | 4339 | Clostridium chauvoei str. ATCC 10092T |
| Firmicutes | Clostridia | Clostridiales | Clostridiaceae | sf_12 | 4598 | Clostridium sardiniense str. DSM 600 |
| Firmicutes | Clostridia | Clostridiales | Clostridiaceae | sf_12 | 4169 | |
| Firmicutes | Bacilli | Lactobacillales | Enterococcaceae | sf_1 | 3261 | Enterococcus mundtii str. LMG 10748 |
| Firmicutes | Bacilli | Lactobacillales | Enterococcaceae | sf_1 | 3288 | Isolation and identification hyper-ammonia |
| | | | | | | producing swine storage pits manure |
| Firmicutes | Bacilli | Lactobacillales | Enterococcaceae | sf_1 | 3298 | Enterococcus saccharolyticus str. LMG 11427 |
| Firmicutes | Bacilli | Lactobacillales | Enterococcaceae | sf_1 | 3318 | Enterococcus ratti str. ATCC 700914 |
| Firmicutes | Bacilli | Lactobacillales | Enterococcaceae | sf_1 | 3382 | |
| Firmicutes | Bacilli | Lactobacillales | Enterococcaceae | sf_1 | 3392 | Vagococcus lutrae str. m1134/97/1; CCUG 39187 |
| Firmicutes | Bacilli | Lactobacillales | Enterococcaceae | sf_1 | 3433 | Tetragenococcus muriaticus |
| Firmicutes | Bacilli | Lactobacillales | Enterococcaceae | sf_1 | 3598 | Enterococcus solitarius str. DSM 5634 |
| Firmicutes | Bacilli | Lactobacillales | Enterococcaceae | sf_1 | 3680 | Melissococcus plutonius str. NCDO 2440 |
| Firmicutes | Bacilli | Lactobacillales | Enterococcaceae | sf_1 | 3713 | Enterococcus cecorum str. ATCC43198 |
| Firmicutes | Bacilli | Lactobacillales | Enterococcaceae | sf_1 | 3881 | Enterococcus dispar str. LMG 13521 |
| Firmicutes | Mollicutes | Entomoplasmatales | Entomoplasmataceae | sf_1 | 4074 | swine intestine clone p-2013-s959-5 |
| Firmicutes | Mollicutes | Anaeroplasmatales | Erysipelotrichaceae | sf_3 | 3952 | Erysipelothrix rhusiopathiae str. Pecs 56 |
| Firmicutes | Mollicutes | Anaeroplasmatales | Erysipelotrichaceae | sf_3 | 3965 | TCE-contaminated site clone ccslm238 |
| Firmicutes | Mollicutes | Anaeroplasmatales | Erysipelotrichaceae | sf_3 | 3981 | phototrophic sludge clone PSB-M-3 |
| Firmicutes | Mollicutes | Anaeroplasmatales | Erysipelotrichaceae | sf_3 | 768 | |
| Firmicutes | Clostridia | Clostridiales | Eubacteriaceae | sf_1 | 28 | termite gut homogenate clone Rs-H81 bacterium |
| Firmicutes | Bacilli | Bacillales | Halobacillaceae | sf_1 | 3633 | Bacillus clausii str. GMBAE 42 |
| Firmicutes | Bacilli | Bacillales | Halobacillaceae | sf_1 | 3344 | Halobacillus yeomjeoni str. MSS-402 |
| Firmicutes | Bacilli | Bacillales | Halobacillaceae | sf_1 | 3488 | Halobacillus salinus str. HSL-3 |
| Firmicutes | Bacilli | Bacillales | Halobacillaceae | sf_1 | 3702 | Amphibacillus xylanus str. DSM 6626 |
| Firmicutes | Bacilli | Bacillales | Halobacillaceae | sf_1 | 3756 | Salibacillus sp. str. YIM-kkny16 |
| Firmicutes | Bacilli | Bacillales | Halobacillaceae | sf_1 | 3769 | Gracilibacillus sp. str. YIM-kkny13 |
| Firmicutes | Clostridia | Clostridiales | Lachnospiraceae | sf_5 | 2698 | termite gut homogenate clone Rs-B88 bacterium |
| Firmicutes | Clostridia | Clostridiales | Lachnospiraceae | sf_5 | 2804 | Clostridium amygdalinum str. BR-10 |
| Firmicutes | Clostridia | Clostridiales | Lachnospiraceae | sf_5 | 2961 | termite gut homogenate clone Rs-F92 bacterium |
| Firmicutes | Clostridia | Clostridiales | Lachnospiraceae | sf_5 | 3042 | swine intestine clone p-2876-6C5 |
| Firmicutes | Clostridia | Clostridiales | Lachnospiraceae | sf_5 | 3036 | termite gut homogenate clone Rs-F27 bacterium |
| Firmicutes | Clostridia | Clostridiales | Lachnospiraceae | sf_5 | 2668 | termite gut homogenate clone Rs-G40 bacterium |
| Firmicutes | Clostridia | Clostridiales | Lachnospiraceae | sf_5 | 3017 | termite gut homogenate clone Rs-D48 bacterium |
| Firmicutes | Clostridia | Clostridiales | Lachnospiraceae | sf_5 | 3076 | Clostridium nexile |
| Firmicutes | Clostridia | Clostridiales | Lachnospiraceae | sf_5 | 2825 | Butyrivibrio fibrisolvens str. LP1265 |
| Firmicutes | Clostridia | Clostridiales | Lachnospiraceae | sf_5 | 2834 | Butyrivibrio fibrisolvens str. OB156 |
| Firmicutes | Clostridia | Clostridiales | Lachnospiraceae | sf_5 | 2844 | Pseudobutyrivibrio ruminis str. pC-XS2 |
| Firmicutes | Clostridia | Clostridiales | Lachnospiraceae | sf_5 | 3059 | Butyrivibrio fibrisolvens str. NCDO 2249 |
| Firmicutes | Clostridia | Clostridiales | Lachnospiraceae | sf_5 | 2994 | termite gut clone Rs-L15 |
| Firmicutes | Clostridia | Clostridiales | Lachnospiraceae | sf_5 | 3038 | swine intestine clone p-1594-c5 |
| Firmicutes | Clostridia | Clostridiales | Lachnospiraceae | sf_5 | 3171 | Lachnospira pectinoschiza |
| Firmicutes | Clostridia | Clostridiales | Lachnospiraceae | sf_5 | 2931 | termite gut homogenate clone Rs-G77 bacterium |
| Firmicutes | Clostridia | Clostridiales | Lachnospiraceae | sf_5 | 3060 | termite gut homogenate clone Rs-B14 bacterium |
| Firmicutes | Clostridia | Clostridiales | Lachnospiraceae | sf_5 | 3218 | termite gut homogenate clone Rs-N53 |
| Firmicutes | Clostridia | Clostridiales | Lachnospiraceae | sf_5 | 2681 | termite gut homogenate clone Rs-K41 bacterium |
| Firmicutes | Clostridia | Clostridiales | Lachnospiraceae | sf_5 | 4212 | termite gut clone Rs-061 |
| Firmicutes | Clostridia | Clostridiales | Lachnospiraceae | sf_5 | 4273 | termite gut homogenate clone Rs-M14 bacterium |
| Firmicutes | Clostridia | Clostridiales | Lachnospiraceae | sf_5 | 4281 | granular sludge clone UASB_brew_B86 |
| Firmicutes | Clostridia | Clostridiales | Lachnospiraceae | sf_5 | 4315 | termite gut homogenate clone Rs-N94 bacterium |
| Firmicutes | Clostridia | Clostridiales | Lachnospiraceae | sf_5 | 4331 | granular sludge clone UASB_brew_B84 |
| Firmicutes | Clostridia | Clostridiales | Lachnospiraceae | sf_5 | 4335 | termite gut homogenate clone Rs-N86 bacterium |
| Firmicutes | Clostridia | Clostridiales | Lachnospiraceae | sf_5 | 4434 | termite gut homogenate clone Rs-K11 bacterium |
| Firmicutes | Clostridia | Clostridiales | Lachnospiraceae | sf_5 | 4510 | termite gut homogenate clone Rs-Q53 bacterium |
| Firmicutes | Clostridia | Clostridiales | Lachnospiraceae | sf_5 | 4511 | ckncm314-B7-17 clone |
| Firmicutes | Clostridia | Clostridiales | Lachnospiraceae | sf_5 | 4512 | granular sludge clone UASB_brew_B25 |
| Firmicutes | Clostridia | Clostridiales | Lachnospiraceae | sf_5 | 4514 | termite gut homogenate clone Rs-B34 bacterium |
| Firmicutes | Clostridia | Clostridiales | Lachnospiraceae | sf_5 | 4533 | termite gut homogenate clone Rs-N06 bacterium |
| Firmicutes | Clostridia | Clostridiales | Lachnospiraceae | sf_5 | 4535 | ckncm297-B1-1 clone |
| Firmicutes | Clostridia | Clostridiales | Lachnospiraceae | sf_5 | 4539 | termite gut homogenate clone Rs-C61 bacterium |
| Firmicutes | Clostridia | Clostridiales | Lachnospiraceae | sf_5 | 4540 | termite gut homogenate clone Rs-M18 bacterium |
| Firmicutes | Clostridia | Clostridiales | Lachnospiraceae | sf_5 | 4567 | human colonic clone HuCB5 |
| Firmicutes | Clostridia | Clostridiales | Lachnospiraceae | sf_5 | 4571 | Faecalibacterium prausnitzii str. ATCC 27766 |
| Firmicutes | Clostridia | Clostridiales | Lachnospiraceae | sf_5 | 4613 | rumen clone 3C0d-3 |
| Firmicutes | Clostridia | Clostridiales | Lachnospiraceae | sf_5 | 4623 | human colonic clone HuCA1 |
| Firmicutes | Clostridia | Clostridiales | Lachnospiraceae | sf_5 | 4525 | termite gut homogenate clone Rs-Q18 bacterium |
| Firmicutes | Bacilli | Lactobacillales | Lactobacillaceae | sf_1 | 3330 | Lactobacillus kitasatonis str. KM9212 |
| Firmicutes | Bacilli | Lactobacillales | Lactobacillaceae | sf_1 | 3342 | Lactobacillus crispatus str. DSM 20584 T |
| Firmicutes | Bacilli | Lactobacillales | Lactobacillaceae | sf_1 | 3478 | Lactobacillus crispatus str. ATCC33197 |
| Firmicutes | Bacilli | Lactobacillales | Lactobacillaceae | sf_1 | 3490 | Lactobacillus suntoryeus str. LH |
| Firmicutes | Bacilli | Lactobacillales | Lactobacillaceae | sf_1 | 3618 | Lactobacillus jensenii str. KC36b |
| Firmicutes | Bacilli | Lactobacillales | Lactobacillaceae | sf_1 | 3696 | Lactobacillus kalixensis str. Kx127A2; LMG |
| | | | | | | 22115T; DSM 16043T; CCUG 48459T |
| Firmicutes | Bacilli | Lactobacillales | Lactobacillaceae | sf_1 | 3395 | Lactobacillus reuteri str. DSM 20016 T |
| Firmicutes | Bacilli | Lactobacillales | Lactobacillaceae | sf_1 | 3547 | Lactobacillus frumenti str. TMW 1.666 |
| Firmicutes | Bacilli | Lactobacillales | Lactobacillaceae | sf_1 | 3566 | Lactobacillus pontis str. LTH 2587 |
| Firmicutes | Bacilli | Lactobacillales | Lactobacillaceae | sf_1 | 3798 | Lactobacillus fermentum str. MD-9 |
| Firmicutes | Bacilli | Lactobacillales | Lactobacillaceae | sf_1 | 3521 | Pediococcus inopinatus str. DSM 20285 |
| Firmicutes | Bacilli | Lactobacillales | Lactobacillaceae | sf_1 | 3885 | Pediococcus pentosaceus |
| Firmicutes | Bacilli | Lactobacillales | Lactobacillaceae | sf_1 | 3634 | Lactobacillus letivazi str. JCL3994 |
| Firmicutes | Bacilli | Lactobacillales | Lactobacillaceae | sf_1 | 3767 | Lactobacillus suebicus str. CECT 5917T |
| Firmicutes | Bacilli | Lactobacillales | Lactobacillaceae | sf_1 | 3810 | Lactobacillus brevis |
| Firmicutes | Bacilli | Lactobacillales | Lactobacillaceae | sf_1 | 3829 | Lactobacillus paralimentarius str. DSM 13238 |
| Firmicutes | Bacilli | Lactobacillales | Lactobacillaceae | sf_1 | 3366 | Lactobacillus saerimneri str. GDA154 LMG 22087 |
| | | | | | | DSM 16049 (T); CCUG 48462 (T) |
| Firmicutes | Bacilli | Lactobacillales | Lactobacillaceae | sf_1 | 3418 | Lactobacillus subsp. aviarius |
| Firmicutes | Bacilli | Lactobacillales | Lactobacillaceae | sf_1 | 3703 | Lactobacillus salivarius str. RA2115 |
| Firmicutes | Bacilli | Lactobacillales | Lactobacillaceae | sf_1 | 3914 | Lactobacillus cypricasei str. LMK3 |
| Firmicutes | Bacilli | Lactobacillales | Lactobacillaceae | sf_1 | 3821 | Lactobacillus casei |
| Firmicutes | Bacilli | Lactobacillales | Lactobacillaceae | sf_1 | 3768 | Lactobacillus perolens str. L532 |
| Firmicutes | Bacilli | Lactobacillales | Lactobacillaceae | sf_1 | 3526 | Lactobacillus sakei |
| Firmicutes | Bacilli | Lactobacillales | Leuconostocaceae | sf_1 | 3497 | Weissella koreensis S-5673 |
| Firmicutes | Bacilli | Lactobacillales | Leuconostocaceae | sf_1 | 3573 | Leuconostoc ficulneum str. FS-1 |
| Firmicutes | Mollicutes | Mycoplasmatales | Mycoplasmataceae | sf_1 | 3929 | Mycoplasma gypsbengalensis str. Gb-V33 |
| Firmicutes | Mollicutes | Mycoplasmatales | Mycoplasmataceae | sf_1 | 3997 | Mycoplasma salivarium str. PG20(T) |
| Firmicutes | Mollicutes | Mycoplasmatales | Mycoplasmataceae | sf_1 | 4014 | Mycoplasma pulmonis str. UAB CTIP |
| Firmicutes | Bacilli | Bacillales | Paenibacillaceae | sf_1 | 3415 | Paenibacillus nematophilus str. NEM1b |
| Firmicutes | Bacilli | Bacillales | Paenibacillaceae | sf_1 | 3630 | |
| Firmicutes | Bacilli | Bacillales | Paenibacillaceae | sf_1 | 3595 | Paenibacillus sp. str. MB 2039 |
| Firmicutes | Bacilli | Bacillales | Paenibacillaceae | sf_1 | 3299 | Brevibacillus borstelensis str. LMG 15536 |
| Firmicutes | Bacilli | Bacillales | Paenibacillaceae | sf_1 | 3641 | Brevibacillus sp. MN 47.2a |
| Firmicutes | Bacilli | Bacillales | Paenibacillaceae | sf_1 | 319 | Ammoniphilus oxalaticus str. RAOx-FF |
| Firmicutes | Bacilli | Bacillales | Paenibacillaceae | sf_1 | 625 | Ammoniphilus oxalivorans str. RAOx-FS |
| Firmicutes | Clostridia | Clostridiales | Peptococc/ | sf_11 | 304 | Selenomonas ruminantium str.JCM6582 |
| | | | Acidaminococc | | | |
| Firmicutes | Clostridia | Clostridiales | Peptococc/ | sf_11 | 709 | Selenomonas ruminantium str.S20 |
| | | | Acidaminococc | | | |
| Firmicutes | Clostridia | Clostridiales | Peptococc/ | sf_11 | 710 | Centipeda periodontii str. HB-2 |
| | | | Acidaminococc | | | |
| Firmicutes | Clostridia | Clostridiales | Peptococc/ | sf_11 | 131 | pig feces clone |
| | | | Acidaminococc | | | |
| Firmicutes | Clostridia | Clostridiales | Peptococc/ | sf_11 | 181 | Allisonella histaminiformans str. MR2 |
| | | | Acidaminococc | | | |
| Firmicutes | Clostridia | Clostridiales | Peptococc/ | sf_11 | 59 | swine intestine clone p-1941-s962-3 |
| | | | Acidaminococc | | | |
| Firmicutes | Clostridia | Clostridiales | Peptococc/ | sf_11 | 940 | Veillonella dispar str. DSM 20735 |
| | | | Acidaminococc | | | |
| Firmicutes | Clostridia | Clostridiales | Peptococc/ | sf_11 | 1036 | Great Artesian Basin clone G07 |
| | | | Acidaminococc | | | |
| Firmicutes | Clostridia | Clostridiales | Peptococc/ | sf_11 | 428 | chlorobenzene-degrading consortium clone |
| | | | Acidaminococc | | | IIIA-1 |
| Firmicutes | Clostridia | Clostridiales | Peptococc/ | sf_11 | 534 | chlorobenzene-degrading consortium clone |
| | | | Acidaminococc | | | IIA-26 |
| Firmicutes | Clostridia | Clostridiales | Peptococc/ | sf_11 | 992 | anoxic bulk soil flooded rice microcosm clone |
| | | | Acidaminococc | | | BSV43 clone |
| Firmicutes | Clostridia | Clostridiales | Peptococc/ | sf_11 | 242 | Desulfosporosinus orientis str. DSMZ 7493 |
| | | | Acidaminococc | | | |
| Firmicutes | Clostridia | Clostridiales | Peptococc/ | sf_11 | 300 | benzene-contaminated groundwater clone |
| | | | Acidaminococc | | | ZZ12C8 |
| Firmicutes | Clostridia | Clostridiales | Peptococc/ | sf_11 | 39 | forested wetland clone RCP2-71 |
| | | | Acidaminococc | | | |
| Firmicutes | Clostridia | Clostridiales | Peptostreptococcaceae | sf_5 | 2721 | termite gut homogenate clone Rs-N71 bacterium |
| Firmicutes | Clostridia | Clostridiales | Peptostreptococcaceae | sf_5 | 2729 | DCP-dechlorinating consortium clone SHA-58 |
| Firmicutes | Clostridia | Clostridiales | Peptostreptococcaceae | sf_5 | 2679 | termite gut homogenate clone BCf9-13 |
| Firmicutes | Clostridia | Clostridiales | Peptostreptococcaceae | sf_5 | 2694 | oral periodontitis clone FX028 |
| Firmicutes | Clostridia | Clostridiales | Peptostreptococcaceae | sf_5 | 2714 | termite gut homogenate clone Rs-N27 bacterium |
| Firmicutes | Clostridia | Clostridiales | Peptostreptococcaceae | sf_5 | 2913 | termite gut homogenate clone Rs-N82 bacterium |
| Firmicutes | Clostridia | Clostridiales | Peptostreptococcaceae | sf_5 | 3080 | termite gut homogenate clone Rs-F43 bacterium |
| Firmicutes | Clostridia | Clostridiales | Peptostreptococcaceae | sf_5 | 3112 | Evry municipal wastewater treatment plant |
| | | | | | | clone 012C11_B_SD_P15 |
| Firmicutes | Clostridia | Clostridiales | Peptostreptococcaceae | sf_5 | 3182 | termite gut homogenate clone Rs-Q64 bacterium |
| Firmicutes | Clostridia | Clostridiales | Peptostreptococcaceae | sf_5 | 2993 | oral clone P2PB_46 P3 |
| Firmicutes | Clostridia | Clostridiales | Peptostreptococcaceae | sf_5 | 2738 | Mogibacterium neglectum str. ATCC 700924 |
| | | | | | | (=P9a-h) |
| Firmicutes | Clostridia | Clostridiales | Peptostreptococcaceae | sf_5 | 2805 | oral periodontitis clone FX033 |
| Firmicutes | Clostridia | Clostridiales | Peptostreptococcaceae | sf_5 | 2797 | Isolation and identification hyper-ammonia |
| | | | | | | producing swine storage pits manure |
| Firmicutes | Clostridia | Clostridiales | Peptostreptococcaceae | sf_5 | 619 | TCE-dechlorinating microbial community clone |
| | | | | | | 1G |
| Firmicutes | Clostridia | Clostridiales | Peptostreptococcaceae | sf_5 | 224 | Finegoldia magna str. ATCC 29328 |
| Firmicutes | Clostridia | Clostridiales | Peptostreptococcaceae | sf_5 | 58 | Peptostreptococcus sp. str. E3_32 |
| Firmicutes | Clostridia | Clostridiales | Peptostreptococcaceae | sf_5 | 1037 | Finegoldia magna |
| Firmicutes | Clostridia | Clostridiales | Peptostreptococcaceae | sf_5 | 616 | Peptoniphilus lacrimalis str. CCUG 31350 |
| Firmicutes | Clostridia | Clostridiales | Peptostreptococcaceae | sf_5 | 393 | Anaerococcus vaginalis str. CCUG 31349 |
| Firmicutes | Bacilli | Bacillales | Sporolactobacillaceae | sf_1 | 3365 | Bacillus sp. clone ML615J-19 |
| Firmicutes | Bacilli | Bacillales | Sporolactobacillaceae | sf_1 | 3747 | Bacillus sp. str. C-59-2 |
| Firmicutes | Bacilli | Bacillales | Staphylococcaceae | sf_1 | 3258 | Staphylococcus auricularis str. MAFF911484 |
| | | | | | | ATCC33753T |
| Firmicutes | Bacilli | Bacillales | Staphylococcaceae | sf_1 | 3284 | |
| Firmicutes | Bacilli | Bacillales | Staphylococcaceae | sf_1 | 3545 | |
| Firmicutes | Bacilli | Bacillales | Staphylococcaceae | sf_1 | 3569 | Staphylococcus saprophyticus |
| Firmicutes | Bacilli | Bacillales | Staphylococcaceae | sf_1 | 3585 | |
| Firmicutes | Bacilli | Bacillales | Staphylococcaceae | sf_1 | 3592 | Staphylococcus caprae str. DSM 20608 |
| Firmicutes | Bacilli | Bacillales | Staphylococcaceae | sf_1 | 3605 | |
| Firmicutes | Bacilli | Bacillales | Staphylococcaceae | sf_1 | 3628 | Staphylococcus haemolyticus str. CCM2737 |
| Firmicutes | Bacilli | Bacillales | Staphylococcaceae | sf_1 | 3638 | Staphylococcus sp str. AG-30 |
| Firmicutes | Bacilli | Bacillales | Staphylococcaceae | sf_1 | 3654 | Staphylococcus pettenkoferi str. B3117 |
| Firmicutes | Bacilli | Bacillales | Staphylococcaceae | sf_1 | 3684 | Staphylococcus sciuri |
| Firmicutes | Bacilli | Bacillales | Staphylococcaceae | sf_1 | 3794 | |
| Firmicutes | Bacilli | Bacillales | Staphylococcaceae | sf_1 | 3822 | Staphylococcus succinus str. SB72 |
| Firmicutes | Bacilli | Bacillales | Staphylococcaceae | sf_1 | 3494 | Micrococcus luteus B-P 26 |
| Firmicutes | Bacilli | Bacillales | Staphylococcaceae | sf_1 | 3865 | Macrococcus lamae str. CCM 4815 |
| Firmicutes | Bacilli | Bacillales | Staphylococcaceae | sf_1 | 3432 | deep-sea sediment isolate str. P_wp0225 |
| Firmicutes | Bacilli | Lactobacillales | Streptococcaceae | sf_1 | 3722 | Lactococcus Il1403 subsp. lactis str. IL1403 |
| Firmicutes | Bacilli | Lactobacillales | Streptococcaceae | sf_1 | 3869 | Streptococcus equi subsp. zooepidemicus str. |
| | | | | | | Tokyo1291 subsp. |
| Firmicutes | Bacilli | Lactobacillales | Streptococcaceae | sf_1 | 3699 | Streptococcus agalactiae str. 2603V/R |
| Firmicutes | Bacilli | Lactobacillales | Streptococcaceae | sf_1 | 3907 | aortic heart valve patient with endocarditis clone |
| | | | | | | v6 |
| Firmicutes | Bacilli | Lactobacillales | Streptococcaceae | sf_1 | 3250 | Streptococcus bovis str. B315 |
| Firmicutes | Bacilli | Lactobacillales | Streptococcaceae | sf_1 | 3253 | derived cheese sample clone 32CR |
| Firmicutes | Bacilli | Lactobacillales | Streptococcaceae | sf_1 | 3313 | Streptococcus salivarius str. ATCC 7073 |
| Firmicutes | Bacilli | Lactobacillales | Streptococcaceae | sf_1 | 3397 | Streptococcus macedonicus str. ACA-DC 206 |
| | | | | | | LAB617 |
| Firmicutes | Bacilli | Lactobacillales | Streptococcaceae | sf_1 | 3422 | Streptococcus thermophilus str. DSM 20617 |
| Firmicutes | Bacilli | Lactobacillales | Streptococcaceae | sf_1 | 3543 | |
| Firmicutes | Bacilli | Lactobacillales | Streptococcaceae | sf_1 | 3588 | Streptococcus downei str. ATCC 33748 |
| Firmicutes | Bacilli | Lactobacillales | Streptococcaceae | sf_1 | 3906 | Streptococcus bovis str.ATCC 43143 |
| Firmicutes | Bacilli | Lactobacillales | Streptococcaceae | sf_1 | 3499 | Streptococcus constellatus str. ATCC27823 |
| Firmicutes | Bacilli | Lactobacillales | Streptococcaceae | sf_1 | 3446 | Streptococcus bovis str. HJ50 |
| Firmicutes | Bacilli | Lactobacillales | Streptococcaceae | sf_1 | 3560 | Streptococcus gallinaceus str. CCUG 42692 |
| Firmicutes | Bacilli | Lactobacillales | Streptococcaceae | sf_1 | 3753 | Streptococcus suis str. 8074 |
| Firmicutes | Bacilli | Lactobacillales | Streptococcaceae | sf_1 | 3251 | Streptococcus cristatus str. ATCC 51100 |
| Firmicutes | Bacilli | Lactobacillales | Streptococcaceae | sf_1 | 3287 | tongue dorsum scrapings clone FP015 |
| Firmicutes | Bacilli | Lactobacillales | Streptococcaceae | sf_1 | 3290 | Streptococcus mitis str. Sm91 |
| Firmicutes | Bacilli | Lactobacillales | Streptococcaceae | sf_1 | 3629 | Streptococcus mutans str. UA96 |
| Firmicutes | Bacilli | Lactobacillales | Streptococcaceae | sf_1 | 3685 | Streptococcus gordonii str. ATCC 10558 |
| Firmicutes | Clostridia | Clostridiales | Syntrophomonadaceae | sf_5 | 2456 | granular sludge clone R4b14 |
| Firmicutes | Bacilli | Bacillales | Thermoactinomycetaceae | sf_1 | 3301 | Thermoactinomyces sp. str. 700375 |
| Firmicutes | Unclassified | Unclassified | Unclassified | sf_8 | 546 | Ferribacter thermoautotrophicus |
| Firmicutes | Clostridia | Clostridiales | Unclassified | sf_17 | 2324 | |
| Firmicutes | Desulfotomaculum | Unclassified | Unclassified | sf_1 | 2351 | Desulfotomaculum thermobenzoicum str. DSM 6193 |
| Firmicutes | Desulfotomaculum | Unclassified | Unclassified | sf_1 | 2359 | UASB granular sludge clone JP |
| Firmicutes | Clostridia | Unclassified | Unclassified | sf_3 | 2373 | |
| Firmicutes | Symbiobacteria | Symbiobacterales | Unclassified | sf_1 | 2388 | G + C Gram-positive clone YNPRH70A |
| Firmicutes | Unclassified | Unclassified | Unclassified | sf_8 | 2433 | Ferribacter thermoautotrophicus str. |
| | | | | | | JW/JH-Fiji-2 |
| Firmicutes | Desulfotomaculum | Unclassified | Unclassified | sf_1 | 2443 | Desulfotomaculum thermoacetoxidans str. DSM |
| | | | | | | 5813 |
| Firmicutes | Desulfotomaculum | Unclassified | Unclassified | sf_1 | 2490 | Desulfotomaculum solfataricum str. V21 |
| Firmicutes | Clostridia | Unclassified | Unclassified | sf_4 | 2398 | deep marine sediment clone MB-C2-106 |
| Firmicutes | Symbiobacteria | Symbiobacterales | Unclassified | sf_1 | 77 | thermal soil clone YNPFFP9 |
| Firmicutes | Clostridia | Clostridiales | Unclassified | sf_17 | 926 | |
| Firmicutes | Desulfotomaculum | Unclassified | Unclassified | sf_1 | 198 | Pelotomaculum sp. str. JT |
| Firmicutes | Catabacter | Unclassified | Unclassified | sf_4 | 2716 | termite gut homogenate clone Rs-F76 bacterium |
| Firmicutes | Clostridia | Clostridiales | Unclassified | sf_17 | 3476 | |
| Firmicutes | Bacilli | Lactobacillales | Unclassified | sf_1 | 3289 | Isobaculum melis CCUG 37660T |
| Firmicutes | Bacilli | Lactobacillales | Unclassified | sf_1 | 3481 | |
| Firmicutes | Clostridia | Clostridiales | Unclassified | sf_17 | 4168 | |
| Firmicutes | Catabacter | Unclassified | Unclassified | sf_4 | 4503 | termite gut homogenate clone Rs-H83 bacterium |
| Firmicutes | Unclassified | Unclassified | Unclassified | sf_8 | 4536 | Mono Lake at depth 35 m station 6 Jul. 2000 |
| | | | | | | clone ML635J-14 G + C |
| Firmicutes | Clostridia | Unclassified | Unclassified | sf_7 | 4216 | |
| Firmicutes | Catabacter | Unclassified | Unclassified | sf_1 | 4261 | termite gut homogenate clone Rs-G04 bacterium |
| Firmicutes | Catabacter | Unclassified | Unclassified | sf_1 | 4293 | termite gut homogenate clone Rs-Q01 bacterium |
| Firmicutes | gut clone group | Unclassified | Unclassified | sf_1 | 4298 | human mouth clone P4PA_66 |
| Firmicutes | Clostridia | Clostridiales | Unclassified | sf_17 | 4307 | |
| Firmicutes | Catabacter | Unclassified | Unclassified | sf_4 | 4526 | TCE-contaminated site clone ocslm210 |
| Firmicutes | gut clone group | Unclassified | Unclassified | sf_1 | 4616 | rumen clone F23-C12 |
| Fusobacteria | Fusobacteria | Fusobacterales | Fusobacteriaceae | sf_3 | 367 | Leptotrichia amnionii str. AMN-1 |
| Fusobacteria | Fusobacteria | Fusobacterales | Fusobacteriaceae | sf_3 | 558 | Sneathia sanguinegens str. CCUG 41628T |
| Fusobacteria | Fusobacteria | Fusobacterales | Fusobacteriaceae | sf_1 | 488 | Fusobacterium nucleatum subsp. vincentii str. |
| | | | | | | ATCC 49256 |
| Gemmatimonadetes | Unclassified | Unclassified | Unclassified | sf_5 | 442 | forest soil clone S0134 |
| Gemmatimonadetes | Unclassified | Unclassified | Unclassified | sf_5 | 227 | uranium mining waste pile clone JG37-AG-36 |
| Gemmatimonadetes | Unclassified | Unclassified | Unclassified | sf_5 | 9464 | lodgepole pine rhizosphere soil British Columbia |
| | | | | | | Ministry Forests Long-Term Soil Productivity |
| Gemmatimonadetes | Unclassified | Unclassified | Unclassified | sf_5 | 10112 | forest soil clone NOS7.157WL |
| Gemmatimonadetes | Unclassified | Unclassified | Unclassified | sf_5 | 317 | penguin droppings sediments clone KD8-87 |
| Gemmatimonadetes | Unclassified | Unclassified | Unclassified | sf_5 | 1127 | uranium mining waste pile near |
| | | | | | | Johanngeorgenstadt soil clone JG37-AG-21 |
| Gemmatimonadetes | Unclassified | Unclassified | Unclassified | sf_5 | 1565 | uranium mining waste pile clone JG34-KF-418 |
| Gemmatimonadetes | Unclassified | Unclassified | Unclassified | sf_5 | 2047 | soil clone #0319-7G21 |
| LD1PA group | Unclassified | Unclassified | Unclassified | sf_1 | 10118 | anoxic marine sediment clone LD1-PA38 |
| Lentisphaerae | Unclassified | Unclassified | Unclassified | sf_5 | 10027 | Cytophaga sp. str. Dex80-43 |
| Lentisphaerae | Unclassified | Unclassified | Unclassified | sf_5 | 10330 | Mono lake clone ML635J-58 |
| Lentisphaerae | Unclassified | Unclassified | Unclassified | sf_5 | 9704 | Cytophaga sp. str. Dex80-64 |
| marine group A | mgA-2 | Unclassified | Unclassified | sf_1 | 6344 | bacterioplankton clone ZA3648c |
| marine group A | mgA-1 | Unclassified | Unclassified | sf_1 | 6408 | Sargasso Sea |
| marine group A | mgA-1 | Unclassified | Unclassified | sf_1 | 6454 | marine clone SAR406 |
| Natronoanaerobium | Unclassified | Unclassified | Unclassified | sf_1 | 769 | fjord ikaite column clone un-c23 |
| Natronoanaerobium | Unclassified | Unclassified | Unclassified | sf_1 | 2437 | Mono Lake at depth 23 m station 6 Jul. 2000 |
| | | | | | | clone ML623J-19 |
| Natronoanaerobium | Unclassified | Unclassified | Unclassified | sf_1 | 3570 | Bacillus sp. clone ML1228J-1 |
| Natronoanaerobium | Unclassified | Unclassified | Unclassified | sf_1 | 3745 | Mono Lake at depth 35 m station 6 Jul. 2000 |
| | | | | | | clone ML635J-45 |
| Natronoanaerobium | Unclassified | Unclassified | Unclassified | sf_1 | 4377 | Mono Lake at depth 35 m station 6 Jul. 2000 |
| | | | | | | clone ML635J-65 G + C |
| NC10 | NC10-1 | Unclassified | Unclassified | sf_1 | 452 | vadose clone 5G01 |
| NC10 | NC10-1 | Unclassified | Unclassified | sf_1 | 536 | uranium mill tailings clone GuBH2-AD-8 |
| NC10 | NC10-2 | Unclassified | Unclassified | sf_1 | 10254 | uranium mill tailings soil sample clone |
| | | | | | | Sh765B-TzT-35 |
| Nitrospira | Nitrospira | Nitrospirales | Nitrospiraceae | sf_1 | 984 | uranium mining waste pile clone JG37-AG-131 |
| | | | | | | sp. |
| Nitrospira | Nitrospira | Nitrospirales | Nitrospiraceae | sf_2 | 542 | forested wetland clone FW19 |
| Nitrospira | Nitrospira | Nitrospirales | Nitrospiraceae | sf_2 | 544 | forested wetland clone FW5 |
| Nitrospira | Nitrospira | Nitrospirales | Nitrospiraceae | sf_2 | 697 | forested wetland clone FW118 |
| OP10 | CH21 duster | Unclassified | Unclassified | sf_1 | 326 | geothermal clone ST01-SN3H |
| OP10 | Unclassified | Unclassified | Unclassified | sf_4 | 484 | forested wetland clone FW68 |
| OP10 | CH21 duster | Unclassified | Unclassified | sf_1 | 514 | sludge clone SBRA136 |
| OP10 | Unclassified | Unclassified | Unclassified | sf_5 | 9782 | Rocky Mountain alpine soil clone S1a-1H |
| OP3 | Unclassified | Unclassified | Unclassified | sf_4 | 628 | CB-contaminated groundwater clone GOUTB15 |
| OP3 | Unclassified | Unclassified | Unclassified | sf_2 | 349 | soil clone PBS-25 |
| OP9/JS1 | OP9 | Unclassified | Unclassified | sf_1 | 726 | hot spring clone OPB72 |
| OP9/JS1 | OP9 | Unclassified | Unclassified | sf_1 | 969 | DCP-dechlorinating consortium clone SHA-1 |
| phylum_tax | class_tax | order_tax | family_tax | subfamily | otu_id | rep_prokMSAname |
| Planctomycetes | Planctomycetacia | Planctomycetales | Anammoxales | sf_2 | 4683 | anoxic basin clone CY0ARA028B09 |
| Planctomycetes | Planctomycetacia | Planctomycetales | Anammoxales | sf_4 | 4694 | USA: Colorado Fort collins Horsetooth Reservoir |
| | | | | | | clone HT2F11 |
| Planctomycetes | Planctomycetacia | Planctomycetales | Anammoxales | sf_4 | 9662 | Great Artesian Basin clone B83 |
| Planctomycetes | Planctomycetacia | Planctomycetales | Pirellulae | sf_3 | 4670 | |
| Planctomycetes | Planctomycetacia | Planctomycetales | Pirellulae | sf_3 | 4677 | aerobic basin clone CY0ARA032A03 |
| Planctomycetes | Planctomycetacia | Planctomycetales | Planctomycetaceae | sf_3 | 4652 | anoxic basin clone CY0ARA028C04 |
| Planctomycetes | Planctomycetacia | Planctomycetales | Planctomycetaceae | sf_3 | 4948 | anoxic basin clone CY0ARA027D01 |
| Proteobacteria | Alphaproteobacteria | Acetobacterales | Acetobacteraceae | sf_1 | 7529 | Gluconacetobacter europaeus str. ZIM B028 V3 |
| Proteobacteria | Gammaproteobacteria | Acidithiobacillales | Acidithiobacillaceae | sf_1 | 8320 | acid mine drainage clone BA11 |
| Proteobacteria | Gammaproteobacteria | Acidithiobacillales | Acdithiobacillaceae | sf_1 | 8552 | Acidithiobacillus ferrooxidans str. D2 |
| Proteobacteria | Gammaproteobacteria | Acidithiobacillales | Acidithiobacillaceae | sf_1 | 9224 | Acidithiobacillus albertensis str. DSM 14366 |
| Proteobacteria | Gammaproteobacteria | Acidithiobacillales | Acidithiobacillaceae | sf_1 | 9497 | Acidithiobacillus ferrooxidans str. ATCC 19859 |
| Proteobacteria | Gammaproteobacteria | Aeromonadales | Aeromonadaceae | sf_1 | 9294 | Arctic deep sea Isolation common |
| | | | | | | chemoorganotrophic oxygen-respiring polar |
| | | | | | | current d 1210 |
| Proteobacteria | Gammaproteobacteria | Aeromonadales | Aeromonadaceae | sf_1 | 8340 | Aeromonas ichthiosmia |
| Proteobacteria | Gammaproteobacteria | Aeromonadales | Aeromonadaceae | sf_1 | 8364 | Aeromonas allosaccharophila str. CECT 4199 |
| Proteobacteria | Gammaproteobacteria | Aeromonadales | Aeromonadaceae | sf_1 | 8621 | Aeromonas sp. PAR2A |
| Proteobacteria | Gammaproteobacteria | Aeromonadales | Aeromonadaceae | sf_1 | 9000 | Aeromonas culicicola str. MTCC 3249 |
| Proteobacteria | Gammaproteobacteria | Aeromonadales | Aeromonadaceae | sf_1 | 9026 | Haemophilus piscium str. NCIMB 1952 |
| Proteobacteria | Gammaproteobacteria | Aeromonadales | Aeromonadaceae | sf_1 | 9440 | Aeromonas sobria str. NCIMB 12065 |
| Proteobacteria | Gammaproteobacteria | Aeromonadales | Aeromonadaceae | sf_1 | 9494 | Aeromonas molluscorum str. 849T |
| Proteobacteria | Betaproteobacteria | Burkholderiales | Alcaligenaceae | sf_1 | 7737 | atrazine-catabolizing microbial presence |
| | | | | | | methanol clone KRA30+06A |
| Proteobacteria | Betaproteobacteria | Burkholderiales | Alcaligenaceae | sf_1 | 7768 | swine intestine clone p-861-a5 |
| Proteobacteria | Betaproteobacteria | Burkholderiales | Alcaligenaceae | sf_1 | 7788 | atrazine-catabolizing microbial absence |
| | | | | | | methanol clone KRA30-58 |
| Proteobacteria | Betaproteobacteria | Burkholderiales | Alcaligenaceae | sf_1 | 7838 | Alcaligenes defragrans str. PD-19 |
| Proteobacteria | Betaproteobacteria | Burkholderiales | Alcaligenaceae | sf_1 | 7902 | Alcaligenes faecalis str. M3A |
| Proteobacteria | Betaproteobacteria | Burkholderiales | Alcaligenaceae | sf_1 | 7932 | Achromobacter subsp. denitrificans str. DSM |
| | | | | | | 30026 (T) |
| Proteobacteria | Betaproteobacteria | Burkholderiales | Alcaligenaceae | sf_1 | 7984 | Waste-gas biofilter clone BIfciii38 |
| Proteobacteria | Betaproteobacteria | Burkholderiales | Alcaligenaceae | sf_1 | 7992 | Alcaligenes faecalis 5659-H |
| Proteobacteria | Betaproteobacteria | Burkholderiales | Alcaligenaceae | sf_1 | 8062 | Brackiella oedipodis str. LMG 1945 R8846 |
| Proteobacteria | Betaproteobacteria | Burkholderiales | Alcaligenaceae | sf_1 | 8094 | Alcaligenes sp. str. VKM B-2263 dcm6 |
| Proteobacteria | Gammaproteobacteria | Oceanospirillales | Alcanivoraceae | sf_1 | 8335 | Alcanivorax sp. str. K3-3 (MBIC 4323) |
| Proteobacteria | Gammaproteobacteria | Oceanospirillales | Alcanivoraceae | sf_1 | 9658 | Alcanivorax sp. str. Haw1 |
| Proteobacteria | Gammaproteobacteria | Alteromonadales | Alteromonadaceae | sf_1 | 9035 | Microbulbifer sp. str. JAMB-A94 |
| Proteobacteria | Gammaproteobacteria | Alteromonadales | Alteromonadaceae | sf_1 | 8348 | Arctic sea ice ARK10038 |
| Proteobacteria | Gammaproteobacteria | Alteromonadales | Alteromonadaceae | sf_1 | 8484 | Alteromonadaceae isolate str. LA50 |
| Proteobacteria | Gammaproteobacteria | Alteromonadales | Alteromonadaceae | sf_1 | 8503 | Arctic sea ice ARK10244 |
| Proteobacteria | Gammaproteobacteria | Alteromonadales | Alteromonadaceae | sf_1 | 8578 | Marinobacter lipolyticus str. SM-19 |
| Proteobacteria | Gammaproteobacteria | Alteromonadales | Alteromonadaceae | sf_1 | 8594 | Marinobacter sp. str. SBS |
| Proteobacteria | Gammaproteobacteria | Alteromonadales | Alteromonadaceae | sf_1 | 9239 | Arctic sea ice ARK10228 |
| Proteobacteria | Gammaproteobacteria | Alteromonadales | Alteromonadaceae | sf_1 | 8196 | |
| Proteobacteria | Gammaproteobacteria | Alteromonadales | Alteromonadaceae | sf_1 | 8222 | |
| Proteobacteria | Gammaproteobacteria | Alteromonadales | Alteromonadaceae | sf_1 | 8600 | Colwellia piezophila str. Y223G |
| Proteobacteria | Gammaproteobacteria | Alteromonadales | Alteromonadaceae | sf_1 | 8753 | Idiomarina loihiensis str. GSP37 |
| Proteobacteria | Gammaproteobacteria | Alteromonadales | Alteromonadaceae | sf_1 | 8174 | attached marine recovered surface clone 17 |
| | | | | | | proteobacterium |
| Proteobacteria | Gammaproteobacteria | Alteromonadales | Alteromonadaceae | sf_1 | 8318 | Aestuariibacter salexigens str. JC2042 |
| Proteobacteria | Gammaproteobacteria | Alteromonadales | Alteromonadaceae | sf_1 | 8374 | Agarivorans albus str. MKT 89 |
| Proteobacteria | Gammaproteobacteria | Alteromonadales | Alteromonadaceae | sf_1 | 8533 | |
| Proteobacteria | Gammaproteobacteria | Alteromonadales | Alteromonadaceae | sf_1 | 8695 | Arctic pack ice; northern Fram Strait; 80 31.1 N; |
| | | | | | | 01 deg 59.7 min E clone ARKIA-34 |
| Proteobacteria | Gammaproteobacteria | Alteromonadales | Alteromonadaceae | sf_1 | 8863 | Alteromonas marina str. SW-47 |
| Proteobacteria | Gammaproteobacteria | Alteromonadales | Alteromonadaceae | sf_1 | 8970 | Arctic seawater isolate str. R9879 |
| Proteobacteria | Gammaproteobacteria | Alteromonadales | Alteromonadaceae | sf_1 | 8978 | Arctic sea ice ARK10108 |
| Proteobacteria | Gammaproteobacteria | Alteromonadales | Alteromonadaceae | sf_1 | 9230 | Antarctic pack ice Lasarev Sea Southern Ocean |
| | | | | | | clone ANTXI/4_14-62 sea |
| Proteobacteria | Gammaproteobacteria | Alteromonadales | Alteromonadaceae | sf_1 | 9236 | attached marine recovered surface clone 18 |
| | | | | | | proteobacterium |
| Proteobacteria | Gammaproteobacteria | Alteromonadales | Alteromonadaceae | sf_1 | 9288 | Alteromonas stellipolaris str. LMG 21861 |
| Proteobacteria | Gammaproteobacteria | Alteromonadales | Alteromonadaceae | sf_1 | 9292 | |
| Proteobacteria | Gammaproteobacteria | Alteromonadales | Alteromonadaceae | sf_1 | 9501 | sea water isolate str. BP-PH |
| Proteobacteria | Gammaproteobacteria | Alteromonadales | Alteromonadaceae | sf_1 | 9562 | Alteromonadaceae clone PH-B55N |
| Proteobacteria | Gammaproteobacteria | Alteromonadales | Alteromonadaceae | sf_1 | 8172 | Pseudoalteromonas sp. str. Bdeep-1 |
| Proteobacteria | Gammaproteobacteria | Alteromonadales | Alteromonadaceae | sf_1 | 8336 | Alteromonas sp. str. MS23 |
| Proteobacteria | Gammaproteobacteria | Alteromonadales | Alteromonadaceae | sf_1 | 8580 | Arctic seawater isolate str. R7076 |
| Proteobacteria | Gammaproteobacteria | Alteromonadales | Alteromonadaceae | sf_1 | 8932 | Pseudoalteromonas antarctica str. N-1 |
| Proteobacteria | Gammaproteobacteria | Alteromonadales | Alteromonadaceae | sf_1 | 8975 | Alteromonas sp. str. NIBH P1M3 |
| Proteobacteria | Gammaproteobacteria | Alteromonadales | Alteromonadaceae | sf_1 | 9058 | Pseudoalteromonas carrageenovora str. ATCC |
| | | | | | | 12662T |
| Proteobacteria | Gammaproteobacteria | Alteromonadales | Alteromonadaceae | sf_1 | 9111 | Pseudoalteromonas sp. str. E36 |
| Proteobacteria | Gammaproteobacteria | Alteromonadales | Alteromonadaceae | sf_1 | 9143 | Pseudoalteromonas agarivorans str. KMM 255 |
| Proteobacteria | Gammaproteobacteria | Alteromonadales | Alteromonadaceae | sf_1 | 9205 | marine clone Arctic96B-17 |
| Proteobacteria | Gammaproteobacteria | Alteromonadales | Alteromonadaceae | sf_1 | 9218 | Pseudoalteromonas haloplanktis str. ATCC 14393 |
| Proteobacteria | Gammaproteobacteria | Alteromonadales | Alteromonadaceae | sf_1 | 9324 | Pseudoalteromonas ruthenica str. KMM300 |
| Proteobacteria | Gammaproteobacteria | Alteromonadales | Alteromonadaceae | sf_1 | 9386 | Alteromonas sp. str. NIBH P2M11 |
| Proteobacteria | Gammaproteobacteria | Alteromonadales | Alteromonadaceae | sf_1 | 9640 | exposed to diatom detritus isolate str. Tw-10 |
| | | | | | | Tw-10 |
| Proteobacteria | Gammaproteobacteria | Alteromonadales | Alteromonadaceae | sf_1 | 8643 | Pseudoalteromonas porphyrae str. S2-65 |
| Proteobacteria | Gammaproteobacteria | Alteromonadales | Alteromonadaceae | sf_1 | 9369 | Pseudoalteromonas luteoviolacea str. NCIMB 1893T |
| Proteobacteria | Gammaproteobacteria | Alteromonadales | Alteromonadaceae | sf_1 | 9222 | Shewanella hanedai str. CIP 103207T |
| Proteobacteria | Gammaproteobacteria | Alteromonadales | Alteromonadaceae | sf_1 | 9384 | Moritella viscosa str. NVI 88/478T |
| Proteobacteria | Gammaproteobacteria | Alteromonadales | Alteromonadaceae | sf_1 | 8916 | Shewanella algae str. 43940 |
| Proteobacteria | Gammaproteobacteria | Alteromonadales | Alteromonadaceae | sf_1 | 9067 | Shewanella algae str. ACM 4733 |
| Proteobacteria | Gammaproteobacteria | Alteromonadales | Alteromonadaceae | sf_1 | 9416 | marine isolate str. R8 |
| Proteobacteria | Gammaproteobacteria | Alteromonadales | Alteromonadaceae | sf_1 | 9586 | Shewanella gaetbuli str. TF-27 |
| Proteobacteria | Gammaproteobacteria | Alteromonadales | Alteromonadaceae | sf_1 | 8579 | Psychromonas profunda str. 2825 |
| Proteobacteria | Alphaproteobacteria | Ricketisiales | Anaplasmataceae | sf_3 | 6628 | Wolbachia pipientis |
| Proteobacteria | Alphaproteobacteria | Rickettsiales | Anaplasmataceae | sf_3 | 6648 | Wolbachia sp |
| Proteobacteria | Alphaproteobacteria | Rickettsiales | Anaplasmataceae | sf_3 | 6803 | Wolbachia sp. Dlem16SWol |
| Proteobacteria | Alphaproteobacteria | Ricketisiales | Anaplasmataceae | sf_3 | 6908 | Rhinocyllus conicus endosymbiont |
| Proteobacteria | Alphaproteobacteria | Rickettsiales | Anaplasmataceae | sf_3 | 7481 | Wolbachia pipientis |
| Proteobacteria | Alphaproteobacteria | Rhizobiales | Bartonellaceae | sf_1 | 7056 | Bartonella schoenbuchensis str. R1 |
| Proteobacteria | Alphaproteobacteria | Rhizobiales | Bartonellaceae | sf_1 | 7384 | aortic heart valve patient with endocarditis |
| | | | | | | clone v9 |
| Proteobacteria | Alphaproteobacteria | Rhizobiales | Bartonellaceae | sf_1 | 7415 | Bartonella quintana str. Toulouse |
| Proteobacteria | Alphaproteobacteria | Rhizobiales | Bartonellaceae | sf_1 | 7634 | Bartonella henselae str. Houston-1 |
| Proteobacteria | Deltaproteobacteria | Bdellovibrionales | Bdellovibrionaceae | sf_1 | 10010 | uranium mining waste pile clone JG37-AG-139 |
| | | | | | | proteobacterium |
| Proteobacteria | Alphaproteobacteria | Bradyrhizobiales | Beijerinck/Rhodoplan/Methylocyst | sf_3 | 7401 | Scrippsiella trochoidea NEPCC 15 |
| Proteobacteria | Alphaproteobacteria | Bradyrhizobiales | Beijerinck/Rhodoplan/Methylocyst | sf_3 | 6651 | Beijerinckia indica |
| Proteobacteria | Alphaproteobacteria | Bradyrhizobiales | Beijerinck/Rhodoplan/Methylocyst | sf_3 | 7275 | Mammoth cave clone CCU18 |
| Proteobacteria | Alphaproteobacteria | Bradyrhizobiales | Beijerinck/Rhodoplan/Methylocyst | sf_3 | 7219 | Methylosinus sporium |
| Proteobacteria | Alphaproteobacteria | Bradyrhizobiales | Beijerinck/Rhodoplan/Methylocyst | sf_3 | 7640 | Methylosinus trichosporium |
| Proteobacteria | Alphaproteobacteria | Bradyrhizobiales | Beijerinck/Rhodoplan/Methylocyst | sf_3 | 6762 | acidic forest soil clone UP8 |
| Proteobacteria | Alphaproteobacteria | Bradyrhizobiales | Beijerinck/Rhodoplan/Methylocyst | sf_3 | 7153 | Methylocella tundrae str. Y1 |
| Proteobacteria | Alphaproteobacteria | Rhizobiales | Bradyrhizobiaceae | sf_1 | 7029 | |
| Proteobacteria | Alphaproteobacteria | Bradyrhizobiales | Bradyrhizobiaceae | sf_1 | 7403 | Oligotropha carboxidovorans str. S23 |
| Proteobacteria | Alphaproteobacteria | Bradyrhizobiales | Bradyrhizobiaceae | sf_1 | 6927 | Nitrobacter hamburgensis str. X14 |
| Proteobacteria | Alphaproteobacteria | Bradyrhizobiales | Bradyrhizobiaceae | sf_1 | 6768 | Rhodopseudomonas palustris str. GH |
| Proteobacteria | Alphaproteobacteria | Bradyrhizobiales | Bradyrhizobiaceae | sf_1 | 6799 | Rhodopseudomonas palustris str. ATCC 17001 |
| Proteobacteria | Alphaproteobacteria | Bradyrhizobiales | Bradyrhizobiaceae | sf_1 | 7316 | |
| Proteobacteria | Alphaproteobacteria | Bradyrhizobiales | Bradyrhizobiaceae | sf_1 | 7333 | Afipia genosp. 4 str. G3644 |
| Proteobacteria | Alphaproteobacteria | Bradyrhizobiales | Bradyrhizobiaceae | sf_1 | 6941 | Rhodopseudomonas rhenobacensis str. Klemme Rb |
| Proteobacteria | Alphaproteobacteria | Bradyrhizobiales | Bradyrhizobiaceae | sf_1 | 7087 | Bradyrhizobium japonicum HA1 |
| Proteobacteria | Alphaproteobacteria | Bradyrhizobiales | Bradyrhizobiaceae | sf_1 | 7398 | Bradyrhizobium japonicum str. USDA 38 |
| Proteobacteria | Alphaproteobacteria | Bradyrhizobiales | Bradyrhizobiaceae | sf_1 | 6636 | Bradyrhizobium elkanii str. USDA 76 |
| Proteobacteria | Alphaproteobacteria | Bradyrhizobiales | Bradyrhizobiaceae | sf_1 | 6867 | heavy metal-contaminated soil clone a13131 |
| Proteobacteria | Alphaproteobacteria | Bradyrhizobiales | Bradyrhizobiaceae | sf_1 | 6887 | Bradyrhizobium str. YB2 |
| Proteobacteria | Alphaproteobacteria | Bradyrhizobiales | Bradyrhizobiaceae | sf_1 | 7044 | Afipia genosp. 2 str. G4438 |
| Proteobacteria | Alphaproteobacteria | Bradyrhizobiales | Bradyrhizobiaceae | sf_1 | 7126 | ground water deep-well injection disposal site |
| | | | | | | radioactive wastes Tomsk-7 clone S15A-MN96 |
| | | | | | | proteobacterium |
| Proteobacteria | Alphaproteobacteria | Bradyrhizobiales | Bradyrhizobiaceae | sf_1 | 7390 | Afipia genosp. 10 str. G8996 |
| Proteobacteria | Alphaproteobacteria | Bradyrhizobiales | Bradyrhizobiaceae | sf_1 | 7477 | Bradyrhizobium elkanii str. SEMIA 6028 |
| Proteobacteria | Alphaproteobacteria | Bradyrhizobiales | Bradyrhizobiaceae | sf_1 | 7522 | Bradyrhizobium sp. str. KKI14 |
| Proteobacteria | Alphaproteobacteria | Bradyrhizobiales | Bradyrhizobiaceae | sf_1 | 6878 | Bradyrhizobium japonicum SD5 |
| Proteobacteria | Alphaproteobacteria | Bradyrhizobiales | Bradyrhizobiaceae | sf_1 | 6917 | Bradyrhizobium japonicum str. IAM 12608 |
| Proteobacteria | Alphaproteobacteria | Bradyrhizobiales | Bradyrhizobiaceae | sf_1 | 7353 | temperate estuarine mud clone HC65 |
| Proteobacteria | Alphaproteobacteria | Rhizobiales | Brucellaceae | sf_1 | 6757 | Ochrobactrum anthropi str. ESC1 |
| Proteobacteria | Alphaproteobacteria | Rhizobiales | Brucellaceae | sf_1 | 6981 | Ochrobactrum gallinifaecis str. Iso 196 |
| Proteobacteria | Alphaproteobacteria | Rhizobiales | Brucellaceae | sf_1 | 6995 | |
| Proteobacteria | Betaproteobacteria | Burkholderiales | Burkholderiaceae | sf_1 | 7720 | penguin droppings sediments clone KD1-79 |
| Proteobacteria | Betaproteobacteria | Burkholderiales | Burkholderiaceae | sf_1 | 7771 | Burkholderia glathei str. ATCC 29195T |
| Proteobacteria | Betaproteobacteria | Burkholderiales | Burkholderiaceae | sf_1 | 7782 | Burkholderia hospita str. LMG 20598T |
| Proteobacteria | Betaproteobacteria | Burkholderiales | Burkholderiaceae | sf_1 | 7969 | Burkholderia sp. |
| Proteobacteria | Betaproteobacteria | Burkholderiales | Burkholderiaceae | sf_1 | 8059 | Burkholderia caribensis str. MWAP71 |
| Proteobacteria | Betaproteobacteria | Burkholderiales | Burkholderiaceae | sf_1 | 8068 | Burkholderia caryophylli str. ATCC 25418 |
| Proteobacteria | Betaproteobacteria | Burkholderiales | Burkholderiaceae | sf_1 | 7747 | |
| Proteobacteria | Alphaproteobacteria | Consistiales | Caedibacteraceae | sf_4 | 7157 | acid mine drainage clone ASL45 |
| Proteobacteria | Alphaproteobacteria | Consistiales | Caedibacteraceae | sf_5 | 6947 | termite gut homogenate clone Rs-B60 |
| | | | | | | proteobacterium |
| Proteobacteria | Epsilonproteobacteria | Campylobacterales | Campylobacteraceae | sf_3 | 10446 | |
| Proteobacteria | Epsilonproteobacteria | Campylobacterales | Campylobacteraceae | sf_3 | 10461 | deepest cold-seep area Japan Trench clone |
| | | | | | | JTB360 proteobacterium |
| Proteobacteria | Epsilonproteobacteria | Campylobacterales | Campylobacteraceae | sf_3 | 10523 | Riftia pachyptila's tube clone R103-B70 |
| Proteobacteria | Epsilonproteobacteria | Campylobacterales | Campylobacteraceae | sf_3 | 10538 | Arcobacter cryaerophilus |
| Proteobacteria | Epsilonproteobacteria | Campylobacterales | Campylobacteraceae | sf_3 | 10447 | Sulfurospirillum deleyianum str. Spirillum 5175 |
| Proteobacteria | Epsilonproteobacteria | Campylobacterales | Campylobacteraceae | sf_3 | 10464 | Campylobacter sp. str. NO2B |
| Proteobacteria | Epsilonproteobacteria | Campylobacterales | Campylobacteraceae | sf_3 | 10434 | Campylobacter gracilis |
| Proteobacteria | Epsilonproteobacteria | Campylobacterales | Campylobacteraceae | sf_3 | 10456 | Campylobacter showae |
| Proteobacteria | Epsilonproteobacteria | Campylobacterales | Campylobacteraceae | sf_3 | 10463 | Campylobacter subsp. fetus |
| Proteobacteria | Epsilonproteobacteria | Campylobacterales | Campylobacteraceae | sf_3 | 10484 | Campylobacter helveticus |
| Proteobacteria | Epsilonproteobacteria | Campylobacterales | Campylobacteraceae | sf_3 | 10540 | Campylobacter showae str. LMG 12636 |
| Proteobacteria | Gammaproteobacteria | Cardiobacteriales | Cardiobacteriaceae | sf_1 | 8536 | Cardiobacterium hominis |
| Proteobacteria | Alphaproteobacteria | Caulobacterales | Caulobacteraceae | sf_1 | 7486 | Asticcacaulis excentricus str. ATCC15261 |
| Proteobacteria | Alphaproteobacteria | Caulobacterales | Caulobacteraceae | sf_1 | 6781 | Brevundimonas intermedia str. MBIC2712 |
| | | | | | | ATCC15262 |
| Proteobacteria | Alphaproteobacteria | Caulobacterales | Caulobacteraceae | sf_1 | 6904 | Brevundimonas vesicularis str. IAM 12105T |
| Proteobacteria | Alphaproteobacteria | Caulobacterales | Caulobacteraceae | sf_1 | 6909 | Brevundimonas diminuta str. DSM 1635 |
| Proteobacteria | Alphaproteobacteria | Caulobacterales | Caulobacteraceae | sf_1 | 6968 | Brevundimonas diminuta str. IAM 12691T |
| Proteobacteria | Alphaproteobacteria | Caulobacterales | Caulobacteraceae | sf_1 | 7359 | Brevundimonas bacteroides str. CB7 |
| Proteobacteria | Alphaproteobacteria | Caulobacterales | Caulobacteraceae | sf_1 | 7366 | Brevundimonas subvibrioides str. CB81 |
| Proteobacteria | Alphaproteobacteria | Caulobacterales | Caulobacteraceae | sf_1 | 7436 | Brevundimonas sp. str. FWC40 |
| Proteobacteria | Gammaproteobacteria | Chromatiales | Chromatiaceae | sf_1 | 9048 | Allochromatium sp. AT2202 |
| Proteobacteria | Gammaproteobacteria | Chromatiales | Chromatiaceae | sf_1 | 8546 | Thiocapsa litoralis |
| Proteobacteria | Gammaproteobacteria | Chromatiales | Chromatiaceae | sf_1 | 8527 | |
| Proteobacteria | Gammaproteobacteria | Chromatiales | Chromatiaceae | sf_1 | 8697 | Thiococcus sp. AT2204 |
| Proteobacteria | Gammaproteobacteria | Chromatiales | Chromatiaceae | sf_1 | 9054 | |
| Proteobacteria | Gammaproteobacteria | Chromatiales | Chromatiaceae | sf_1 | 9052 | |
| Proteobacteria | Gammaproteobacteria | Chromatiales | Chromatiaceae | sf_1 | 9356 | |
| Proteobacteria | Gammaproteobacteria | Chromatiales | Chromatiaceae | sf_1 | 9370 | isolate str. HTB019 |
| Proteobacteria | Betaproteobacteria | Burkholderiales | Comamonadaceae | sf_1 | 8112 | Comamonas testosteroni str. SMCC B329 |
| Proteobacteria | Betaproteobacteria | Burkholderiales | Comamonadaceae | sf_1 | 7704 | freshwater clone PRD01b009B |
| Proteobacteria | Betaproteobacteria | Burkholderiales | Comamonadaceae | sf_1 | 7705 | penguin droppings sediments clone KD4-7 |
| Proteobacteria | Betaproteobacteria | Burkholderiales | Comamonadaceae | sf_1 | 7801 | Toolik Lake main station at 3 m depth clone |
| | | | | | | TLM05/TLMdgge10 proteobacterium |
| Proteobacteria | Betaproteobacteria | Burkholderiales | Comamonadaceae | sf_1 | 7829 | Xylophilus ampelinus str. ATCC 33914 |
| Proteobacteria | Betaproteobacteria | Burkholderiales | Comamonadaceae | sf_1 | 7928 | penguin droppings sediments clone KD5-43 |
| Proteobacteria | Betaproteobacteria | Burkholderiales | Comamonadaceae | sf_1 | 7941 | MCB-contaminated groundwater-treating |
| | | | | | | reactor clone RB9C10 |
| Proteobacteria | Betaproteobacteria | Burkholderiales | Comamonadaceae | sf_1 | 7986 | Arctic sea ice ARK10281 |
| Proteobacteria | Betaproteobacteria | Burkholderiales | Comamonadaceae | sf_1 | 8138 | Pseudomonas lanceolata str. ATCC 14669T |
| Proteobacteria | Betaproteobacteria | Burkholderiales | Comamonadaceae | sf_1 | 8139 | Delftia tsuruhatensis str. AD9 |
| Proteobacteria | Betaproteobacteria | Burkholderiales | Comamonadaceae | sf_1 | 7856 | Variovorax paradoxus |
| Proteobacteria | Betaproteobacteria | Burkholderiales | Comamonadaceae | sf_1 | 7964 | napthalene-contaminated sediment clone 76 |
| Proteobacteria | Betaproteobacteria | Burkholderiales | Comamonadaceae | sf_1 | 7888 | Hydrogenophaga flava str. DSM 619T |
| Proteobacteria | Betaproteobacteria | Burkholderiales | Comamonadaceae | sf_1 | 7919 | strain isolate str. rM4 |
| Proteobacteria | Betaproteobacteria | Burkholderiales | Comamonadaceae | sf_1 | 7987 | Acidovorax sp. str. OS-6 |
| Proteobacteria | Betaproteobacteria | Burkholderiales | Comamonadaceae | sf_1 | 8012 | Acidovorax konjaci str. DSM 7481 |
| Proteobacteria | Betaproteobacteria | Burkholderiales | Comamonadaceae | sf_1 | 8018 | Acidovorax delafieldii str. ATCC 17505 |
| Proteobacteria | Betaproteobacteria | Burkholderiales | Comamonadaceae | sf_1 | 8021 | Acidovorax facilis str. CCUG 2113 |
| Proteobacteria | Betaproteobacteria | Burkholderiales | Comamonadaceae | sf_1 | 8022 | Acidovorax avenae subsp. cattleyae str. NCPPB |
| | | | | | | 961 subsp. |
| Proteobacteria | Betaproteobacteria | Burkholderiales | Comamonadaceae | sf_1 | 8031 | strain isolate str. rJ10 |
| Proteobacteria | Betaproteobacteria | Burkholderiales | Comamonadaceae | sf_1 | 8046 | Acidovorax defluvii str. BSB411 |
| Proteobacteria | Betaproteobacteria | Burkholderiales | Comamonadaceae | sf_1 | 8152 | nephridia Octolasion lacteum clone Ol2-2 |
| Proteobacteria | Betaproteobacteria | Burkholderiales | Comamonadaceae | sf_1 | 7807 | Aquaspirillum metamorphum str. DSM 1837 |
| Proteobacteria | Betaproteobacteria | Burkholderiales | Comamonadaceae | sf_1 | 7884 | Germany: Elbe River clone Elb37 |
| Proteobacteria | Betaproteobacteria | Burkholderiales | Comamonadaceae | sf_1 | 7965 | Anoxobacterium dechloraticum |
| Proteobacteria | Gammaproteobacteria | Legionellales | Coxiellaceae | sf_3 | 7893 | agricultural soil clone SC-I-71 |
| Proteobacteria | Gammaproteobacteria | Legionellales | Coxiellaceae | sf_3 | 8457 | 5′ clone CHAB-XI-27 |
| Proteobacteria | Gammaproteobacteria | Legionellales | Coxiellaceae | sf_3 | 9198 | uranium mining waste pile clone KF-JG30-B15 |
| | | | | | | KF-JG30-B15 |
| Proteobacteria | Gammaproteobacteria | Legionellales | Coxiellaceae | sf_3 | 8969 | uranium mining waste pile soil sample clone |
| | | | | | | JG30-KF-C15 proteobacterium |
| Proteobacteria | Gammaproteobacteria | Legionellales | Coxiellaceae | sf_3 | 9444 | forested wetland clone FW23 |
| Proteobacteria | Deltaproteobacteria | Desulfobacterales | Desulfoarculaceae | sf_2 | 10227 | marine sediment clone Bol11 |
| Proteobacteria | Deltaproteobacteria | Desulfobacterales | Desulfobacteraceae | sf_5 | 9666 | marine sediment above hydrate ridge clone |
| | | | | | | Hyd89-13 proteobacterium |
| Proteobacteria | Deltaproteobacteria | Desulfobacterales | Desulfobacteraceae | sf_5 | 9875 | hydrothermal sediment clone AF420354 |
| Proteobacteria | Deltaproteobacteria | Desulfobacterales | Desulfobacteraceae | sf_5 | 9800 | forested wetland clone FW57 |
| Proteobacteria | Deltaproteobacteria | Desulfobacterales | Desulfobacteraceae | sf_5 | 10268 | |
| Proteobacteria | Deltaproteobacteria | Desulfobacterales | Desulfobacteraceae | sf_5 | 10046 | Desulfobacterium cetonicum str. DSM 7267 oil |
| | | | | | | recovery water |
| Proteobacteria | Deltaproteobacteria | Desulfobacterales | Desulfobacteraceae | sf_5 | 10239 | |
| Proteobacteria | Deltaproteobacteria | Desulfobacterales | Desulfobacteraceae | sf_5 | 10319 | sulfate-reducing habitat clone SLM-CP-116 |
| Proteobacteria | Deltaproteobacteria | Desulfobacterales | Desulfobacteraceae | sf_5 | 10031 | Antarctic sediment clone SB1_49 |
| Proteobacteria | Deltaproteobacteria | Desulfobacterales | Desulfobacteraceae | sf_5 | 10083 | Desulfobacter curvatus str. DSM 3379 |
| Proteobacteria | Deltaproteobacteria | Desulfobacterales | Desulfobacteraceae | sf_5 | 9940 | Antarctic sediment clone SB2_56 |
| Proteobacteria | Deltaproteobacteria | Desulfobacterales | Desulfobulbaceae | sf_1 | 10047 | epibiontic clone C11-D3 |
| Proteobacteria | Deltaproteobacteria | Desulfobacterales | Desulfobulbaceae | sf_1 | 10187 | Mono Lake at depth 23 m station 6 Jul. 2000 |
| | | | | | | clone ML623J-57 proteobacterium |
| Proteobacteria | Deltaproteobacteria | Desulfobacterales | Desulfobulbaceae | sf_1 | 9734 | Riftia pachyptila's tube clone R103-B13 |
| Proteobacteria | Deltaproteobacteria | Desulfobacterales | Desulfobulbaceae | sf_1 | 9739 | gas hydrate clone Hyd89-51 |
| Proteobacteria | Deltaproteobacteria | Desulfovibrionales | Desulfohalobiaceae | sf_1 | 9894 | Desulfonauticus submarinus str. 6N |
| Proteobacteria | Deltaproteobacteria | Desulfovibrionales | Desulfomicrobiaceae | sf_1 | 10079 | Desulfomicrobium baculatum str. DSM 1742 |
| Proteobacteria | Deltaproteobacteria | Desulfovibrionales | Desulfovibrionaceae | sf_1 | 10262 | Desulfovibrio sp. str. Ac5.2 |
| Proteobacteria | Deltaproteobacteria | Desulfovibrionales | Desulfovibrionaceae | sf_1 | 10248 | Desulfovibrio giganteus str. DSM 4370 |
| Proteobacteria | Deltaproteobacteria | Desulfovibrionales | Desulfovibrionaceae | sf_1 | 10016 | termite gut homogenate clone Rs-N35 |
| | | | | | | proteobacterium |
| Proteobacteria | Deltaproteobacteria | Desulfovibrionales | Desulfovibrionaceae | sf_1 | 9826 | termite gut homogenate clone Rs-M72 |
| | | | | | | proteobacterium |
| Proteobacteria | Deltaproteobacteria | Desulfovibrionales | Desulfovibrionaceae | sf_1 | 10071 | Desulfovibrio desulfuricans |
| Proteobacteria | Deltaproteobacteria | Desulfovibrionales | Desulfovibrionaceae | sf_1 | 10212 | |
| Proteobacteria | Deltaproteobacteria | Desulfovibrionales | Desulfovibrionaceae | sf_1 | 9709 | termite gut homogenate clone Rs-N31 |
| | | | | | | proteobacterium |
| Proteobacteria | Deltaproteobacteria | Desulfuromonadales | Desulfuromonaceae | sf_1 | 10020 | uranium mill tailings soil sample clone GuBH2- |
| | | | | | | AG-114 proteobacterium |
| Proteobacteria | Gammaproteobacteria | Chromatiales | Ectothiorhodospiraceae | sf_1 | 9450 | Halorhodospira neutrophila str. SG 3304 |
| Proteobacteria | Gammaproteobacteria | Chromatiales | Ectothiorhodospiraceae | sf_1 | 9598 | Mono Lake at depth 2 m station 6 Jul. 2000 clone |
| | | | | | | ML602J-47 proteobacterium |
| Proteobacteria | Gammaproteobacteria | Enterobacteriales | Enterobacteriaceae | sf_6 | 433 | coal effluent wetland clone RCP2-6 |
| Proteobacteria | Gammaproteobacteria | Enterobacteriales | Enterobacteriaceae | sf_6 | 646 | Opitutus sp. str. SA-9 |
| Proteobacteria | Gammaproteobacteria | Enterobacteriales | Enterobacteriaceae | sf_1 | 9309 | Buchnera sp |
| Proteobacteria | Gammaproteobacteria | Enterobacteriales | Enterobacteriaceae | sf_1 | 8742 | USA: New York isolate str. KN4 |
| Proteobacteria | Gammaproteobacteria | Enterobacteriales | Enterobacteriaceae | sf_6 | 8783 | Alterococcus agarolyticus str. ADT3; CCRC17102 |
| Proteobacteria | Gammaproteobacteria | Enterobacteriales | Enterobacteriaceae | sf_1 | 9135 | intestine Zophobas mori clone |
| Proteobacteria | Gammaproteobacteria | Enterobacteriales | Enterobacteriaceae | sf_1 | 9358 | Salmonella subsp. enterica serovar Waycross str. |
| | | | | | | Swy1 subsp. |
| Proteobacteria | Gammaproteobacteria | Enterobacteriales | Enterobacteriaceae | sf_1 | 9496 | |
| Proteobacteria | Gammaproteobacteria | Enterobacteriales | Enterobacteriaceae | sf_1 | 8886 | Salmonella typhimurium LT2 str. SGSC1412 |
| Proteobacteria | Gammaproteobacteria | Enterobacteriales | Enterobacteriaceae | sf_1 | 8740 | Erwinia chrysanthemi str. 573 |
| Proteobacteria | Gammaproteobacteria | Enterobacteriales | Enterobacteriaceae | sf_1 | 9651 | Pectobacterium subsp. atrosepticum str. GSPB |
| | | | | | | 1710 |
| Proteobacteria | Gammaproteobacteria | Enterobacteriales | Enterobacteriaceae | sf_1 | 8379 | Erwinia amylovora EA G-5 |
| Proteobacteria | Gammaproteobacteria | Enterobacteriales | Enterobacteriaceae | sf_1 | 9142 | Erwinia amylovora str. DSM 30165 |
| Proteobacteria | Gammaproteobacteria | Enterobacteriales | Enterobacteriaceae | sf_1 | 9252 | Pantoea cedenensis str. A34 |
| Proteobacteria | Gammaproteobacteria | Enterobacteriales | Enterobacteriaceae | sf_1 | 9345 | Erwinia amylovora str. BC199(=Ea528) |
| Proteobacteria | Gammaproteobacteria | Enterobacteriales | Enterobacteriaceae | sf_1 | 8554 | Kluyvera ascorbata 69 |
| Proteobacteria | Gammaproteobacteria | Enterobacteriales | Enterobacteriaceae | sf_1 | 8885 | Morganella morganii str. AP28 |
| Proteobacteria | Gammaproteobacteria | Enterobacteriales | Enterobacteriaceae | sf_1 | 9363 | Citrobacter freundii str. CDC 621-64 |
| Proteobacteria | Gammaproteobacteria | Enterobacteriales | Enterobacteriaceae | sf_1 | 9594 | Morganella morganii str. ATCC35200 |
| Proteobacteria | Gammaproteobacteria | Enterobacteriales | Enterobacteriaceae | sf_1 | 8758 | Pectobacterium cypripedii str. ATCC 29267 |
| Proteobacteria | Gammaproteobacteria | Enterobacteriales | Enterobacteriaceae | sf_1 | 8282 | Antonina pretiosa symbiont |
| Proteobacteria | Gammaproteobacteria | Enterobacteriales | Enterobacteriaceae | sf_1 | 8693 | Pantoea agglomerans str. A40 |
| Proteobacteria | Gammaproteobacteria | Enterobacteriales | Enterobacteriaceae | sf_1 | 8700 | Baumannia cicadellinicola |
| Proteobacteria | Gammaproteobacteria | Enterobacteriales | Enterobacteriaceae | sf_1 | 9302 | Pantoea subsp. stewartii str. GSPB 2626 |
| Proteobacteria | Gammaproteobacteria | Enterobacteriales | Enterobacteriaceae | sf_1 | 8236 | Vryburgia amaryllidis symbiont |
| Proteobacteria | Gammaproteobacteria | Enterobacteriales | Enterobacteriaceae | sf_1 | 8504 | Dysmicoccus neobrevipes symbiont |
| Proteobacteria | Gammaproteobacteria | Enterobacteriales | Enterobacteriaceae | sf_1 | 8603 | Melanococcus albizziae symbiont |
| Proteobacteria | Gammaproteobacteria | Enterobacteriales | Enterobacteriaceae | sf_1 | 8607 | Amonostherium lichtensioides symbiont |
| Proteobacteria | Gammaproteobacteria | Enterobacteriales | Enterobacteriaceae | sf_1 | 8624 | Erium globosum symbiont |
| Proteobacteria | Gammaproteobacteria | Enterobacteriales | Enterobacteriaceae | sf_1 | 9290 | Baumannia cicadellinicola |
| Proteobacteria | Gammaproteobacteria | Enterobacteriales | Enterobacteriaceae | sf_1 | 9293 | USA clone 14/7 |
| Proteobacteria | Gammaproteobacteria | Enterobacteriales | Enterobacteriaceae | sf_1 | 9420 | |
| Proteobacteria | Gammaproteobacteria | Enterobacteriales | Enterobacteriaceae | sf_1 | 8934 | Pectobacterium subsp. carotovorum str. E155 |
| | | | | | | subsp. |
| Proteobacteria | Gammaproteobacteria | Enterobacteriales | Enterobacteriaceae | sf_1 | 9266 | Parasite BEV of E. variegatus |
| Proteobacteria | Gammaproteobacteria | Enterobacteriales | Enterobacteriaceae | sf_1 | 8467 | Serratia marcescens subsp. sakuensis str. KRED |
| | | | | | | subsp. |
| Proteobacteria | Gammaproteobacteria | Enterobacteriales | Enterobacteriaceae | sf_1 | 9348 | |
| Proteobacteria | Gammaproteobacteria | Enterobacteriales | Enterobacteriaceae | sf_1 | 8505 | Buttiauxella warmboldiae str. DSM 9404 |
| Proteobacteria | Gammaproteobacteria | Enterobacteriales | Enterobacteriaceae | sf_1 | 8528 | Enterobacter cloacae Nr. 3 |
| Proteobacteria | Gammaproteobacteria | Enterobacteriales | Enterobacteriaceae | sf_1 | 8530 | Enterobacteriaceae CF01Ent-1 |
| Proteobacteria | Gammaproteobacteria | Enterobacteriales | Enterobacteriaceae | sf_1 | 8640 | |
| Proteobacteria | Gammaproteobacteria | Enterobacteriales | Enterobacteriaceae | sf_1 | 8936 | Klebsiella oxytoca str. ChDC OS31 |
| Proteobacteria | Gammaproteobacteria | Enterobacteriales | Enterobacteriaceae | sf_1 | 9060 | Enterobacter ludwigii str. EN-119 = DSMZ 16688 |
| Proteobacteria | Gammaproteobacteria | Enterobacteriales | Enterobacteriaceae | sf_1 | 9274 | Enterobacter sp. CC1 |
| Proteobacteria | Gammaproteobacteria | Enterobacteriales | Enterobacteriaceae | sf_1 | 9361 | Enterobacter intermedius str. JCM1238 |
| Proteobacteria | Gammaproteobacteria | Enterobacteriales | Enterobacteriaceae | sf_1 | 9390 | Enterobacter nimipressuralis str. LMG 10245-T |
| Proteobacteria | Gammaproteobacteria | Enterobacteriales | Enterobacteriaceae | sf_1 | 8251 | Nitrogen-fixing isolate str. CANF3 |
| Proteobacteria | Gammaproteobacteria | Enterobacteriales | Enterobacteriaceae | sf_1 | 8529 | Raoultella planticola 7 |
| Proteobacteria | Gammaproteobacteria | Enterobacteriales | Enterobacteriaceae | sf_1 | 8627 | Australicoccus grevilleae symbiont |
| Proteobacteria | Gammaproteobacteria | Enterobacteriales | Enterobacteriaceae | sf_1 | 8770 | |
| Proteobacteria | Gammaproteobacteria | Enterobacteriales | Enterobacteriaceae | sf_1 | 8890 | Raoultella planticola str. DR3 |
| Proteobacteria | Gammaproteobacteria | Enterobacteriales | Enterobacteriaceae | sf_1 | 8362 | Klebsiella pneumoniae str. ASR1 |
| Proteobacteria | Gammaproteobacteria | Enterobacteriales | Enterobacteriaceae | sf_1 | 8510 | Klebsiella pneumoniae str. DSM 30104 |
| Proteobacteria | Gammaproteobacteria | Enterobacteriales | Enterobacteriaceae | sf_1 | 8773 | |
| Proteobacteria | Gammaproteobacteria | Enterobacteriales | Enterobacteriaceae | sf_1 | 8286 | Cyphonococcus alpinus symbiont |
| Proteobacteria | Gammaproteobacteria | Enterobacteriales | Enterobacteriaceae | sf_1 | 8711 | Serratia odorifera str. DSM 4582 |
| Proteobacteria | Gammaproteobacteria | Enterobacteriales | Enterobacteriaceae | sf_1 | 8712 | Serratia proteamaculans str. DSM 4543 |
| Proteobacteria | Gammaproteobacteria | Enterobacteriales | Enterobacteriaceae | sf_1 | 8739 | Serratia entomophila str. DSM 12358 |
| Proteobacteria | Gammaproteobacteria | Enterobacteriales | Enterobacteriaceae | sf_1 | 8892 | Aranicola proteolyticus |
| Proteobacteria | Gammaproteobacteria | Enterobacteriales | Enterobacteriaceae | sf_1 | 9151 | |
| Proteobacteria | Gammaproteobacteria | Enterobacteriales | Enterobacteriaceae | sf_1 | 9417 | Serratia fonticola str. DSM 4576 |
| Proteobacteria | Gammaproteobacteria | Enterobacteriales | Enterobacteriaceae | sf_1 | 8631 | Planococcus ficus symbiont |
| Proteobacteria | Gammaproteobacteria | Enterobacteriales | Enterobacteriaceae | sf_1 | 8283 | Heteropsylla texana symbiont |
| Proteobacteria | Gammaproteobacteria | Enterobacteriales | Enterobacteriaceae | sf_1 | 8173 | Photorhabdus asymbiotica str. ATCC 43949 |
| Proteobacteria | Gammaproteobacteria | Enterobacteriales | Enterobacteriaceae | sf_1 | 8225 | |
| Proteobacteria | Gammaproteobacteria | Enterobacteriales | Enterobacteriaceae | sf_1 | 8642 | Erwinia chrysanthemi str. 580 |
| Proteobacteria | Gammaproteobacteria | Enterobacteriales | Enterobacteriaceae | sf_1 | 9029 | Photorhabdus asymbiotica subsp. australis str. MB |
| Proteobacteria | Gammaproteobacteria | Enterobacteriales | Enterobacteriaceae | sf_1 | 8473 | Hafnia alvei |
| Proteobacteria | Gammaproteobacteria | Enterobacteriales | Enterobacteriaceae | sf_1 | 9265 | Rahnella aquatilis k 8 |
| Proteobacteria | Gammaproteobacteria | Enterobacteriales | Enterobacteriaceae | sf_1 | 9337 | Rahnella geno sp. 3 str. DSM 30078 |
| Proteobacteria | Gammaproteobacteria | Enterobacteriales | Enterobacteriaceae | sf_1 | 8564 | Rahnella aquatilis str. ATCC 33989 |
| Proteobacteria | Gammaproteobacteria | Enterobacteriales | Enterobacteriaceae | sf_1 | 9157 | Secondary symbiont type-U Acyrthosiphon |
| | | | | | | pisum (rrs) clone 5B type-U |
| Proteobacteria | Gammaproteobacteria | Enterobacteriales | Enterobacteriaceae | sf_1 | 9262 | Yersinia aldovae str. A125 |
| Proteobacteria | Gammaproteobacteria | Enterobacteriales | Enterobacteriaceae | sf_1 | 1206 | Dermacentor variabilis symbiont |
| Proteobacteria | Gammaproteobacteria | Thiotrichales | Francisellaceae | sf_1 | 9554 | Tilapia parasite TPT-541 |
| Proteobacteria | Gammaproteobacteria | Thiotrichales | Francisellaceae | sf_1 | 8949 | Caedibacter taeniospiralis |
| Proteobacteria | Deltaproteobacteria | Desulfuromonadales | Geobacteraceae | sf_1 | 482 | trichloroethene-contaminated site clone |
| | | | | | | FTLM205 proteobacterium |
| Proteobacteria | Deltaproteobacteria | Desulfuromonadales | Geobacteraceae | sf_1 | 10171 | |
| Proteobacteria | Gammaproteobacteria | Oceanospirillales | Halomonadaceae | sf_1 | 8514 | Chromohalobacter israelensis str. ATCC 43985 T |
| Proteobacteria | Gammaproteobacteria | Oceanospirillales | Halomonadaceae | sf_1 | 8562 | Halomonas sp. str. TNB I20 |
| Proteobacteria | Gammaproteobacteria | Oceanospirillales | Halomonadaceae | sf_1 | 8576 | Halomonas sp. Ko502 |
| Proteobacteria | Gammaproteobacteria | Oceanospirillales | Halomonadaceae | sf_1 | 8598 | Halomonas desiderata str. FB2 |
| Proteobacteria | Gammaproteobacteria | Oceanospirillales | Halomonadaceae | sf_1 | 8854 | Halomonas variabilis str. ANT9112 |
| Proteobacteria | Gammaproteobacteria | Oceanospirillales | Halomonadaceae | sf_1 | 9471 | Boston Harbor surface water isolate str. |
| | | | | | | UMB18C UMB18C |
| Proteobacteria | Gammaproteobacteria | Oceanospirillales | Halomonadaceae | sf_1 | 9141 | Halomonas sp. SK1 |
| Proteobacteria | Epsilonproteobacteria | Campylobacterales | Helicobacteraceae | sf_3 | 10385 | |
| Proteobacteria | Epsilonproteobacteria | Campylobacterales | Helicobacteraceae | sf_3 | 10428 | Flexispira rappini FH 9702248 |
| Proteobacteria | Epsilonproteobacteria | Campylobacterales | Helicobacteraceae | sf_3 | 10430 | Helicobacter heilmannii str. MM2 |
| Proteobacteria | Epsilonproteobacteria | Campylobacterales | Helicobacteraceae | sf_3 | 10436 | Helicobacter aurati str. MIT 97-5075c |
| Proteobacteria | Epsilonproteobacteria | Campylobacterales | Helicobacteraceae | sf_3 | 10442 | Helicobacter cetorum str. MIT 99-5656 |
| Proteobacteria | Epsilonproteobacteria | Campylobacterales | Helicobacteraceae | sf_3 | 10444 | Helicobacter suncus str. Kaz-2 |
| Proteobacteria | Epsilonproteobacteria | Campylobacterales | Helicobacteraceae | sf_3 | 10448 | Helicobacter felis str. Dog-1 |
| Proteobacteria | Epsilonproteobacteria | Campylobacterales | Helicobacteraceae | sf_3 | 10451 | Helicobacter heilmannii str. C4S |
| Proteobacteria | Epsilonproteobacteria | Campylobacterales | Helicobacteraceae | sf_3 | 10454 | Helicobacter pullorum str. NCTC 12826 |
| Proteobacteria | Epsilonproteobacteria | Campylobacterales | Helicobacteraceae | sf_3 | 10462 | Helicobacter rodentium str. MIT 96-1312 |
| Proteobacteria | Epsilonproteobacteria | Campylobacterales | Helicobacteraceae | sf_3 | 10518 | Helicobacter pylori str. ATCC 49396T |
| Proteobacteria | Epsilonproteobacteria | Campylobacterales | Helicobacteraceae | sf_3 | 10520 | Helicobacter sp. blood isolate 964 |
| Proteobacteria | Epsilonproteobacteria | Campylobacterales | Helicobacteraceae | sf_3 | 10548 | Helicobacter rappini W.Tee-Bat |
| Proteobacteria | Epsilonproteobacteria | Campylobacterales | Helicobacteraceae | sf_3 | 10552 | Helicobacter winghamensis str. NLEP 97-1611 |
| Proteobacteria | Epsilonproteobacteria | Campylobacterales | Helicobacteraceae | sf_3 | 10562 | Helicobacter rappini W.Tee-Yu |
| Proteobacteria | Epsilonproteobacteria | Campylobacterales | Helicobacteraceae | sf_3 | 10425 | Sulfurimonas autotrophica str. OK5 |
| Proteobacteria | Epsilonproteobacteria | Campylobacterales | Helicobacteraceae | sf_3 | 10411 | termite gut homogenate clone Rs-P71 |
| | | | | | | proteobacterium |
| Proteobacteria | Epsilonproteobacteria | Campylobacterales | Helicobacteraceae | sf_3 | 10432 | Riftia pachyptila's tube clone R76-B51 |
| Proteobacteria | Epsilonproteobacteria | Campylobacterales | Helicobacteraceae | sf_3 | 10438 | hydrocarbon seep clone GCA014 |
| Proteobacteria | Epsilonproteobacteria | Campylobacterales | Helicobacteraceae | sf_3 | 10590 | termite gut homogenate clone Rs-H40 |
| | | | | | | proteobacterium |
| Proteobacteria | Epsilonproteobacteria | Campylobacterales | Helicobacteraceae | sf_3 | 10614 | strain isolate str. BHI80-49 |
| Proteobacteria | Epsilonproteobacteria | Campylobacterales | Helicobacteraceae | sf_3 | 10417 | temperate estuarine mud clone KM61 |
| Proteobacteria | Epsilonproteobacteria | Campylobacterales | Helicobacteraceae | sf_3 | 10467 | |
| Proteobacteria | Epsilonproteobacteria | Campylobacterales | Helicobacteraceae | sf_3 | 10507 | termite gut homogenate clone Rs-M59 |
| | | | | | | proteobacterium |
| Proteobacteria | Alphaproteobacteria | Bradyrhizobiales | Hyphomicrobiaceae | sf_1 | 7646 | Hyphomicrobium aestuarii str. DSM 1564 |
| Proteobacteria | Alphaproteobacteria | Rhizobiales | Hyphomicrobiaceae | sf_1 | 7392 | |
| Proteobacteria | Gammaproteobacteria | Legionellales | Legionellaceae | sf_1 | 8865 | Arctic pack ice; northern Fram Strait; 80 31.1 N; |
| | | | | | | 01 deg 59.7 min E clone ARKCH2Br2-23 |
| Proteobacteria | Alphaproteobacteria | Azospirillales | Magnetospirillaceae | sf_1 | 6922 | Dechlorospirillum sp. str. SN1 |
| Proteobacteria | Alphaproteobacteria | Bradyrhizobiales | Methylobacteriaceae | sf_1 | 7585 | Methylobacterium thiocyanatum str. ALL/SCN-P |
| Proteobacteria | Gammaproteobacteria | Methylococcales | Methylococcaceae | sf_1 | 8243 | isolate str. IR |
| Proteobacteria | Gammaproteobacteria | Methylococcales | Methylococcaceae | sf_1 | 8821 | Methylobacter psychrophilus str. Z-0021 |
| Proteobacteria | Gammaproteobacteria | Methylococcales | Methylococcaceae | sf_1 | 9438 | marine sediment above hydrate ridge clone |
| | | | | | | Hyd24-01 proteobacterium |
| Proteobacteria | Betaproteobacteria | Methylophilales | Methylophilaceae | sf_1 | 8137 | freshwater clone PRD01a011B |
| Proteobacteria | Gammaproteobacteria | Pseudomonadales | Moraxellaceae | sf_3 | 8366 | Psychrobacter frigidicola str. DSM 12411 |
| Proteobacteria | Gammaproteobacteria | Pseudomonadales | Moraxellaceae | sf_3 | 8604 | Moraxella oblonga str. IAM 14971 |
| Proteobacteria | Gammaproteobacteria | Pseudomonadales | Moraxellaceae | sf_3 | 8838 | Psychrobacter psychrophilus CMS 28 |
| Proteobacteria | Gammaproteobacteria | Pseudomonadales | Moraxellaceae | sf_3 | 8727 | Alkanindiges hongkongensis str. HKU9 |
| Proteobacteria | Gammaproteobacteria | Pseudomonadales | Moraxellaceae | sf_3 | 9359 | Acinetobacter junii str. S33 |
| Proteobacteria | Gammaproteobacteria | Pseudomonadales | Moraxellaceae | sf_3 | 9428 | hydrocarbon-degrading consortium clone |
| | | | | | | AF2-1D |
| Proteobacteria | Gammaproteobacteria | Pseudomonadales | Moraxellaceae | sf_3 | 9466 | Acinetobacter tandoii str. 4N13 |
| Proteobacteria | Gammaproteobacteria | Pseudomonadales | Moraxellaceae | sf_3 | 9641 | Acinetobacter haemolyticus |
| Proteobacteria | Deltaproteobacteria | Myxococcales | Myxococcaceae | sf_1 | 10358 | Myxococcus fulvus str. Mx f2 |
| Proteobacteria | Epsilonproteobacteria | Nautiliales | Nautiliaceae | sf_1 | 10477 | S17sBac5 complete clone |
| Proteobacteria | Betaproteobacteria | Neisseriales | Neisseriaceae | sf_1 | 7945 | Aquaspirillum serpens str. IAM 13944 |
| Proteobacteria | Betaproteobacteria | Neisseriales | Neisseriaceae | sf_1 | 7675 | Neisseria sp. str. CCUG 46910 |
| Proteobacteria | Betaproteobacteria | Neisseriales | Neisseriaceae | sf_1 | 7662 | Mars Odyssey Orbiter and encapsulation facility |
| | | | | | | clone T5-1 sp. |
| Proteobacteria | Betaproteobacteria | Nitrosomonadales | Nitrosomonadaceae | sf_1 | 7789 | |
| Proteobacteria | Betaproteobacteria | Nitrosomonadales | Nitrosomonadaceae | sf_1 | 7976 | Nitrosomonas sp. str. Nm86 |
| Proteobacteria | Betaproteobacteria | Nitrosomonadales | Nitrosomonadaceae | sf_1 | 7770 | Nitrosomonas europaea str. ATCC 19718 |
| Proteobacteria | Betaproteobacteria | Nitrosomonadales | Nitrosomonadaceae | sf_1 | 8145 | Nitrosomonas eutropha str. Nm57 |
| Proteobacteria | Deltaproteobacteria | Desulfobacterales | Nitrospinaceae | sf_2 | 594 | uranium mining mill tailing clone GR-296.II.52 |
| | | | | | | GR-296.I.52 |
| Proteobacteria | Gammaproteobacteria | Oceanospirillales | Oceanospirillaceae | sf_1 | 9351 | bacterioplankton clone ZA2333c |
| Proteobacteria | Betaproteobacteria | Burkholderiales | Oxalobacteraceae | sf_1 | 7743 | Herbaspirillum sp. str. NAH4 |
| Proteobacteria | Betaproteobacteria | Burkholderiales | Oxalobacteraceae | sf_1 | 7843 | Massilia timonae timone |
| Proteobacteria | Betaproteobacteria | Burkholderiales | Oxalobacteraceae | sf_1 | 7845 | Diaphorina citri symbiont |
| Proteobacteria | Betaproteobacteria | Burkholderiales | Oxalobacteraceae | sf_1 | 7866 | Paucimonas lemoignei str. ATCC 17989T |
| Proteobacteria | Betaproteobacteria | Burkholderiales | Oxalobacteraceae | sf_1 | 7878 | napthalene-contaminated sediment clone 29 |
| Proteobacteria | Betaproteobacteria | Burkholderiales | Oxalobacteraceae | sf_1 | 7921 | Collimonas fungivorans str. Ter331 |
| Proteobacteria | Betaproteobacteria | Burkholderiales | Oxalobacteraceae | sf_1 | 7968 | Oxalobacter formigenes str. OXB ovinen rumen |
| Proteobacteria | Betaproteobacteria | Burkholderiales | Oxalobacteraceae | sf_1 | 8013 | isolate str. A1020 |
| Proteobacteria | Betaproteobacteria | Burkholderiales | Oxalobacteraceae | sf_1 | 8032 | Aquaspirillum arcticum str. IAM 14963 |
| Proteobacteria | Betaproteobacteria | Burkholderiales | Oxalobacteraceae | sf_1 | 8034 | Janthinobacterium agaricidamnosum str. W1r3T |
| Proteobacteria | Betaproteobacteria | Burkholderiales | Oxalobacteraceae | sf_1 | 8058 | Herbaspirillum seropedicae str. DSM 6445 ATCC |
| | | | | | | 35892 |
| Proteobacteria | Gammaproteobacteria | Pasteurellales | Pasteurellaceae | sf_1 | 9360 | Pasteurella multocida subsp. gallicida str. MCCM |
| | | | | | | 00021 subsp. |
| Proteobacteria | Gammaproteobacteria | Pasteurellales | Pasteurellaceae | sf_1 | 9349 | Pasteurella sp. str. 91985 |
| Proteobacteria | Gammaproteobacteria | Pasteurellales | Pasteurellaceae | sf_1 | 8195 | Haemophilus influenzae str. R2866 |
| Proteobacteria | Gammaproteobacteria | Pasteurellales | Pasteurellaceae | sf_1 | 8555 | Haemophilus influenzae str. M9741 |
| Proteobacteria | Gammaproteobacteria | Pasteurellales | Pasteurellaceae | sf_1 | 9213 | Haemophilus quentini str. MCCM 02026 |
| Proteobacteria | Gammaproteobacteria | Pasteurellales | Pasteurellaceae | sf_1 | 9477 | Haemophilus influenzae str. M11105 |
| Proteobacteria | Gammaproteobacteria | Pasteurellales | Pasteurellaceae | sf_1 | 8228 | Actinobacillus indolicus str. H1419 |
| Proteobacteria | Gammaproteobacteria | Pasteurellales | Pasteurellaceae | sf_1 | 8861 | Haemophilus parasuis 427 |
| Proteobacteria | Gammaproteobacteria | Pasteurellales | Pasteurellaceae | sf_1 | 8614 | Acidithiobacillus thiooxidans str. KCTC 8928P |
| Proteobacteria | Gammaproteobacteria | Pasteurellales | Pasteurellaceae | sf_1 | 8952 | Actinobacillus lignieresii |
| Proteobacteria | Gammaproteobacteria | Pasteurellales | Pasteurellaceae | sf_1 | 9263 | Actinobacillus capsulatus |
| Proteobacteria | Gammaproteobacteria | Pasteurellales | Pasteurellaceae | sf_1 | 8876 | Mannheimia sp. R19.2 str. R19.2; CCUG 38463 |
| | | | | | | R19.2 |
| Proteobacteria | Gammaproteobacteria | Pasteurellales | Pasteurellaceae | sf_1 | 9237 | |
| Proteobacteria | Gammaproteobacteria | Pasteurellales | Pasteurellaceae | sf_1 | 8409 | human colonic mucosal biopsy clone ABLCf1 |
| Proteobacteria | Gammaproteobacteria | Pasteurellales | Pasteurellaceae | sf_1 | 8432 | |
| Proteobacteria | Gammaproteobacteria | Pasteurellales | Pasteurellaceae | sf_1 | 8848 | str. 86355 |
| Proteobacteria | Gammaproteobacteria | Pasteurellales | Pasteurellaceae | sf_1 | 9533 | Haemophilus segnis str. MCCM 00337 |
| Proteobacteria | Gammaproteobacteria | Pasteurellales | Pasteurellaceae | sf_1 | 9628 | Histophilus somni str. CCUG 12839 |
| Proteobacteria | Alphaproteobacteria | Rhizobiales | Phyllobacteriaceae | sf_1 | 6857 | Mesorhizobium mediterraneum str. PECA20 |
| Proteobacteria | Alphaproteobacteria | Rhizobiales | Phyllobacteriaceae | sf_1 | 6692 | Phyllobacterium trifolii str. PETP02 |
| Proteobacteria | Alphaproteobacteria | Rhizobiales | Phyllobacteriaceae | sf_1 | 6916 | lake microbial mat isolate str. R-9219 |
| Proteobacteria | Alphaproteobacteria | Rhizobiales | Phyllobacteriaceae | sf_1 | 6966 | Mesorhizobium tianshanense str.-1BS; USDA 3592 |
| Proteobacteria | Alphaproteobacteria | Rhizobiales | Phyllobacteriaceae | sf_1 | 7009 | |
| Proteobacteria | Alphaproteobacteria | Rhizobiales | Phyllobacteriaceae | sf_1 | 7216 | Ahrensia kielensis str. IAM12618 |
| Proteobacteria | Alphaproteobacteria | Rhizobiales | Phyllobacteriaceae | sf_1 | 7379 | Phyllobacterium myrsinacearum HM35 |
| Proteobacteria | Alphaproteobacteria | Rhizobiales | Phyllobacteriaceae | sf_1 | 7381 | Aminobacter aminovorans str. DSM7048T |
| Proteobacteria | Alphaproteobacteria | Rhizobiales | Phyllobacteriaceae | sf_1 | 7497 | Pseudaminobacter salicylatoxidans str. KTC001 |
| Proteobacteria | Alphaproteobacteria | Rhizobiales | Phyllobacteriaceae | sf_1 | 7300 | marine isolate JP57 |
| Proteobacteria | Gammaproteobacteria | Thiotrichales | Piscirickettsiaceae | sf_3 | 8664 | Thiomicrospira sp. str. Milos-T2 |
| Proteobacteria | Gammaproteobacteria | Thiotrichales | Piscirickettsiaceae | sf_3 | 9027 | Thiomicrospira crunogena str. XCL-2 |
| Proteobacteria | Gammaproteobacteria | Thiotrichales | Piscirickettsiaceae | sf_3 | 9557 | Riftia pachyptila's tube clone R76-B23 |
| Proteobacteria | Gammaproteobacteria | Thiotrichales | Piscirickettsiaceae | sf_3 | 9291 | Methylophaga alcalica str. M39 |
| Proteobacteria | Gammaproteobacteria | Thiotrichales | Piscirickettsiaceae | sf_3 | 9392 | Methylophaga sp. str. V4.ME.29 = MM_2343 |
| Proteobacteria | Deltaproteobacteria | Myxococcales | Polyangiaceae | sf_3 | 10249 | soil sample uranium mining waste pile near |
| | | | | | | town Johanngeorgenstadt clone JG36-TzT-168 |
| | | | | | | proteobacterium |
| Proteobacteria | Deltaproteobacteria | Myxococcales | Polyangiaceae | sf_3 | 10298 | marine tidal mat clone BTM36 |
| Proteobacteria | Deltaproteobacteria | Myxococcales | Polyangiaceae | sf_3 | 10353 | sludge clone A9 |
| Proteobacteria | Deltaproteobacteria | Myxococcales | Polyangiaceae | sf_3 | 9671 | hydrothermal sediment clone AF420357 |
| Proteobacteria | Deltaproteobacteria | Myxococcales | Polyangiaceae | sf_3 | 9735 | uranium mining waste pile clone JG37-AG-15 |
| | | | | | | proteobacterium |
| Proteobacteria | Deltaproteobacteria | Myxococcales | Polyangiaceae | sf_3 | 9755 | bacterioplankton clone ZA3704c |
| Proteobacteria | Deltaproteobacteria | Myxococcales | Polyangiaceae | sf_3 | 9874 | uranium mining waste pile clone JG34-KF-243 |
| | | | | | | proteobacterium |
| Proteobacteria | Deltaproteobacteria | Myxococcales | Polyangiaceae | sf_3 | 9900 | bioreactor clone mle1-27 |
| Proteobacteria | Deltaproteobacteria | Myxococcales | Polyangiaceae | sf_3 | 10082 | uranium mining waste pile clone JG37-AG-33 |
| | | | | | | proteobacterium |
| Proteobacteria | Deltaproteobacteria | Myxococcales | Polyangiaceae | sf_4 | 9733 | bacterioplankton clone ZA3735c |
| Proteobacteria | Betaproteobacteria | Procabacteriales | Procabacteriaceae | sf_1 | 8136 | Acanthamoeba sp. UWC6 symbiont |
| Proteobacteria | Gammaproteobacteria | Alteromonadales | Pseudoalteromonadaceae | sf_1 | 9627 | Pseudoalteromonas sp |
| Proteobacteria | Gammaproteobacteria | Alteromonadales | Pseudoalteromonadaceae | sf_1 | 9339 | Pseudoalteromonas sp. str. 05 |
| Proteobacteria | Gammaproteobacteria | Pseudomonadales | Pseudomonadaceae | sf_1 | 8813 | Lyrodus pedicellatus symbiont |
| Proteobacteria | Gammaproteobacteria | Pseudomonadales | Pseudomonadaceae | sf_1 | 9300 | Lyrodus pedicellatus symbiont |
| Proteobacteria | Gammaproteobacteria | Pseudomonadales | Pseudomonadaceae | sf_1 | 8487 | |
| Proteobacteria | Gammaproteobacteria | Pseudomonadales | Pseudomonadaceae | sf_1 | 8508 | Pseudomonas citronellolis str. TERIDB26 |
| Proteobacteria | Gammaproteobacteria | Pseudomonadales | Pseudomonadaceae | sf_1 | 8691 | Pseudomonas aeruginosa str. PAO1 |
| Proteobacteria | Gammaproteobacteria | Pseudomonadales | Pseudomonadaceae | sf_1 | 8754 | Pseudomonas sp. str. P400Y-1 |
| Proteobacteria | Gammaproteobacteria | Pseudomonadales | Pseudomonadaceae | sf_1 | 9002 | Paederus fuscipes endosymbiont |
| Proteobacteria | Gammaproteobacteria | Pseudomonadales | Pseudomonadaceae | sf_1 | 9056 | Pseudomonas aeruginosa str. #47 |
| Proteobacteria | Gammaproteobacteria | Pseudomonadales | Pseudomonadaceae | sf_1 | 9588 | Pseudomonas citronellolis str. TERIDB18 |
| Proteobacteria | Gammaproteobacteria | Pseudomonadales | Pseudomonadaceae | sf_1 | 8288 | |
| Proteobacteria | Gammaproteobacteria | Pseudomonadales | Pseudomonadaceae | sf_1 | 8777 | Pseudomonas sp. str. KNA6-5 |
| Proteobacteria | Gammaproteobacteria | Pseudomonadales | Pseudomonadaceae | sf_1 | 8852 | Pseudomonas stutzeri str. KC |
| Proteobacteria | Gammaproteobacteria | Pseudomonadales | Pseudomonadaceae | sf_1 | 9068 | Pseudomonas stutzeri str. A1501 |
| Proteobacteria | Gammaproteobacteria | Pseudomonadales | Pseudomonadaceae | sf_1 | 9228 | Pseudomonas stutzeri HY-105 |
| Proteobacteria | Gammaproteobacteria | Pseudomonadales | Pseudomonadaceae | sf_1 | 9295 | |
| Proteobacteria | Gammaproteobacteria | Pseudomonadales | Pseudomonadaceae | sf_1 | 8344 | Anabaena circinalis AWQC118C isolate str. |
| | | | | | | UNSW3 |
| Proteobacteria | Gammaproteobacteria | Pseudomonadales | Pseudomonadaceae | sf_1 | 8553 | Pseudomonas fulva str. IAM 1587 |
| Proteobacteria | Gammaproteobacteria | Pseudomonadales | Pseudomonadaceae | sf_1 | 8725 | Pseudomonas sp. str. 2N1-1 |
| Proteobacteria | Gammaproteobacteria | Pseudomonadales | Pseudomonadaceae | sf_1 | 8850 | Agrobacterium agile str. IAM12615 |
| Proteobacteria | Gammaproteobacteria | Pseudomonadales | Pseudomonadaceae | sf_1 | 9238 | |
| Proteobacteria | Gammaproteobacteria | Pseudomonadales | Pseudomonadaceae | sf_1 | 9005 | Pseudomonas sp. str. KY |
| Proteobacteria | Gammaproteobacteria | Pseudomonadales | Pseudomonadaceae | sf_1 | 9613 | Pseudomonas flavescens str. B62 |
| Proteobacteria | Gammaproteobacteria | Pseudomonadales | Pseudomonadaceae | sf_1 | 8474 | ground water deep-well injection disposal site |
| | | | | | | radioactive wastes Tomsk-7 clone S15A-MN7 |
| | | | | | | proteobacterium |
| Proteobacteria | Gammaproteobacteria | Pseudomonadales | Pseudomonadaceae | sf_1 | 8513 | Pseudomonas monteilii str. CIP 104883 |
| Proteobacteria | Gammaproteobacteria | Pseudomonadales | Pseudomonadaceae | sf_1 | 9049 | uranium mining mill tailing clone GR-Sh2-34 |
| | | | | | | GR-Sh2-34 |
| Proteobacteria | Gammaproteobacteria | Pseudomonadales | Pseudomonadaceae | sf_1 | 9219 | Pseudomonas cf. monteilii 9 |
| Proteobacteria | Gammaproteobacteria | Pseudomonadales | Pseudomonadaceae | sf_1 | 9343 | Cellvibrio subsp. mixtus str. ACM 2601 |
| Proteobacteria | Gammaproteobacteria | Pseudomonadales | Pseudomonadaceae | sf_1 | 9469 | cf. Pseudomonas sp. clone Llangefni 52 |
| Proteobacteria | Gammaproteobacteria | Pseudomonadales | Pseudomonadaceae | sf_1 | 9493 | Pseudomonas sp. str. dcm7B |
| Proteobacteria | Gammaproteobacteria | Pseudomonadales | Pseudomonadaceae | sf_1 | 8209 | uranium mining waste pile clone JG37-AG-122 |
| | | | | | | proteobacterium |
| Proteobacteria | Gammaproteobacteria | Pseudomonadales | Pseudomonadaceae | sf_1 | 8433 | Pseudomonas syringae pv. broussonetiae str. KOZ |
| | | | | | | 8101 pv. |
| Proteobacteria | Gammaproteobacteria | Pseudomonadales | Pseudomonadaceae | sf_1 | 8635 | |
| Proteobacteria | Gammaproteobacteria | Pseudomonadales | Pseudomonadaceae | sf_1 | 8853 | Pseudomonas cichorii str. ATCC 10857T |
| Proteobacteria | Gammaproteobacteria | Pseudomonadales | Pseudomonadaceae | sf_1 | 9028 | Pseudomonas koreensis str. Ps 9-14 |
| Proteobacteria | Gammaproteobacteria | Pseudomonadales | Pseudomonadaceae | sf_1 | 9240 | Pseudomonas fluorescens str. CHA0 |
| Proteobacteria | Gammaproteobacteria | Pseudomonadales | Pseudomonadaceae | sf_1 | 9267 | Pseudomonas syringae pv. theae str. PT1 |
| Proteobacteria | Gammaproteobacteria | Pseudomonadales | Pseudomonadaceae | sf_1 | 9310 | Pseudomonas sp. str. AC-167 |
| Proteobacteria | Gammaproteobacteria | Pseudomonadales | Pseudomonadaceae | sf_1 | 8338 | Pseudomonas synxantha str. DSM 13080 G |
| Proteobacteria | Gammaproteobacteria | Pseudomonadales | Pseudomonadaceae | sf_1 | 8561 | Pseudomonas sp. B65 |
| Proteobacteria | Gammaproteobacteria | Pseudomonadales | Pseudomonadaceae | sf_1 | 8601 | Pseudomonas marginalis str. ATCC 10844T |
| Proteobacteria | Gammaproteobacteria | Pseudomonadales | Pseudomonadaceae | sf_1 | 8687 | Pseudomonas putida str. ATCC 17472 |
| Proteobacteria | Gammaproteobacteria | Pseudomonadales | Pseudomonadaceae | sf_1 | 8708 | |
| Proteobacteria | Gammaproteobacteria | Pseudomonadales | Pseudomonadaceae | sf_1 | 9175 | Pseudomonas extremorientalis str. KMM3447 |
| Proteobacteria | Gammaproteobacteria | Pseudomonadales | Pseudomonadaceae | sf_1 | 9221 | Pseudomonas fulgida str. DSM 14938 = LMG 2146 |
| | | | | | | P 515/12 |
| Proteobacteria | Gammaproteobacteria | Pseudomonadales | Pseudomonadaceae | sf_1 | 9243 | Pseudomonas tolaasii str. LMG 2342T ( ) |
| Proteobacteria | Gammaproteobacteria | Pseudomonadales | Pseudomonadaceae | sf_1 | 9366 | Arctic seawater isolate str. R7366 |
| Proteobacteria | Gammaproteobacteria | Pseudomonadales | Pseudomonadaceae | sf_1 | 8755 | Pseudomonas sp. SK-1-3-1 |
| Proteobacteria | Gammaproteobacteria | Pseudomonadales | Pseudomonadaceae | sf_1 | 9172 | Pseudomonas psychrophila str. E-3 |
| Proteobacteria | Betaproteobacteria | Burkholderiales | Ralstoniaceae | sf_1 | 7823 | Wautersia basilensis str. DSM 11853 |
| Proteobacteria | Betaproteobacteria | Burkholderiales | Ralstoniaceae | sf_1 | 8110 | Wautersia paucula str. LMG 3413 |
| Proteobacteria | Betaproteobacteria | Burkholderiales | Ralstoniaceae | sf_1 | 8128 | Cupriavidus necator |
| Proteobacteria | Betaproteobacteria | Burkholderiales | Ralstoniaceae | sf_1 | 7761 | Ralstonia detusculanense str. APF11 |
| Proteobacteria | Betaproteobacteria | Burkholderiales | Ralstoniaceae | sf_1 | 7778 | Ralstonia insidiosa str. CCUG 46388 |
| Proteobacteria | Alphaproteobacteria | Rhizobiales | Rhizobiaceae | sf_1 | 7051 | Mycoplana dimorpha str. IAM 13154 |
| Proteobacteria | Alphaproteobacteria | Rhizobiales | Rhizobiaceae | sf_1 | 6683 | Sinorhizobium fredii str. ATCC35423 |
| Proteobacteria | Alphaproteobacteria | Rhizobiales | Rhizobiaceae | sf_1 | 6725 | Sinorhizobium meliloti str. 1021 |
| Proteobacteria | Alphaproteobacteria | Rhizobiales | Rhizobiaceae | sf_1 | 6972 | Ensifer adhaerens str. LMG 20582 |
| Proteobacteria | Alphaproteobacteria | Rhizobiales | Rhizobiaceae | sf_1 | 6974 | India: Himalayas Kaza Spiti Valley Cold Desert |
| | | | | | | isolate str. Kaza-35 Kaza-35 |
| Proteobacteria | Alphaproteobacteria | Rhizobiales | Rhizobiaceae | sf_1 | 6770 | Rhizobium tropici str. LMG 9517 |
| Proteobacteria | Alphaproteobacteria | Rhizobiales | Rhizobiaceae | sf_1 | 6871 | Rhizobium mongolense str. USDA 1832 |
| Proteobacteria | Alphaproteobacteria | Rhizobiales | Rhizobiaceae | sf_1 | 7135 | Rhizobium gallicum str. FL27 |
| Proteobacteria | Alphaproteobacteria | Rhizobiales | Rhizobiaceae | sf_1 | 7568 | Rhizobium etli str. USDA 2667 ATCC 14483 |
| | | | | | | SEMIA 043 |
| Proteobacteria | Alphaproteobacteria | Rhizobiales | Rhizobiaceae | sf_1 | 6798 | Agrobacterium tumefaciens TG14 |
| Proteobacteria | Alphaproteobacteria | Rhizobiales | Rhizobiaceae | sf_1 | 6804 | Rhizobium sp. str. SH19312 |
| Proteobacteria | Alphaproteobacteria | Rhizobiales | Rhizobiaceae | sf_1 | 6964 | Agrobacterium tumefaciens str. C58 Cereon |
| Proteobacteria | Alphaproteobacteria | Rhizobiales | Rhizobiaceae | sf_1 | 7334 | Agrobacterium tumefaciens C4 |
| Proteobacteria | Alphaproteobacteria | Rhizobiales | Rhizobiaceae | sf_1 | 7041 | Rhizobium huautlense str. SO2 ( ) |
| Proteobacteria | Alphaproteobacteria | Rhodobacterales | Rhodobacteraceae | sf_1 | 6701 | Roseobacter clone NAC11-3 |
| Proteobacteria | Alphaproteobacteria | Rhodobacterales | Rhodobacteraceae | sf_1 | 6980 | Loktanella vestfoldensis str. LMG 22003 |
| Proteobacteria | Alphaproteobacteria | Rhodobacterales | Rhodobacteraceae | sf_1 | 7433 | Scrippsiella trochoidea NEPCC 15 |
| Proteobacteria | Alphaproteobacteria | Rhodobacterales | Rhodobacteraceae | sf_1 | 7453 | Sulfitobacter sp. BIO-11 |
| Proteobacteria | Alphaproteobacteria | Rhodobacterales | Rhodobacteraceae | sf_1 | 6888 | hydrothermal vent strain str. TB66 |
| Proteobacteria | Alphaproteobacteria | Rhodobacterales | Rhodobacteraceae | sf_1 | 7026 | Leisingera methylohalidivorans str. MB2 |
| Proteobacteria | Alphaproteobacteria | Rhodobacterales | Rhodobacteraceae | sf_1 | 7263 | |
| Proteobacteria | Alphaproteobacteria | Rhodobacterales | Rhodobacteraceae | sf_1 | 7040 | Paracoccus alcaliphilus str. JCM 7364 |
| Proteobacteria | Alphaproteobacteria | Rhodobacterales | Rhodobacteraceae | sf_1 | 7508 | lichen-dominated Antarctic cryptoendolithic |
| | | | | | | community clone FBP492 proteobacterium |
| Proteobacteria | Alphaproteobacteria | Rhodobacterales | Rhodobacteraceae | sf_1 | 6991 | Rhodobacter sphaeroides str. 2.4.1 |
| Proteobacteria | Alphaproteobacteria | Rhodobacterales | Rhodobacteraceae | sf_1 | 7084 | Scrippsiella trochoidea NEPCC 15 |
| Proteobacteria | Betaproteobacteria | Rhodocyclales | Rhodocyclaceae | sf_1 | 7800 | sample taken upstream landfill clone BVC77 |
| | | | | | | landfill |
| Proteobacteria | Betaproteobacteria | Rhodocyclales | Rhodocyclaceae | sf_1 | 7817 | TCE-contaminated site clone ccs265 |
| Proteobacteria | Betaproteobacteria | Rhodocyclales | Rhodocyclaceae | sf_1 | 7956 | |
| Proteobacteria | Betaproteobacteria | Rhodocyclales | Rhodocyclaceae | sf_1 | 8127 | Zoogloea resiniphila str. PIV-3A2y |
| Proteobacteria | Betaproteobacteria | Rhodocyclales | Rhodocyclaceae | sf_1 | 8131 | |
| Proteobacteria | Betaproteobacteria | Rhodocyclales | Rhodocyclaceae | sf_1 | 7907 | Thauera aromatica str. LG356 |
| Proteobacteria | Betaproteobacteria | Rhodocyclales | Rhodocyclaceae | sf_1 | 7925 | Thauera selenatis str. ATCC 55363T |
| Proteobacteria | Betaproteobacteria | Rhodocyclales | Rhodocyclaceae | sf_1 | 8156 | industrial-phenol-degrading community clone |
| | | | | | | MM1 sp. |
| Proteobacteria | Betaproteobacteria | Rhodocyclales | Rhodocyclaceae | sf_1 | 7824 | termite gut homogenate clone Rs-B77 |
| | | | | | | proteobacterium |
| Proteobacteria | Betaproteobacteria | Rhodocyclales | Rhodocyclaceae | sf_1 | 7762 | EIbe River snow isolate Iso18 Iso18_1411 |
| Proteobacteria | Alphaproteobacteria | Rickettsiales | Rickettsiaceae | sf_1 | 7556 | Rickettsia bellii str. strains 369-C and G2D42 |
| Proteobacteria | Gammaproteobacteria | Oceanospirillales | Saccharospirillaceae | sf_1 | 8889 | hypersaline Mono Lake clone ML110J-5 |
| Proteobacteria | Alphaproteobacteria | Consistiales | SAR11 | sf_2 | 7043 | marine clone Arctic95D-8 |
| Proteobacteria | Gammaproteobacteria | Alteromonadales | Shewanellaceae | sf_1 | 8581 | Shewanella benthica str. DB21MT-2 |
| Proteobacteria | Gammaproteobacteria | Alteromonadales | Shewanellaceae | sf_1 | 8641 | Moritella abyssi str. 2693 |
| Proteobacteria | Gammaproteobacteria | Alteromonadales | Shewanellaceae | sf_1 | 9081 | Shewanella sp. str. MTW-1 |
| Proteobacteria | Gammaproteobacteria | Alteromonadales | Shewanellaceae | sf_1 | 8662 | |
| Proteobacteria | Alphaproteobacteria | Sphingomonadales | Sphingomonadaceae | sf_1 | 7440 | Sphingobium chungbukense str. DJ77 |
| Proteobacteria | Alphaproteobacteria | Sphingomonadales | Sphingomonadaceae | sf_1 | 7528 | Sphingobium yanoikuyae str. GIFU9882 |
| Proteobacteria | Alphaproteobacteria | Sphingomonadales | Sphingomonadaceae | sf_1 | 7548 | Afipia genosp. 13 str. G8991 |
| Proteobacteria | Alphaproteobacteria | Sphingomonadales | Sphingomonadaceae | sf_1 | 6650 | Sphingomonas phyllosphaerae str. FA1 |
| Proteobacteria | Alphaproteobacteria | Sphingomonadales | Sphingomonadaceae | sf_1 | 7016 | Sphingomonas sp. str. SAFR-027 |
| Proteobacteria | Alphaproteobacteria | Sphingomonadales | Sphingomonadaceae | sf_1 | 7535 | Sphingomonas paucimobilis str. GIFU2395 |
| Proteobacteria | Alphaproteobacteria | Sphingomonadales | Sphingomonadaceae | sf_15 | 7035 | Sphingomonas asaccharolytica str. IFO 10564-T |
| Proteobacteria | Alphaproteobacteria | Sphingomonadales | Sphingomonadaceae | sf_1 | 7215 | travertine hot spring clone SM2B06 |
| Proteobacteria | Alphaproteobacteria | Sphingomonadales | Sphingomonadaceae | sf_1 | 6663 | Sphingopyxis flavimaris str. SW-151 |
| Proteobacteria | Alphaproteobacteria | Sphingomonadales | Sphingomonadaceae | sf_1 | 7100 | Novosphingobium capsulatum str. GIFU11526 |
| Proteobacteria | Alphaproteobacteria | Sphingomonadales | Sphingomonadaceae | sf_1 | 7036 | Lutibacterium anuloederans str. LC8 |
| Proteobacteria | Gammaproteobacteria | Aeromonadales | Succinivibrionaceae | sf_1 | 8822 | Anaerobiospirillum sp. str. 3J102 |
| Proteobacteria | Deltaproteobacteria | Syntrophobacterales | Syntrophaceae | sf_3 | 10067 | benzoate-degrading consortium clone BA044 |
| Proteobacteria | Deltaproteobacteria | Syntrophobacterales | Syntrophobacteraceae | sf_1 | 9864 | uranium mining waste pile clone JG37-AG-133 |
| | | | | | | proteobacterium |
| Proteobacteria | Deltaproteobacteria | Syntrophobacterales | Syntrophobacteraceae | sf_1 | 10013 | hydrothermal sediment clone AF420341 |
| Proteobacteria | Deltaproteobacteria | Syntrophobacterales | Syntrophobacteraceae | sf_1 | 10021 | uranium mill tailings soil sample clone Sh765B- |
| | | | | | | TzT-29 proteobacterium |
| Proteobacteria | Deltaproteobacteria | Syntrophobacterales | Syntrophobacteraceae | sf_1 | 9731 | uranium mining waste pile clone JG37-AG-90 |
| | | | | | | proteobacterium |
| Proteobacteria | Deltaproteobacteria | Syntrophobacterales | Syntrophobacteraceae | sf_1 | 9845 | uranium mining waste pile clone JG37-AG-128 |
| | | | | | | proteobacterium |
| Proteobacteria | Deltaproteobacteria | Syntrophobacterales | Syntrophobacteraceae | sf_1 | 10184 | granular sludge clone R1p32 |
| Proteobacteria | Deltaproteobacteria | Syntrophobacterales | Syntrophobacteraceae | sf_1 | 10221 | granular sludge clone R3p4 |
| Proteobacteria | Deltaproteobacteria | Syntrophobacterales | Syntrophobacteraceae | sf_1 | 10294 | Desulfacinum hydrothermale str. MT-96 |
| Proteobacteria | Deltaproteobacteria | Syntrophobacterales | Syntrophobacteraceae | sf_1 | 9661 | DCP-dechlorinating consortium clone SHD-1 |
| Proteobacteria | Gammaproteobacteria | Thiotrichales | Thiotrichaceae | sf_3 | 8321 | Wadden Sea sediment clone Dangast A9 |
| Proteobacteria | Gammaproteobacteria | Thiotrichales | Thiotrichaceae | sf_3 | 8741 | marine sediment clone Limfjorden L10 |
| Proteobacteria | Gammaproteobacteria | Thiotrichales | Thiotrichaceae | sf_3 | 8752 | Beggiatoa sp. str. MS-81-1c |
| Proteobacteria | Gammaproteobacteria | Thiotrichales | Thiotrichaceae | sf_3 | 9015 | Beggiatoa alba str. B18LD; ATCC 33555 |
| Proteobacteria | Gammaproteobacteria | Thiotrichales | Thiotrichaceae | sf_3 | 9321 | marine sediment clone Tokyo Bay D |
| Proteobacteria | Gammaproteobacteria | Thiotrichales | Thiotrichaceae | sf_3 | 8703 | Beggiatoa sp. str. AA5A |
| Proteobacteria | Deltaproteobacteria | Desulfobacterales | Unclassified | sf_3 | 468 | marine sediment clone Sva0515 |
| Proteobacteria | Alphaproteobacteria | Unclassified | Unclassified | sf_6 | 7377 | Rocky Mountain alpine soil clone W2b-8C |
| Proteobacteria | Alphaproteobacteria | Verorhodospirilla | Unclassified | sf_1 | 7109 | diesel-polluted Bohai Gulf isolate str. M-5 M-5 |
| Proteobacteria | Alphaproteobacteria | Unclassified | Unclassified | sf_6 | 7340 | uranium mining waste pile soil sample clone |
| | | | | | | JG30-KF-AS50 |
| Proteobacteria | Alphaproteobacteria | Azospirillales | Unclassified | sf_1 | 7400 | sphagnum peat bog clone K-5b5 |
| Proteobacteria | Alphaproteobacteria | Unclassified | Unclassified | sf_6 | 6694 | forested wetland clone RCP2-92 |
| Proteobacteria | Alphaproteobacteria | Azospirillales | Unclassified | sf_1 | 6732 | Anabaena circinalis AWQC118C isolate str. |
| | | | | | | UNSW7 |
| Proteobacteria | Alphaproteobacteria | Acetobacterales | Unclassified | sf_1 | 7028 | |
| Proteobacteria | Alphaproteobacteria | Ellin314/wr0007 | Unclassified | sf_1 | 7123 | uranium mining waste pile near |
| | | | | | | Johanngeorgenstadt soil clone JG37-AG-102 |
| Proteobacteria | Alphaproteobacteria | Ellin314/wr0007 | Unclassified | sf_1 | 7222 | Great Artesian Basin clone B79 |
| Proteobacteria | Alphaproteobacteria | Unclassified | Unclassified | sf_6 | 7575 | |
| Proteobacteria | Alphaproteobacteria | Rhizobiales | Unclassified | sf_1 | 6726 | |
| Proteobacteria | Alphaproteobacteria | Unclassified | Unclassified | sf_6 | 6920 | Pseudovibrio denitrificans str. DN34 |
| Proteobacteria | Alphaproteobacteria | Unclassified | Unclassified | sf_6 | 6954 | |
| Proteobacteria | Alphaproteobacteria | Ellin329/Riz1046 | Unclassified | sf_1 | 6945 | Rhizobiales str. A48 |
| Proteobacteria | Alphaproteobacteria | Bradyrhizobiales | Unclassified | sf_1 | 7067 | Blastochloris sulfoviridis str. GN1 |
| Proteobacteria | Alphaproteobacteria | Bradyrhizobiales | Unclassified | sf_1 | 7264 | Bosea thiooxidans TJ1 |
| Proteobacteria | Alphaproteobacteria | Rhizobiales | Unclassified | sf_1 | 7339 | |
| Proteobacteria | Alphaproteobacteria | Unclassified | Unclassified | sf_6 | 6898 | heavy metal-contaminated soil clone a13113 |
| Proteobacteria | Alphaproteobacteria | Bradyrhizobiales | Unclassified | sf_1 | 7199 | uranium mill tailings clone Gitt-KF-194 |
| Proteobacteria | Alphaproteobacteria | Rhizobiales | Unclassified | sf_1 | 6899 | |
| Proteobacteria | Alphaproteobacteria | Unclassified | Unclassified | sf_6 | 6665 | hydrocarbon-degrading consortium clone |
| | | | | | | 4-Org2-22 |
| Proteobacteria | Alphaproteobacteria | Unclassified | Unclassified | sf_6 | 7312 | |
| Proteobacteria | Alphaproteobacteria | Rhizobiales | Unclassified | sf_1 | 6789 | Shinella zoogloeoides str. ATCC 19623 |
| Proteobacteria | Alphaproteobacteria | Unclassified | Unclassified | sf_2 | 6697 | termite gut homogenate clone Rs-D84 |
| | | | | | | proteobacterium |
| Proteobacteria | Alphaproteobacteria | Unclassified | Unclassified | sf_2 | 7188 | termite gut homogenate clone Rs-B50 |
| | | | | | | proteobacterium |
| Proteobacteria | Alphaproteobacteria | Consistiales | Unclassified | sf_4 | 7105 | Mariana trough hydrothermal vent water 0.2 micro-m |
| | | | | | | filterable fraction clone MT-NB25 |
| Proteobacteria | Alphaproteobacteria | Rhodobacterales | Unclassified | sf_5 | 7471 | sponge clone TK03 |
| Proteobacteria | Alphaproteobacteria | Consistiales | Unclassified | sf_5 | 6735 | Candidatus Pelagibacter ubique str. HTCC1002 |
| Proteobacteria | Unclassified | Unclassified | Unclassified | sf_20 | 6763 | |
| Proteobacteria | Alphaproteobacteria | Rickettsiales | Unclassified | sf_2 | 6639 | |
| Proteobacteria | Alphaproteobacteria | Rickettsiales | Unclassified | sf_1 | 7156 | termite gut homogenate clone Rs-M62 |
| | | | | | | proteobacterium |
| Proteobacteria | Deltaproteobacteria | AMD clone group | Unclassified | sf_1 | 6830 | coal effluent wetland clone RCP124 |
| Proteobacteria | Alphaproteobacteria | Sphingomonadales | Unclassified | sf_1 | 6653 | Kaistobacter koreensis str. PB229 |
| Proteobacteria | Deltaproteobacteria | Bdellovibrionales | Unclassified | sf_1 | 7382 | marine clone Arctic95C-5 |
| Proteobacteria | Alphaproteobacteria | Unclassified | Unclassified | sf_6 | 6987 | |
| Proteobacteria | Alphaproteobacteria | Unclassified | Unclassified | sf_6 | 7572 | |
| Proteobacteria | Betaproteobacteria | Burkholderiales | Unclassified | sf_1 | 8035 | |
| Proteobacteria | Betaproteobacteria | MND1 clone group | Unclassified | sf_1 | 7808 | Mammoth cave clone CCU25 |
| Proteobacteria | Betaproteobacteria | Unclassified | Unclassified | sf_3 | 8007 | |
| Proteobacteria | Betaproteobacteria | Unclassified | Unclassified | sf_3 | 8036 | Uranium mill tailings soil sample clone Sh765B- |
| | | | | | | TzT-132 proteobacterium |
| Proteobacteria | Betaproteobacteria | Unclassified | Unclassified | sf_3 | 7974 | |
| Proteobacteria | Betaproteobacteria | Unclassified | Unclassified | sf_3 | 8114 | |
| Proteobacteria | Betaproteobacteria | MND1 clone group | Unclassified | sf_1 | 8023 | ferromanganous micronodule clone MND1 |
| Proteobacteria | Betaproteobacteria | Unclassified | Unclassified | sf_3 | 8045 | |
| Proteobacteria | Betaproteobacteria | MND1 clone group | Unclassified | sf_1 | 7818 | soil sample uranium mining waste pile near |
| | | | | | | town Johanngeorgenstadt clone JG36-TzT-215 |
| | | | | | | proteobacterium |
| Proteobacteria | Betaproteobacteria | Neisseriales | Unclassified | sf_1 | 8037 | Chitinimonas taiwanensis str. cf |
| Proteobacteria | Betaproteobacteria | Unclassified | Unclassified | sf_3 | 7997 | |
| Proteobacteria | Gammaproteobacteria | uranium waste clones | Unclassified | sf_1 | 8747 | uranium waste soil clone JG30-KF-CM35 |
| Proteobacteria | Gammaproteobacteria | GAO cluster | Unclassified | sf_1 | 9059 | activated sludge clone SBRH10 |
| Proteobacteria | Gammaproteobacteria | aquatic clone group | Unclassified | sf_1 | 9246 | Mammoth Cave sediment clone CCD24 |
| Proteobacteria | Gammaproteobacteria | Unclassified | Unclassified | sf_3 | 9498 | |
| Proteobacteria | Gammaproteobacteria | Unclassified | Unclassified | sf_3 | 9568 | forested wetland clone RCP2-96 |
| Proteobacteria | Gammaproteobacteria | Chromatiales | Unclassified | sf_1 | 9282 | |
| Proteobacteria | Gammaproteobacteria | Legionellales | Unclassified | sf_1 | 9418 | uranium mining waste pile clone JG37-AG-14 |
| | | | | | | proteobacterium |
| Proteobacteria | Deltaproteobacteria | EB1021 group | Unclassified | sf_4 | 8169 | forested wetland clone RCP2-54 |
| Proteobacteria | Gammaproteobacteria | Symbionts | Unclassified | sf_1 | 8403 | Selenate-reducing isolate str. KE4OH1 |
| Proteobacteria | Gammaproteobacteria | Unclassified | Unclassified | sf_3 | 8488 | |
| Proteobacteria | Gammaproteobacteria | Unclassified | Unclassified | sf_3 | 8646 | |
| Proteobacteria | Gammaproteobacteria | Unclassified | Unclassified | sf_3 | 8676 | |
| Proteobacteria | Gammaproteobacteria | Unclassified | Unclassified | sf_3 | 8926 | inactive deep-sea hydrothermal vent chimneys |
| | | | | | | clone IheB2-13 |
| Proteobacteria | Gammaproteobacteria | aquatic clone group | Unclassified | sf_1 | 8957 | marine clone Arctic97C-5 |
| Proteobacteria | Gammaproteobacteria | Unclassified | Unclassified | sf_3 | 9105 | |
| Proteobacteria | Gammaproteobacteria | Unclassified | Unclassified | sf_3 | 9124 | 10e−6 dilution marine samples Weser estuary |
| | | | | | | clone DC8-80-1 proteobacterium |
| Proteobacteria | Gammaproteobacteria | Symbionts | Unclassified | sf_1 | 9128 | Lucina nassula gill symbiont |
| Proteobacteria | Gammaproteobacteria | Unclassified | Unclassified | sf_3 | 9394 | |
| Proteobacteria | Gammaproteobacteria | Symbionts | Unclassified | sf_1 | 9556 | Seepiophila jonesi symbiont |
| Proteobacteria | Gammaproteobacteria | SUP05 | Unclassified | sf_1 | 8605 | bacterioplankton clone ZA2525c |
| Proteobacteria | Gammaproteobacteria | SUP05 | Unclassified | sf_1 | 8654 | inactive deep-sea hydrothermal vent chimneys |
| | | | | | | clone IheB2-31 |
| Proteobacteria | Gammaproteobacteria | SUP05 | Unclassified | sf_1 | 8965 | Bathymodiolus thermophilus gill symbiont |
| Proteobacteria | Gammaproteobacteria | uranium waste clones | Unclassified | sf_1 | 8231 | uranium waste soil clone JG30a-KF-21 |
| Proteobacteria | Gammaproteobacteria | Unclassified | Unclassified | sf_3 | 8339 | water 5 m downstream manure clone 35ds5 |
| Proteobacteria | Gammaproteobacteria | Ellin307/WD2124 | Unclassified | sf_1 | 8532 | |
| Proteobacteria | Gammaproteobacteria | Ellin307/WD2124 | Unclassified | sf_1 | 9458 | uranium mining waste pile clone JG37-AG-94 |
| | | | | | | proteobacterium |
| Proteobacteria | Gammaproteobacteria | SAR86 | Unclassified | sf_1 | 8962 | bacterioplankton clone AEGEAN_234 |
| Proteobacteria | Gammaproteobacteria | Legionellales | Unclassified | sf_3 | 8587 | Mars Odyssey Orbiter and encapsulation facility |
| | | | | | | clone T5-3 |
| Proteobacteria | Gammaproteobacteria | GAO cluster | Unclassified | sf_1 | 9468 | activated sludge clone SBRL2_40 |
| Proteobacteria | Gammaproteobacteria | Unclassified | Unclassified | sf_4 | 8855 | |
| Proteobacteria | Unclassified | Unclassified | Unclassified | sf_8 | 9558 | |
| Proteobacteria | Gammaproteobacteria | Oceanospirillales | Unclassified | sf_3 | 8230 | |
| Proteobacteria | Gammaproteobacteria | Unclassified | Unclassified | sf_3 | 8245 | |
| Proteobacteria | Gammaproteobacteria | Unclassified | Unclassified | sf_3 | 8883 | |
| Proteobacteria | Gammaproteobacteria | Unclassified | Unclassified | sf_3 | 9044 | hydrothermal sediment clone AF420370 |
| Proteobacteria | Gammaproteobacteria | Thiotrichales | Unclassified | sf_1 | 8323 | hydrothermal sediment clone AF420363 |
| Proteobacteria | Alphaproteobacteria | Unclassified | Unclassified | sf_6 | 8780 | uranium mining mill tailing clone GR-296.II.89 |
| | | | | | | GR-296.II.89 |
| Proteobacteria | Gammaproteobacteria | Oceanospirillales | Unclassified | sf_3 | 8327 | Arctic sea ice ARK10148 |
| Proteobacteria | Gammaproteobacteria | Unclassified | Unclassified | sf_3 | 8606 | |
| Proteobacteria | Gammaproteobacteria | Unclassified | Unclassified | sf_3 | 8714 | Marinobacter hydrocarbonoclasticus str. ATCC |
| | | | | | | 27132T |
| Proteobacteria | Gammaproteobacteria | Unclassified | Unclassified | sf_3 | 8959 | bacterioplankton clone AEGEAN_133 |
| Proteobacteria | Gammaproteobacteria | Alteromonadales | Unclassified | sf_1 | 8483 | Rheinheimera baltica str. OS140 Baltic # 166 |
| Proteobacteria | Gammaproteobacteria | Shewanella | Unclassified | sf_1 | 9344 | Shewanella algae str. ATCC 51192 |
| Proteobacteria | Gammaproteobacteria | Unclassified | Unclassified | sf_3 | 9367 | USA: Pacific Ocean seawater Naha Vents Hawaii isolate |
| | | | | | | str. PV-4 |
| Proteobacteria | Gammaproteobacteria | Unclassified | Unclassified | sf_3 | 9473 | Arctic pack ice; northern Fram Strait; 80 31.1 N; |
| | | | | | | 01 deg 59.7 min E clone ARKDMS-58 |
| Proteobacteria | Gammaproteobacteria | Enterobacteriales | Unclassified | sf_1 | 8430 | Salmonella bongori str. JEO 4162 |
| Proteobacteria | Deltaproteobacteria | Desulfovibrionales | Unclassified | sf_1 | 9828 | termite gut homogenate clone Rs-M89 |
| | | | | | | proteobacterium |
| Proteobacteria | Deltaproteobacteria | Myxococcales | Unclassified | sf_1 | 10092 | heavy metal-contaminated soil clone a13134 |
| Proteobacteria | Deltaproteobacteria | Myxococcales | Unclassified | sf_1 | 10259 | |
| Proteobacteria | Deltaproteobacteria | Unclassified | Unclassified | sf_7 | 10048 | |
| Proteobacteria | Deltaproteobacteria | Unclassified | Unclassified | sf_9 | 10049 | DCP-dechlorinating consortium clone SHA-72 |
| Proteobacteria | Deltaproteobacteria | Unclassified | Unclassified | sf_9 | 9760 | deep marine sediment clone MB-A2-137 |
| Proteobacteria | Deltaproteobacteria | Unclassified | Unclassified | sf_9 | 9784 | Antarctic sediment clone LH5_30 |
| Proteobacteria | Deltaproteobacteria | Unclassified | Unclassified | sf_9 | 9798 | uranium mill tailings soil sample clone GuBH2- |
| | | | | | | AD/TzT-67 proteobacterium |
| Proteobacteria | Deltaproteobacteria | Unclassified | Unclassified | sf_9 | 9876 | deep marine sediment clone MB-B2-106 |
| Proteobacteria | Deltaproteobacteria | EB1021 group | Unclassified | sf_4 | 9884 | forested wetland clone RCP2-62 |
| Proteobacteria | Deltaproteobacteria | AMD clone group | Unclassified | sf_1 | 10084 | acid mine drainage clone AS6 |
| Proteobacteria | Deltaproteobacteria | Desulfuromonadales | Unclassified | sf_1 | 10076 | Great Artesian Basin clone G13 |
| Proteobacteria | Deltaproteobacteria | dechlorinating | Unclassified | sf_1 | 9959 | forested wetland clone FW110 |
| | | clone group | | | | |
| Proteobacteria | Deltaproteobacteria | EB1021 group | Unclassified | sf_4 | 10024 | hydrothermal sediment clone AF420338 |
| Proteobacteria | Deltaproteobacteria | AMD clone group | Unclassified | sf_1 | 9678 | coal effluent wetland clone RCP185 |
| Proteobacteria | Deltaproteobacteria | Desulfobacterales | Unclassified | sf_4 | 9951 | forested wetland clone FW13 |
| Proteobacteria | Deltaproteobacteria | Unclassified | Unclassified | sf_9 | 9738 | marine methane seep clone 1513 |
| Proteobacteria | Deltaproteobacteria | AMD clone group | Unclassified | sf_1 | 9945 | acid mine drainage clone BA18 |
| Proteobacteria | Deltaproteobacteria | Desulfobacterales | Unclassified | sf_3 | 9813 | hydrothermal sediment clone AF420340 |
| Proteobacteria | Deltaproteobacteria | Unclassified | Unclassified | sf_9 | 9890 | termite gut homogenate clone Rs-K70 |
| | | | | | | proteobacterium |
| Proteobacteria | Epsilonproteobacteria | Campylobacterales | Unclassified | sf_1 | 10543 | hydrothermal vent clone PVB_10 |
| Proteobacteria | Epsilonproteobacteria | Campylobacterales | Unclassified | sf_1 | 10427 | hydrothermal vent 9 degrees North East Rise |
| | | | | | | Pacific Ocean clone |
| | | | | | | CH3_17_BAC_16SrRNA_9N_EPR |
| Proteobacteria | Epsilonproteobacteria | Campylobacterales | Unclassified | sf_1 | 10475 | hydrothermal sediment clone AF420359 |
| Proteobacteria | Epsilonproteobacteria | Campylobacterales | Unclassified | sf_1 | 10480 | Paralvinella palmiformis mucus secretions clone P. palm |
| | | | | | | C 84 proteobacterium |
| Proteobacteria | Epsilonproteobacteria | Campylobacterales | Unclassified | sf_1 | 10489 | S17sBac16 complete clone |
| Proteobacteria | Epsilonproteobacteria | Campylobacterales | Unclassified | sf_1 | 10497 | UASB reactor granular sludge clone PD-UASB-2 |
| | | | | | | proteobacterium |
| Proteobacteria | Epsilonproteobacteria | Campylobacterales | Unclassified | sf_1 | 10530 | hydrothermal vent 9 degrees North East Rise |
| | | | | | | Pacific Ocean clone |
| | | | | | | CH5_6_BAC_16SrRNA_9N_EPR |
| Proteobacteria | Unclassified | Unclassified | Unclassified | sf_20 | 2520 | |
| Proteobacteria | Deltaproteobacteria | Unclassified | Unclassified | sf_9 | 244 | deep marine sediment clone MB-C2-152 |
| Proteobacteria | Deltaproteobacteria | AMD clone group | Unclassified | sf_1 | 3084 | coal effluent wetland clone RCP216 |
| Proteobacteria | Gammaproteobacteria | Vibrionales | Vibrionaceae | sf_1 | 8999 | Photobacterium leiognathi str. LN101 |
| Proteobacteria | Gammaproteobacteria | Vibrionales | Vibrionaceae | sf_1 | 8665 | Vibrio gallicus str. CIP 107867; HT 3-3 |
| Proteobacteria | Gammaproteobacteria | Vibrionales | Vibrionaceae | sf_1 | 8267 | Vibrio pomeroyi str. LMG 20537 |
| Proteobacteria | Gammaproteobacteria | Vibrionales | Vibrionaceae | sf_1 | 8798 | Vibrio aestuarianus str. KT0901 |
| Proteobacteria | Gammaproteobacteria | Vibrionales | Vibrionaceae | sf_1 | 8888 | Vibrio aestuarianus str. 01/151 |
| Proteobacteria | Alphaproteobacteria | Bradyrhizobiales | Xanthobacteraceae | sf_1 | 6660 | Azorhizobium caulinodans str. ORS 571 |
| Proteobacteria | Gammaproteobacteria | Xanthomonadales | Xanthomonadaceae | sf_3 | 9167 | pea aphid symbiont clone APe4_38 |
| Proteobacteria | Gammaproteobacteria | Xanthomonadales | Xanthomonadaceae | sf_3 | 8689 | Dyemonas todaii str. XD10 |
| Proteobacteria | Gammaproteobacteria | Xanthomonadales | Xanthomonadaceae | sf_3 | 9332 | wetland ecosystem constructed to remediate |
| | | | | | | mine drainage isolate str. WJ2 WJ2 |
| Proteobacteria | Gammaproteobacteria | Xanthomonadales | Xanthomonadaceae | sf_3 | 8392 | penguin droppings sediments clone KD2-14 |
| Proteobacteria | Gammaproteobacteria | Xanthomonadales | Xanthomonadaceae | sf_3 | 8983 | Iron oxidizing strain ES-1 |
| Proteobacteria | Gammaproteobacteria | Xanthomonadales | Xanthomonadaceae | sf_3 | 9031 | municipal wastewater treatment bioreactor clone LB-P |
| | | | | | | bacterium |
| Proteobacteria | Gammaproteobacteria | Xanthomonadales | Xanthomonadaceae | sf_3 | 9320 | Waste-gas biofilter clone BIyi3 |
| Proteobacteria | Gammaproteobacteria | Xanthomonadales | Xanthomonadaceae | sf_3 | 8577 | Xanthomonas axonopodis pv. citri str. MA |
| Proteobacteria | Gammaproteobacteria | Xanthomonadales | Xanthomonadaceae | sf_3 | 9569 | |
| Proteobacteria | Gammaproteobacteria | Xanthomonadales | Xanthomonadaceae | sf_3 | 8538 | |
| Proteobacteria | Gammaproteobacteria | Xanthomonadales | Xanthomonadaceae | sf_3 | 8563 | Pseudoxanthomonas mexicana str. AMX 26B |
| Proteobacteria | Gammaproteobacteria | Xanthomonadales | Xanthomonadaceae | sf_3 | 9270 | Stenotrophomonas rhizophila str. e-p10 |
| Proteobacteria | Gammaproteobacteria | Xanthomonadales | Xanthomonadaceae | sf_3 | 9286 | Stenotrophomonas maltophilia str. LMG 11104 |
| SPAM | Unclassified | Unclassified | Unclassified | sf_1 | 705 | uranium tailings soil clone Sh765B-AG-45 |
| SPAM | Unclassified | Unclassified | Unclassified | sf_1 | 738 | uranium mining waste clone JG34-KF-252 |
| Spirochaetes | Spirochaetes | Spirochaetales | Leptospiraceae | sf_3 | 6496 | Leptospira interrogans serovar Copenhageni str. |
| | | | | | | Fiocruz L1-130 |
| Spirochaetes | Spirochaetes | Spirochaetales | Spirochaetaceae | sf_1 | 6459 | Spirochaeta sp. str. BHI80-158 |
| Spirochaetes | Spirochaetes | Spirochaetales | Spirochaetaceae | sf_3 | 6558 | Spironema culicis str. BR91 |
| Spirochaetes | Spirochaetes | Spirochaetales | Spirochaetaceae | sf_1 | 6526 | Treponema sp. str. 7CPL208 |
| Spirochaetes | Spirochaetes | Spirochaetales | Spirochaetaceae | sf_1 | 6479 | Treponema sp |
| Spirochaetes | Spirochaetes | Spirochaetales | Spirochaetaceae | sf_1 | 6580 | Treponema sp. str. III:C:BA213 |
| Spirochaetes | Spirochaetes | Spirochaetales | Spirochaetaceae | sf_1 | 6458 | termite gut clone NkS34 |
| Spirochaetes | Spirochaetes | Spirochaetales | Spirochaetaceae | sf_1 | 6494 | termite gut homogenate clone Rs-C47 sp. |
| Spirochaetes | Spirochaetes | Spirochaetales | Spirochaetaceae | sf_1 | 6562 | forested wetland clone RCP1-96 |
| Spirochaetes | Spirochaetes | Spirochaetales | Spirochaetaceae | sf_1 | 6507 | termite gut clone NkS-Ste2 |
| Spirochaetes | Spirochaetes | Spirochaetales | Spirochaetaceae | sf_1 | 6476 | termite gut clone NkS50 |
| Spirochaetes | Spirochaetes | Spirochaetales | Spirochaetaceae | sf_1 | 6488 | Treponema primitia str. ZAS-1 |
| Spirochaetes | Spirochaetes | Spirochaetales | Spirochaetaceae | sf_1 | 6490 | termite gut homogenate clone BCf4-14 |
| Spirochaetes | Spirochaetes | Spirochaetales | Spirochaetaceae | sf_1 | 6491 | termite gut homogenate clone BCf8-03 |
| Spirochaetes | Spirochaetes | Spirochaetales | Spirochaetaceae | sf_1 | 6506 | termite gut homogenate clone Rs-J58 sp. |
| Spirochaetes | Spirochaetes | Spirochaetales | Spirochaetaceae | sf_1 | 6508 | termite hindgut clone mpsp2 |
| Spirochaetes | Spirochaetes | Spirochaetales | Spirochaetaceae | sf_1 | 6523 | termite gut homogenate clone Rs-J64 sp. |
| Spirochaetes | Spirochaetes | Spirochaetales | Spirochaetaceae | sf_1 | 6565 | termite gut clone NkS-Oxy25 |
| Spirochaetes | Spirochaetes | Spirochaetales | Spirochaetaceae | sf_1 | 6571 | Mixotricha paradoxa is flagellate hindgut |
| | | | | | | Mastotermes darwiniensis clone mp4 of |
| Synergistes | Unclassified | Unclassified | Unclassified | sf_3 | 117 | termite gut homogenate clone Rs-D89 |
| Synergistes | Unclassified | Unclassified | Unclassified | sf_3 | 353 | UASB reactor granular sludge clone PD-UASB-13 G + C |
| Synergistes | Unclassified | Unclassified | Unclassified | sf_3 | 60 | Flexistipes sp. str. E3_33 |
| Synergistes | Unclassified | Unclassified | Unclassified | sf_3 | 601 | terephthalate-degrading consortium clone TA19 |
| Synergistes | Unclassified | Unclassified | Unclassified | sf_3 | 719 | Synergistes sp. P1 str. P4G_18 |
| Synergistes | Unclassified | Unclassified | Unclassified | sf_3 | 740 | swine intestine clone p-4292-4Wa3 |
| Synergistes | Unclassified | Unclassified | Unclassified | sf_3 | 808 | oral cavity clone BH017 |
| Termite group 1 | Unclassified | Unclassified | Unclassified | sf_2 | 437 | termite gut homogenate clone Rs-D43 group |
| Thermodesulfobacteria | Thermodesulfobacteria | Thermodesulfobacteriales | Thermodesulfobacteriaceae | sf_1 | 667 | Geothermobacterium ferrireducens |
| Thermotogae | Thermotogae | Thermotogales | Thermotogaceae | sf_4 | 51 | Thermosipho sp. str. MV1063 |
| TM6 | Unclassified | Unclassified | Unclassified | sf_1 | 9803 | forest soil clone S1204 |
| TM7 | Unclassified | Unclassified | Unclassified | sf_1 | 5177 | |
| TM7 | TM7-3 | Unclassified | Unclassified | sf_1 | 8155 | oral periodontitis clone EW086 |
| TM7 | TM7-3 | Unclassified | Unclassified | sf_1 | 2697 | midgut homogenate Pachnoda ephippiata larva clone PeM47 |
| TM7 | Unclassified | Unclassified | Unclassified | sf_1 | 3025 | |
| Unclassified | Unclassified | Unclassified | Unclassified | sf_93 | 925 | 4MB-degrading consortium clone UASB_TL26 |
| Unclassified | Unclassified | Unclassified | Unclassified | sf_106 | 243 | hot spring clone OPB25 |
| Unclassified | Unclassified | Unclassified | Unclassified | sf_160 | 485 | thermal spring mat clone O1aA90 |
| Unclassified | Unclassified | Unclassified | Unclassified | sf_160 | 226 | |
| Unclassified | Unclassified | Unclassified | Unclassified | sf_160 | 333 | |
| Unclassified | Unclassified | Unclassified | Unclassified | sf_160 | 651 | |
| Unclassified | Unclassified | Unclassified | Unclassified | sf_160 | 6430 | |
| Unclassified | Unclassified | Unclassified | Unclassified | sf_160 | 6456 | |
| Unclassified | Unclassified | Unclassified | Unclassified | sf_160 | 6360 | |
| Unclassified | Unclassified | Unclassified | Unclassified | sf_140 | 6355 | |
| Unclassified | Unclassified | Unclassified | Unclassified | sf_160 | 7444 | |
| Unclassified | Unclassified | Unclassified | Unclassified | sf_160 | 7767 | |
| Unclassified | Unclassified | Unclassified | Unclassified | sf_160 | 10012 | |
| Unclassified | Unclassified | Unclassified | Unclassified | sf_95 | 2545 | anaerobic sludge isolate str. JE |
| Unclassified | Unclassified | Unclassified | Unclassified | sf_160 | 2488 | |
| Unclassified | Unclassified | Unclassified | Unclassified | sf_156 | 4291 | Mono Lake at depth 35 m station 6 Jul. 2000 |
| | | | | | | clone ML635J-21 G + C |
| Unclassified | Unclassified | Unclassified | Unclassified | sf_160 | 4410 | |
| Verrucomicrobia | Verrucomicrobiae | Verrucomicrobiales | Unclassified | sf_4 | 169 | anoxic marine sediment clone LD1-PA26 |
| Verrucomicrobia | Unclassified | Unclassified | Unclassified | sf_3 | 40 | Elbe river clone DEV055 |
| Verrucomicrobia | Unclassified | Unclassified | Unclassified | sf_3 | 486 | Elbe river clone DEV045 |
| Verrucomicrobia | Unclassified | Unclassified | Unclassified | sf_5 | 686 | hydrothermal vent sediment clone a2b018 |
| Verrucomicrobia | Verrucomicrobiae | Verrucomicrobiales | Unclassified | sf_3 | 11 | sludge clone H2 |
| Verrucomicrobia | Unclassified | Unclassified | Unclassified | sf_4 | 288 | Prosthecobacter dejongeii |
| Verrucomicrobia | Verrucomicrobiae | Verrucomicrobiales | Unclassified | sf_3 | 792 | termite gut homogenate clone Rs-P07 bacterium |
| Verrucomicrobia | Verrucomicrobiae | Verrucomicrobiales | Verrucomicrobia SD 5 | sf_1 | 530 | anoxic marine sediment clone LD1-PB20 |
| Verrucomicrobia | Verrucomicrobiae | Verrucomicrobiales | Verrucomicrobia SD 5 | sf_1 | 533 | anoxic marine sediment clone LD1-PB12 |
| Verrucomicrobia | Verrucomicrobiae | Verrucomicrobiales | Verrucomicrobia SD 5 | sf_1 | 547 | anoxic marine sediment clone LD1-PB1 |
| Verrucomicrobia | Verrucomicrobiae | Verrucomicrobiales | Verrucomicrobia SD 5 | sf_1 | 629 | anoxic marine sediment clone LD1-PA50 |
| Verrucomicrobia | Verrucomicrobiae | Verrucomicrobiales | Verrucomicrobia SD 7 | sf_1 | 446 | anoxic marine sediment clone LD1-PA34 |
| Verrucomicrobia | Verrucomicrobiae | Verrucomicrobiales | Verrucomicrobia SD 7 | sf_1 | 559 | anoxic marine sediment clone LD1-PA20 |
| Verrucomicrobia | Verrucomicrobiae | Verrucomicrobiales | Verrucomicrobia SD 7 | sf_1 | 760 | Mono lake clone ML316M-1 |
| Verrucomicrobia | Verrucomicrobiae | Verrucomicrobiales | Verrucomicrobiaceae | sf_7 | 29 | Fucophilus fucoidanolyticus str. SI-1234 |
| Verrucomicrobia | Verrucomicrobiae | Verrucomicrobiales | Verrucomicrobiaceae | sf_6 | 871 | |
| Verrucomicrobia | Verrucomicrobiae | Verrucomicrobiales | Xiphinematobacteraceae | sf_3 | 888 | Candidatus Xiphinematobacter brevicolli |
| WS3 | Unclassified | Unclassified | Unclassified | sf_3 | 95 | marine sediment above hydrate ridge clone Hyd24-32 |
| WS3 | Unclassified | Unclassified | Unclassified | sf_1 | 2537 | anoxic marine sediment clone LD1-PA39 |
| WS5 | Unclassified | Unclassified | Unclassified | sf_2 | 8119 | hydrothermal vent sediment clone a2b013 |

^{a}S-F, Subfamily identification;
^{b}Taxon ID, PhyloChip Taxon identification number;
^{c}Representative species, Taxon bacterial species identifier.

TABLE 4
BACTERIAL TAXA WITH SIGNIFICANT DIFFERENCES IN RELATIVE ABUNDANCE BETWEEN COPD PATIENT GROUP 1 (≦6 INTUBATION DAYS)
AND GROUP 2 (≧16 INTUBATION DAYS)

| | | | | | | | | | Fluorescence difference |
|---|---|---|---|---|---|---|---|---|---|
| Phylum | Class | Order | Family | S-F^{a} | Taxon ID^{b} | Representative species^{c} | p-value | q-value | (Group 1 − Group 2) |
| Firmicutes | Symbiobacteria | Symbiobacterales | Unclassified | 1 | 77 | thermal soil clone YNPFFP9 | <0.001 | <0.01 | 1264 |
| Proteobacteria | Deltaproteobacteria | Unclassified | Unclassified | 9 | 244 | deep marine sediment clone MB-C2-152 | <0.02 | <0.05 | 1048 |
| Chloroflexi | Anaerolineae | Unclassified | Unclassified | 9 | 375 | forest soil clone C043 | <0.02 | <0.05 | 1873 |
| Proteobacteria | Deltaproteobacteria | Desulfuromonadales | Geobacteraceae | 1 | 482 | trichloroethene-contaminated | ≦0.01 | <0.05 | 1092 |
| | | | | | | site clone FTLM205 | | | |
| | | | | | | proteobacterium | | | |
| OP10 | CH21 cluster | Unclassified | Unclassified | 1 | 514 | sludge clone SBRA136 | <0.01 | <0.05 | 1081 |
| Chlorobi | Unclassified | Unclassified | Unclassified | 8 | 636 | benzene-degrading nitrate- | <0.01 | <0.05 | 1475 |
| | | | | | | reducing consortium clone | | | |
| | | | | | | Cart-N3 bacterium | | | |
| Unclassified | Unclassified | Unclassified | Unclassified | 160 | 651 | | <0.01 | <0.05 | 1750 |
| Chloroflexi | Unclassified | Unclassified | Unclassified | 7 | 757 | DCP-dechlorinating consortium | <0.001 | <0.01 | 1619 |
| | | | | | | clone SHA-8 | | | |
| Natronoanaerobium | Unclassified | Unclassified | Unclassified | 1 | 769 | fjord ikaite column clone un-c23 | <0.001 | <0.01 | 1305 |
| Firmicutes | Clostridia | Clostridiales | Peptococc/Acidaminococc | 11 | 940 | Veillonella dispar str. DSM 20735 | <0.01 | <0.05 | 1150 |
| OP9/JS1 | OP9 | Unclassified | Unclassified | 1 | 969 | DCP-dechlorinating consortium | <0.02 | <0.05 | 1190 |
| | | | | | | clone SHA-1 | | | |
| Firmicutes | Bacilli | Bacillales | Bacillaceae | 1 | 1050 | Bacillus firmus CV93b | ≦0.001 | <0.05 | 1746 |
| Actinobacteria | Actinobacteria | Unclassified | Unclassified | 1 | 1898 | termite gut homogenate clone Rs- | <0.01 | <0.05 | 1906 |
| | | | | | | J10 bacterium | | | |
| AD3 | Unclassified | Unclassified | Unclassified | 1 | 2338 | uranium mining waste pile soil | <0.001 | <0.01 | 1148 |
| | | | | | | clone JG30-KF-C12 | | | |
| Chloroflexi | Dehalococcoidetes | Unclassified | Unclassified | 1 | 2339 | uranium mill tailings soil sample | <0.02 | <0.05 | 1532 |
| | | | | | | clone Sh765B-TzT-20 | | | |
| | | | | | | bacterium | | | |
| Chloroflexi | Unclassified | Unclassified | Unclassified | 1 | 2534 | forest soil clone S085 | <0.001 | <0.01 | 1193 |
| Firmicutes | Clostridia | Clostridiales | Lachnospiraceae | 5 | 2668 | termite gut homogenate clone Rs- | <0.01 | <0.05 | 2395 |
| | | | | | | G40 bacterium | | | |
| Firmicutes | Clostridia | Clostridiales | Peptostreptococcaceae | 5 | 2694 | oral periodontitis clone FX028 | <0.02 | <0.05 | 1338 |
| Firmicutes | Clostridia | Clostridiales | Peptostreptococcaceae | 5 | 2714 | termite gut homogenate clone Rs- | <0.01 | <0.05 | 2061 |
| | | | | | | N27 bacterium | | | |
| Firmicutes | Clostridia | Clostridiales | Peptostreptococcaceae | 5 | 2729 | DCP-dechlorinating consortium | <0.01 | <0.05 | 1402 |
| | | | | | | clone SHA-58 | | | |
| Firmicutes | Clostridia | Clostridiales | Peptostreptococcaceae | 5 | 2797 | Isolation and identification | <0.01 | <0.05 | 1611 |
| | | | | | | hyper-ammonia producing | | | |
| | | | | | | swine storage pits manure | | | |
| Firmicutes | Clostridia | Clostridiales | Peptostreptococcaceae | 5 | 2805 | oral periodontitis clone FX033 | <0.02 | <0.05 | 1625 |
| Firmicutes | Clostridia | Clostridiales | Lachnospiraceae | 5 | 2834 | Butyrivibrio fibrisolvens str. OB156 | <0.01 | <0.05 | 1005 |
| Firmicutes | Clostridia | Clostridiales | Lachnospiraceae | 5 | 2994 | termite gut clone Rs-L15 | <0.001 | <0.01 | 3929 |
| Firmicutes | Clostridia | Clostridiales | Clostridiaceae | 12 | 3021 | Clostridium caminithermale str. | <0.01 | <0.05 | 1944 |
| | | | | | | DVird3 | | | |
| Firmicutes | Clostridia | Clostridiales | Lachnospiraceae | 5 | 3038 | swine intestine clone p-1594-c5 | <0.01 | <0.05 | 1363 |
| Firmicutes | Clostridia | Clostridiales | Lachnospiraceae | 5 | 3059 | Butyrivibrio fibrisolvens str. NCDO | <0.01 | <0.05 | 1069 |
| | | | | | | 2249 | | | |
| Firmicutes | Clostridia | Clostridiales | Lachnospiraceae | 5 | 3060 | termite gut homogenate clone Rs- | <0.001 | <0.01 | 3703 |
| | | | | | | B14 bacterium | | | |
| Firmicutes | Clostridia | Clostridiales | Lachnospiraceae | 5 | 3076 | Clostridium nexile | <0.001 | <0.01 | 1395 |
| Firmicutes | Clostridia | Clostridiales | Clostridiaceae | 12 | 3077 | Clostridium glycolicum str. DSM | <0.01 | <0.05 | 1953 |
| | | | | | | 1288 | | | |
| Firmicutes | Clostridia | Clostridiales | Lachnospiraceae | 5 | 3171 | Lachnospira pectinoschiza | <0.01 | <0.05 | 1398 |
| Firmicutes | Clostridia | Clostridiales | Peptostreptococcaceae | 5 | 3182 | termite gut homogenate clone Rs- | ≦0.01 | <0.05 | 1107 |
| | | | | | | Q64 bacterium | | | |
| Firmicutes | Bacilli | Lactobacillales | Streptococcaceae | 1 | 3250 | Streptococcus bovis str. B315 | <0.001 | <0.01 | 4284 |
| Firmicutes | Bacilli | Lactobacillales | Streptococcaceae | 1 | 3251 | Streptococcus cristatus str. ATCC | <0.01 | <0.05 | 3986 |
| | | | | | | 51100 | | | |
| Firmicutes | Bacilli | Lactobacillales | Streptococcaceae | 1 | 3253 | derived cheese sample clone | <0.02 | <0.05 | 2680 |
| | | | | | | 32CR | | | |
| Firmicutes | Bacilli | Bacillales | Staphylococcaceae | 1 | 3258 | Staphylococcus auricularis str. | <0.01 | <0.05 | 1525 |
| | | | | | | MAFF911484 ATCC33753T | | | |
| Firmicutes | Bacilli | Lactobacillales | Enterococcaceae | 1 | 3261 | Enterococcus mundtii str. LMG | <0.02 | <0.05 | 2560 |
| | | | | | | 10748 | | | |
| Firmicutes | Bacilli | Bacillales | Bacillaceae | 1 | 3283 | Bacillus niacini str. IFO15566 | <0.01 | <0.05 | 1201 |
| Firmicutes | Bacilli | Bacillales | Staphylococcaceae | 1 | 3284 | | <0.01 | <0.05 | 1347 |
| Firmicutes | Bacilli | Bacillales | Caryophanaceae | 1 | 3285 | Caryophanon latum str. DSM | <0.01 | <0.05 | 1499 |
| | | | | | | 14151 | | | |
| Firmicutes | Bacilli | Lactobacillales | Streptococcaceae | 1 | 3287 | tongue dorsum scrapings clone | <0.01 | <0.05 | 3582 |
| | | | | | | FP015 | | | |
| Firmicutes | Bacilli | Lactobacillales | Enterococcaceae | 1 | 3288 | Isolation and identification | <0.01 | <0.05 | 2528 |
| | | | | | | hyper-ammonia producing | | | |
| | | | | | | swine storage pits manure | | | |
| Firmicutes | Bacilli | Lactobacillales | Streptococcaceae | 1 | 3290 | Streptococcus mitis str. Sm91 | ≦0.01 | <0.05 | 3971 |
| Firmicutes | Bacilli | Bacillales | Paenibacillaceae | 1 | 3299 | Brevibacillus borstelensis str. LMG | <0.02 | <0.05 | 1035 |
| | | | | | | 15536 | | | |
| Firmicutes | Bacilli | Lactobacillales | Streptococcaceae | 1 | 3313 | Streptococcus salivarius str. ATCC | <0.001 | <0.01 | 3189 |
| | | | | | | 7073 | | | |
| Firmicutes | Bacilli | Lactobacillales | Enterococcaceae | 1 | 3318 | Enterococcus ratti str. ATCC | <0.02 | <0.05 | 2272 |
| | | | | | | 700914 | | | |
| Firmicutes | Bacilli | Lactobacillales | Aerococcaceae | 1 | 3323 | Trichococcus flocculiformis str. | <0.01 | <0.05 | 1431 |
| | | | | | | DSM 2094 | | | |
| Firmicutes | Bacilli | Lactobacillales | Aerococcaceae | 1 | 3326 | Nostocoida limicola I str. Ben206 | <0.01 | <0.05 | 2363 |
| Firmicutes | Bacilli | Bacillales | Bacillaceae | 1 | 3328 | Pseudobacillus carolinae | <0.001 | <0.01 | 2370 |
| Firmicutes | Bacilli | Lactobacillales | Lactobacillaceae | 1 | 3330 | Lactobacillus kitasatonis str. | <0.02 | <0.05 | 1389 |
| | | | | | | KM9212 | | | |
| Firmicutes | Bacilli | Bacillales | Sporolactobacillaceae | 1 | 3365 | Bacillus sp. clone ML615J-19 | <0.001 | <0.01 | 1757 |
| Firmicutes | Bacilli | Lactobacillales | Aerococcaceae | 1 | 3386 | feedlot manure clone B87 | <0.01 | <0.05 | 2321 |
| Firmicutes | Bacilli | Lactobacillales | Enterococcaceae | 1 | 3392 | Vagococcus lutrae str. m1134/97/1; | <0.001 | ≦0.01 | 1976 |
| | | | | | | CCUG 39187 | | | |
| Firmicutes | Bacilli | Lactobacillales | Streptococcaceae | 1 | 3397 | Streptococcus macedonicus str. | <0.01 | <0.05 | 4011 |
| | | | | | | ACA-DC 206 LAB617 | | | |
| Firmicutes | Bacilli | Lactobacillales | Lactobacillaceae | 1 | 3418 | Lactobacillus subsp. aviarius | <0.01 | <0.05 | 3036 |
| Firmicutes | Bacilli | Bacillales | Bacillaceae | 1 | 3419 | Bacillus algicola str. KMM 3737 | <0.01 | <0.05 | 1590 |
| Firmicutes | Bacilli | Lactobacillales | Streptococcaceae | 1 | 3422 | Streptococcus thermophilus str. | <0.01 | <0.05 | 3243 |
| | | | | | | DSM 20617 | | | |
| Firmicutes | Bacilli | Lactobacillales | Enterococcaceae | 1 | 3433 | Tetragenococcus muriaticus | <0.01 | <0.05 | 2715 |
| Firmicutes | Bacilli | Lactobacillales | Streptococcaceae | 1 | 3446 | Streptococcus bovis str. HJ50 | <0.01 | <0.05 | 3846 |
| Firmicutes | Bacilli | Lactobacillales | Unclassified | 1 | 3481 | | <0.01 | <0.05 | 2102 |
| Firmicutes | Bacilli | Bacillales | Bacillaceae | 1 | 3489 | Bacillus silvestris str. SAFN-010 | <0.001 | <0.01 | 1206 |
| Firmicutes | Bacilli | Bacillales | Bacillaceae | 1 | 3492 | Bacillus subtilis str. IAM 12118T | <0.01 | <0.05 | 1320 |
| Firmicutes | Bacilli | Bacillales | Staphylococcaceae | 1 | 3494 | Micrococcus luteus B-P 26 | ≦0.01 | <0.05 | 1334 |
| Firmicutes | Bacilli | Lactobacillales | Leuconostocaceae | 1 | 3497 | Weissella koreensis S-5673 | <0.02 | <0.05 | 1457 |
| Firmicutes | Bacilli | Lactobacillales | Streptococcaceae | 1 | 3499 | Streptococcus constellatus str. | <0.01 | <0.05 | 4476 |
| | | | | | | ATCC27823 | | | |
| Firmicutes | Bacilli | Lactobacillales | Aerococcaceae | 1 | 3504 | Marinilactibacillus psychrotolerans | <0.01 | <0.05 | 1505 |
| | | | | | | str. O21 | | | |
| Firmicutes | Bacilli | Bacillales | Bacillaceae | 1 | 3517 | Planococcus maritimus str. TF-9 | <0.01 | <0.05 | 1358 |
| Firmicutes | Bacilli | Lactobacillales | Lactobacillaceae | 1 | 3521 | Pediococcus inopinatus str. DSM | <0.001 | <0.05 | 1122 |
| | | | | | | 20285 | | | |
| Firmicutes | Bacilli | Lactobacillales | Lactobacillaceae | 1 | 3526 | Lactobacillus sakei | <0.02 | <0.05 | 1609 |
| Firmicutes | Bacilli | Bacillales | Staphylococcaceae | 1 | 3545 | | <0.01 | <0.05 | 1372 |
| Firmicutes | Bacilli | Lactobacillales | Lactobacillaceae | 1 | 3547 | Lactobacillus frumenti str. TMW | <0.01 | <0.05 | 1491 |
| | | | | | | 1.666 | | | |
| Firmicutes | Bacilli | Bacillales | Bacillaceae | 1 | 3550 | Bacillus megaterium str. QM B1551 | ≦0.001 | <0.05 | 1620 |
| Firmicutes | Bacilli | Lactobacillales | Aerococcaceae | 1 | 3553 | Desemzia incerta str. DSM 20581 | <0.001 | <0.01 | 1553 |
| Firmicutes | Bacilli | Lactobacillales | Streptococcaceae | 1 | 3560 | Streptococcus gallinaceus str. | <0.001 | <0.01 | 2835 |
| | | | | | | CCUG 42692 | | | |
| Firmicutes | Bacilli | Lactobacillales | Lactobacillaceae | 1 | 3566 | Lactobacillus pontis str. LTH 2587 | <0.01 | <0.05 | 2320 |
| Firmicutes | Bacilli | Bacillales | Staphylococcaceae | 1 | 3569 | Staphylococcus saprophyticus | <0.01 | <0.05 | 1391 |
| Firmicutes | Bacilli | Lactobacillales | Streptococcaceae | 1 | 3588 | Streptococcus downei str. ATCC | <0.01 | <0.05 | 2440 |
| | | | | | | 33748 | | | |
| Firmicutes | Bacilli | Bacillales | Bacillaceae | 1 | 3589 | Bacillus senegalensis str. RS8; CIP | ≦0.02 | <0.05 | 1198 |
| | | | | | | 106 669 | | | |
| Firmicutes | Bacilli | Bacillales | Staphylococcaceae | 1 | 3592 | Staphylococcus caprae str. DSM | ≦0.01 | <0.05 | 1322 |
| | | | | | | 20608 | | | |
| Firmicutes | Bacilli | Bacillales | Staphylococcaceae | 1 | 3605 | | <0.01 | <0.05 | 1472 |
| Firmicutes | Bacilli | Bacillales | Bacillaceae | 1 | 3612 | Bacillus schlegelii str. ATCC | <0.01 | <0.05 | 1224 |
| | | | | | | 43741T | | | |
| Firmicutes | Bacilli | Bacillales | Staphylococcaceae | 1 | 3628 | Staphylococcus haemolyticus str. | <0.01 | <0.05 | 1572 |
| | | | | | | CCM2737 | | | |
| Firmicutes | Bacilli | Lactobacillales | Streptococcaceae | 1 | 3629 | Streptococcus mutans str. UA96 | <0.01 | <0.05 | 1466 |
| Firmicutes | Bacilli | Bacillales | Halobacillaceae | 1 | 3633 | Bacillus clausii str. GMBAE 42 | <0.001 | <0.01 | 2363 |
| Firmicutes | Bacilli | Lactobacillales | Lactobacillaceae | 1 | 3634 | Lactobacillus letivazi str. JCL3994 | <0.01 | <0.05 | 1586 |
| Firmicutes | Bacilli | Bacillales | Staphylococcaceae | 1 | 3638 | Staphylococcus sp str. AG-30 | <0.01 | <0.05 | 1359 |
| Firmicutes | Bacilli | Bacillales | Paenibacillaceae | 1 | 3641 | Brevibacillus sp. MN 47.2a | <0.02 | <0.05 | 1735 |
| Firmicutes | Bacilli | Bacillales | Staphylococcaceae | 1 | 3654 | Staphylococcus pettenkoferi str. | <0.01 | <0.05 | 1310 |
| | | | | | | B3117 | | | |
| Firmicutes | Bacilli | Bacillales | Bacillaceae | 1 | 3661 | Bacillus sp. str. 2216.25.2 | <0.01 | <0.05 | 1593 |
| Firmicutes | Bacilli | Bacillales | Bacillaceae | 1 | 3675 | Bacillus mojavensis str. M-1 | <0.01 | <0.05 | 1535 |
| Firmicutes | Bacilli | Bacillales | Staphylococcaceae | 1 | 3684 | Staphylococcus sciuri | <0.02 | <0.05 | 1324 |
| Firmicutes | Bacilli | Bacillales | Halobacillaceae | 1 | 3702 | Amphibacillus xylanus str. DSM | ≦0.01 | <0.05 | 1523 |
| | | | | | | 6626 | | | |
| Firmicutes | Bacilli | Lactobacillales | Lactobacillaceae | 1 | 3703 | Lactobacillus salivarius str. RA2115 | <0.01 | <0.05 | 1636 |
| Firmicutes | Bacilli | Bacillales | Bacillaceae | 1 | 3706 | Bacillus sonorensis str. NRRL B- | <0.02 | <0.05 | 1324 |
| | | | | | | 23155 | | | |
| Firmicutes | Bacilli | Lactobacillales | Streptococcaceae | 1 | 3722 | Lactococcus Il1403 subsp. lactis | ≦0.001 | <0.05 | 2673 |
| | | | | | | str. IL1403 | | | |
| Firmicutes | Bacilli | Bacillales | Sporolactobacillaceae | 1 | 3747 | Bacillus sp. str. C-59-2 | <0.001 | <0.01 | 1959 |
| Firmicutes | Bacilli | Lactobacillales | Streptococcaceae | 1 | 3753 | Streptococcus suis str. 8074 | <0.02 | <0.05 | 3463 |
| Firmicutes | Bacilli | Lactobacillales | Lactobacillaceae | 1 | 3767 | Lactobacillus suebicus str. CECT | <0.01 | <0.05 | 2031 |
| | | | | | | 5917T | | | |
| Firmicutes | Bacilli | Lactobacillales | Lactobacillaceae | 1 | 3768 | Lactobacillus perolens str. L532 | <0.001 | <0.001 | 1593 |
| Firmicutes | Bacilli | Bacillales | Staphylococcaceae | 1 | 3794 | | <0.01 | <0.05 | 1324 |
| Firmicutes | Bacilli | Bacillales | Staphylococcaceae | 1 | 3822 | Staphylococcus succinus str. SB72 | <0.01 | <0.05 | 1358 |
| Firmicutes | Bacilli | Bacillales | Bacillaceae | 1 | 3827 | Bacillus acidogenesis str. 105-2 | <0.01 | <0.05 | 1996 |
| Firmicutes | Bacilli | Bacillales | Bacillaceae | 1 | 3831 | Bacillus licheniformis str. KL-068 | <0.01 | <0.05 | 2057 |
| Firmicutes | Bacilli | Lactobacillales | Aerococcaceae | 1 | 3833 | Carnobacterium alterfunditum | <0.001 | <0.01 | 2781 |
| Firmicutes | Bacilli | Lactobacillales | Aerococcaceae | 1 | 3840 | Trichococcus pasteurii str. KoTa2 | <0.001 | <0.01 | 2656 |
| Firmicutes | Bacilli | Lactobacillales | Streptococcaceae | 1 | 3869 | Streptococcus equi subsp. | ≦0.01 | <0.05 | 1766 |
| | | | | | | zooepidemicus str. Tokyo1291 | | | |
| | | | | | | subsp. | | | |
| Firmicutes | Bacilli | Bacillales | Bacillaceae | 1 | 3900 | Bacillus licheniformis str. DSM 13 | <0.01 | <0.05 | 1261 |
| Firmicutes | Bacilli | Lactobacillales | Streptococcaceae | 1 | 3906 | Streptococcus bovis str.ATCC | <0.001 | <0.01 | 4284 |
| | | | | | | 43143 | | | |
| Firmicutes | Bacilli | Bacillales | Bacillaceae | 1 | 3909 | Bacillus subtilis subsp. Marburg | <0.01 | <0.05 | 1367 |
| | | | | | | str. 168 | | | |
| Firmicutes | Bacilli | Bacillales | Bacillaceae | 1 | 3918 | Bacillus subtilis | <0.001 | <0.01 | 1486 |
| Firmicutes | Mollicutes | Anaeroplasmatales | Erysipelotrichaceae | 3 | 3965 | TCE-contaminated site clone | ≦0.01 | <0.05 | 1844 |
| | | | | | | ccslm238 | | | |
| Firmicutes | Mollicutes | Anaeroplasmatales | Erysipelotrichaceae | 3 | 3981 | phototrophic sludge clone PSB- | <0.01 | <0.05 | 1361 |
| | | | | | | M-3 | | | |
| Firmicutes | Clostridia | Clostridiales | Clostridiaceae | 12 | 4180 | termite gut homogenate clone Rs- | <0.01 | <0.05 | 1383 |
| | | | | | | M23 bacterium | | | |
| Firmicutes | Clostridia | Unclassified | Unclassified | 7 | 4216 | | <0.001 | <0.01 | 2447 |
| Firmicutes | Clostridia | Clostridiales | Clostridiaceae | 12 | 4266 | termite gut homogenate clone Rs- | <0.01 | <0.05 | 1302 |
| | | | | | | M86 bacterium | | | |
| Firmicutes | Clostridia | Clostridiales | Lachnospiraceae | 5 | 4281 | granular sludge clone | ≦0.001 | <0.05 | 1333 |
| | | | | | | UASB_brew_B86 | | | |
| Firmicutes | gut clone group | Unclassified | Unclassified | 1 | 4298 | human mouth clone P4PA_66 | <0.01 | <0.05 | 1991 |
| Firmicutes | Clostridia | Clostridiales | Clostridiaceae | 12 | 4306 | UASB reactor granular sludge | <0.01 | <0.05 | 1483 |
| | | | | | | clone PD-UASB-4 bacterium | | | |
| Firmicutes | Clostridia | Clostridiales | Clostridiaceae | 12 | 4321 | termite gut homogenate clone Rs- | ≦0.01 | <0.05 | 1362 |
| | | | | | | C76 bacterium | | | |
| Firmicutes | Clostridia | Clostridiales | Lachnospiraceae | 5 | 4331 | granular sludge clone | <0.01 | <0.05 | 1091 |
| | | | | | | UASB_brew_B84 | | | |
| Firmicutes | Clostridia | Clostridiales | Clostridiaceae | 12 | 4339 | Clostridium chauvoei str. ATCC | <0.02 | <0.05 | 1542 |
| | | | | | | 10092T | | | |
| Firmicutes | Clostridia | Clostridiales | Clostridiaceae | 12 | 4369 | termite gut homogenate clone Rs- | <0.01 | <0.05 | 1579 |
| | | | | | | N73 bacterium | | | |
| Natronoanaerobium | Unclassified | Unclassified | Unclassified | 1 | 4377 | Mono Lake at depth 35 m station | <0.01 | <0.05 | 1585 |
| | | | | | | 6 Jul. 2000 clone ML635J-65 | | | |
| | | | | | | G + C | | | |
| Firmicutes | Clostridia | Clostridiales | Clostridiaceae | 12 | 4418 | termite gut homogenate clone Rs- | <0.02 | <0.05 | 1173 |
| | | | | | | H18 bacterium | | | |
| Firmicutes | Clostridia | Clostridiales | Lachnospiraceae | 5 | 4434 | termite gut homogenate clone Rs- | <0.01 | <0.05 | 1298 |
| | | | | | | K11 bacterium | | | |
| Firmicutes | Clostridia | Clostridiales | Clostridiaceae | 12 | 4475 | termite gut homogenate clone Rs- | <0.001 | <0.01 | 1853 |
| | | | | | | N02 bacterium | | | |
| Firmicutes | Clostridia | Clostridiales | Clostridiaceae | 12 | 4477 | termite gut homogenate clone Rs- | 0.01 | <0.05 | 1505 |
| | | | | | | N85 bacterium | | | |
| Firmicutes | Clostridia | Clostridiales | Clostridiaceae | 12 | 4507 | termite gut homogenate clone Rs- | ≦0.01 | <0.05 | 1169 |
| | | | | | | N21 bacterium | | | |
| Firmicutes | Clostridia | Clostridiales | Lachnospiraceae | 5 | 4510 | termite gut homogenate clone Rs- | <0.02 | <0.05 | 1896 |
| | | | | | | Q53 bacterium | | | |
| Firmicutes | Clostridia | Clostridiales | Lachnospiraceae | 5 | 4512 | granular sludge clone | <0.01 | <0.05 | 1006 |
| | | | | | | UASB_brew_B25 | | | |
| Firmicutes | Clostridia | Clostridiales | Lachnospiraceae | 5 | 4514 | termite gut homogenate clone Rs- | ≦0.001 | <0.05 | 1800 |
| | | | | | | B34 bacterium | | | |
| Firmicutes | Clostridia | Clostridiales | Clostridiaceae | 12 | 4524 | termite gut clone Rs-093 | <0.02 | <0.05 | 1269 |
| Firmicutes | Clostridia | Clostridiales | Lachnospiraceae | 5 | 4533 | termite gut homogenate clone Rs- | <0.01 | <0.05 | 1671 |
| | | | | | | N06 bacterium | | | |
| Firmicutes | Unclassified | Unclassified | Unclassified | 8 | 4536 | Mono Lake at depth 35 m station | <0.01 | <0.05 | 1005 |
| | | | | | | 6 Jul. 2000 clone ML635J-14 | | | |
| | | | | | | G + C | | | |
| Firmicutes | Clostridia | Clostridiales | Lachnospiraceae | 5 | 4540 | termite gut homogenate clone Rs- | <0.01 | <0.05 | 1962 |
| | | | | | | M18 bacterium | | | |
| Firmicutes | Clostridia | Clostridiales | Clostridiaceae | 12 | 4598 | Clostridium sardiniense str. DSM | <0.02 | <0.05 | 1253 |
| | | | | | | 600 | | | |
| Firmicutes | Clostridia | Clostridiales | Clostridiaceae | 12 | 4607 | Clostridium novyi str. NCTC538 | <0.01 | <0.05 | 1082 |
| Firmicutes | Clostridia | Clostridiales | Lachnospiraceae | 5 | 4613 | rumen clone 3C0d-3 | <0.02 | <0.05 | 1321 |
| Firmicutes | gut clone group | Unclassified | Unclassified | 1 | 4616 | rumen clone F23-C12 | <0.01 | <0.05 | 2628 |
| Firmicutes | Clostridia | Clostridiales | Clostridiaceae | 12 | 4622 | termite gut clone Rs-L36 | ≦0.01 | <0.05 | 1112 |
| Firmicutes | Clostridia | Clostridiales | Clostridiaceae | 12 | 4638 | | <0.01 | <0.05 | 2515 |
| Cyanobacteria | Unclassified | Unclassified | Unclassified | 9 | 5038 | Rumen isolate str. YS2 | <0.001 | <0.01 | 1724 |
| Bacteroidetes | Bacteroidetes | Unclassified | Unclassified | 15 | 5481 | marine sediment above hydrate | <0.02 | <0.05 | 2056 |
| | | | | | | ridge clone Hyd89-72 | | | |
| | | | | | | bacterium | | | |
| Bacteroidetes | Sphingobacteria | Sphingobacteriales | Flexibacteraceae | 19 | 5542 | Cytophaga sp. I-1787 | <0.01 | <0.05 | 2304 |
| Bacteroidetes | Bacteroidetes | Bacteroidales | Unclassified | 15 | 5783 | Mono Lake at depth 35 m station | <0.01 | <0.05 | 1032 |
| | | | | | | 6 Jul. 2000 clone ML635J-15 | | | |
| | | | | | | bacterium | | | |
| Bacteroidetes | Bacteroidetes | Bacteroidales | Unclassified | 15 | 5874 | Paralvinella palmiformis mucus | <0.02 | <0.05 | 1805 |
| | | | | | | secretions clone P. palm 53 | | | |
| | | | | | | bacterium | | | |
| Bacteroidetes | Sphingobacteria | Sphingobacteriales | Flexibacteraceae | 19 | 6124 | Flexibacter flexilis subsp. | <0.001 | <0.01 | 1387 |
| | | | | | | pelliculosus str. IFO 16028 | | | |
| | | | | | | subsp. | | | |
| Spirochaetes | Spirochaetes | Spirochaetales | Spirochaetaceae | 1 | 6459 | Spirochaeta sp. str. BHI80-158 | <0.001 | ≦0.01 | 2558 |
| Proteobacteria | Deltaproteobacteria | Desulfobacterales | Unclassified | 3 | 9813 | hydrothermal sediment clone | <0.01 | <0.05 | 1453 |
| | | | | | | AF420340 | | | |
| Proteobacteria | Deltaproteobacteria | Desulfobacterales | Desulfobacteraceae | 5 | 9875 | hydrothermal sediment clone | <0.01 | <0.05 | 1147 |
| | | | | | | AF420354 | | | |
| Proteobacteria | Deltaproteobacteria | Desulfuromonadales | Geobacteraceae | 1 | 10171 | | <0.01 | <0.05 | 1375 |
| Proteobacteria | Deltaproteobacteria | Desulfobacterales | Desulfoarculaceae | 2 | 10227 | marine sediment clone Bol11 | <0.01 | <0.05 | 1549 |
| Proteobacteria | Deltaproteobacteria | Desulfobacterales | Desulfobacteraceae | 5 | 10319 | sulfate-reducing habitat clone SLM-CP-116 | <0.01 | <0.05 | 1235 |

^{a}S-F, Subfamily identification;
^{b}Taxon ID, PhyloChip Taxon identification number;
^{c}Representative species, Taxon bacterial species identifier.

TABLE 5
CORE COMMUNITY OF BACTERIAL TAXA DETECTED IN ALL COPD PATIENTS DURING TREATMENT FOR SEVERE EXACERBATIONS (REPRESENTATIVE SPECIES
WTTH A PROVEN ROLE IN MAMMALIAN PATHOGENESIS ARE HIGHLIGHTED)

| Phylum | Class | Order | Family | S-F^{a} | Taxon ID^{b} | Representative species^{c} |
|---|---|---|---|---|---|---|
| Actinobacteria | Actinobacteria | Acidimicrobiales | Acidimicrobiaceae | sf_1 | 1749 | forest soil clone DUNssu275 (-3A) (OTU#188) |
| Acidobacteria | Acidobacteria | Acidobacteriales | Acidobacteriaceae | sf_6 | 6362 | grassland soil clone DA052 |
| Proteobacteria | Gammaproteobacteria | Alteromonadales | Alteromonadaceae | sf_1 | 8578 | Marinobacter lipolyticus str. SM-19 |
| Proteobacteria | Gammaproteobacteria | Alteromonadales | Alteromonadaceae | sf_1 | 9239 | Arctic sea ice ARK10228 |
| Proteobacteria | Gammaproteobacteria | Alteromonadales | Alteromonadaceae | sf_1 | 8222 | |
| Proteobacteria | Gammaproteobacteria | Alteromonadales | Alteromonadaceae | sf_1 | 8753 | Idiomarina loihiensis str. GSP37 |
| Proteobacteria | Gammaproteobacteria | Alteromonadales | Alteromonadaceae | sf_1 | 9324 | Pseudoalteromonas ruthenica str. KMM300 |
| Proteobacteria | Gammaproteobacteria | Alteromonadales | Alteromonadaceae | sf_1 | 8579 | Psychromonas profunda str. 2825 |
| Proteobacteria | Alphaproteobacteria | Rickettsiales | Anaplasmataceae | sf_3 | 6648 | Wolbachia sp |
| Proteobacteria | Betaproteobacteria | Burkholderiales | Burkholderiaceae | sf_1 | 7747 | |
| Proteobacteria | Epsilonproteobacteria | Campylobacterales | Campylobacteraceae | sf_3 | 10538 | Arcobacter cryaerophilus |
| Proteobacteria | Epsilonproteobacteria | Campylobacterales | Campylobacteraceae | sf_3 | 10447 | Sulfurospirillum deleyianum str. Spirillum 5175 |
| Proteobacteria | Epsilonproteobacteria | Campylobacterales | Campylobacteraceae | sf_3 | 10456 | Campylobacter showae |
| Proteobacteria | Alphaproteobacteria | Caulobacterales | Caulobacteraceae | sf_1 | 6909 | Brevundimonas diminuta str. DSM 1635 |
| Proteobacteria | Alphaproteobacteria | Caulobacterales | Caulobacteraceae | sf_1 | 7436 | Brevundimonas sp. str. FWC40 |
| Cyanobacteria | Cyanobacteria | Chloroplasts | Chloroplasts | sf_5 | 5147 | Emiliania huxleyi str. Plymouth Marine Laborator PML 92 |
| Proteobacteria | Gammaproteobacteria | Legionellales | Coxiellaceae | sf_3 | 9198 | uranium mining waste pile clone KF-JG30-B15 KF-JG30-B15 |
| Bacteroidetes | Sphingobacteria | Sphingobacteriales | Crenotrichaceae | sf_11 | 6267 | Cilia-respiratory isolate str. 243-54 |
| Proteobacteria | Deltaproteobacteria | Desulfovibrionales | Desulfomicrobiaceae | sf_1 | 10079 | Desulfomicrobium baculatum str. DSM 1742 |
| Proteobacteria | Gammaproteobacteria | Enterobacteriales | Enterobacteriaceae | sf_1 | 8504 | Dysmicoccus neobrevipes symbiont |
| Proteobacteria | Epsilonproteobacteria | Campylobacterales | Helicobacteraceae | sf_3 | 10385 | |
| Proteobacteria | Epsilonproteobacteria | Campylobacterales | Helicobacteraceae | sf_3 | 10442 | Helicobacter cetorum str. MIT 99-5656 |
| Proteobacteria | Epsilonproteobacteria | Campylobacterales | Helicobacteraceae | sf_3 | 10444 | Helicobacter suncus str. Kaz-2 |
| Proteobacteria | Epsilonproteobacteria | Campylobacterales | Helicobacteraceae | sf_3 | 10448 | Helicobacter felis str. Dog-1 |
| Proteobacteria | Epsilonproteobacteria | Campylobacterales | Helicobacteraceae | sf_3 | 10451 | Helicobacter heilmannii str. C4S |
| Spirochaetes | Spirochaetes | Spirochaetales | Leptospiraceae | sf_3 | 6496 | Leptospira interrogans serovar Copenhageni str. Fiocruz L1-130 |
| Proteobacteria | Gammaproteobacteria | Pseudomonadales | Moraxellaceae | sf_3 | 8366 | Psychrobacter frigidicola str. DSM 12411 |
| Proteobacteria | Gammaproteobacteria | Pseudomonadales | Moraxellaceae | sf_3 | 8838 | Psychrobacter psychrophilus CMS 28 |
| Proteobacteria | Gammaproteobacteria | Pseudomonadales | Moraxellaceae | sf_3 | 8727 | Alkanindiges hongkongensis str. HKU9 |
| Proteobacteria | Betaproteobacteria | Nitrosomonadales | Nitrosomonadaceae | sf_1 | 7789 | |
| Firmicutes | Clostridia | Clostridiales | Peptococc/Acidaminococc | sf_11 | 992 | anoxic bulk soil flooded rice microcosm clone BSV43 clone |
| Planctomycetes | Planctomycetacia | Planctomycetales | Pirellulae | sf_3 | 4670 | |
| Proteobacteria | Gammaproteobacteria | Thiotrichales | Piscirickettsiaceae | sf_3 | 9291 | Methylophaga alcalica str. M39 |
| Proteobacteria | Gammaproteobacteria | Pseudomonadales | Pseudomonadaceae | sf_1 | 8691 | Pseudomonas aeruginosa str. PAO1 |
| Proteobacteria | Gammaproteobacteria | Pseudomonadales | Pseudomonadaceae | sf_1 | 9056 | Pseudomonas aeruginosa str. #47 |
| Proteobacteria | Gammaproteobacteria | Pseudomonadales | Pseudomonadaceae | sf_1 | 9068 | Pseudomonas stutzeri str. A1501 |
| Proteobacteria | Gammaproteobacteria | Pseudomonadales | Pseudomonadaceae | sf_1 | 9295 | |
| Proteobacteria | Gammaproteobacteria | Pseudomonadales | Pseudomonadaceae | sf_1 | 9613 | Pseudomonas flavescens str. B62 |
| Proteobacteria | Gammaproteobacteria | Pseudomonadales | Pseudomonadaceae | sf_1 | 9049 | uranium mining mill tailing clone GR-Sh2-34 GR-Sh2-34 |
| Proteobacteria | Gammaproteobacteria | Pseudomonadales | Pseudomonadaceae | sf_1 | 9469 | cf. Pseudomonas sp. clone Llangefni 52 |
| Proteobacteria | Gammaproteobacteria | Pseudomonadales | Pseudomonadaceae | sf_1 | 9240 | Pseudomonas fluorescens str. CHA0 |
| Proteobacteria | Gammaproteobacteria | Pseudomonadales | Pseudomonadaceae | sf_1 | 9366 | Arctic seawater isolate str. R7366 |
| Proteobacteria | Gammaproteobacteria | Pseudomonadales | Pseudomonadaceae | sf_1 | 8755 | Pseudomonas sp. SK-1-3-1 |
| Bacteroidetes | Sphingobacteria | Sphingobacteriales | Sphingobacteriaceae | sf_1 | 5913 | Sphingobacteriaceae str. Ellin160 |
| Proteobacteria | Alphaproteobacteria | Sphingomonadales | Sphingomonadaceae | sf_1 | 6663 | Sphingopyxis flavimaris str. SW-151 |
| Firmicutes | Bacilli | Bacillales | Thermoactinomycetaceae | sf_1 | 3301 | Thermoactinomyces sp. str. 700375 |
| Thermodesulfobacteria | Thermodesulfobacteria | Thermodesulfobacteriales | Thermodesulfobacteriaceae | sf_1 | 667 | Fjonesia |
| Proteobacteria | Gammaproteobacteria | Thiotrichales | Thiotrichaceae | sf_3 | 8752 | Beggiatoa sp. str. MS-81-1c |
| Chloroflexi | Unclassified | Unclassified | Unclassified | sf_2 | 818 | |
| Verrucomicrobia | Unclassified | Unclassified | Unclassified | sf_4 | 288 | Prosthecobacter dejongeii |
| Synergistes | Unclassified | Unclassified | Unclassified | sf_3 | 117 | termite gut homogenate clone Rs-D89 |
| Synergistes | Unclassified | Unclassified | Unclassified | sf_3 | 719 | Synergistes sp. P1 str. P4G_18 |
| OP3 | Unclassified | Unclassified | Unclassified | sf_4 | 628 | CB-contaminated groundwater clone GOUTB15 |
| Unclassified | Unclassified | Unclassified | Unclassified | sf_160 | 485 | thermal spring mat clone O1aA90 |
| Unclassified | Unclassified | Unclassified | Unclassified | sf_160 | 226 | |
| Bacteroidetes | KSA1 | Unclassified | Unclassified | sf_1 | 5951 | CFB group clone ML615J-4 |
| Chloroflexi | Anaerolineae | Unclassified | Unclassified | sf_9 | 727 | forest soil clone S0208 |
| Cyanobacteria | Unclassified | Unclassified | Unclassified | sf_8 | 5206 | |
| marine group A | mgA-2 | Unclassified | Unclassified | sf_1 | 6344 | bacterioplankton clone ZA3648c |
| Unclassified | Unclassified | Unclassified | Unclassified | sf_160 | 6430 | |
| Proteobacteria | Alphaproteobacteria | Unclassified | Unclassified | sf_6 | 7575 | |
| TM7 | TM7-3 | Unclassified | Unclassified | sf_1 | 8155 | oral periodontitis clone EW086 |
| Proteobacteria | Gammaproteobacteria | uranium waste clones | Unclassified | sf_1 | 8747 | uranium waste soil clone JG30-KF-CM35 |
| Proteobacteria | Gammaproteobacteria | Unclassified | Unclassified | sf_3 | 9568 | forested wetland clone RCP2-96 |
| Proteobacteria | Gammaproteobacteria | SUP05 | Unclassified | sf_1 | 8605 | bacterioplankton clone ZA2525c |
| Proteobacteria | Gammaproteobacteria | Unclassified | Unclassified | sf_3 | 8339 | water 5 m downstream manure clone 35ds5 |
| Proteobacteria | Gammaproteobacteria | Unclassified | Unclassified | sf_4 | 8855 | |
| Proteobacteria | Epsilonproteobacteria | Campylobacterales | Unclassified | sf_1 | 10480 | Paralvinella palmiformis mucus secretions cloneP. palm C 84 proteobacterium |
| Proteobacteria | Epsilonproteobacteria | Campylobacterales | Unclassified | sf_1 | 10530 | hydrothermal vent 9 degrees North East Rise PacificOcean clone |
| | | | | | | CH5_6_BAC_16SrRNA_9N_EPR |
| Actinobacteria | Actinobacteria | Actinomycetales | Unclassified | sf_3 | 1687 | Jonesia quinghaiensis str. DSM 15701 |
| Actinobacteria | Actinobacteria | Actinomycetales | Unclassified | sf_3 | 1405 | Arthrobacter ureafaciens str. DSM 20126 |
| Firmicutes | Clostridia | Unclassified | Unclassified | sf_3 | 2373 | |
| Firmicutes | Catabacter | Unclassified | Unclassified | sf_1 | 4293 | termite gut homogenate clone Rs-Q01 bacterium |
| Proteobacteria | Gammaproteobacteria | Xanthomonadales | Xanthomonadaceae | sf_3 | 8689 | Dyemonas todaii str. XD10 |
| Verrucomicrobia | Verrucomicrobiae | Verrucomicrobiales | Xiphinematobacteraceae | sf_3 | 888 | Candidatus Xiphinematobacter brevicolli |

^{a}S-F, Subfamily identification;
^{b}Taxon ID, PhyloChip Taxon identification number;
^{c}Representative species, Taxon bacterial species identifier.

1. A method for determining a pulmonary condition of a subject comprising:
(a) obtaining nucleic acid material from a sample from said subject;
(b) contacting the nucleic acid material with a plurality of different probes, wherein at least one of the probes is complementary to a section within one or more polynucleotides highly conserved in bacteria;
(c) determining hybridization signal strength for each of said probes, wherein said determination establishes a biosignature for said sample; and
(d) determining a pulmonary condition of said subject based on the results of step (c).

2. A method of classification, diagnosis, prognosis, and/or prediction of an outcome of a pulmonary condition in a subject, said method comprising:
(a) isolating nucleic acid material from a sample from said subject;
(b) contacting the nucleic acid material with a plurality of negative control probes and a plurality of interrogation probes, wherein the negative control probes do not specifically hybridize to one or more highly conserved polynucleotides in one or more target operational taxon units (OTUs), and wherein each of the interrogation probes is complementary to a section within said one or more highly conserved polynucleotides;
(c) determining hybridization signal strength distributions of the negative control probes;
(d) determining hybridization signal strengths for the interrogation probes;
(e) using the hybridization signal strengths of the negative and the hybridization signal strengths of the positive probes to determine the probability that the hybridization signal for the different interrogation probes represents the presence, relative abundance, and/or quantity of said one or more OTUs; and
(f) classifying, diagnosing, prognosing, and/or predicting an outcome of said pulmonary condition based on the results of step (d).

3. A method for assessing a pulmonary condition of a subject comprising
detecting in a sample from said subject the presence, relative abundance, and/or quantity of one or more operational taxon units (OTUs) in a single assay, wherein said one or more OTUs are selected from the OTUs listed in one or more of Table 3, Table 4, and Table 5; and
determining the pulmonary condition of said subject based on said detection.

4. The method of claim 1, wherein step (b) further comprises comparing the biosignature of said sample to a biosignature for one or more pulmonary conditions.

5. The method of claim 1, wherein said sample is a pulmonary sample.

6. The method of claim 5, wherein the pulmonary sample is sputum, endotracheal aspirate, a bronchoalveolar lavage sample, or a swab of the endotrachea.

7. The method of claim 1, further comprising making a healthcare decision based on the results of step (c).

8. The method of claim 2, further comprising making a healthcare decision based on the results of step (e).

9. The method of claim 3, further comprising making a healthcare decision based on the determination of the pulmonary condition of said subject.

10. The method of claim 1, wherein said biosignature comprises the presence, relative abundance, and/or quantity of one or more OTUs selected from the OTUs listed in one or more of Table 3, Table 4, and Table 5.

11. The method of claim 1, wherein said pulmonary condition is selected from the group consisting of: healthy, exacerbated COPD, non-exacerbated COPD, and intermediate COPD exacerbation, wherein the intermediate COPD exacerbation comprises a prediction of the onset of exacerbation of COPD in said subject.

12. The method of claim 2, wherein said presence, relative abundance, and/or quantity is detected with a confidence level greater than 95%.

13. The method of claim 1, wherein said probes are used to detect the presence, absence, relative abundance, and/or quantity of at least 10,000 different OTUs in a single assay.

14. The method of claim 2, wherein one or more of said highly conserved polynucleotides are 16S rRNA gene, 23S rRNA gene, 5S rRNA gene, 5.8S rRNA gene, 12S rRNA gene, 18S rRNA gene, 28S rRNA gene, gyrB gene, rpoB gene, fusA gene, recA gene, cox1 gene, nif13 gene, RNA molecules derived therefrom, or a combination thereof.

15. The method of claim 1, wherein said probes are attached to a substrate.

16. The method of claim 15, wherein said substrate comprises glass, plastic, silicon, a bead, or a microsphere.

17. (canceled)

18. A system comprising a plurality of probes capable of determining the presence, relative abundance, and/or quantity of a plurality of operational taxon units (OTUs), wherein said plurality of probes comprise:
(a) negative control probes that do not specifically hybridize to one or more highly conserved polynucleotides in a plurality of target OTUs; and
(b) a plurality of different interrogation probes, each of which is complementary to a section within said one or more highly conserved polynucleotides in one or more of said plurality of target OTUs,
wherein said plurality of target OTUs consists of OTUs in one or more of Table 3, Table 4, and Table 5.

19. The system of claim 18, wherein one or more of said highly conserved polynucleotides are 16S rRNA gene, 23S rRNA gene, 5S rRNA gene, 5.8S rRNA gene, 12S rRNA gene, 18S rRNA gene, 28S rRNA gene, gyrB gene, rpoB gene, fusA gene, recA gene, cox1 gene, nif13 gene, RNA molecules derived therefrom, or a combination thereof.

20. The system of claim 18, wherein said probes are attached to a substrate.

21. The system of claim 20, wherein said substrate comprises glass, plastic, silicon, a bead, or a microsphere.

22. (canceled)

23. The system of claim 18, further comprising a plurality of positive control probes.

24. The system of claim 23, wherein said positive control probes comprise sequences selected from SEQ ID NOs: 51-100, or the complements thereof.

25. The system of claim 18, wherein said interrogation probes comprise a plurality of probes that selectively hybridize to the same highly conserved region in each of said OTUs.


SEQUENCE LISTING (100 sequences)

SEQ ID NO: 1 - DNA, 25 bp, Artificial Sequence
  Description of Artificial Sequence Synthetic oligonucleotide Pair ID 265003; MM probe is SEQ ID NO2
aatggaatttgatagaacctctgga

SEQ ID NO: 2 - DNA, 25 bp, Artificial Sequence
  Description of Artificial Sequence Synthetic oligonucleotide Pair ID 265003; PM probe is SEQ ID NO1
aatggaatttgaaagaacctctgga

SEQ ID NO: 3 - DNA, 25 bp, Artificial Sequence
  Description of Artificial Sequence Synthetic oligonucleotide Pair ID 231625; MM probe is SEQ ID NO4
cagtaaggcatgagtaacttaccgt

SEQ ID NO: 4 - DNA, 25 bp, Artificial Sequence
  Description of Artificial Sequence Synthetic oligonucleotide Pair ID 231625; PM probe is SEQ ID NO3
cagtaaggcatgggtaacttaccgt

SEQ ID NO: 5 - DNA, 25 bp, Artificial Sequence
  Description of Artificial Sequence Synthetic oligonucleotide Pair ID 186992; MM probe is SEQ ID NO6
aaacgatgaccactagacgttgggg

SEQ ID NO: 6 - DNA, 25 bp, Artificial Sequence
  Description of Artificial Sequence Synthetic oligonucleotide Pair ID 186992; PM probe is SEQ ID NO5
aaacgatgaccattagacgttgggg

SEQ ID NO: 7 - DNA, 25 bp, Artificial Sequence
  Description of Artificial Sequence Synthetic oligonucleotide Pair ID 327194; MM probe is SEQ ID NO8
ataaagttacttgcctgcatttggt

SEQ ID NO: 8 - DNA, 25 bp, Artificial Sequence
  Description of Artificial Sequence Synthetic oligonucleotide Pair ID 327194; PM probe is SEQ ID NO7
ataaagttacttccctgcatttggt

SEQ ID NO: 9 - DNA, 25 bp, Artificial Sequence
  Description of Artificial Sequence Synthetic oligonucleotide Pair ID 151981; MM probe is SEQ ID NO10
ccgtagcgtacgtgatctacgatta

SEQ ID NO: 10 - DNA, 25 bp, Artificial Sequence
  Description of Artificial Sequence Synthetic oligonucleotide Pair ID 151981; PM probe is SEQ ID NO9
ccgtagcgtacgggatctacgatta

SEQ ID NO: 11 - DNA, 25 bp, Artificial Sequence
  Description of Artificial Sequence Synthetic oligonucleotide Pair ID 191212; MM probe is SEQ ID NO12
taaaatttcgatggatacggattgg

SEQ ID NO: 12 - DNA, 25 bp, Artificial Sequence
  Description of Artificial Sequence Synthetic oligonucleotide Pair ID 191212; PM probe is SEQ ID NO11
taaaatttcgatcgatacggattgg

SEQ ID NO: 13 - DNA, 25 bp, Artificial Sequence
  Description of Artificial Sequence Synthetic oligonucleotide Pair ID 276480; MM probe is SEQ ID NO14
caggcacgaaaacgtggggatccaa

SEQ ID NO: 14 - DNA, 25 bp, Artificial Sequence
  Description of Artificial Sequence Synthetic oligonucleotide Pair ID 276480; PM probe is SEQ ID NO13
caggcacgaaaaggtggggatccaa

SEQ ID NO: 15 - DNA, 25 bp, Artificial Sequence
  Description of Artificial Sequence Synthetic oligonucleotide Pair ID 300668; MM probe is SEQ ID NO16
cggttctttttgatggcgaccggcg

SEQ ID NO: 16 - DNA, 25 bp, Artificial Sequence
  Description of Artificial Sequence Synthetic oligonucleotide Pair ID 300668; PM probe is SEQ ID NO15
cggttctttttgttggcgaccggcg

SEQ ID NO: 17 - DNA, 25 bp, Artificial Sequence
  Description of Artificial Sequence Synthetic oligonucleotide Pair ID 25579; MM probe is SEQ ID NO18
ggccttagcccgtgctgccgtacga

SEQ ID NO: 18 - DNA, 25 bp, Artificial Sequence
  Description of Artificial Sequence Synthetic oligonucleotide Pair ID 25579; PM probe is SEQ ID NO17
ggccttagcccgagctgccgtacga

SEQ ID NO: 19 - DNA, 25 bp, Artificial Sequence
  Description of Artificial Sequence Synthetic oligonucleotide Pair ID 176744; MM probe is SEQ ID NO20
cgcatgtcgagtatgttaaatatcc

SEQ ID NO: 20 - DNA, 25 bp, Artificial Sequence
  Description of Artificial Sequence Synthetic oligonucleotide Pair ID 176744; PM probe is SEQ ID NO19
cgcatgtcgagtttgttaaatatcc

SEQ ID NO: 21 - DNA, 25 bp, Artificial Sequence
  Description of Artificial Sequence Synthetic oligonucleotide Pair ID 263709; MM probe is SEQ ID NO22
cccaggttcgatagtaccaattagg

SEQ ID NO: 22 - DNA, 25 bp, Artificial Sequence
  Description of Artificial Sequence Synthetic oligonucleotide Pair ID 263709; PM probe is SEQ ID NO21
cccaggttcgatggtaccaattagg

SEQ ID NO: 23 - DNA, 25 bp, Artificial Sequence
  Description of Artificial Sequence Synthetic oligonucleotide Pair ID 289612; MM probe is SEQ ID NO24
ccaaggacgttcgtgagccgttcga

SEQ ID NO: 24 - DNA, 25 bp, Artificial Sequence
  Description of Artificial Sequence Synthetic oligonucleotide Pair ID 289612; PM probe is SEQ ID NO23
ccaaggacgttcttgagccgttcga

SEQ ID NO: 25 - DNA, 25 bp, Artificial Sequence
  Description of Artificial Sequence Synthetic oligonucleotide Pair ID 4284; MM probe is SEQ ID NO26
aaacgacccactgggactgtcctga

SEQ ID NO: 26 - DNA, 25 bp, Artificial Sequence
  Description of Artificial Sequence Synthetic oligonucleotide Pair ID 4284; PM probe is SEQ ID NO25
aaacgacccactaggactgtcctga

SEQ ID NO: 27 - DNA, 25 bp, Artificial Sequence
  Description of Artificial Sequence Synthetic oligonucleotide Pair ID 111799; MM probe is SEQ ID NO28
aaaattgcccgaaggaggatctatt

SEQ ID NO: 28 - DNA, 25 bp, Artificial Sequence
  Description of Artificial Sequence Synthetic oligonucleotide Pair ID 111799; PM probe is SEQ ID NO27
aaaattgcccgatggaggatctatt

SEQ ID NO: 29 - DNA, 25 bp, Artificial Sequence
  Description of Artificial Sequence Synthetic oligonucleotide Pair ID 57769; MM probe is SEQ ID NO30
atattactccccataacattcgtcc

SEQ ID NO: 30 - DNA, 25 bp, Artificial Sequence
  Description of Artificial Sequence Synthetic oligonucleotide Pair ID 57769; PM probe is SEQ ID NO29
atattactccccctaacattcgtcc

SEQ ID NO: 31 - DNA, 25 bp, Artificial Sequence
  Description of Artificial Sequence Synthetic oligonucleotide Pair ID 277222; MM probe is SEQ ID NO32
aacttccttagctccaaatacattc

SEQ ID NO: 32 - DNA, 25 bp, Artificial Sequence
  Description of Artificial Sequence Synthetic oligonucleotide Pair ID 277222; PM probe is SEQ ID NO31
aacttccttagcaccaaatacattc

SEQ ID NO: 33 - DNA, 25 bp, Artificial Sequence
  Description of Artificial Sequence Synthetic oligonucleotide Pair ID 39458; MM probe is SEQ ID NO34
aagtcccgtacgagcgcaacccttg

SEQ ID NO: 34 - DNA, 25 bp, Artificial Sequence
  Description of Artificial Sequence Synthetic oligonucleotide Pair ID 39458; PM probe is SEQ ID NO33
aagtcccgtacgcgcgcaacccttg

SEQ ID NO: 35 - DNA, 25 bp, Artificial Sequence
  Description of Artificial Sequence Synthetic oligonucleotide Pair ID 298577; MM probe is SEQ ID NO36
aaggcccggcactaactatgaccgg

SEQ ID NO: 36 - DNA, 25 bp, Artificial Sequence
  Description of Artificial Sequence Synthetic oligonucleotide Pair ID 298577; PM probe is SEQ ID NO35
aaggcccggcacgaactatgaccgg

SEQ ID NO: 37 - DNA, 25 bp, Artificial Sequence
  Description of Artificial Sequence Synthetic oligonucleotide Pair ID 126538; MM probe is SEQ ID NO38
acagtacttaaagaataagcaccgg

SEQ ID NO: 38 - DNA, 25 bp, Artificial Sequence
  Description of Artificial Sequence Synthetic oligonucleotide Pair ID 126538; PM probe is SEQ ID NO37
acagtacttaaaaaataagcaccgg

SEQ ID NO: 39 - DNA, 25 bp, Artificial Sequence
  Description of Artificial Sequence Synthetic oligonucleotide Pair ID 252982; MM probe is SEQ ID NO40
aaatattggggctcaaccttaagca

SEQ ID NO: 40 - DNA, 25 bp, Artificial Sequence
  Description of Artificial Sequence Synthetic oligonucleotide Pair ID 252982; PM probe is SEQ ID NO39
aaatattggggcgcaaccttaagca

SEQ ID NO: 41 - DNA, 25 bp, Artificial Sequence
  Description of Artificial Sequence Synthetic oligonucleotide Pair ID 197225; MM probe is SEQ ID NO42
cgtatagtacggtcagttttctaca

SEQ ID NO: 42 - DNA, 25 bp, Artificial Sequence
  Description of Artificial Sequence Synthetic oligonucleotide Pair ID 197225; PM probe is SEQ ID NO41
cgtatagtacgggcagttttctaca

SEQ ID NO: 43 - DNA, 25 bp, Artificial Sequence
  Description of Artificial Sequence Synthetic oligonucleotide Pair ID 162084; MM probe is SEQ ID NO44
ccgaaggaccggttctcgctcgact

SEQ ID NO: 44 - DNA, 25 bp, Artificial Sequence
  Description of Artificial Sequence Synthetic oligonucleotide Pair ID 162084; PM probe is SEQ ID NO43
ccgaaggaccggctctcgctcgact

SEQ ID NO: 45 - DNA, 25 bp, Artificial Sequence
  Description of Artificial Sequence Synthetic oligonucleotide Pair ID 228980; MM probe is SEQ ID NO46
cctagttaccgatcttgccctaggc

SEQ ID NO: 46 - DNA, 25 bp, Artificial Sequence
  Description of Artificial Sequence Synthetic oligonucleotide Pair ID 228980; PM probe is SEQ ID NO45
cctagttaccgagcttgccctaggc

SEQ ID NO: 47 - DNA, 25 bp, Artificial Sequence
  Description of Artificial Sequence Synthetic oligonucleotide Pair ID 123763; MM probe is SEQ ID NO48
cacagatttccctgtgttattcccc

SEQ ID NO: 48 - DNA, 25 bp, Artificial Sequence
  Description of Artificial Sequence Synthetic oligonucleotide Pair ID 123763; PM probe is SEQ ID NO47
cacagatttcccggtgttattcccc

SEQ ID NO: 49 - DNA, 25 bp, Artificial Sequence
  Description of Artificial Sequence Synthetic oligonucleotide Pair ID 240310; MM probe is SEQ ID NO50
tagcaatacatcaggtagttagtgg

SEQ ID NO: 50 - DNA, 25 bp, Artificial Sequence
  Description of Artificial Sequence Synthetic oligonucleotide Pair ID 240310; PM probe is SEQ ID NO49
tagcaatacatccggtagttagtgg

SEQ ID NO: 51 - DNA, 25 bp, Artificial Sequence
  Description of Artificial Sequence Synthetic oligonucleotide Pair ID 16702; MM probe is SEQ ID NO52
gactcaacaggcatcacatcagata

SEQ ID NO: 52 - DNA, 25 bp, Artificial Sequence
  Description of Artificial Sequence Synthetic oligonucleotide Pair ID 16702; PM probe is SEQ ID NO51
gactcaacaggcttcacatcagata

SEQ ID NO: 53 - DNA, 25 bp, Artificial Sequence
  Description of Artificial Sequence Synthetic oligonucleotide Pair ID 16703; MM probe is SEQ ID NO54
tatctgatgtgatgcctgttgagtc

SEQ ID NO: 54 - DNA, 25 bp, Artificial Sequence
  Description of Artificial Sequence Synthetic oligonucleotide Pair ID 16703; PM probe is SEQ ID NO53
tatctgatgtgaagcctgttgagtc

SEQ ID NO: 55 - DNA, 25 bp, Artificial Sequence
  Description of Artificial Sequence Synthetic oligonucleotide Pair ID 24979; MM probe is SEQ ID NO56
tcgggcgttgttaaatcaatcaaga

SEQ ID NO: 56 - DNA, 25 bp, Artificial Sequence
  Description of Artificial Sequence Synthetic oligonucleotide Pair ID 24979; PM probe is SEQ ID NO55
tcgggcgttgtttaatcaatcaaga

SEQ ID NO: 57 - DNA, 25 bp, Artificial Sequence
  Description of Artificial Sequence Synthetic oligonucleotide Pair ID 24980; MM probe is SEQ ID NO58
tcttgattgatttaacaacgcccga

SEQ ID NO: 58 - DNA, 25 bp, Artificial Sequence
  Description of Artificial Sequence Synthetic oligonucleotide Pair ID 24980; PM probe is SEQ ID NO57
tcttgattgattaaacaacgcccga

SEQ ID NO: 59 - DNA, 25 bp, Artificial Sequence
  Description of Artificial Sequence Synthetic oligonucleotide Pair ID 41927; MM probe is SEQ ID NO60
aagcatctgactcaacaggcatcac

SEQ ID NO: 60 - DNA, 25 bp, Artificial Sequence
  Description of Artificial Sequence Synthetic oligonucleotide Pair ID 41927; PM probe is SEQ ID NO59
aagcatctgactgaacaggcatcac

SEQ ID NO: 61 - DNA, 25 bp, Artificial Sequence
  Description of Artificial Sequence Synthetic oligonucleotide Pair ID 41928; MM probe is SEQ ID NO62
gtgatgcctgttgagtcagatgctt

SEQ ID NO: 62 - DNA, 25 bp, Artificial Sequence
  Description of Artificial Sequence Synthetic oligonucleotide Pair ID 41928; PM probe is SEQ ID NO61
gtgatgcctgttcagtcagatgctt

SEQ ID NO: 63 - DNA, 25 bp, Artificial Sequence
  Description of Artificial Sequence Synthetic oligonucleotide Pair ID 44977; MM probe is SEQ ID NO64
ctgatcgtatgtatggtctatggcc

SEQ ID NO: 64 - DNA, 25 bp, Artificial Sequence
  Description of Artificial Sequence Synthetic oligonucleotide Pair ID 44977; PM probe is SEQ ID NO63
ctgatcgtatgtttggtctatggcc

SEQ ID NO: 65 - DNA, 25 bp, Artificial Sequence
  Description of Artificial Sequence Synthetic oligonucleotide Pair ID 44978; MM probe is SEQ ID NO66
ggccatagaccatacatacgatcag

SEQ ID NO: 66 - DNA, 25 bp, Artificial Sequence
  Description of Artificial Sequence Synthetic oligonucleotide Pair ID 44978; PM probe is SEQ ID NO65
ggccatagaccaaacatacgatcag

SEQ ID NO: 67 - DNA, 25 bp, Artificial Sequence
  Description of Artificial Sequence Synthetic oligonucleotide Pair ID 46837; MM probe is SEQ ID NO68
taaatcaatcaagacatccggttgt

SEQ ID NO: 68 - DNA, 25 bp, Artificial Sequence
  Description of Artificial Sequence Synthetic oligonucleotide Pair ID 46837; PM probe is SEQ ID NO67
taaatcaatcaacacatccggttgt

SEQ ID NO: 69 - DNA, 25 bp, Artificial Sequence
  Description of Artificial Sequence Synthetic oligonucleotide Pair ID 46838; MM probe is SEQ ID NO70
acaaccggatgtcttgattgattta

SEQ ID NO: 70 - DNA, 25 bp, Artificial Sequence
  Description of Artificial Sequence Synthetic oligonucleotide Pair ID 46838; PM probe is SEQ ID NO69
acaaccggatgtgttgattgattta

SEQ ID NO: 71 - DNA, 25 bp, Artificial Sequence
  Description of Artificial Sequence Synthetic oligonucleotide Pair ID 48919; MM probe is SEQ ID NO72
cgatgatggctccgatccctttttc

SEQ ID NO: 72 - DNA, 25 bp, Artificial Sequence
  Description of Artificial Sequence Synthetic oligonucleotide Pair ID 48919; PM probe is SEQ ID NO71
cgatgatggctcggatccctttttc

SEQ ID NO: 73 - DNA, 25 bp, Artificial Sequence
  Description of Artificial Sequence Synthetic oligonucleotide Pair ID 48920; MM probe is SEQ ID NO74
gaaaaagggatcggagccatcatcg

SEQ ID NO: 74 - DNA, 25 bp, Artificial Sequence
  Description of Artificial Sequence Synthetic oligonucleotide Pair ID 48920; PM probe is SEQ ID NO73
gaaaaagggatccgagccatcatcg

SEQ ID NO: 75 - DNA, 25 bp, Artificial Sequence
  Description of Artificial Sequence Synthetic oligonucleotide Pair ID 74275; MM probe is SEQ ID NO76
cagtatcgcaccgagcgcaaaattt

SEQ ID NO: 76 - DNA, 25 bp, Artificial Sequence
  Description of Artificial Sequence Synthetic oligonucleotide Pair ID 74275; PM probe is SEQ ID NO75
cagtatcgcacccagcgcaaaattt

SEQ ID NO: 77 - DNA, 25 bp, Artificial Sequence
  Description of Artificial Sequence Synthetic oligonucleotide Pair ID 74276; MM probe is SEQ ID NO78
aaattttgcgctcggtgcgatactg

SEQ ID NO: 78 - DNA, 25 bp, Artificial Sequence
  Description of Artificial Sequence Synthetic oligonucleotide Pair ID 74276; PM probe is SEQ ID NO77
aaattttgcgctgggtgcgatactg

SEQ ID NO: 79 - DNA, 25 bp, Artificial Sequence
  Description of Artificial Sequence Synthetic oligonucleotide Pair ID 80839; MM probe is SEQ ID NO80
aatcagcttctgagaaaccggttgt

SEQ ID NO: 80 - DNA, 25 bp, Artificial Sequence
  Description of Artificial Sequence Synthetic oligonucleotide Pair ID 80839; PM probe is SEQ ID NO79
aatcagcttctgtgaaaccggttgt

SEQ ID NO: 81 - DNA, 25 bp, Artificial Sequence
  Description of Artificial Sequence Synthetic oligonucleotide Pair ID 80840; MM probe is SEQ ID NO82
acaaccggtttctcagaagctgatt

SEQ ID NO: 82 - DNA, 25 bp, Artificial Sequence
  Description of Artificial Sequence Synthetic oligonucleotide Pair ID 80840; PM probe is SEQ ID NO81
acaaccggtttcacagaagctgatt

SEQ ID NO: 83 - DNA, 25 bp, Artificial Sequence
  Description of Artificial Sequence Synthetic oligonucleotide Pair ID 83957; MM probe is SEQ ID NO84
ctcaacaggcatcacatcagataat

SEQ ID NO: 84 - DNA, 25 bp, Artificial Sequence
  Description of Artificial Sequence Synthetic oligonucleotide Pair ID 83957; PM probe is SEQ ID NO83
ctcaacaggcatgacatcagataat

SEQ ID NO: 85 - DNA, 25 bp, Artificial Sequence
  Description of Artificial Sequence Synthetic oligonucleotide Pair ID 83958; MM probe is SEQ ID NO86
attatctgatgtgatgcctgttgag

SEQ ID NO: 86 - DNA, 25 bp, Artificial Sequence
  Description of Artificial Sequence Synthetic oligonucleotide Pair ID 83958; PM probe is SEQ ID NO85
attatctgatgtcatgcctgttgag

SEQ ID NO: 87 - DNA, 25 bp, Artificial Sequence
  Description of Artificial Sequence Synthetic oligonucleotide Pair ID 93455; MM probe is SEQ ID NO88
tttctgtaaaacaggcatggatatc

SEQ ID NO: 88 - DNA, 25 bp, Artificial Sequence
  Description of Artificial Sequence Synthetic oligonucleotide Pair ID 93455; PM probe is SEQ ID NO87
tttctgtaaaactggcatggatatc

SEQ ID NO: 89 - DNA, 25 bp, Artificial Sequence
  Description of Artificial Sequence Synthetic oligonucleotide Pair ID 93456; MM probe is SEQ ID NO90
gatatccatgcctgttttacagaaa

SEQ ID NO: 90 - DNA, 25 bp, Artificial Sequence
  Description of Artificial Sequence Synthetic oligonucleotide Pair ID 93456; PM probe is SEQ ID NO89
gatatccatgccagttttacagaaa

SEQ ID NO: 91 - DNA, 25 bp, Artificial Sequence
  Description of Artificial Sequence Synthetic oligonucleotide Pair ID 140612; MM probe is SEQ ID NO92
ctcaacatcctcaaaatagttggca

SEQ ID NO: 92 - DNA, 25 bp, Artificial Sequence
  Description of Artificial Sequence Synthetic oligonucleotide Pair ID 140612; PM probe is SEQ ID NO91
ctcaacatcctctaaatagttggca

SEQ ID NO: 93 - DNA, 25 bp, Artificial Sequence
  Description of Artificial Sequence Synthetic oligonucleotide Pair ID 140613; MM probe is SEQ ID NO94
tgccaactattttgaggatgttgag

SEQ ID NO: 94 - DNA, 25 bp, Artificial Sequence
  Description of Artificial Sequence Synthetic oligonucleotide Pair ID 140613; PM probe is SEQ ID NO93
tgccaactatttagaggatgttgag

SEQ ID NO: 95 - DNA, 25 bp, Artificial Sequence
  Description of Artificial Sequence Synthetic oligonucleotide Pair ID 193149; MM probe is SEQ ID NO96
atttcatcatcagtatcgcaccgag

SEQ ID NO: 96 - DNA, 25 bp, Artificial Sequence
  Description of Artificial Sequence Synthetic oligonucleotide Pair ID 193149; PM probe is SEQ ID NO95
atttcatcatcactatcgcaccgag

SEQ ID NO: 97 - DNA, 25 bp, Artificial Sequence
  Description of Artificial Sequence Synthetic oligonucleotide Pair ID 193150; MM probe is SEQ ID NO98
ctcggtgcgatactgatgatgaaat

SEQ ID NO: 98 - DNA, 25 bp, Artificial Sequence
  Description of Artificial Sequence Synthetic oligonucleotide Pair ID 193150; PM probe is SEQ ID NO97
ctcggtgcgatagtgatgatgaaat

SEQ ID NO: 99 - DNA, 25 bp, Artificial Sequence
  Description of Artificial Sequence Synthetic oligonucleotide Pair ID 195043; MM probe is SEQ ID NO100
taaaacaggcatggatatctgtgta

SEQ ID NO: 100 - DNA, 25 bp, Artificial Sequence
  Description of Artificial Sequence Synthetic oligonucleotide Pair ID 195043; PM probe is SEQ ID NO99
taaaacaggcatcgatatctgtgta